(19) United States
(12) Patent Application Publication
(10) Pub. No.: US 2015/0379238 A1
(43) Pub. Date: Dec. 31, 2015

(54) Wearable Imaging Device for Monitoring Food Consumption Using Gesture Recognition

(71) Applicant: Robert A. Connor, Forest Lake, MN (US)

(72) Inventor: Robert A. Connor, Forest Lake, MN (US)

(73) Assignee: Medibotics LLC, Forest Lake, MN (US)

(21) Appl. No.: 14/846,802

(22) Filed: Sep. 6, 2015

Related U.S. Application Data
(63) Continuation-in-part of application No. 13/616,238, filed on Sep. 14, 2012.
Application No. 13/616,238 is a continuation of application No. 13/902,919, filed on May 27, 2013.
Application No. 13/902,919 is a continuation-in-part of application No. 13/523,739, filed on Jun. 14, 2012, now Pat. No. 9,042,596.

(51) Int. Cl. G06F 19/00

(52) U.S. Cl. CPC G06F 19/3475

(57) ABSTRACT

This invention comprises devices and methods which use a wearable camera and gesture recognition in order to identify when a person is eating. Eating-related gestures are recognized by tracking the configuration and movement of a person's thumb, a person's index finger, a portion of food, and/or a food-transporting object (such as a fork, spoon, chop stick, drinking glass, beverage can, cup, mug, or bowl). These devices and methods can help people to better manage their food consumption, energy balance, and weight.

### CROSS-REFERENCE TO RELATED APPLICATIONS

This application: (a) is a continuation-in-part of U.S. patent application Ser. No. 13/616,238 entitled “Interactive Voluntary and Involuntary Caloric Intake Monitor” by Robert A. Connor filed on Sep. 14, 2012; and (b) is a continuation-in-part of U.S. patent application Ser. No. 13/902,919 entitled “Wearable Imaging Device for Monitoring Food Consumption using Gesture Recognition” by Robert A. Connor filed on May 27, 2013 which is a continuation-in-part of U.S. patent application Ser. No. 13/523,739 entitled “The Willpower Watch™ A Wearable Food Consumption Monitor” by Robert A. Connor filed on Jun. 14, 2012. The entire contents of these applications are incorporated herein by reference.

### FEDERALLY SPONSORED RESEARCH

Not Applicable

### SEQUENCE LISTING OR PROGRAM

Not Applicable

### BACKGROUND

### Field of Invention

This invention relates to wearable devices and methods for monitoring food consumption.

### INTRODUCTION

The United States population has some of the highest prevalence rates of obese and overweight people in the world. Further, these rates have increased dramatically during recent decades. In the late 1990's, around one in five Americans was obese. Today, that figure has increased to around one in three. It is estimated that around one in five American children is now obese. The prevalence of Americans who are generally overweight is estimated to be as high as two out of three.

This increase in the prevalence of Americans who are overweight or obese has become one of the most common causes of health problems in the United States. Potential adverse health effects from obesity include: cancer (especially endometrial, breast, prostate, and colon cancers); cardiovascular disease (including heart attack and arterial sclerosis); diabetes (type 2); digestive diseases; gallbladder disease; hypertension; kidney failure; obstructive sleep apnea; orthopedic complications; osteoarthritis; respiratory problems; stroke; metabolic syndrome (including hypertension, abnormal lipid levels, and high blood sugar); impairment of quality of life in general including stigma and discrimination; and even death. There are estimated to be over a quarter-million obesity-related deaths each year in the United States. The tangible costs to American society of obesity have been estimated at over $100 billion dollars per year. This does not include the intangible costs of human pain and suffering.

Obesity is a complex disorder with multiple interacting causal factors including genetic factors, environmental factors, and behavioral factors. A person's behavioral factors include the person's caloric intake (the types and quantities of food which the person consumes) and caloric expenditure (the calories that the person burns in regular activities and exercise). Energy balance is the net difference between caloric intake and caloric expenditure. Other factors being equal, energy balance surplus (caloric intake greater than caloric expenditure) causes weight gain and energy balance deficit (caloric intake less than caloric expenditure) causes weight loss. There are many factors that contribute to obesity. Good approaches to weight management are comprehensive in nature and engage the motivation of the person managing their own weight. Management of energy balance is a key part of an overall system for weight management. The invention that will be disclosed herein comprises a novel and useful technology that engages people in energy balance management as part of an overall system for weight management.

There are two key components to managing energy balance: (1) managing caloric intake—the types and quantities of food consumed; and (2) managing caloric expenditure—the calories burned in daily activities and exercise. Both components are essential, but there have been some large-scale studies indicating that the increase in obesity in the United States has been predominantly caused by increased food consumption. People in the U.S. are now consuming large portion sizes and too many calories. Of these calories consumed, there is too much saturated fat and not enough vitamins and minerals. Many people consistently underestimate the amount of food that they eat.

These adverse eating trends are fueling the increase in obesity despite the fact that many people are really trying to eat less, eat better, and lose weight. The American Obesity Association (AOA) estimates that around 30% of Americans are actively trying to lose weight. It appears that many people want to manage their food consumption, but the vast majority of these people are unsuccessful in doing so over the long term. Long-term compliance with diets is notoriously low.

### REVIEW OF THE PRIOR ART

There have been many innovations in the prior art to create technology to successfully monitor and/or control food consumption and caloric intake. This review and the invention that will be disclosed are focused on non-surgical approaches to measuring food consumption and caloric intake. The vast majority of non-surgical approaches to measuring food consumption in the prior art rely on voluntary logging of food consumption and/or calories. For decades, this was done on paper. Now this can be done with the help of an application on a smart phone, electronic pad, or other mobile electronic device. However, most of these computer-assisted devices and methods still rely on voluntary actions by the person to record what they eat.

Food and calorie logging methods that depend on voluntary human action each time that a person eats anything, even a snack, can be time-consuming They are associated with delays in food recording, “caloric amnesia,” errors of omission, chronic under-estimation of portion sizes, and low long-term compliance. Recently, there have been new approaches to measuring food consumption and/or caloric intake in an automatic and involuntary manner. For example, some approaches use wearable motion sensors, wearable sound sensors, or wearable cameras to monitor food consumption. FIGS. 1 through 4 show some of the methods for measuring food consumption and/or caloric intake in the prior art.

FIG. 1 shows a basic method of measuring food consumption and/or caloric intake based on voluntary data only. Voluntary data about food consumption is data that is collected by voluntary action performed by a person in association with an eating event other than the actual action of eating. The method in FIG. 1 has two steps: (101) receiving voluntary data about food consumption from voluntary action performed by the person; and (102) estimating caloric intake based on this voluntary data only. Examples of voluntary action can include writing, typing, touching a screen, speech, and taking pictures.

FIG. 2 shows a basic method of measuring food consumption and/or caloric intake based on involuntary data only. Involuntary data about food consumption is data that is collected automatically, such as by a sensor worn on the person, without requiring any voluntary action by the person in association with an eating event other than the actual action of eating. The method in FIG. 2 has two steps: (201) receiving involuntary data about food consumption from one or more sensors worn in or on the person; and (202) estimating caloric intake based on this involuntary data only. Examples of involuntary data can include data that is automatically collected from wearable motion sensors, wearable sound sensors, and wearable cameras.

FIG. 3 shows a method of measuring food consumption and/or caloric intake based on a combination of involuntary data and voluntary data that are independently collected. The method in FIG. 3 has three steps: (201) receiving involuntary data about food consumption from one or more sensors worn in or on the person; (101) receiving voluntary data about food consumption from voluntary action performed by the person; and (301) estimating caloric intake based on this involuntary data and/or voluntary data. The method shown in FIG. 4 is like that in FIG. 3 except that involuntary data about food consumption prompts the person to enter voluntary data about food consumption. As an example of the latter, a wearable motion sensor or sound sensor may detect probable food consumption and prompt the person to enter specifics concerning the types and quantities of food consumed.

The following are some specific examples of innovative prior art:

Brown (U.S. Patent Application 20080262557, “Obesity Management System”) appears to disclose a system and method for obesity management that includes an interactive user interface and remote monitoring capability. This system can be embodied in an implant that automatically collects periodic measurements of parameters affecting a person's obesity. User interactive sessions for calibration ensure more accurate feedback.

Cox (U.S. Patent Application 20030076983, “Personal Food Analyzer”) appears to disclose a system that takes two separate pictures of food, automatically identifies the food, and then estimates the caloric intake associated with the food. If the automated system makes a mistake in food identification, then the person can correct this mistake manually.

Fernstrom et al. (U.S. Patent Application 20090012433, “Method, Apparatus and System for Food Intake and Physical Activity Assessment”) appear to disclose a device worn on a person that continuously collects video data, including video images of eating events and other physical activities. The device can also collect sound data. The device can be worn like a necklace around a person's neck. Collected data is analyzed, in a largely-automated manner, to identify food consumed and other physical activities. For privacy reasons, the system includes automatic mechanisms to identify images of people and to screen out such images from the images retained in memory.

Hoover et al. (U.S Patent Application 20100194573, “Weight Control Device”) appear to disclose a device worn on a person that uses a motion sensor to estimate the number and timing of bites of food consumed by the person. In an example, the device can be worn on the person's wrist or hand. Long term data analysis can be used to verify the accuracy of bite estimation.

Karnieli (U.S. Patent Application 20020022774 and U.S. Pat. No. 6,508,762, “Method for Monitoring Food Intake”) appears to disclose a system including a camera worn on a person that takes pictures of food placed in front of the person, identifies the food, and then provides feedback concerning whether it is acceptable for the person to eat the food or not. If the system makes a mistake in food identification, then the person can correct this mistake manually.

Mault et al. (U.S. Patent Applications 20010049470, “Diet and Activity Monitoring Device” and 20030065257, “Diet and Activity Monitoring Device,” and U.S. Pat. No. 6,513,532, “Diet and Activity-Monitoring Device”) appear to disclose a body activity monitor worn by a person, with one or more sensors, that can automatically create an “activity flag” each time that a person eats. These sensors may include a motion sensor, imaging sensor, or GPS sensor. The “activity flag” can include motion, image, sound, and/or location data. The system can prompt the person for more information based on activity flags. In various examples, identification of food consumed can be done voluntarily by the person wearing the monitor as prompted by the “activity flags”, can be done by a person in a remote location using data transfer, or can be done automatically by the system.

Pacione et al. (U.S. Patent Application 20050113650, “System for Monitoring and Managing Body Weight and Other Physiological Conditions Including Iterative and Personalized Planning, Intervention and Reporting Capability”) appear to disclose a device that combines information from a physiological sensor and voluntary information from a person to estimate caloric intake. The system uses adaptive and inferential methods to simplify food entry. If the person cannot remember what they ate for a particular meal, then the system can insert an estimated number of calories based on the person's historical eating habits.

Shalon et al. (U.S. Patent Applications 20060064037, “Systems and Methods for Monitoring and Modifying Behavior,” 20110125063, “Systems and Methods for Monitoring and Modifying Behavior,” 20110276312, “Device for Monitoring and Modifying Eating Behavior,” and U.S. Pat. No. 7,914,468, “Systems and Methods for Monitoring and Modifying Behavior”) appear to disclose a wearable device with sound sensors to detect non-verbal acoustic energy or a jaw motion sensor. The device can detect chewing and create a log of food consumed. In an example, the system can detect an eating event automatically and prompt the user to enter what they ate via a menu-driven interface or a voice-activated interface. Alternatively, the system may automatically identify the type of food consumed using a chemical sensor. The person can also manually enter an eating event. The system can adapt to the person's eating habits and can be calibrated using body mass detection means. If the person does not enter information for a meal, then the system can insert an estimated number of calories based on the person's historical eating habits.

Srivathsa et al. (U.S. Patent Application 20070106129, “Dietary Monitoring System for Comprehensive Patient Management”) appear to disclose a device with at least one physiological sensor that can monitor food consumption without manual input or even with incorrect manual input. Sensors can be selected from the group consisting of: a sodium sensor, a weight measuring sensor, a blood pressure sensor, a heart rate sensor, an INR/Coumadin sensor, a glucose sensor, a respiration sensor, an insulin sensor, a temperature sensor, and a hydration sensor. Deviation of collected data from an expected dietary model can result in reports or alarms.

Stivoric et al. (U.S. Patent Applications 20040152957, “Apparatus for Detecting, Receiving, Deriving and Displaying Human Physiological And Contextual Information” and 20080275309, “Input Output Device for Use with Body Monitor,” and U.S. Pat. No. 7,285,090, “Apparatus for Detecting, Receiving, Deriving and Displaying Human Physiological and Contextual Information” and U.S. Pat. No. 7,959,567, “Device to Enable Quick Entry of Caloric Content”) appear to disclose a device that is worn on a person to track caloric intake and expenditure. The device analyzes discrepancies between predicted weight and actual weight to estimate caloric amounts. When automatic interpretation of data is uncertain, the device prompts the person with questions. Stivoric et al. (U.S. Pat. No. 7,020,508, “Apparatus for Detecting Human Physiological and Contextual Information”) appears to disclose a device with physiological sensors which determine whether a person has complied with a predetermined routine.

Teller et al. (U.S Patent Applications 20040133081, 20080167536, 20080167537, 20080167538, 20080171920, 20080171921, and 20080171922, “Method and Apparatus for Auto Journaling of Body States and Providing Derived Physiological States Utilizing Physiological and/or Contextual Parameter” and U.S. Pat. No. 8,157,731, “Method and Apparatus for Auto Journaling of Continuous or Discrete Body States Utilizing Physiological and/or Contextual Parameters”) appear to disclose a calorie tracking system with one or more sensors that can fill in gaps for missing meals based on historical eating patterns. The device analyzes discrepancies between predicted weight and actual weight to estimate caloric amounts. When the device is uncertain how to interpret data, it prompts the person with questions.

### SUMMARY OF THIS INVENTION

Despite advances in the prior art, there remains an unmet need for better wearable devices and methods to automatically monitor food consumption. Such devices and methods can help people to better manage their food consumption, energy balance, and weight. This invention can be embodied in devices and methods which use a wearable camera and gesture recognition in order to identify when a person is eating. Pictures taken by the wearable camera are analyzed by a data processor in order to identify eating-related gestures. Eating-related gestures are recognized by tracking the configuration and movement of one or more objects selected from the group consisting of: the person's thumb comprising a distal segment and a proximal segment; the person's index finger comprising a distal segment, a middle segment, and a proximal segment; a portion of food; and a food-transporting object selected from the group consisting of a fork, spoon, chop stick, drinking glass, beverage can, cup, mug, and bowl. In an example, a virtual model of one or more of these objects can be created and this virtual model can then analyzed in order to recognize eating-related gestures.

### BRIEF INTRODUCTION TO THE FIGURES

FIGS. 1 through 4 relate to prior art and were discussed earlier.

FIG. 5 shows an example of an iterative method to measure caloric intake.

FIG. 6 is like FIG. 5, except that additional involuntary data is also collected.

FIG. 7 shows a method for measuring caloric intake in which data collection can escalate from a first, less-intrusive level to a second, more-intrusive level.

FIG. 8 is like FIG. 7, except that first and second level involuntary data sensors are specified as motion and imaging sensors, respectively.

FIG. 9 is like FIG. 7, except that first and second level involuntary data sensors are specified as sound and imaging sensors, respectively.

FIG. 10 shows a method for measuring caloric intake in which data collection can escalate from a first level, to a second level, to a third level.

FIG. 11 shows a method for measuring caloric intake in which operation of an imaging sensor escalates from motion-triggered operation to continuous operation.

FIG. 12 is like FIG. 11, except that a first-level operation of an imaging sensor is sound-triggered.

FIG. 13 shows a method for measuring caloric intake wherein an estimation process is refined.

FIG. 14 shows a method for measuring caloric intake wherein additional data concerning food consumption is collected if predicted vs. actual weight gain or loss do not meet criteria for similarity and/or convergence.

FIG. 15 is like FIG. 14, except that additional data concerning caloric expenditure is also collected if predicted vs. actual weight gain or loss do not meet criteria for similarity and/or convergence.

FIG. 16 shows a method for measuring caloric intake in which data collection can escalate from a first, less-intrusive level to a second, more-intrusive level.

FIG. 17 is like FIG. 16, except that first and second level involuntary data sensors are specified as motion and imaging sensors, respectively.

FIG. 18 is like FIG. 16, except that first and second level involuntary data sensors are specified as sound and imaging sensors, respectively.

FIG. 19 shows a method for measuring caloric intake in which operation of an imaging sensor can escalate from motion-triggered operation to continuous operation.

FIG. 20 is like FIG. 19, except that a first-level operation of an imaging sensor is sound-triggered.

FIG. 21 shows a device to measure caloric intake that is worn on a person's wrist, wherein a device includes a motion sensor, a microphone and speaker unit, a video camera, and a data processing and transmission unit.

FIG. 22 shows this device as a person tilts a glass up to their mouth.

FIG. 23 shows this device asking a person what they are eating.

FIG. 24 shows this device receiving a response from a person concerning what they are eating.

FIG. 25 shows this device receiving information about a person's weight from a scale.

FIGS. 26 and 27 show a device taking pictures of what a person is consuming if needed because predicted vs. actual weight gain or loss do not meet criteria for similarity and/or convergence.

FIGS. 28, 29, and 31 show a device to measure caloric intake that is worn on a person's neck, wherein a device includes a microphone and speaker unit, a video camera, and a data processing and transmission unit.

FIG. 28 shows a device detecting biting, chewing, or swallowing sounds as a person eats.

FIG. 29 shows a device receiving information from a person concerning what they are eating.

FIG. 30 shows a device receiving information about a person's weight from a scale.

FIG. 31 shows a device taking pictures of what a person is consuming if needed because predicted vs. actual weight gain or loss do not meet criteria for similarity and/or convergence.

FIGS. 32 and 33 show two sequential views of a device comprising two opposite-facing cameras that are worn on band around a person's wrist.

FIGS. 34 and 35 show pictures of a person's mouth and of a food source from the perspectives of two cameras.

FIGS. 36 and 37 show an example of a device with only one camera worn on a band around a person's wrist.

FIGS. 38 and 39 show an example of a device wherein a camera's field of vision automatically shifts as food moves toward a person's mouth.

FIGS. 40, 41, 42, 43, 44, and 45 show an example of how a device can function in a six-picture sequence of food consumption.

FIGS. 46 and 47 show a two-picture sequence of how the field of vision from a single wrist-worn camera shifts as a person brings food up to their mouth.

FIGS. 48 and 49 show a two-picture sequence of how the fields of vision from two wrist-worn cameras shift as a person brings food up to their mouth.

FIGS. 50, 51, and 52 show an example of example of a tamper-resistant device that monitors the line of sight to a person's mouth and responds if this line of sight is obstructed.

FIG. 53 shows an example of a tamper-resistant device using a first imaging member to monitor a person's mouth and a second imaging member to scan for food sources.

FIG. 54 shows a device for recognizing eating-related gestures comprising a wearable camera in eyewear.

FIG. 55 shows a device for recognizing eating-related gestures comprising a wearable camera in earwear.

FIG. 56 shows a device for recognizing eating-related gestures comprising a wearable camera on a necklace.

FIGS. 57 through 59 show an eating-related gesture wherein a person grasps food with their thumb and index finger, with the index finger on top.

FIGS. 60 through 62 show an eating-related gesture wherein a person grasps food with their thumb and index finger, with the thumb on top.

FIGS. 63 through 65 show an eating-related gesture wherein a person grasps food with their thumb and index finger and then rotates the food.

FIGS. 66 through 68 show an eating-related gesture wherein a person grasps food with two hands.

FIGS. 69 through 71 show an eating-related gesture wherein a person grasps food in their fist.

FIGS. 72 through 74 show an eating-related gesture wherein a person uses a knife to cut food.

FIGS. 75 through 77 show an eating-related gesture wherein a person grasps a fork in their fist.

FIGS. 78 through 80 show an eating-related gesture wherein a person grasps a spoon in their fist.

FIGS. 81 and 82 show an eating-related gesture wherein a person uses a fork with the handle resting between the thumb and index finger.

FIGS. 83 and 84 show an eating-related gesture wherein a person uses a spoon with the handle resting between the thumb and index finger.

FIGS. 85 and 86 show an eating-related gesture wherein a person uses chop sticks with their proximal ends resting between the thumb and index finger.

FIGS. 87 through 89 show a eating-related gesture wherein a person grasps and tilts a beverage glass.

FIG. 90 shows an eating-related gesture wherein a person grasps a beverage can.

FIG. 91 shows an eating-related gesture wherein a person grasps a (tea) cup.

FIG. 92 shows an eating-related gesture wherein a person grasps a cup (or mug) with a thumb and two fingers.

FIG. 93 shows an eating-related gesture wherein a person grasps a cup (or mug) with a thumb and four fingers.

FIG. 94 shows an eating-related gesture wherein a person grasps a bowl with two hands.

### DETAILED DESCRIPTION OF THE FIGURES

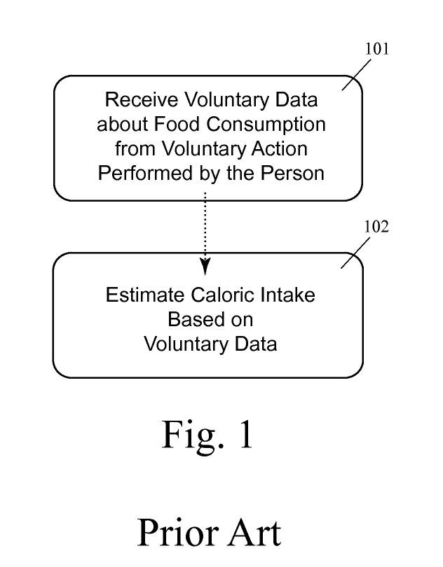

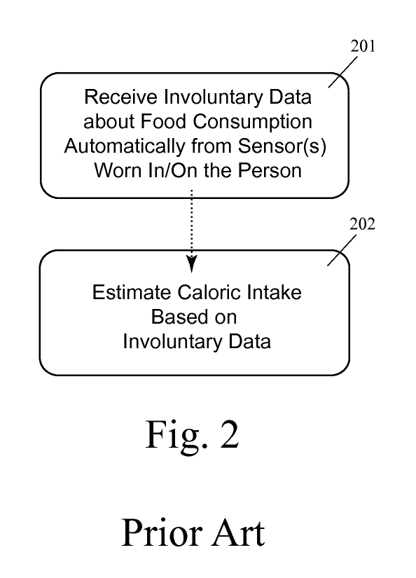

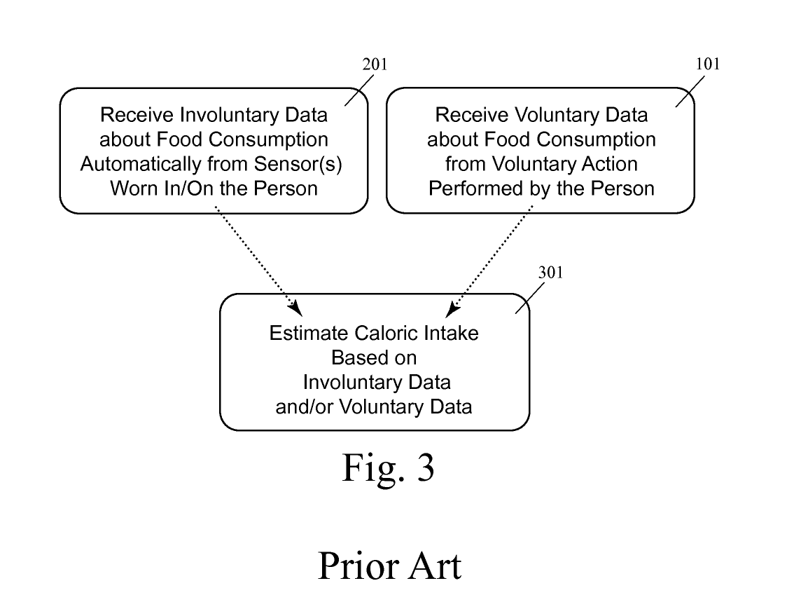

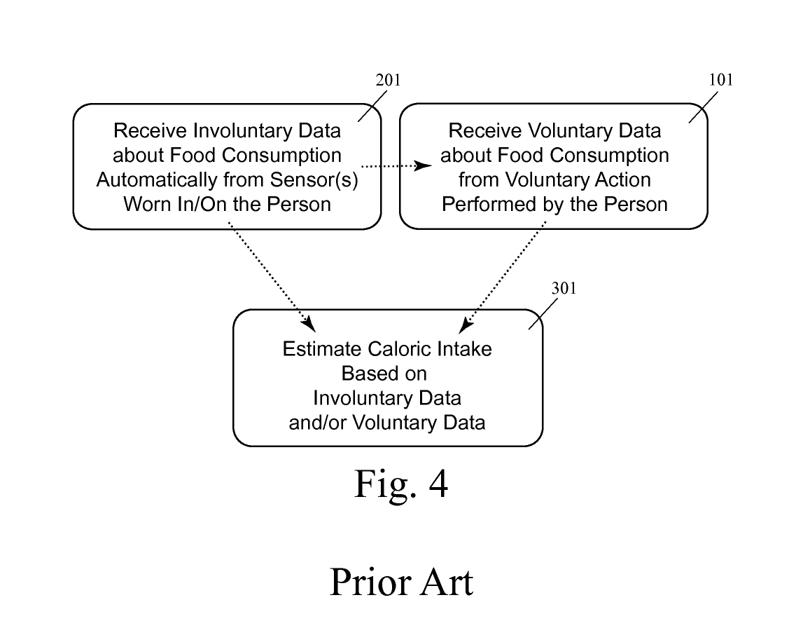

FIGS. 1 through 4 relate to prior art and were discussed previously.

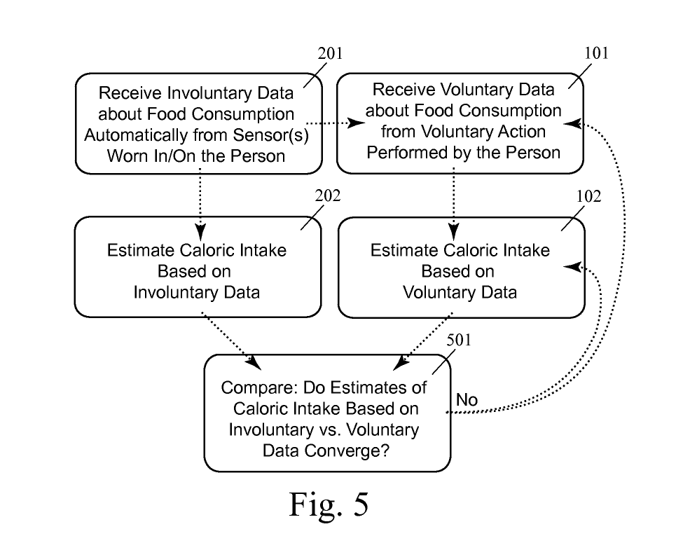

FIGS. 5 through 31 show examples of methods and devices which measure a person's food consumption and/or caloric intake, wherein two estimates of caloric intake from different data sources are compared. One estimate is based on involuntary data concerning food consumption that is collected from relatively non-intrusive sensors and one estimate is based on voluntary data concerning food consumption that comes from action by the person in association with an eating event other than the actual action of eating. Additional data from relatively more-intrusive sensors is only collected if the initial estimates of food consumption and/or caloric intake do not meet criteria for similarity and/or convergence. FIGS. 5 through 31 also show examples of methods and devices which measure a person's food consumption and/or caloric intake wherein the predicted weight gain or loss for the person is compared to the actual weight gain or loss for the person. If predicted vs. actual weight gain or loss do not meet criteria for similarity and/or convergence, then additional information concerning food consumption is collected from relatively more-intrusive sensors.

FIGS. 5 through 31 also show examples of methods and devices with multiple sensors to measure food consumption and/or caloric intake. For example, a device for measuring a person's caloric intake can comprise: (a) a first sensor and/or user interface that collects a first set of data concerning what the person eats; (b) a data processor that calculates a first estimate of the person's caloric intake based on the first set of data, uses this first estimate of the person's caloric intake to estimate predicted weight change for the person during a period of time, and compares predicted to actual weight change to determine whether predicted and actual weight change meet criteria for similarity and/or convergence; and (c) a second sensor and/or user interface that collects a second set of data concerning what the person eats if the criteria for similarity and/or convergence of predicted and actual weight change are not met. FIGS. 5 through 31 also show examples of method and devices for automatically and iteratively adjusting the tradeoff between accuracy and intrusiveness based on empirical verification of caloric intake measurement accuracy over time. In this manner, a device can achieve a desired level of accuracy in measurement of food consumption and/or caloric intake, while minimizing intrusiveness. In the process, a device can advantageously engage the person in accurate measurement of their caloric intake by rewarding accurate voluntary reporting of caloric intake with lower levels of intrusiveness.

FIG. 5 shows an example of a five-step iterative method for measuring a person's food consumption and caloric intake. In this specification, food is broadly interpreted to include beverages and soft food, as well as solid food. In an example, this method can be performed with the assistance of one or more computing units or data processors. A computing unit may be incorporated into a wearable device, into a mobile device, or located in a remote location via data transmission means such as wireless communication or the internet.

The method shown in FIG. 5 includes step 201 that comprises receiving involuntary data about the person's food consumption, in an automatic manner, from one or more sensors that are worn in or on the person. Involuntary data about food consumption is defined herein as data about food consumption that is received in an automatic manner that does not require any voluntary action by the person in association with an eating event, other than the actual action of eating. For example, if a camera worn on a person's wrist automatically records and analyzes images that indicate that the person is eating, then this would be involuntary data about food consumption. In another example, if a motion sensor worn on a person's wrist automatically records and analyzes motion data that indicates that the person is eating, then this would also be involuntary data about food consumption.

Involuntary data about food consumption is in contrast to voluntary data about food consumption. Voluntary data about a person's food consumption requires voluntary action by the person in association with an eating event, other than the actual action of eating. For example, if a person manually aims a digital and/or smart phone camera toward food which they are going to eat and then manually presses a button to take a picture of this food, then the resulting image is voluntary data about food consumption. In another example, maintaining a traditional diet log, recording food consumed by manual writing on paper, is another method of collecting voluntary data about food consumption. This latter method has been used for many decades.

Returning to our discussion of step 201 in FIG. 1, in various examples involuntary data about a person's food consumption can be collected automatically through one or more sensors. These one or more sensors can be selected from the group consisting of: accelerometer, inclinometer, other motion sensor, sound sensor, smell or olfactory sensor, blood pressure sensor, heart rate sensor, EEG sensor, ECG sensor, EMG sensor, electrical sensor, chemical sensor, gastric activity sensor, GPS sensor, camera or other image-creating sensor or device, optical sensor, piezoelectric sensor, respiration sensor, strain gauge, electrogoniometer, chewing sensor, swallow sensor, temperature sensor, and pressure sensor.

In an example, these one or more sensors can be worn on the person's body, either directly or worn on clothing. In various examples, these one or more sensors can be worn on the person's wrist, neck, ear, head, arm, finger, mouth or other locations on the person's body. In various examples, these one or more sensors can be worn in manner similar to that of a wrist watch, bracelet, necklace, pendant, button, belt, hearing aid, bluetooth device, ear ring, and/or finger ring. In other examples, these one or more sensors can be implanted within the person's body and may internally monitor chewing, swallowing, biting, other muscle activity, enzyme secretion, neural signals, or other ingestion-related processes or activities.

In an example, involuntary data can be analyzed to extract information about the types and quantities of food consumed. In various examples, involuntary data about food consumption can be analyzed by one or more methods selected from the group consisting of: pattern recognition or identification; human motion recognition or identification; facial recognition or identification; gesture recognition or identification; food recognition or identification; sound pattern recognition; Fourier transformation; chemical recognition or identification; smell recognition or identification; word recognition or identification; logo recognition or identification; bar code recognition or identification; and 3D modeling.

In various examples, involuntary data about food consumption can include information selected from the group consisting of: the types and volumes of food sources within view and/or reach of the person; changes in the volumes of these food sources over time; the number of times that the person brings their hand (with food) to their mouth; the sizes or portions of food that the person brings to their mouth; and the number, frequency, speed, or magnitude of chewing, biting, or swallowing movements.

In an example, one or more sensors may continually monitor the person to collect data about the person's food consumption. In various examples, one or more sensors may monitor sounds, motion, images, speed, geographic location, or other parameters. In other examples, one or more sensors may monitor parameters periodically, intermittently, or randomly. In other examples, the output of one type of sensor can be used to trigger operation of another type of sensor. In an example, a relatively less-intrusive sensor (such as a motion sensor) can be used to continually monitor the person and this less-intrusive sensor may trigger operation of a more-intrusive sensor (such as an imaging sensor) only when probable food consumption is detected by the less-intrusive sensor.

In various examples, some types of sensors and some modes of operation are more intrusive with respect to a person's privacy and/or time than other types of sensors and modes of operation. In an example, wearable motion sensors and sound sensors can be less intrusive than wearable imaging sensors. In an example, a wearable camera that records images within a narrow field of vision and a shorter focal length can be less intrusive than a wearable camera that records images with a wide field of vision and longer focal length. In an example, wearable sensors that operate only when triggered by a probable eating event are less intrusive than sensors than operate continuously. In an example, sensors that are worn under clothing or on less-prominent parts of the body are less intrusive than sensors that are worn on highly-visible portions of clothing or the body. In an example, sensors that allow a person to enter food consumption data a considerable time after a meal (delayed diet logging) are less intrusive than sensors that actively prompt a person to enter food consumption data right in the middle of a meal (real-time diet logging).

In the example that is shown in FIG. 5, the involuntary data about food consumption that is received in step 201 is subsequently used to estimate the person's caloric intake in step 202. In an example, the types and quantities of food consumed are explicitly identified in step 201. In other examples, the involuntary data collected in step 201 can be in a raw format that does not explicitly identify the types and quantities of food consumed. In this latter case, this raw data can be analyzed in step 202 to identify the types and quantities of food consumed as well as total caloric intake. In various examples, this analysis may include one or more methods selected from the group consisting of: food recognition or identification; visual pattern recognition or identification; human motion recognition or identification; chemical recognition or identification; smell recognition or identification; sound pattern recognition; word recognition or identification; logo recognition or identification; bar code recognition or identification; and 3D modeling.

In an example, information concerning the types and quantities of food consumed is used to estimate caloric intake in step 202. In an example, a standard database of the calories associated with various types of food, and portions thereof, can be used to convert information about the types and quantities of food consumed into an estimate of caloric intake in step 202. In another example, a customized database specific to an individual can be created based on the person's past eating habits. In an example, an estimate of caloric intake can be estimated directly from raw involuntary data received in step 201 without the need for an intermediate step involving identifying specific types and quantities of food consumed. In an example, an estimate of caloric intake can be for a particular eating event, such as a specific meal or snack. In another example, an estimate of caloric intake can be for a specific period of time such as a day, week, or month.

In an example, the estimation of caloric intake in step 202 can be largely, or entirely, automated. In an example, this estimation of caloric intake in step 202 can be done by a data processing device such as a computer. In an example, this estimation process can be performed within a device that is worn in or on a person. In another example, this estimation process can be performed in a mobile device that is carried by the person. In another example, this estimation process can be performed in a computer in a remote location, with data transferred back and forth between a wearable device and a computer in the remote location. In an example, data transferred between a wearable device and a computer in a remote location can be encrypted for the sake of privacy.

In an example, identification of the types and quantities of food consumed by a person can be done, in whole or in part, by using a standardized database that associates certain patterns of output from involuntary data sensors with consumption of certain types and quantities of food. In an example, estimation of the number of calories consumed by the person can be done, in whole or in part, by using a standardized database that associates certain types and quantities of food with certain calorie values.

In an example, identification of the types and quantities of food consumed by the person can be done, in whole or in part, by predicting a person's current eating patterns based on the person's historical eating patterns. For example, if the person tends to eat a particular type of food at a particular time of day in a particular location, then this can be taken into account when identifying food consumed. In an example, estimation of the number of calories consumed by the person can be done, in whole or in part, by predicting the calories associated with particular foods or meals based on the person's historical eating patterns. For example, if the person tends to consume larger-than-standard portions of a particular food, then this can be taken into account when estimating calories.

In the example shown in FIG. 5, voluntary data about food consumption is received from voluntary action performed by the person in step 101. As defined earlier, voluntary data about a person's food consumption is data that is received from voluntary actions performed by the person in association with eating events, other than the actual actions of eating. In various examples, voluntary action for recording food consumption can be selected from the group consisting of: writing on paper, typing on a keyboard, touching a touch screen, moving a cursor, speaking into a device with voice recognition capability, gesturing to a device with gesture recognition capability, manually scanning a bar code or other food code; and manually initiating the taking of a picture of food that will be consumed.

In an example, the voluntary data about food consumption that is received in step 101 can include precise information concerning the types and quantities of food consumed. In another example, voluntary data about food consumption received in step 101 may only include indirect raw data such as a picture of food, or general food categories, which must be subsequently analyzed in order to identify the types and quantities of food consumed. In an example, this voluntary data can be received by a computer and stored therein.

In the example shown in FIG. 5, voluntary data entry in step 101 can be independently initiated by the person before an eating event, during the eating event, or after the eating event. In another example, voluntary data collection in step 101 can be prompted or solicited based on the results of involuntary data collection in step 201. For example, involuntary data may suggest a high probability that the person is eating, which could trigger a request for voluntary data entry. The possibility that step 101 can be prompted by step 201 is represented by the dotted-line arrow from step 201 to step 101. In an example of how this prompt can be operationalized, a wearable sensor may detect a probable eating event in step 201 and this detection may prompt the person to enter voluntary data about the eating event, if any, in step 101.

In various examples, prompting or soliciting voluntary data collection in step 101 can be done using one or more methods selected from the group consisting of: a ring tone, a voice prompt, a musical prompt, an alarm, some other sound prompt, a text message, a phone call, a vibration or other tactile prompt, a mild electromagnetic stimulus, an image prompt, or activation of one or more lights. In various examples, some of these prompts are less intrusive with respect to the person's privacy and/or time, while other prompts are more intrusive with respect to the person's privacy and/or time—especially in social eating situations. In various examples, prompts that are less easily detected by other people are generally less intrusive in social eating settings.

In various examples, voluntary data concerning food consumption can be received in step 101 before, concurrently with, or after involuntary data is received in step 201. If the person initiates voluntary data about food consumption in step 101 before an eating event is detected via involuntary data collection in step 201, then prompting of voluntary data collection by step 201 is not needed. In an example, a person's initiating voluntary data about food consumption prior to an eating event, wherein this submission comprises accurate reporting of food to be consumed, is rewarded by enabling the person to avoid a more intrusive prompt for data during the eating event.

As shown in the embodiment of this invention in FIG. 5, voluntary data about food consumption from step 101 is used to estimate the person's caloric intake in step 102. In an example, the types and quantities of food consumed can be precisely identified in step 101, so that all that needs to be done in step 102 is to assign calorie values to each food portion consumed.

In another example, voluntary data from step 101 can be in a relatively raw form that requires analysis in step 102 in order to identify the types and quantities of food consumed. For example, the voluntary data from step 101 may comprise images of food consumed, without any accompanying explanation from the person. In various examples, analysis of voluntary data in step 102 may include one or more methods selected from the group consisting of: food image recognition or identification; word recognition or identification; logo recognition or identification; bar code recognition or identification; and 3D modeling.

In an example, estimation of the number of calories consumed by the person in step 102 can be done, in whole or in part, by using a standardized database that associates certain types and quantities of food with certain calorie values. In an example, estimation of the number of calories consumed by the person in step 102 can be done, in whole or in part, by predicting the calories associated with particular foods or meals based on the person's historical eating patterns. For example, if the person tends to consume large portions of a particular food, then this is taken into account when estimating calories.

In an example, the estimation process in step 102 may include automated pattern recognition and analysis of voluntarily-entered images in order to identify food types and quantities. In an example, a database of types of food (and portions) and their associated calories can be used to convert types and quantities of food into calories. In an example, the estimation of caloric intake in step 102 can be done by a data processing device such as a computer. In an example, an estimate of caloric intake can be made for a particular eating event such as a particular meal or snack. In an example, an estimate of caloric intake can be made for a particular period of time such as a day, week, or month. In various examples, estimation of caloric intake from voluntary data in step 102 can occur before, concurrently with, or after the estimation of caloric intake from involuntary data in step 202.

In the embodiment of this invention that is shown in FIG. 5, the estimate of caloric intake based on involuntary data from step 202 is compared in step 501 to the estimate of caloric intake based on voluntary data from 102. In an example, a determination is made in step 501 concerning whether these two estimates of caloric intake are sufficiently similar. In an example, a determination in made in step 501 concerning whether these two estimates of caloric intake are similar and/or converge. In an example, determination of sufficient similarity and/or convergence can be based on quantitative criteria for similarity and/or convergence. In an example, this comparison and determination of similarity and/or convergence can be done within a computer.

In an example, the criteria for similarity and/or convergence of these two estimates of caloric intake can be based on the absolute value of the difference in calories between these two estimates being less than a target number of calories. This target number can differ depending on the eating event or the time period for which the caloric intake is estimated. In another example, the criteria for similarity and/or convergence of these two estimates of caloric intake can be based on the percentage difference in calories between these two estimates being less than a target percentage.

In another example, the criteria for similarity and/or convergence of these two estimates of caloric intake can be based on projected mathematical and/or statistical models. For example, mathematical convergence can be identified based on a series of paired estimates from involuntary and voluntary data over time. In an example, paired estimates from involuntary and voluntary data over time can come from a series of cycles through some or all of the steps in FIG. 5. In this case, convergence criteria can be based on projected mathematical and/or statistical convergence of these two estimates. In another example, criteria for similarity and/or convergence of these two estimates can be based on overlapping statistical confidence intervals or statistical hypothesis testing.

In an example, the criteria for similarity and/or convergence of these two estimates can apply to individual eating events, such as individual meals or snacks. In an example, the criteria for similarity and/or convergence of these two estimates can apply to several events spread out over a period of time. In an example, the criteria for similarity and/or convergence can apply to summary statistics spanning multiple eating events in manner that allows for some degree of variation and outliers, as long as long-term accuracy is maintained.

In an example, the person can be allowed to temporarily adjust the criteria for similarity and/or convergence. In another example, the person can be allowed to permanently adjust the criteria for similarity and/or convergence. In an example, the person's ability to adjust the criteria for similarity and/or convergence can depend on the degree of historical convergence of estimates from involuntary and voluntary data. In an example, the person can be given more control over adjustment of the convergence criteria as a reward for a history of accurately reporting voluntary data about food consumption and/or achievement of energy balance goals.

If the estimate of caloric intake from the involuntary data from step 202 and the estimate of caloric intake from voluntary data from step 102, in combination, meet the criteria for similarity and/or convergence in step 501, then the method shown in FIG. 5 can conclude after this comparison is done. If these estimates do not meet these criteria for similarity and/or convergence, then more information is required. In the case shown in FIG. 5, more information is collected by having the method cycle back to repeat steps 101 and/or 102, in repeated cycles, until the similarity and/or convergence criteria are met. Cycling back to steps 101 and/or 102 is represented by dotted line arrows from step 501 back up to steps 101 and 102.

In an example, if the similarity and/or convergence criteria are not met in step 501, then the person is prompted to provide additional voluntary data concerning food consumption in a repeat of step 101. In an example, this additional voluntary data can be similar in nature, but more detailed or broader in scope, than the data that was originally received in step 101. For example, if the data that the person entered the first time in step 101 was a brief natural-language phrase concerning food consumed (that the person entered into a device), then additional data in the second sub-cycle could comprise a detailed and structured (menu-driven) interface. In another example, this additional voluntary data could be quite different in nature. For example, if the data that the person entered the first time in step 101 was a brief verbal description of food, then additional data in the second sub-cycle could be a manually-taken picture of food.

In another example, if similarity and/or convergence criteria are not met in step 501, then the estimation process or estimation model in step 102 may be modified. In an example, the relative weights given to different data elements in the estimation process or the structure of the estimation model may be modified. In an example, the relative weights given to historical vs. current data in an estimation model may be adjusted. In an example, modification of the estimation process may use Bayesian statistical methods. In an example, modification of the estimation process may use nonlinear mathematical programming or optimization methods. In an example, modification of the estimation process may include goal-directed changes. In an example, modification of the estimation process may include randomized, non-goal-directed changes.

In various examples, if similarity and/or convergence criteria are not met in step 501, then the person may be prompted for additional data in a return to step 101, the estimation process may be modified in a return to step 102, or both steps 101 and 102 may be revisited. In this manner, a new estimate of caloric intake, one that is based on more-complete voluntary data, is created. The possibility of returning to steps 101 and/or 102 creates a potentially-repeating sub-cycle of steps 101, 102, and 501 in this method. In an example, this sub-cycle can repeat indefinitely until the caloric intake estimate from involuntary data and the caloric intake estimate from voluntary data meet the criteria for similarity and/or convergence. Alternatively, there can be a limit on how many times this sub-cycle repeats before it stops, regardless of whether the criteria for similarity and/or convergence have been met.

In the method shown in FIG. 5, the similarity and/or convergence of the caloric intake estimates from involuntary data and voluntary data functions as a proxy for data accuracy. However, even in the case wherein estimates of caloric intake based on involuntary data are consistently more accurate than estimates of caloric intake based on voluntary data, this method may be superior to estimating caloric intake based on involuntary data alone. Even if estimates from voluntary data are redundant or inferior to estimates from involuntary data, there are psychological and motivational benefits to engaging someone in managing their own energy balance and weight. The method shown in FIG. 5 can achieve the benefits of such engagement, while minimizing intrusion into the person's privacy and/or time.

The embodiment of this invention that is shown in FIG. 5 gives the person incentives to provide accurate and timely voluntary data concerning food consumption in step 101. In an example, the person can provide such voluntary data in step 101 first, before the automated detection of a likely eating event in step 201. In another example, accurate voluntary data can be provided when such data is prompted by automated detection of a likely eating event in step 201. In an example, if accurate and timely data concerning food consumption is not provided at first, then the person will be prompted to provide it when the estimates of caloric intake from involuntary and voluntary data fail to converge in step 501.

This method provides the person with multiple incentives to provide both accurate and timely voluntary data. One such incentive is the avoidance of increasingly-intrusive data collection methods in subsequent sub-cycles of steps 101, 102, and 501. As the person becomes more engaged and accurate with respect to voluntary reporting of caloric intake, involuntary data collection becomes less necessary and less intrusive.

Involuntary data and voluntary data generally have different strengths and weaknesses with respect to estimating caloric intake. Involuntary data in which sensors automatically monitor a person's behavior and surrounding space for eating events can be great for compliance and automated analysis of portion size, but can be intrusive. Voluntary data in which a person uses all of their senses to identify food consumed can be great for accuracy and privacy when the person is 100% compliant with reporting, but 100% long-term compliance with manual diet logging is rare. Combining both involuntary and voluntary data collection, in an optimal manner driven by empirical convergence of estimates (as shown in the method given in FIG. 5) can provide more accurate measurement of caloric intake than either involuntary data alone or voluntary data alone.

For example, on the one hand, a motion sensor that collects involuntary data concerning hand motion can accurately detect that a person is eating “something” each time that the person eats, but may not be able to accurately identify exactly what the person is eating. On the other hand, a person can accurately detect what they are eating each time that they eat, but they may forget to enter the eating event or may intentionally omit the eating event in the food log (in an passive act of denial).

A system in which a person is prompted by a motion sensor to enter what they eat (each time that they eat) can provide a more accurate measurement of caloric intake than either involuntary data from a motion sensor alone or voluntary data from manual diet logging alone. The method in FIG. 5 takes this concept even further. Additional voluntary data is collected until the two estimates of caloric intake meet the criteria for similarity and/or convergence. This provides the person with incentives for both timeliness and accuracy in voluntary data reporting of food consumption. It also actively engages the person in managing their own energy balance.

Entirely-voluntary systems for tracking food consumption are generally oblivious concerning skipped or inaccurate food consumption log entries. When a person has a snack and does not enter it into the log, then that is the end of the story. The log is a passive data collector, not an intelligent and interactive data-collecting agent. The method that is shown in FIG. 5 corrects this problem. Skipped or inaccurate voluntary data concerning food consumption triggers escalation in data collection. If the person does not provide accurate and timely information concerning an eating event, then this method cycles back to prompt them until they do so.

By way of a colorful analogy, this method and system for ensuring accurate measurement of caloric intake may be compared to the ridges in highway pavement along the sides of some roads that help to keep a person from driving their car off the road. If a driver stays alert and accurately stays within their lane, then they never encounter the ridges and may not even be aware of the ridges. However, if a driver becomes drowsy (or distracted) and begins to drift off the road, then their car tires hit the ridges, which creates a loud rumbling noise. This alerts the driver to correctively steer and get back on the road. While it is true that the noise of the tires on the ridges is intrusive (and potentially annoying), it serves an important purpose. It helps to keep the driver on the road, can prevent injury, and may even prevent death.

In an analogous manner to road ridges which help keep a driver safely on the road, the caloric intake method and system shown in FIG. 5 helps to keep a person “on the road” to proper energy balance. When the person promptly and accurately records food consumed, then this caloric intake measuring method and system is minimally intrusive. The collection of involuntary data may even become completely transparent to the person. However, if the person begins to figuratively “drift off the road” of energy balance (by not recording snacks or by entering inaccurate information concerning meals), then the system figuratively “creates a noise” to get the person back on track. While a secondary sub-cycle of data collection can be more intrusive (or even potentially annoying), it serves an important purpose. It helps the person to better track their caloric intake, to maintain energy balance, and to prevent the negative health outcomes associated with obesity.

Systems and methods for tracking food consumption which rely entirely on involuntary data collection do not engage the person in managing their own energy balance and weight. The method in FIG. 5 does not suffer from this limitation. This method, including convergence criteria, encourages the person to work together with automated sensors in order to track and manage their own caloric intake, maintain proper energy balance, and make progress toward their weight goals.

There are systems and methods in the prior art that use a fixed blend of involuntary and voluntary data to estimate caloric intake. These systems can be superior to those that depend on voluntary data alone, but even these systems do not minimize intrusion of the person's privacy and/or time in the achievement of a desired level of caloric intake measurement accuracy. The optimal blend of involuntary and voluntary data for estimating caloric intake can vary between individuals. It can also vary over time for the same individual. Real-time adjustment of the blend of involuntary and voluntary data is required to find the optimal blend that achieves desired accuracy with minimal intrusion into the person's privacy and/or time. The method in FIG. 5 corrects this problem. The method in FIG. 5 uses interactive adjustments and convergence criteria to achieve the desired level of accuracy in measuring caloric intake while minimizing intrusion into the person's privacy and/or time.

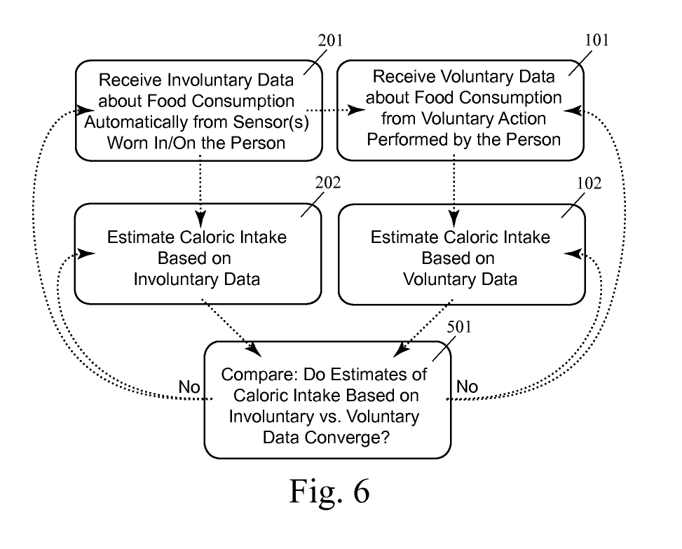

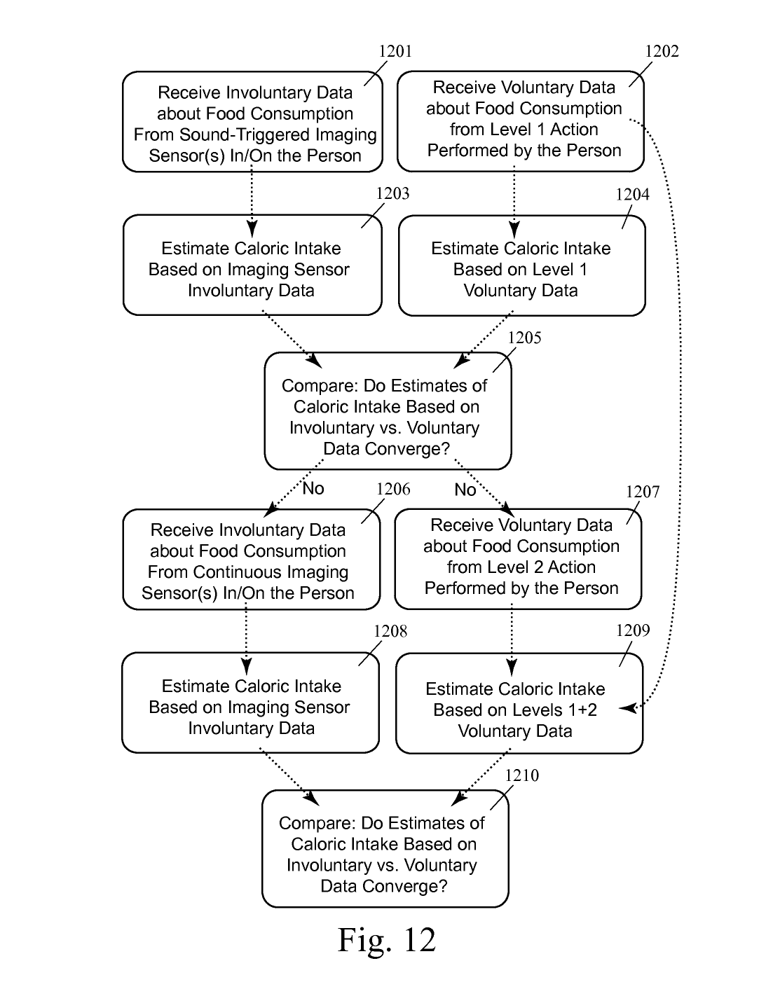

The next set of figures in this disclosure includes FIGS. 6 through 12. FIGS. 6 through 12 show additional examples of how this invention can be embodied, wherein these additional examples are variations on the method introduced in FIG. 5. The methods shown in FIGS. 6 through 12 all include collection of both involuntary data and voluntary data concerning food consumption, calculating and comparing estimates of caloric intake from these two data sources, and collecting additional information if the criteria for similarity and/or convergence of these two estimates are not met. Further, the examples in FIGS. 6 through 12 provide greater specificity with respect to what types of data and what types of sensors are used for data collection in a first data-collection cycle vs. subsequent data-collection cycles. All of the examples shown in FIGS. 6 through 12 also implicitly assume that the similarity and/or convergence of estimates from two data sources can function as a proxy for estimation accuracy. We will relax this assumption later in the examples shown after FIG. 12. We now discuss FIGS. 6 through 12 in detail.

FIG. 6 shows another example of how this invention can be embodied in a method for measuring caloric intake. The example in FIG. 6 is like the example in FIG. 5, except that it also includes a sub-cycle that collects additional involuntary data in the event that the estimates of caloric intake based on involuntary data and voluntary data do not meet the criteria for similarity and/or convergence. This is represented by the dotted-line arrows from step 501 back to steps 201 and 202. In FIG. 6, the lack of similarity and/or convergence prompts collection of additional involuntary data as well as additional voluntary data.

In an example, the collection of additional involuntary data in a second sub-cycle, in the event of non-convergence of estimates, is more intrusive (but also more accurate) than the collection of involuntary data a first sub-cycle. In an example, the nature of the additional involuntary data may be the same as the original involuntary data, but in greater detail. For example, the original involuntary data can be periodic, short-focal-length images from an imaging sensor worn by the person, but the additional involuntary data may be continuous, variable-focal-length images from the imaging sensor. In another example, the nature of the additional involuntary data may be different than that of the original involuntary data. For example, the original involuntary data may be motion patterns collected from a motion sensor worn by the person, but the additional involuntary data may be sound patterns from a sound sensor worn by the person.

In an example, the scope and depth of involuntary and voluntary data collection may be escalated until the two estimates of caloric intake based on involuntary data vs. voluntary data meet the criteria for similarity and/or convergence. In an example, similarity criteria can be used for a single pair of estimates and convergence criteria can be used for a time series of estimate pairs. While such escalation may sound harsh, the result is a system and method that is less intrusive than a system and method that always operates at a high level of intrusiveness regardless of the relative accuracy or convergence of estimates based on involuntary and voluntary data. As was the case in FIG. 5, convergence of estimates from involuntary and voluntary data functions as a proxy for accuracy.

Comparing the methods shown in FIG. 5 vs. FIG. 6, the method in FIG. 5 relies more on the accuracy of estimates from involuntary data, while the method in FIG. 6 is relatively-neutral with respect to the assumed relative accuracy of estimates from involuntary and voluntary data. Both methods implicitly assume that similarity and/or convergence of estimates from different sources can be used as a proxy for accuracy. Both methods engage the person in monitoring their caloric intake, which can be a key component of an overall system for energy balance and weight management.

In an example, steps 202 and 102 can occur in a simultaneous or parallel manner. In the event that the two estimates do not meet the criteria for similarity and/or convergence, the second iterations back to steps 201 and 202 and back to steps 101 and 102 can also occur simultaneously and in parallel. In another example, steps 202 and 102 can occur in a sequential or alternating manner. In the latter case, iteration back to steps 201 and 202 can occur in a sequential or alternating manner with iteration back to steps 101 and 102.

In an example, the ratio of iterations back to 201 and 202 vs. back to 101 and 102 need not be one-to-one. In an example, there may be multiple iterations back to 201 and 202 as compared to back to 101 and 102, or vice versa, depending on changes or convergence patterns in their respective caloric intake estimates. In an example, there may be relatively more iterations in involuntary data collection when estimated caloric intake values from involuntary data from successive cycles display significant changes with additional data collection. On the other hand, there may be relatively fewer iterations in involuntary data collection when estimated caloric intake values from involuntary data from successive cycles do not display significant changes with additional data collection.

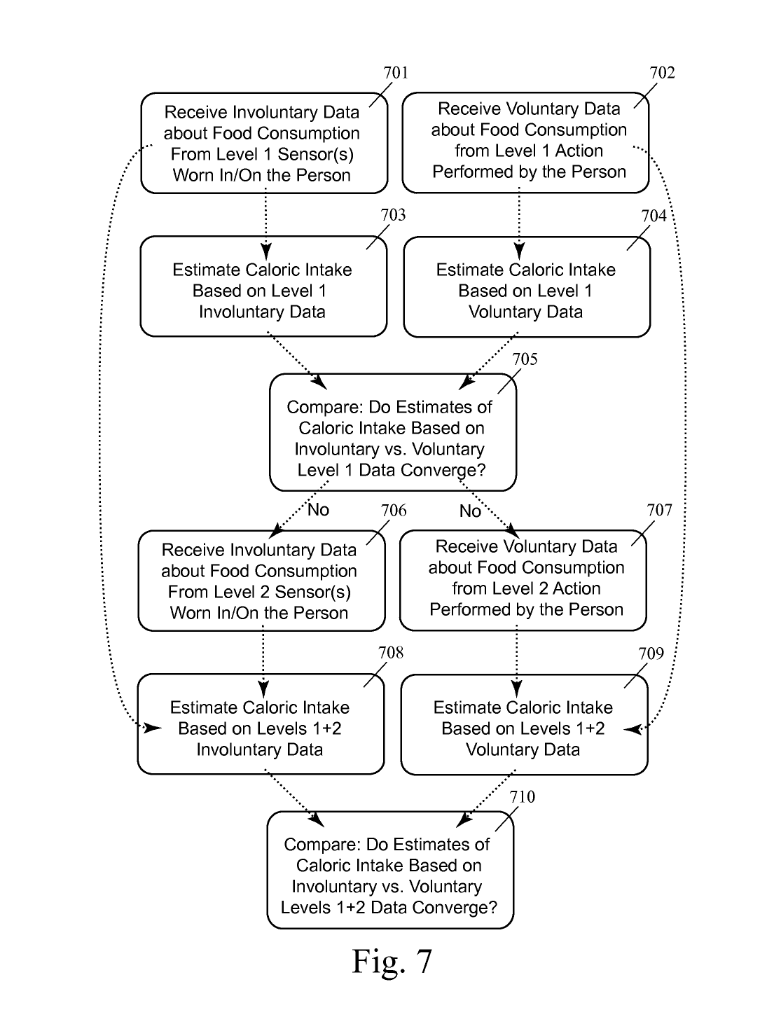

FIG. 7 shows another example of how this invention can be embodied in a method to measure a person's caloric intake. The example shown in FIG. 7 is similar to that shown in FIG. 6, except that: (a) FIG. 7 shows greater specificity about the different levels of sensors used to collect involuntary data and the different levels of actions used to record voluntary data; and (b) FIG. 7 explicitly limits the number of data collection sub-cycles to a maximum of two.

In an example, “level 1” wearable sensors in FIG. 7 can be relatively less-intrusive because of their low-level modality (e.g. motion and sound), non-continuous operation (e.g. only when triggered by a probable eating event), low-profile placement (e.g. under clothing), and/or flexible timing (e.g. delayed data acquisition after multiple eating events). In an example, “level 2” wearable sensors in FIG. 7 can be more-intrusive because of their high-level modality (e.g. images), continuous operation, high-profile placement (e.g. around the person's neck), and/or immediate timing (e.g. real time data acquisition during eating events).

The method in FIG. 7 also differs from that in FIG. 6 in that it explicitly shows only two cycles of data collection when intake estimates based on involuntary and voluntary data do not meet the criteria for similarity and/or convergence. The first cycle of data collection, shown in the upper half of FIG. 7, comprises receiving involuntary data about food consumption from one or more “level 1” sensors worn in or on the person in step 701. Data from step 701 is then used to estimate caloric intake in step 703. This first cycle of data collection also comprises receiving voluntary data about food consumption from one or more “level 1” actions performed by the person in step 702. Data from step 702 is then used to estimate caloric intake in step 704.

In FIG. 7, if the two estimates of caloric intake from steps 703 and 704, based on involuntary data and voluntary data respectively, meet the criteria for similarity and/or convergence in step 705, then the method is concluded after this comparison. The second cycle of data collection, shown on the bottom half of FIG. 7, does not occur. However, if the estimates of caloric intake from steps 703 and 704 do not meet the criteria for similarity and/or convergence in step 705, then the method continues to steps 706 and 707 in a second cycle of data collection.

The second cycle of data collection, shown in the lower half of FIG. 7, commences with: receiving involuntary data about food consumption from one or more “level 2” sensors worn in or on the person in step 706; and receiving voluntary data about food consumption from one or more “level 2” actions performed by the person in step 707. In an example, “level 2” sensors can be more intrusive than “level 1” sensors, but can also provide more accurate information for estimating caloric intake. In an example, “level 2” actions can be more intrusive and/or time-consuming than “level 1” actions, but can also provide more accurate information for estimating caloric intake.

In an example, a “level 1” sensor can be a wearable motion sensor or sound sensor and a “level 2” sensor can be a wearable camera or other image-creating sensor. In another example, a “level 1” sensor can be a wearable camera with a narrow field of view and a short-range focus and a “level 2” sensor can be a wearable camera with a wide field of view and a variable-range focus. In an example, a “level 1” sensor can be a wearable camera that only takes pictures when a motion or sound sensor suggests that an eating event is occurring and a “level 2” sensor can be a wearable camera that takes pictures continuously. In an example, a “level 1” sensor can be a wearable camera that only takes pictures at a certain time of day, or in a certain GPS-indicated location, that suggests that the person may be eating, and a “level 2” camera can take pictures continuously.

In an example, a “level 1” action can comprise manually entering a phrase to describe food into a mobile device and a “level 2” action can comprise manually taking (e.g. “pointing and shooting”) a picture of food. In another example, a “level 1” action can be manually entering (at the end of the day) information on food that was consumed during the day at a private moment, but a “level 2” action may be entering information about food consumed in real time during each eating event. In an example, a “level 1” action can be responding to a quiet vibration from a wearable device by entering data on food consumed, but a “level 2” action can be responding to full-volume voice inquiry from a wearable device.

In various examples, collection of “level 2” voluntary data can be more-intrusive, offer less flexibility, and be more time-consuming than collection of “level 1” data. In an example, “level 1” voluntary data collection may allow considerable flexibility in terms of whether food consumption entries are made before, during, or after eating. Level 2 voluntary data collection may offer less flexibility in timing. For example, “level 2” data collection may require real-time reporting for maximum accuracy. If the person wants to eat in peace without dealing with real-time data prompts, then they have a strong incentive to provide accurate voluntary data concerning food consumption in the first data collection cycle.

The second cycle of data collection, shown in the bottom half of in FIG. 7, continues in step 708 with estimation of caloric intake based on cumulative involuntary data from “level 1” and “level 2” sensors and in step 709 with estimation of caloric intake based on cumulative voluntary data from “level 1” and “level 2” actions. Analytic methods such as those discussed for the embodiments in FIGS. 5 and 6 may also be used in steps 708 and 709 in FIG. 7. FIG. 7 is more explicit than FIGS. 5 and 6 with respect to the use of cumulative data from both the first and second collection cycles when making estimates in the second cycle. In an example, information from the first and second data collection cycles can be combined using Bayesian statistical methods, with data from the first data collection cycle functioning as prior values.

The method disclosed in FIG. 7 concludes with the comparison in step 710 of caloric intake estimates from steps 708 and 709. In various examples, the criteria for similarity and/or convergence of caloric intake estimates can be similar to those discussed for FIGS. 5 and 6. The method and system shown in FIG. 7 differs from those shown in FIGS. 5 and 6 in that FIG. 7 shows a finite number of data collection sub-cycles. In FIG. 7, there is a maximum of two data collection cycles; the first occurs in the upper half of FIG. 7 and the second occurs in the bottom half of FIG. 7. In other examples, there may be a higher maximum number of data collection cycles, such as three or more, with an explicit progression of increasingly-intrusive data collection methods until similarity and/or convergence of estimates is achieved.

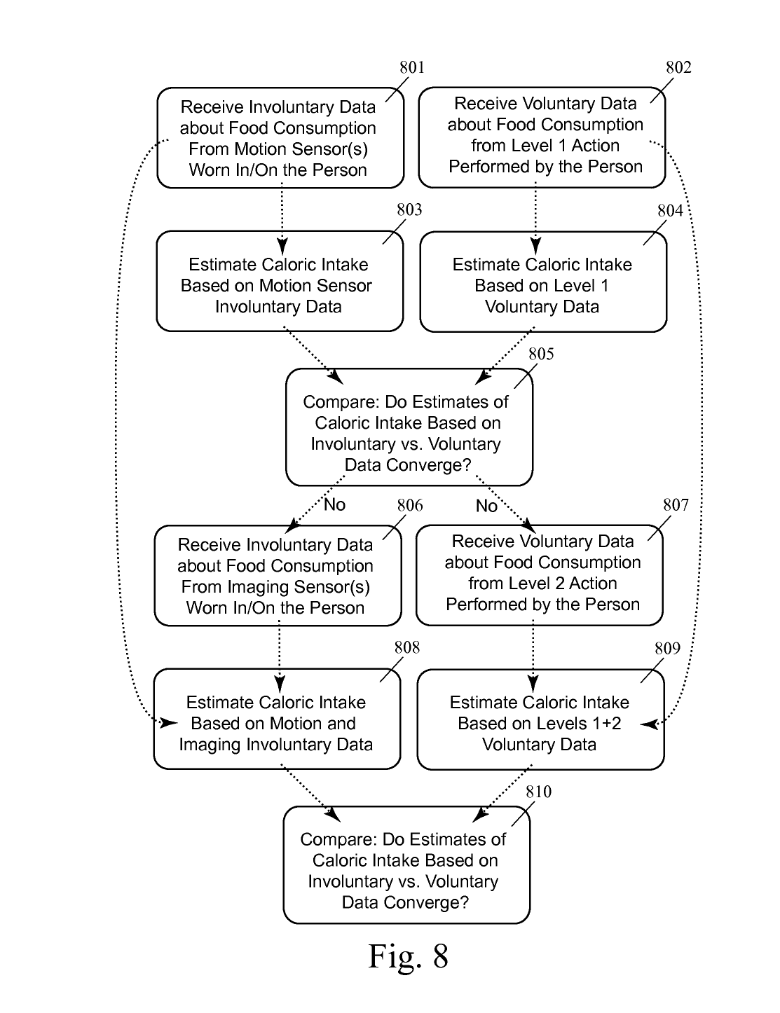

FIG. 8 shows another example of how this invention may be embodied in a method and system to measure a person's caloric intake. This example is similar to that shown in FIG. 7 in that it has a maximum of two sub-cycles of data collection and the second cycle is only triggered if the estimates from the first cycle do not meet the criteria for similarity and/or convergence. However, FIG. 8 differs from FIG. 7 in that the types or modes of sensors that are used to collect involuntary data are explicitly specified. In FIG. 8, the less-intrusive (and presumably less-accurate) “level 1” sensor is specified as a wearable motion sensor.

In an example, a wearable motion sensor may be a three-dimensional accelerometer that is incorporated into a device that the person wears on their wrist, in a manner like a wrist watch. In an example, this three-dimensional accelerometer may detect probable eating events based on monitoring and analysis of the three-dimensional movement of the person's arm and hand. Eating activity may be indicated by particular patterns of up and down, rolling and pitching, movements. Although a continuously-monitoring motion sensor could be viewed as intrusive to some extent, it is likely to intrude much less on the person's privacy that would a continuously-monitoring wearable microphone or wearable camera. Thus, it can be a good choice for a “level 1” sensor.

In FIG. 8, the more-intrusive (and presumably more-accurate) “level 2” sensor is specified as a wearable imaging sensor. In an example, a wearable imaging sensor may be a camera that is part of a device that the person wears on their wrist, in a manner like a wrist watch. In an example, this camera may be directed toward the person's fingers to identify food which the person reaches for, grasps, holds, and consumes during eating activities. In various examples, this food may be on a plate, on a shelf, in a bag, in a glass, on a table, or otherwise within viewing (and reaching) distance of the person. In another example, a camera may be worn on the person's neck in a manner like a necklace, incorporated into a button worn on clothing, or incorporated into a finger or ear ring. In an example, the focal direction and focal range of such a wearable camera can be chosen so as to capture images of food consumed, while minimizing privacy-intruding images. In an example, pattern recognition can be used to automatically blur out privacy-intruding images (such as images of other people) by adjusting focal range in real time.

In an example, images of food can be taken by mobile devices that are carried by, but not worn on, the person. However, it is difficult to ensure involuntary data collection by a device that is not worn by the person. The person might forget to bring the device to a meal. The person might hide the device in a location where it does not record eating activity. The person might unintentionally place the device in a location, or pointed in a direction, that does not capture eating activity. In an example, a smartphone “ap” that can be used to take pictures of food can be useful for tracking caloric intake, but not if it is left in a purse, left at home, or simply pointed in the wrong direction. For these reasons, a wearable sensor is preferable for involuntary data collection.

While is still possible for a person to tamper with, and impair, the operation of a wearable sensor, anti-tampering features can be more easily incorporated into the design a wearable device than a non-wearable device. For example, a wearable sensor may trigger an alarm, or other response, if it removed from contact with the person's skin. Skin contact can be monitored using electromagnetic, pressure, motion, and/or sound sensors. In an example, a wearable motion sensor may trigger an alarm, or other response, if there is a lack of motion that is not also accompanied by specific indications of sleeping activity. In an example, a wearable sound sensor may trigger an alarm or other response if there is a lack of sounds (such as pulse or respiration) that are normally associated with proximity to the person's body. In an example, a wearable imaging sensor may trigger an alarm, or other response, if there is a lack of images (such as a view of the person's hand or face identified by recognition software) that are associated with proper positioning on the person's body.

Turning to the voluntary action side of FIG. 8, “level 2” actions are more intrusive into the person's privacy and/or time than are “level 1” actions. Level 2 actions give the person less flexibility with respect to data entry structure, timing, and precision; and are less discrete with respect to the data entry interface. For these reasons, the person has an incentive to be engaged and record timely and accurate data concerning food consumption in “level 1” data collection in order to avoid the intrusiveness of “level 2” data collection. As discussed earlier in the analogy to road ridges (which can be annoying, but can save lives), the escalating intrusiveness of “level 2” actions could also be viewed as “annoying.” However, in the long-run, it can be far less “annoying” than the many negative health outcomes of obesity or the health risks of invasive stomach-altering surgery.

The exact types of less-intrusive voluntary actions performed by the person for recording “level 1” voluntary data and the exact types of more-intrusive voluntary actions performed by the person for recording “level 2” voluntary data are not specified in FIG. 8. There are a variety of voluntary actions to record voluntary data concerning food consumption. Further, there can be considerably more variability within a given type of voluntary action (as compared to a given type of involuntary sensor data) due to the variability in human compliance. For example, there is a wide variety of open-ended or menu-driven human-computer interfaces which can be used for voluntary data collection. In various examples, this interface can comprise a touch screen, voice commands and recognition, key pad, gesture recognition, eye movements, or a variety of other modes of human-computer interaction. Accordingly, the specific types of actions used in “level 1” and “level 2” voluntary data collection are not specified in this example,

The top half of the method and system for measuring caloric intake that is shown in FIG. 8 starts with: (a) the receipt of involuntary data about food consumption, from one or more motion sensors that are worn in or on the person, in step 801; and (b) the receipt of voluntary data about food consumption, from one or more “level 1” actions performed by the person, in step 802. In the steps that follow, caloric intake is estimated in step 803 based on data from the wearable motion sensor and caloric intake is estimated in step 804 based on data from “level 1” voluntary action performed by the person. Then, in step 805, these two estimates of caloric intake, one based on involuntary data and one based on voluntary data, are compared to determine whether they meet the criteria for similarity and/or convergence. The criteria for similarity and/convergence can be selected from among those that were discussed in previous examples.

If the estimates of the person's caloric intake from steps 803 and 804 meet the criteria for similarity and/or convergence in step 805, then the method in FIG. 8 concludes and steps 806 through 810 shown in the bottom half of FIG. 8 are not required. If the estimates of caloric intake from steps 803 and 804 do not meet the criteria for similarity and/or convergence in step 805, then this method continues with a second round of additional data collection and caloric intake estimation. This second round is shown in the bottom half of FIG. 8. If these estimates of caloric intake do not converge in step 805, then: involuntary data about food consumption is received from one or more imaging sensors that are worn in or on the person in step 806; and voluntary data about food consumption is received from one or more “level 2” actions performed by the person in step 807.

In the event that the estimates do not meet criteria for similarity and/or convergence in step 805, then in step 808 an estimate of the person's caloric intake is determined based on cumulative involuntary data from both motion sensors and imaging sensors. Also, in step 809, an estimate of the person's caloric intake is determined based on cumulative voluntary data from both “level 1” and “level 2” actions. Finally, in step 810, the estimates of the person's caloric intake from steps 808 and 809, one based on involuntary data and one based on voluntary data, are compared to determine whether they meet the criteria for similarity and/or convergence. The criteria for similarity and/convergence can be those discussed for previous figures.

In an example, the collection and use of additional involuntary data (steps 806 and 808) and additional voluntary data (steps 807 and 809) can be done in parallel. In an example, collection of these two types of data can be done in an alternating manner or in a series. In an example, the collection of additional involuntary data and additional voluntary data can be done in a one-to-one correspondence. In another example, it can be done a many-to-one correspondence. In an example, the type of data (involuntary or voluntary) whose latest augmentation most contributes to the similarity and/or convergence of caloric intake estimates can be disproportionately selected for additional data collection.

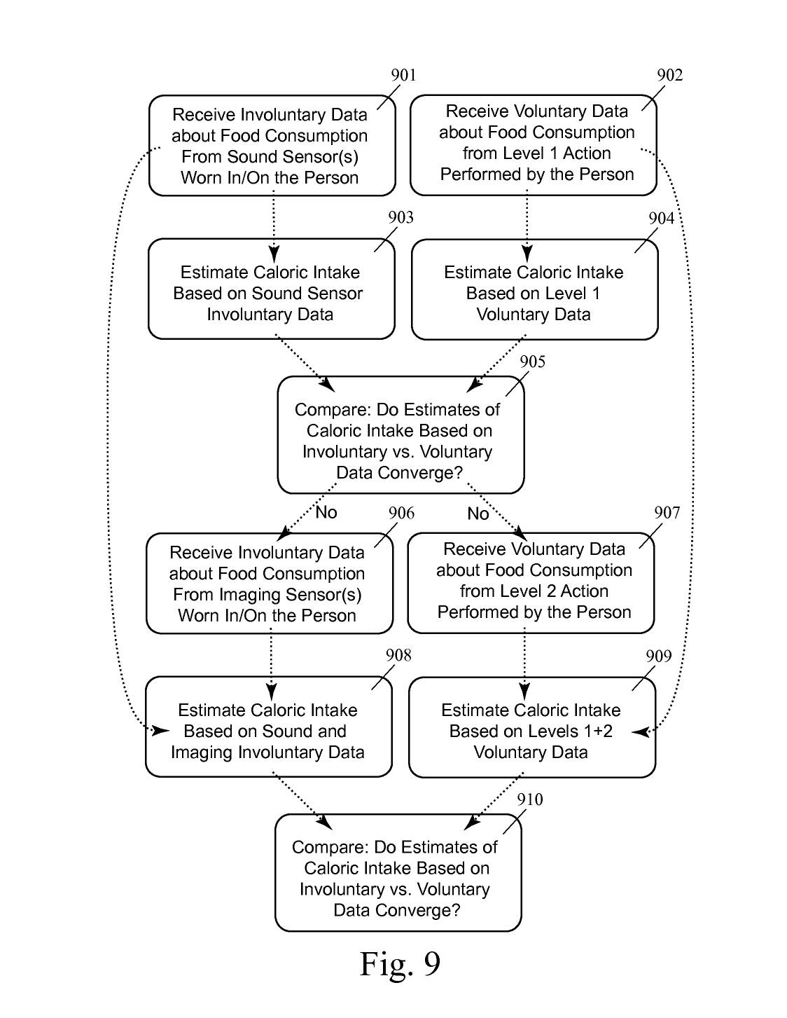

FIG. 9 shows an example of this invention that is similar to that shown in FIG. 8 except that it specifies a different modality of less-intrusive sensor for the first-round of involuntary data collection. In FIG. 9, in steps 901, 903, and 908, a wearable sound sensor is used (in contrast to the wearable motion sensor in FIG. 8). In an example, a sound sensor can be more intrusive than a motion sensor with respect to possibly recording conversations or other sounds that could intrude on privacy, but is not as intrusive as an imaging sensor with respect to possibly recording people or other images that could intrude on privacy. In an example, speech recognition software could be used to explicitly filter out the recording of human speech in the interest of privacy, while still recording chewing, biting, and swallowing sounds in order to identify the types and quantities of food consumed.

In an example, a wearable sound sensor can be worn around the neck like a necklace. In an example, a wearable sound sensor can detect chewing, biting, or swallowing sounds that indicate a probable eating activity. This detection can be through direct contact with the body or through chewing, biting, or swallowing sounds traveling through the air. In another example, a sound sensor can be worn behind the ear. In another example, a wearable sound sensor can be worn under clothing in a manner that is less conspicuous than a wearable imaging sensor.

In an example, the same sound sensor may be used for both involuntary and voluntary data collection. In an example, the same sound sensor may also be used to receive voice messages from the person. It can also serve as the hardware embodiment for receiving voluntary data in steps 902 and 907. The other numbered steps in FIG. 9 have descriptions and functions that are similar to their counterparts in FIG. 8 (with step numbers that have the same last two digits—for example step 907 in FIG. 9 corresponding to step 807 in FIG. 8), so it is not necessary to repeat the descriptions and functions of those steps here.

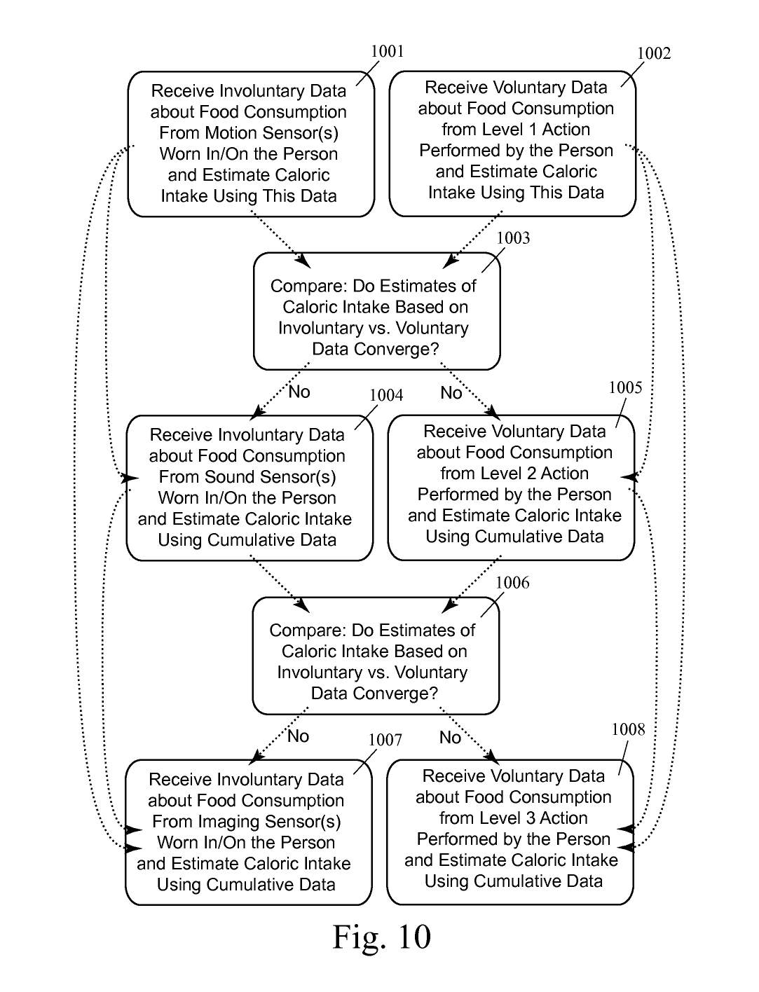

FIG. 10 shows another example of how this invention can be embodied. FIG. 10 shows a method and system for measuring a person's caloric intake that includes up to three cycles of data collection and explicitly specifies three types (modalities) of involuntary data sensors. In some respects, the method that is shown in FIG. 10 links together, in series, the sensor modality progressions that were previously-specified in FIGS. 8 and 9. The three-cycle method in FIG. 10 escalates, as needed, from motion sensors to sound sensors to imaging sensors. If similarity and/or convergence criteria are met in any given cycle (e.g. at step 1003, or 1006), then the method comes to a stop. If the similarity and/or convergence criteria are not met, then the method escalates to the next data collection cycle, up to a maximum of three cycles. In the method for caloric intake measurement that is shown in FIG. 10, as well as the methods shown in prior FIGS. 5 through 9, the similarity and/or convergence of caloric estimates from involuntary and voluntary data functions as a proxy for estimation accuracy.

We now discuss FIG. 10 in detail. The first data collection cycle in FIG. 10, shown in the upper three steps, comprises: (a) step 1001 in which involuntary data about food consumption is received from motion sensors that are worn in or on the person and this data is used to estimate caloric intake; (b) step 1002 in which voluntary data about food consumption is received from “level 1” actions performed by the person and this data used to estimate caloric intake; and (c) step 1003 in which these two estimates are compared to determined whether they meet the criteria for similarity and/or convergence. If these criteria are met, then the method stops and the person is only engaged with less-intrusive motion sensors and “level 1” actions.

If the criteria for similarity and/or convergence are not met in step 1003, then the method in FIG. 10 escalates to a second cycle of more-intrusive collection of additional involuntary and voluntary data about food consumption. The second cycle is shown in the third and fourth rows of steps in FIG. 10. This second cycle of data collection comprises: (a) step 1004 in which involuntary data about food consumption is received from sound sensors that are worn in or on the person and the cumulative data (from both motion and sound sensors) is used to estimate caloric intake; (b) step 1005 in which voluntary data about food consumption is received from “level 2” actions performed by the person and the cumulative data (from both “level 1” and “level 2” actions) is used to estimate caloric intake; and (c) step 1006 in which these two estimates are compared to determined whether they meet the criteria for similarity and/or convergence. If these criteria are met, then the method stops.

If the criteria for similarity and/or convergence are not met in step 1006, then this method escalates to a third cycle of more-intrusive collection of additional involuntary and voluntary data about food consumption. This third cycle is shown in the last row of steps in FIG. 10. This third cycle of data collection comprises: step 1007 in which involuntary data about food consumption is received from imaging sensors that are worn in or on the person and the cumulative data (from motion, sound, and imaging sensors) is used to estimate caloric intake; and step 1008 in which voluntary data about food consumption is received from “level 3” actions performed by the person and the cumulative data (from level 1, 2, and 3 actions) is used to estimate caloric intake.

FIG. 10 shows an example of a method for measuring caloric intake in which the intrusiveness of data collection is escalated only as far as is required to achieve a desired level of accuracy. In this respect, this method could be called “minimally-intrusive” yet highly-accurate caloric intake monitoring. This method can achieve accuracy that is superior to methods of estimating caloric intake in the prior art that rely on voluntary data collection only—especially voluntary methods with no empirically-validated methods to encourage compliance and accuracy. This method can be better (greater accuracy and/or greater privacy) than methods of estimating caloric intake in the prior art that rely on involuntary data collection through a static configuration of sensors, especially a static configuration of more-intrusive sensors. FIG. 10 illustrates how this method achieves the optimal tradeoff between accuracy and intrusiveness in caloric intake measurement. This is superior to methods and systems for caloric intake measurement in the prior art.

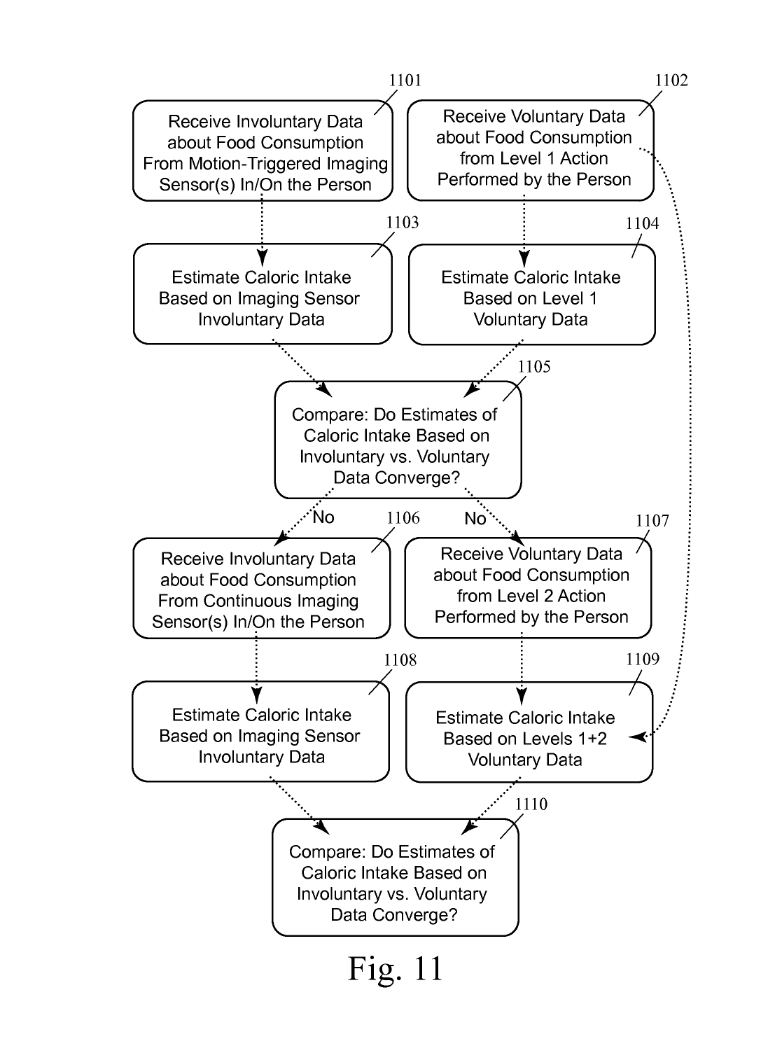

FIG. 11 shows another example of how this invention can be embodied in a method and system for measuring a person's caloric intake. The method shown in FIG. 11 is similar to the methods with two cycles of data collection that were shown in FIGS. 7 through 9, except that now escalation in the intrusiveness of involuntary data collection (in successive cycles) is done through an increase in the continuity of sensor operation rather than a change in sensor type (or modality). In FIG. 11, the same type of sensor is used for both the first and second cycles of involuntary data collection, but the sensor operates in a less-continuous manner in the first (less-intrusive) data collection cycle and operates in a more-continuous manner in the second (more-intrusive) data collection cycle. If there is similarity and/or convergence between caloric intake estimates from involuntary and voluntary data in the first cycle, then the person is spared having the sensor operate in a continuous manner. In various examples, the sensor may be a motion sensor, a sound sensor, an imaging sensor, or a combination thereof.

As with previous examples of this invention, with the method shown in FIG. 11 the person has incentives to provide timely and accurate voluntary data concerning food consumption in the first cycle of data collection. If the person provides timely and accurate voluntary data in the first cycle, then the person is spared having one or more sensors record information in a more continuous manner. In this way, this method actively engages the person in managing their own energy balance and weight. Such active engagement of the person is not provided by methods in the prior art in which involuntary sensors are always in continuous operation, regardless of the person's behavior or compliance. Such active engagement of the person in managing their own energy balance is important not only as a technical method for improving measurement accuracy, but also for encouraging weight management in a holistic manner.

The method and system for caloric intake measurement that is shown in FIG. 11 begins with a first cycle of data collection that comprises the five steps that are shown in the upper half of FIG. 11. The first cycle in FIG. 11 includes step 1101 in which involuntary data about food consumption is received from one or more sensors that are worn in or on the person, wherein these sensors operate in a non-continuous manner. In an example, one or more wearable sensors may sample data periodically. In an example, one or more of sensors may sample data at random intervals.

In an example, a sensor of a generally more-intrusive type (that operates in a less-continuous manner) can collect data only when it is triggered by the results from a sensor of a generally less-intrusive type (that operates in more-continuous manner). For example, a generally more-intrusive imaging sensor may be activated to take pictures only when results from a generally less-intrusive motion sensor indicate that a person is probably eating. This is the case that is specified in FIG. 11. As shown in step 1101 in FIG. 11, involuntary data about food consumption is received from one or more motion-triggered imaging sensors that are worn on the person. In an example, these one or more imaging sensors may be wearable video cameras.

In an example, a motion-triggered imaging sensor may take video images for a set interval of time after analysis of output from the continually-operating motion sensor suggests that the person is eating. In another example, a motion-triggered imaging sensor may start taking pictures based on output from a motion sensor and may continue operation for as long as eating continues, wherein eating is determined based on the results of the motion sensor, the imaging sensor, or both. If analysis of images from the imaging sensor shows that the indication of probable eating by the motion sensor was a false alarm, then the imaging sensor can stop taking pictures. In an example, if the imaging sensor determines that a food source within view or reach of the person remains unfinished, then the imaging sensor may continue to take pictures even if motion stops for a period of time.

In another example, the duration of imaging by the imaging sensor can depend on the strength of the probability indication that eating is occurring. If the results from one or more sensors indicate, with a high level of certainty, that eating is occurring, then the imaging sensor may operate for a longer period of time. If the results from one or more sensors are less certain with respect to whether the person is eating, then the imaging sensor may operate for a shorter period of time.

In an example, the field of vision and the focal length of the wearable imaging sensor (such as a wearable digital video camera) can be adjusted automatically to track a particular object as the object moves, the sensor moves, or both the object and the sensor move. In an example, a wrist-worn camera may track the ends of the person's fingers wherein a utensil or glass is engaged. In an example, a wrist-worn camera may track the person's face and mouth even when the person is moves their arm and hand. In an example, a camera may continuously or periodically scan the space around the person's hand and/or mouth to increase the probability of automatically detecting food consumption. In an example, the field of vision and/or focal length of an imaging sensor may be automatically adjusted based on the output of a motion sensor. In an example, an imaging sensor and a motion sensor may both be incorporated into a device that is worn on the person's wrist. In an example, an imaging sensor may be worn on the person's neck and a sound sensor may be worn on the person's wrist.

The first cycle of data collection in FIG. 11 also includes step 1102 in which voluntary data about the person's food consumption is received from “level 1” action performed by the person. In an example, a “level 1” action can comprise having the person make a voice entry into a device, wherein this voice entry briefly describes food that will be, is being, or has been consumed. In another example, a “level 1” action can comprise having the person enter data about food consumption via a menu-driven, touch-screen-activated user interface. In another example, a “level 1” action can comprise having the person scan a bar code (or other identifying code) on the packaging of food that will be, is being, or has been consumed. In another example, a “level 1” action can comprise pattern recognition of a logo, other design, or wording on the food packaging.

As the first cycle in FIG. 11 continues, it moves to: step 1103 in which caloric intake is estimated based on involuntary data collected from the motion-triggered imaging sensor; and to step 1104 in which caloric intake is estimated based on voluntary data from the “level 1” action. This first cycle concludes with step 1105 in which these two estimates of caloric intake are compared to each other in order to determine whether they meet the criteria for similarity and/or convergence. If these two estimates do meet the criteria for similarity and/or convergence, then this method stops after the first cycle of data collection. If these two estimates do not meet the criteria for similarity and/or convergence, then this method continues to a second cycle of data collection as shown in the bottom half of FIG. 11.

In the method shown in FIG. 11, if the two estimates from the first cycle of data collection do not meet the criteria for similarity and/or convergence in step 1105, then this method escalates to a second cycle of more-intrusive data collection. This second cycle begins with step 1106 in which involuntary data about a person's food consumption is received from an imaging sensor that is worn on the person and takes pictures in a more continuous manner than in the first cycle. In an example, this imaging sensor can be a miniature video camera that is worn by the person and which continuously takes video images of the space surrounding the person in this second cycle of more-intrusive data collection.

Continuous video imaging of the space surrounding a person, especially space near the person's mouth and hands, is likely to provide relatively accurate monitoring of food consumption. However, continuous video imaging of the space surrounding a person, including whatever or whoever enters that space, can be relatively intrusive. Some approaches in the prior art that rely on continuous video imaging seek to address privacy concerns by having automated screening mechanisms that screen out images of people or things that would infringe on privacy. The embodiments of this invention that are described herein can also include automated screening mechanisms to enhance privacy. However, this invention can potentially avoid this problem entirely and avoid continuous video in the first place, by encouraging the person to enter timely and accurate voluntary data about food consumption in the first cycle.

Methods and systems in the prior art in which a wearable camera takes video images continuously regardless of the person's compliance or behavior can be unnecessarily intrusive. Granted, such systems may be modified to screen out privacy-invading sounds and images, but why create these sounds and images in the first place if they are redundant and unnecessary? Why subject a person to continuous video monitoring if the person is willing to provide consistently timely and accurate voluntary data concerning food consumption? Why not give them a choice? This present invention, as shown various embodiments including that shown in FIG. 11, gives a person this choice. This present invention does not escalate to continuous imaging if the combination of eating-motion-triggered imaging and voluntary data reporting is sufficient to achieve the desired level of accuracy in caloric intake measurement in the first cycle of data collection.

In an example, the “level 2” action in step 1107 of FIG. 11 can comprise having the person manually focus and trigger (“point and shoot”) a camera toward food that will be consumed. In another example, “level 2” action can comprise having the person respond to a series of menu-driven prompts on a mobile touch screen device in order to precisely identify food that will be, is being, or has been consumed. In another example, “level 2” action can comprise having the person answer an automatically-generated phone call and give a series of response to voice-prompts in order to precisely identify consumed food.

In addition to technical advantages over the prior art, this present invention also has psychological and motivational advantages over prior art that relies on continuous imaging regardless of the person's behavior. This present invention engages the person in managing their own energy balance and weight in a constructive manner that is not provided by methods in the prior art that always use continuous video imaging. With this present invention, the person is an actively-engaged participant in the measurement and management of their energy balance and body weight. The degree to which they are continually monitored depends on their behavior. In some respects, the system allows the person to earn “trust” (and greater monitoring freedom) by demonstrating past compliance with accurate dietary monitoring. This is an improvement over prior art in which a person is in a passive role (like a subject in an experiment) and is continuously monitored regardless of how well they behave.

The example of this invention that is shown in FIG. 12 is similar to the method that was shown in FIG. 11, except that now the non-continuous imaging sensor in step 1201 is activated by the output of wearable sound sensor instead of a wearable motion sensor. In an example, a sound sensor may be worn on the person's neck in a manner like a necklace. In an example, a sound sensor may be worn behind the person's ear in a manner like a bluetooth communication device. In an example, when the sound sensor detects chewing, biting, or swallowing sounds, the sound sensor can activate an imaging sensor which can better determine what, if anything, the person is eating. Apart from substituting a sound sensor for a motion sensor, the other steps in FIG. 12 have the same descriptions as those in FIG. 11 which are labeled with the same last 2 digits.

As shown in FIGS. 5 through 12, this invention can be embodied in a method for measuring a person's caloric intake comprising: (a) receiving a first set of data concerning what the person eats from a first source and receiving a second set of data concerning what the person eats from a second source; (b) calculating a first estimate of the person's caloric intake based on the first set of data, calculating a second estimate of the person's caloric intake based on the second set of data, and comparing these first and second estimates of caloric intake to determine whether these estimates meet criteria for similarity and/or convergence; and (c) if the first and second estimates of caloric intake do not meet the criteria for similarity and/or convergence, then receiving a third set of data concerning what the person eats and calculating one or more new estimates of caloric intake using this third set of data.

In an example, collection of the first set of data does not require voluntary actions by the person associated with particular eating events other than the actions of eating, but collection of the second set of data requires voluntary actions by the person associated with particular eating events other than the actions of eating, or vice versa. In an example, receiving the first set of data does not require voluntary actions by the person associated with particular eating events other than the actions of eating, but receiving the second set of data requires voluntary actions by the person associated with particular eating events other than the actions of eating, or vice versa.

In an example, data collection methods or methods of receiving data can be selected from the group consisting of: (a) collection of the first and third sets of data does not require voluntary actions by the person associated with particular eating events other than the actions of eating, but collection of the second set of data does require voluntary actions by the person associated with particular eating events other than the actions of eating; (b) collection of the first and second sets of data does not require voluntary actions by the person associated with particular eating events other than the actions of eating, but collection of the third set of data does require voluntary actions by the person associated with particular eating events other than the actions of eating; and (c) collection of the first set of data does not require voluntary actions by the person associated with particular eating events other than the actions of eating, but collection of the second and third sets of data does require voluntary actions by the person associated with particular eating events other than the actions of eating.

In an example, data collection methods or methods of receiving data can be selected from the group consisting of: (a) receiving the first and third sets of data does not require voluntary actions by the person associated with particular eating events other than the actions of eating, but receiving the second set of data does require voluntary actions by the person associated with particular eating events other than the actions of eating; (b) receiving the first and second sets of data does not require voluntary actions by the person associated with particular eating events other than the actions of eating, but receiving the third set of data does require voluntary actions by the person associated with particular eating events other than the actions of eating; and (c) receiving the first set of data does not require voluntary actions by the person associated with particular eating events other than the actions of eating, but receiving the second and third sets of data does require voluntary actions by the person associated with particular eating events other than the actions of eating.

In an example, this invention can be embodied in a method for measuring a person's caloric intake comprising: (a) receiving a first set of data concerning what the person eats in a manner that does not require voluntary actions by the person associated with particular eating events other than the actions of eating; (b) receiving a second set of data concerning what the person eats in a manner that requires voluntary actions by the person associated with particular eating events other than the actions of eating; (c) calculating a first estimate of the person's caloric intake based on the first set of data, calculating a second estimate of the person's caloric intake based on the second set of data, and comparing these first and second estimates of caloric intake to determine whether these estimates meet criteria for similarity and/or convergence; and (d) if the first and second estimates of caloric intake do not meet the criteria for similarity and/or convergence, then receiving a third set of data concerning what the person eats and calculating one or more new estimates of caloric intake using this third set of data.

As shown in FIGS. 5 through 12, data sets can be selected from the group consisting of: (a) at least one of the first set of data and the second set of data comprises image data whose collection requires voluntary actions by the person associated with particular eating events other than the actions of eating and the third set of data comprises image data whose collection is more continuous than the collection of at least one of the first and second sets of data; (b) at least one of the first set of data and the second set of data comprises image data whose collection is intermittent, periodic, or random, not requiring voluntary actions by the person associated with particular eating events other than the actions of eating, and the third set of data comprises image data whose collection is more continuous than the collection of at least one of the first and second sets of data; and (c) at least one of the first set of data and the second set of data comprises image data whose collection is triggered by sounds, motions, or sounds and motions indicating an eating event, wherein this collection does not require voluntary actions by the person associated with particular eating events other than the actions of eating, and the third set of data comprises image data whose collection is more continuous than the collection of at least one of the first and second sets of data.

In an example, at least one of the first set of data and the second set of data comprises sound data, motion data, or both sound and motion data, the third set of data comprises image data, and collection of these sets of data does not require voluntary actions by the person associated with particular eating events other than the actions of eating. In an example, the criteria for similarity and/or convergence are selected from the group consisting of: raw difference between two values is less than a target value; percentage difference between two values is less than a target value; mathematical analysis of paired variables predicts convergence between them; and statistical analysis of two variables does not show a statistically-significant difference between them.

As shown in FIGS. 5 through 12, this invention can be embodied in a method for measuring a person's caloric intake comprising: (a) receiving a first set of data from a first source concerning what the person eats, wherein collecting this first set of data requires a first level of intrusion into the person's privacy or time, and receiving a second set of data from a second source concerning what the person eats, wherein collecting this second set of data requires a second level of intrusion into the person's privacy or time; (b) calculating a first estimate of the person's caloric intake based on the first set of data, calculating a second estimate of the person's caloric intake based on the second set of data, and comparing these first and second estimates of caloric intake to determine whether these estimates meet criteria for similarity and/or convergence; and (c) if the first and second estimates of caloric intake do not meet the criteria for similarity and/or convergence, then receiving a third set of data concerning what the person eats, wherein collection of this third set of data requires a third level of intrusion into the person's privacy or time, and wherein this third level is greater than the first level and is greater than the second level, and calculating a third estimate of caloric intake based, in whole or in part, on this third set of data.

In an example, this invention can be embodied in a method for measuring the types and quantities of food consumed by a person comprising: (a) receiving a first set of data from a first source concerning what the person eats and receiving a second set of data from a second source concerning what the person eats; (b) calculating a first estimate of the types and quantities of food consumed based on the first set of data, calculating a second estimate of the types and quantities of food consumed based on the second set of data, and comparing these first and second estimates of caloric intake to determine whether these estimates meet criteria for similarity and/or convergence; and then (c) if the first and second estimates of caloric intake do not meet the criteria for similarity and/or convergence, then receiving a third set of data concerning what the person eats and calculating a third estimate of the types and quantities of food consumed using this third set of data.

In an example, collection of the first set of data does not require voluntary actions by the person associated with particular eating events other than the actions of eating, but collection of the second set of data does require voluntary actions by the person associated with particular eating events other than the actions of eating, or vice versa. In an example, receiving the first set of data does not require voluntary actions by the person associated with particular eating events other than the actions of eating, but receiving the second set of data does require voluntary actions by the person associated with particular eating events other than the actions of eating, or vice versa.

In an example, collection of the first and third sets of data does not require voluntary actions by the person associated with particular eating events other than the actions of eating, but collection of the second set of data does require voluntary actions by the person associated with particular eating events other than the actions of eating. In an example, collection of the first and second sets of data does not require voluntary actions by the person associated with particular eating events other than the actions of eating, but collection of the third set of data does require voluntary actions by the person associated with particular eating events other than the actions of eating. In an example, collection of the first set of data does not require voluntary actions by the person associated with particular eating events other than the actions of eating, but collection of the second and third sets of data does require voluntary actions by the person associated with particular eating events other than the actions of eating. In an example, at least one of the first set of data and the second set of data comprises image data whose collection requires voluntary actions by the person associated with particular eating events other than the actions of eating, and the third set of data comprises image data whose collection is more continuous than the collection of at least one of the first and second sets of data.

In an example, at least one of the first set of data and the second set of data comprises image data whose collection is intermittent, periodic, or random, not requiring voluntary actions by the person associated with particular eating events other than the actions of eating, and the third set of data comprises image data whose collection is more continuous than the collection of at least one of the first and second sets of data. In an example, at least one of the first set of data and the second set of data comprises image data whose collection is triggered by sounds, motions, or sounds and motions indicating an eating event, not requiring voluntary actions by the person associated with particular eating events other than the actions of eating, and the third set of data comprises image data whose collection is more continuous than the collection of at least one of the first and second sets of data. In an example, at least one of the first set of data and the second set of data comprises sound data, motion data, or both sound and motion data, the third set of data comprises image data, and collection of these sets of data does not require voluntary actions by the person associated with particular eating events other than the actions of eating.

In an example, the criteria for similarity and/or convergence are selected from the group consisting of: raw difference between two values is not greater than a target value; percentage difference between two values is not greater than a target value; mathematical analysis of paired variables predicts convergence between them; and statistical analysis of two variables does not show a statistically-significant difference between them.

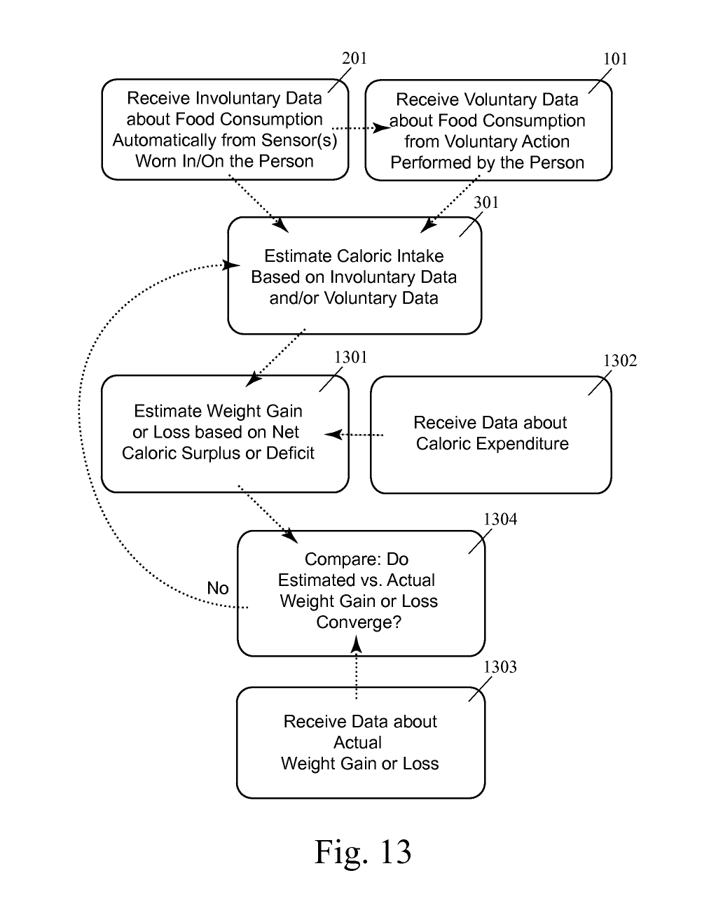

The embodiments of this invention that have been shown in FIGS. 5 through 12 all implicitly assume that the similarity and/or convergence of caloric estimates based on involuntary data and voluntary data can function as a proxy for accuracy. This is better than having no empirical basis at all for measuring the accuracy of data collected. However, we now relax this assumption for the examples of this invention which follow, starting with the example shown in FIG. 13. When it is possible to collect data about caloric expenditure and actual weight (gain or loss), in addition to data about caloric intake, then we no longer need to assume that the similarity of caloric intake estimates from two sources implies accuracy. We can test the accuracy of caloric intake measurement more directly by comparing predicted weight gain or loss to actual weight gain or loss.

In the examples of this invention that follow, beginning with the example shown in FIG. 13, the estimate of caloric expenditure for a period of time is subtracted from the estimate of caloric intake for a period of time in order to predict the person's weight gain or loss during that period of time. Then, the predicted weight gain or loss is compared to the actual weight gain or loss in order to test the accuracy of the estimate of caloric intake. If the predicted weight gain or loss is sufficiently close to the actual weight gain or loss, then this indicates that the estimated caloric intake is relatively accurate and no additional information or methodological adjustments are required.

However, if the predicted weight gain or loss is significantly different than the actual weight gain or loss, then this suggests that the estimate of caloric intake is not sufficiently accurate and that additional information or methodological adjustments are required. To be precise, such a difference could also be caused by imprecision in the estimation of caloric expenditure, but even in the case of imprecise caloric expenditure, improvement in the accuracy of caloric intake estimation will (holding other factors constant) cause greater similarity and/or convergence between predicted and actual weight gain or loss.

A person's weight gain or loss can be predicted because: net energy balance is caloric intake minus caloric expenditure; and weight gain or loss follows directly from net energy balance. Predicted weight gain or loss can then be compared to actual weight gain or loss. If estimated caloric intake is inaccurate, then predicted weight gain or loss will be significantly different than actual weight gain or loss. If estimated caloric intake is accurate (and caloric expenditure is also accurate), then predicted weight gain or loss will be close to actual weight gain or loss. Based on this logic, the examples of this invention that start with FIG. 13 evaluate the accuracy of caloric intake estimation based on the similarity and/or convergence of predicted weight gain or loss vs. actual weight gain or loss.

The example method of this invention that is shown in FIG. 13 starts in step 201 by receiving involuntary data about food consumption from one or more sensors that are worn in, or on, the person. These one or more sensors can be selected from the group consisting of: accelerometer, inclinometer, other motion sensor, sound sensor, smell or other olfactory sensor, blood pressure sensor, heart rate sensor, EEG sensor, ECG sensor, EMG sensor, electrical sensor, chemical sensor, gastric activity sensor, GPS sensor, camera or other image-creating sensor or device, optical sensor, piezoelectric sensor, respiration sensor, strain gauge, electrogoniometer, chewing sensor, swallow sensor, temperature sensor, and pressure sensor.

As also shown in FIG. 13, in step 101 voluntary data about food consumption is received from voluntary actions that are performed by the person in association with eating events, other than the actions of eating itself. In an example, step 101 may be prompted by the results of step 201. In another example, voluntary initiation of step 101 by the person may be independent of step 201.

In various examples, the voluntary data about food consumption that is collected in step 101 may be obtained from one or more actions selected from the group consisting of: having the person enter the types and portions of food consumed on paper or into an electronic device, having the person manually calculate or estimate calories consumed and record or enter them on paper or into an electronic device. In various examples, human-computer interface options may be selected from the group consisting of: touch screen, keypad, mouse and/or other cursor-moving device, speech or voice recognition, gesture recognition, scanning a bar code or other food code, and taking a picture of food or food packaging.

After involuntary data and voluntary data concerning food consumption are received in steps 201 and 101, this method then progresses to estimation of the person's caloric intake in step 301. In the method shown in FIG. 13, a single estimate of caloric intake is created. In an example, this single estimate may be created by combining, weighting, and/or merging involuntary data and voluntary data concerning food consumption. This is different than in the prior methods shown in FIGS. 5 through 12 wherein two different estimates of caloric intake were created, one estimate based on involuntary data and one estimate based on voluntary data. The reason for this difference is that the similarity and/or convergence of caloric intake estimates from involuntary and voluntary data is no longer needed in FIG. 13 as a proxy for accuracy. Thus, two separate estimates of caloric intake are not needed. Instead, in FIG. 13 and the methods that follow, the accuracy of caloric intake estimation is tested by the similarity and/or convergence of predicted vs. actual weight gain or loss.

In an example, caloric intake may be estimated by combining involuntary data and voluntary data concerning food consumption: using weights from a multivariate linear estimation model; using weights from a Bayesian statistical model; using linear or non-linear mathematical programming; or using other multivariate statistical methods. In an example, these weights may be standardized, based on empirical evidence from many people over multiple time periods. In an example, these weights may be customized to a particular individual, based on the individual's unique history of eating habits, sensor monitoring, and diet logging.

In an example, the key variables of this model (caloric intake, caloric expenditure, predicted weight gain or loss, and actual weight gain or loss) may be estimated for fixed duration, non-overlapping periods of time—such as individual days, weeks, months, or years. In an example, these key variables may be estimated for a rolling time period, such as a rolling 7-day period wherein, each day, one day is dropped from the beginning of the rolling time period and one day is added to the end of the rolling time period. In an example, the key variables of this model may be estimated for variable-length periods whose variable lengths are defined empirically by clustering together multiple eating and/or physical activity events.

In this example, data about the person's caloric expenditure is received in step 1302. For example, caloric expenditure can be estimated by one or more wearable motion sensors. There are many methods for estimating caloric expenditure in the prior art and the precise method for measuring caloric expenditure is not central to this invention. Accordingly, the precise method used for measuring caloric expenditure is not specified herein. Even if the method for measuring caloric expenditure is not completely accurate, the accuracy of estimated caloric intake will still be positively correlated with the accuracy of predicted weight gain or loss. Accordingly, this method can be used to evaluate the relative accuracy of estimated caloric intake even if there is error in the estimation of caloric expenditure. In an example, the criteria for similarity and/or convergence can be adjusted to reflect imprecision in the estimation of caloric expenditure.

Data about the person's actual weight gain or loss is received in step 1303. In an example, the person's actual weight (gain or loss) can be measured by having the person stand on a scale and having the scale wirelessly transmit the person's current weight to the same computing unit that performs caloric intake estimation. This computing unit can compare the person's current weight to the person's previous weight in order to calculate actual weight gain or loss. In an example, the person can manually enter current weight information from the scale via a human-computer interface such as touch screen, voice recognition, or keypad. In an example, the person may be prompted to stand on the scale periodically (e.g. each day, week, or month).

In a different example, the person's actual weight (gain or loss) may be monitored and estimated in an involuntary manner. For example, a camera may be placed in a location from which it can take pictures of the person in an automatic manner on a regular basis. In an example, these pictures may be automatically analyzed by three-dimensional image analysis in order to estimate the person's weight (gain or loss). In an example, pressure or weight sensors may be placed in locations where the person walks, sits, or reclines on a regular basis. Data from these pressure or weight sensors may be analyzed to estimate the person's weight (gain or loss).

In an example, data concerning the person's current weight on a scale may be adjusted to reflect differences in what the person is wearing, the time of day, the proximity to an eating event, or other factors which may temporarily distort the person's weight. In an example, information concerning these factors may be voluntarily recorded by the person or automatically identified by one or more sensors. In an example, a camera in association with a scale may recognize the types of clothing currently worn by the person and adjust estimation of the person's current weight accordingly.

In the method and system for measuring a person's caloric intake that is shown in FIG. 13, the person's predicted weight gain or loss for a period of time is calculated in step 1301. The person's predicted weight gain or loss is calculated based on the estimate of caloric intake from step 301 and the estimate of caloric expenditure from step 1302. Then, in step 1304, the person's predicted weight gain or loss is compared to the person's actual weight gain or loss.

If the values for predicted vs. actual weight gain or loss meet the criteria for similarity and/or convergence in step 1304, then the method concludes with this step. However, if the values for predicted vs. actual weight gain or loss do not meet the criteria for similarity and/or convergence in step 1304, then this method cycles back to step 301 and the process for estimating caloric intake from involuntary data and voluntary data is adjusted. This cycling back to step 301 is represented in FIG. 13 by a dotted-line arrow (labeled “No” for “no convergence”) that goes upwards from step 1304 to step 301. In an example, this iterative cycle of estimation adjustment can repeat indefinitely until the criteria for similarity and/or convergence are met. In an example, this cycle may only repeat until the earlier of: criteria for similarity and/or convergence are met; or a target maximum number of cycles occur. The criteria for similarity and/or convergence can be selected from those that were specified in this disclosure for earlier figures.

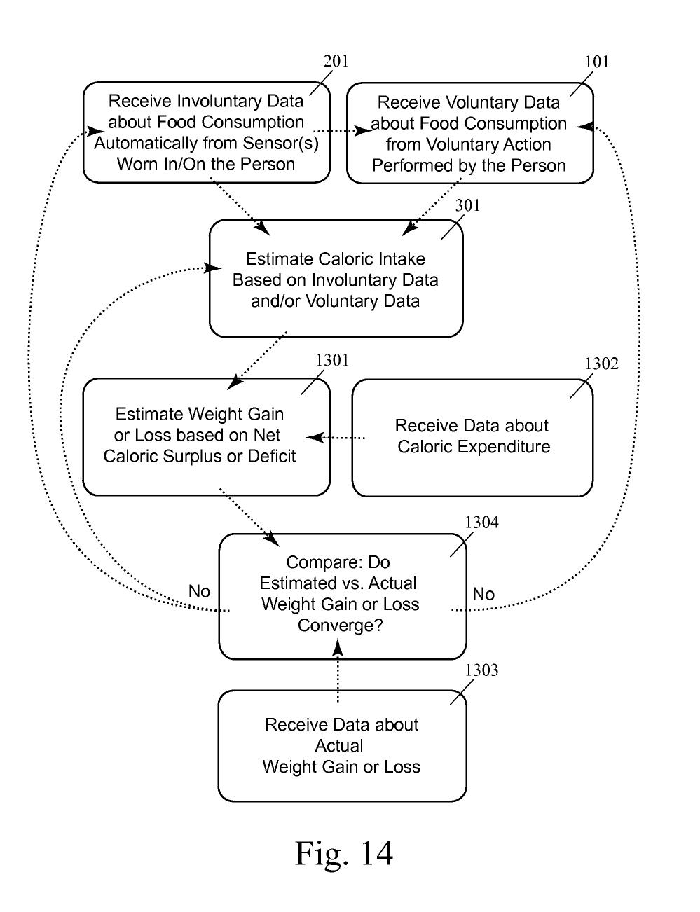

The method for measuring caloric intake that is shown in FIG. 13 relies only on adjustment of the process (or model) for estimating caloric intake in step 301 in order to improve the estimate of caloric intake to achieve similarity and/or convergence of the predicted vs. actual weight gain or loss. However, the method shown in FIG. 14 now expands the adjustment process to also include potential collection of additional involuntary data and/or voluntary data to refine caloric intake estimation. The method in FIG. 14 comprises the same steps as those in FIG. 13, but now also includes dotted-line arrows from step 1304 back to steps 201 and 101. These dotted-line arrows indicate that, in this method, additional involuntary data and voluntary data concerning food consumption can be collected if the criteria for similarity and/or convergence of predicted vs. actual weight gain or loss are not met in step 1304.

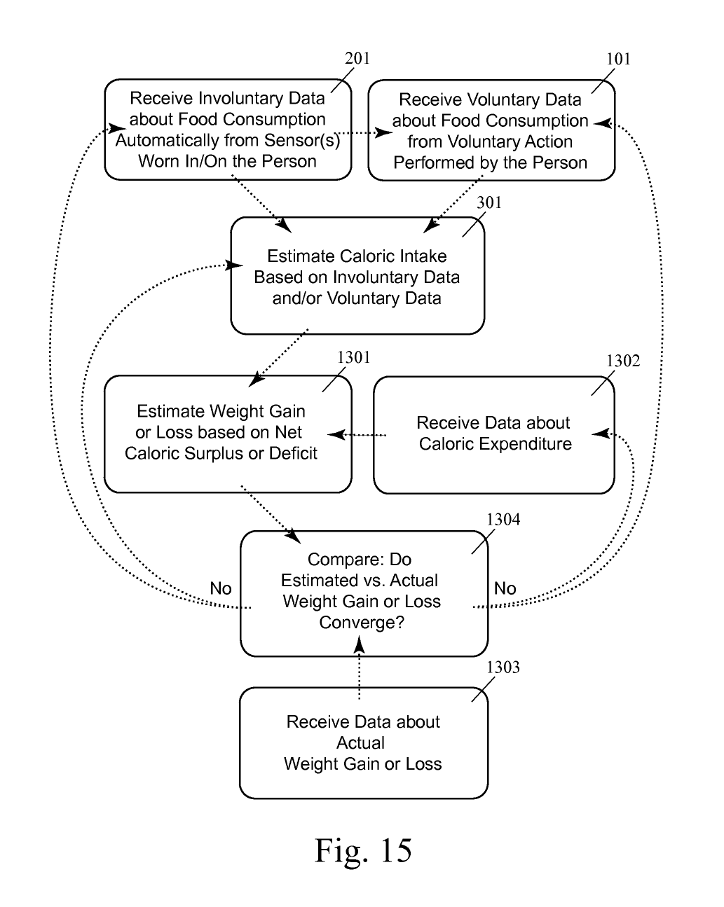

The method shown in FIG. 15 further expands the breadth of adjustment by also adding possible collection of additional information concerning caloric expenditure when convergence and/or similarity criteria are not met.

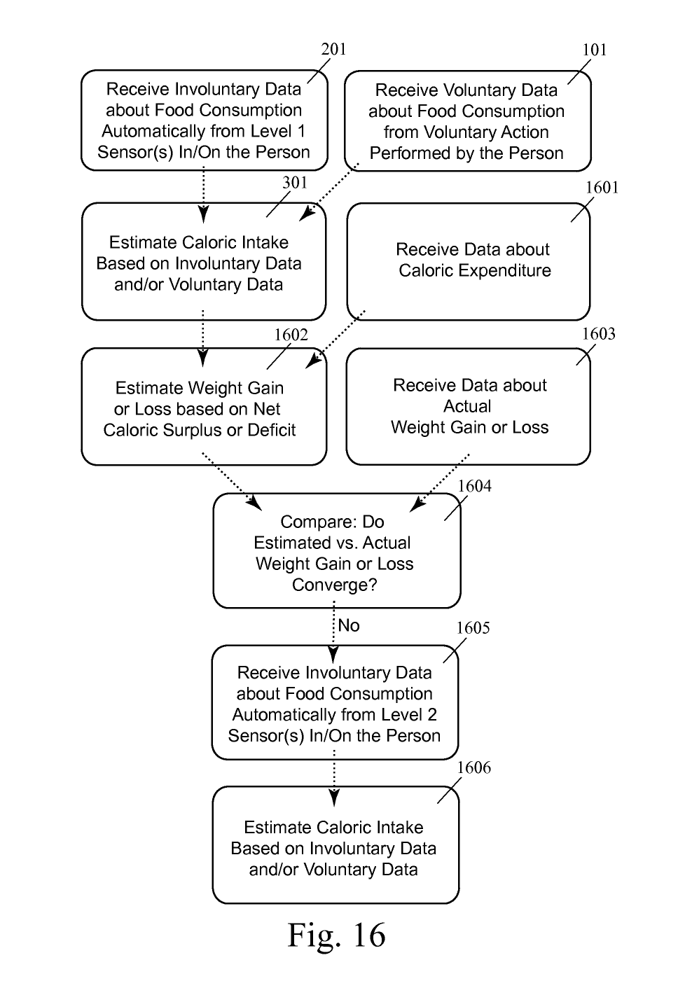

The examples of this invention that are subsequently shown in FIGS. 16 through 20 may be seen as variations on the example that is shown in FIG. 15, with three main differences. These three main differences are: (1) FIGS. 16 through 20 show a maximum of two cycles of data collection and/or estimation process adjustment; (2) FIGS. 16 through 20 show additional involuntary data collection only in the second cycle of data collection; and (3) FIGS. 16 through 20 provide greater specificity with respect to the types, activation, and timing of the sensors that are used to collect involuntary data about food consumption.

FIG. 16 shows one example of how this invention may be embodied in a method for measuring caloric intake which escalates from collecting data on food consumption from “level 1” (less intrusive) automatic sensors to collecting data on food consumption from “level 2” (more intrusive) automatic sensors—if the “level 1” sensors do not achieve a desired level of measurement accuracy. In an example, “level 1” sensors can be less-intrusive because of their low-level modality (e.g. motion or sound), non-continuous operation (e.g. only when triggered by an eating event), low-profile placement (e.g. under clothing), and/or flexible timing (e.g. delayed data acquisition at the end of the day). In an example, “level 2” can be more-intrusive because of their high-level modality (e.g. images), continuous operation, high-profile placement (e.g. around the neck), and/or immediate timing (e.g. real time data acquisition while eating).

The method in FIG. 16 starts, in step 201, with the collection of involuntary data concerning food consumption from “level 1” sensors that are worn in, or on, the person. In step 101, voluntary data is collected concerning food consumption. Also, in step 301, the person's caloric intake is estimated based on a combination, weighting, or merging of involuntary data from step 201 and voluntary data from step 101. In step 1601, data is collected and received concerning the person's caloric expenditure. In step 1602, predicted weight gain or loss for the person is estimated based on the person's caloric intake minus the person's caloric expenditure (i.e. net energy balance).

In step 1603, data concerning the person's actual weight (gain or loss) is received. Then, in step 1604, predicted weight gain or loss for the person is compared to actual weight gain or loss for the person. If predicted vs. actual weight gain or loss meet the criteria for similarity and/or convergence, then the method stops. If predicted vs. actual weight gain or loss do not meet the criteria for similarity and/or convergence, then the method escalates to step 1605 in which involuntary data concerning food consumption is collected from “level 2” sensors. Finally, a new estimate of caloric intake is calculated in step 1606 based on both “level 1” and “level 2” involuntary data (as well as the original voluntary data).

The method shown in FIG. 16 provides the person with incentives to provide accurate and timely voluntary data concerning food consumption. One such incentive is the avoidance of more-intrusive automatic data collection in step 1605. If the combination of “level 1” involuntary data and voluntary data combine to accurately predict caloric intake (as determined in step 1604), then the person can avoid being monitored by “level 2” sensors. In this manner, as the person becomes more engaged, timely, and accurate with respect to voluntary reporting of caloric intake, then involuntary data collection becomes less intrusive.

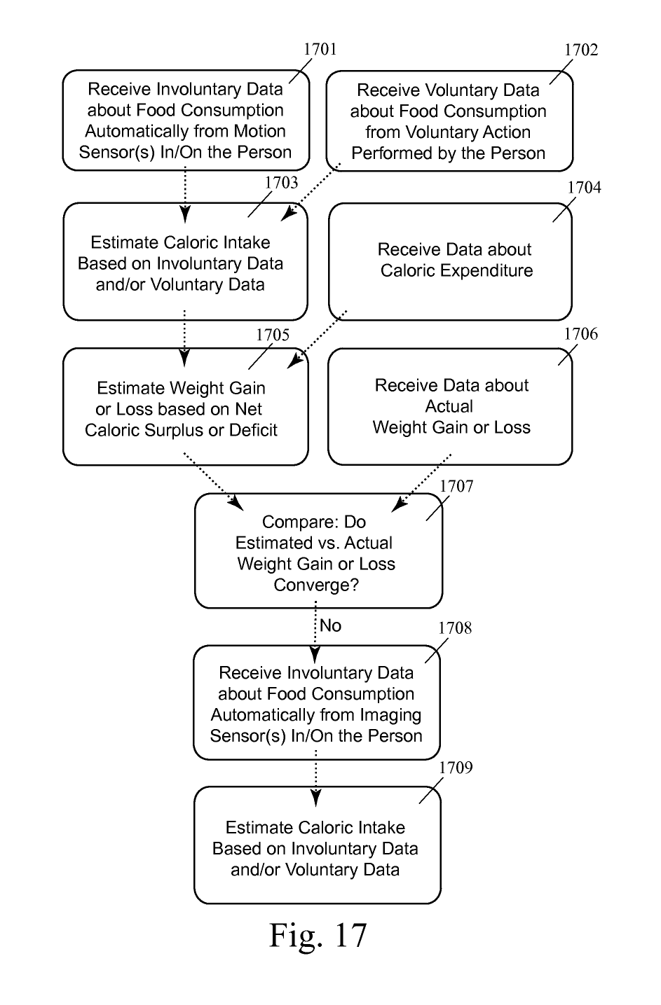

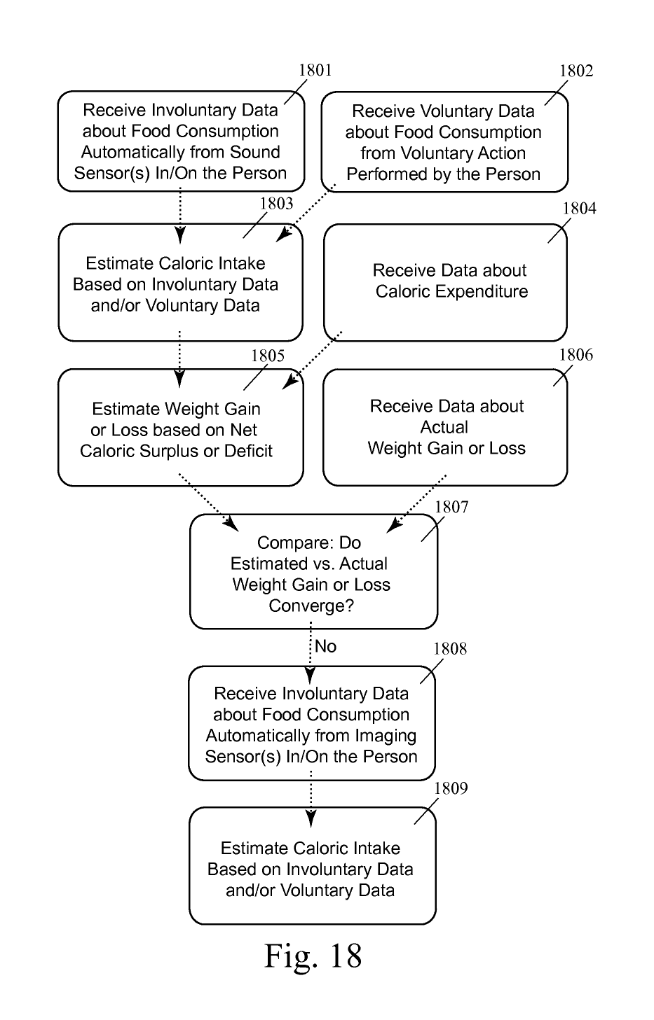

The method shown in FIG. 17 is similar to that shown in FIG. 16 except that the types of involuntary data sensors that are used in “level 1” vs. “level 2” are explicitly specified. As shown in step 1701 of FIG. 17, one or more wearable motion sensors (such as wearable accelerometers) are used to collect data concerning food consumption in “level 1”. As shown in step 1708 of FIG. 17, one or more wearable image sensors (such as wearable cameras) are used to collect data concerning food consumption in “level 2”. The example in FIG. 18 is like that in FIG. 17 except that one or more wearable sound sensors (such as wearable microphones) as used in “level 1” in step 1801. The other steps in FIGS. 17 and 18 are the same as the steps located in similar diagrammatic positions in FIG. 16.

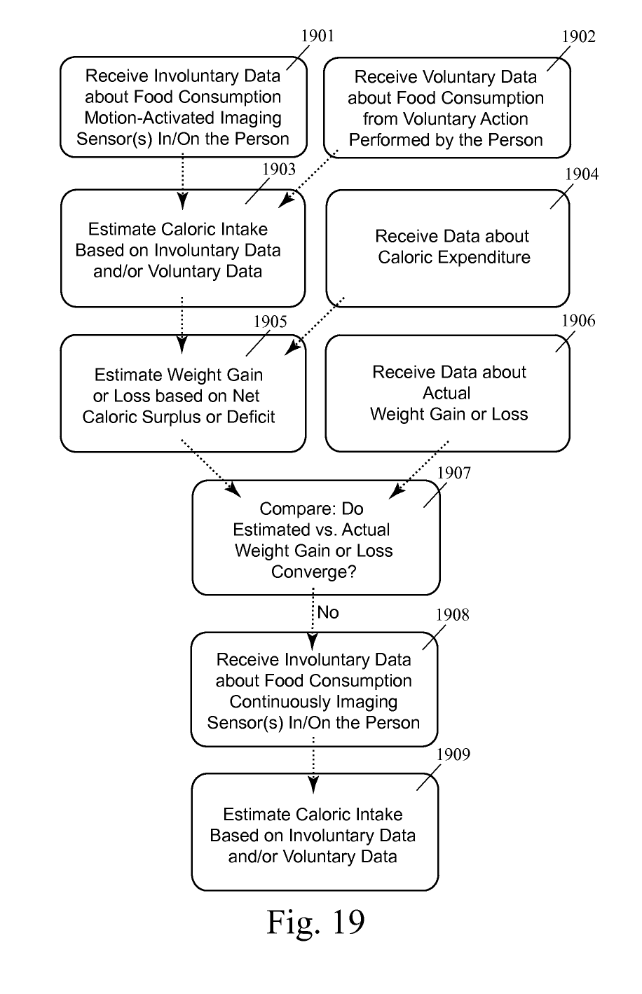

The method shown in FIG. 19 is similar to that shown in FIG. 16 except that “level 1” vs. “level 2” automatic sensors are differentiated by the timing of their operation, not their type or modality. As shown in step 1901, in the first round of involuntary data collection in FIG. 19, the automatic sensor is a motion-activated imaging sensor (such as a wearable camera) that only collects information on food consumption when the person's movements suggest that the person is eating. This is less intrusive on the person's privacy than an imaging sensor that takes pictures continuously.

As shown in step 1908, in the second round of involuntary data collection (if convergence is not achieved in step 1907), an automatic imaging sensor takes pictures continuously. In an example, this imaging sensor can be a wearable video camera. In an example, this imaging sensor can be worn on the person's wrist, neck, head, or torso. In an example, this imaging sensor can continuously track the location of the person's mouth and take continuous video images of the person's mouth to detect and identify food consumption. In an example, this imaging sensor can continuously track the location of the person's hands and take continuous video images of the space near the person's fingers to detect and identify food consumption.

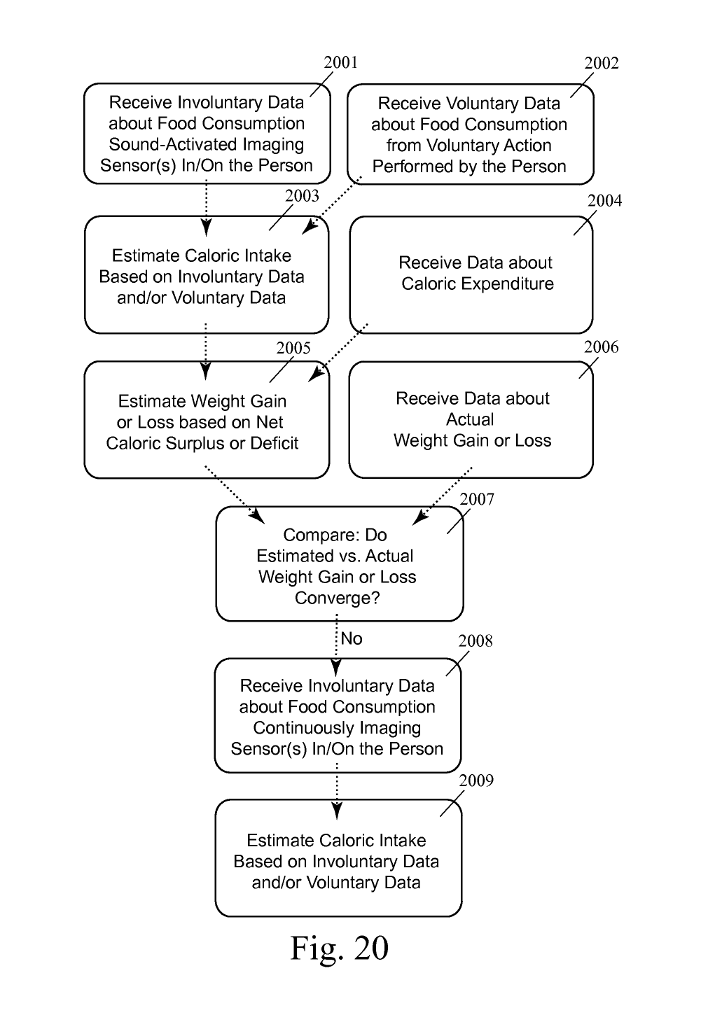

The method shown in FIG. 20 is like that shown in FIG. 19, except that the non-continuous imaging sensor in the first round of involuntary data collection is a sound-activated imaging sensor. In an example, the imaging sensor (such as a wearable video camera) can be activated to take pictures by chewing, biting, or swallowing sounds that are detected by a wearable microphone. The other steps in FIGS. 19 and 20 are the same as the steps located in similar diagrammatic positions in FIG. 16.

As shown in FIGS. 13 through 20, this invention can be embodied in a method for measuring a person's caloric intake comprising: (a) receiving a first set of data concerning what the person eats; (b) calculating a first estimate of the person's caloric intake based on the first set of data, using this first estimate of the person's caloric intake to estimate predicted weight change for the person during a period of time, and comparing predicted weight change to actual weight change to determine whether predicted weight change and actual weight change meet criteria for similarity and/or convergence; and (c) if predicted weight change and actual weight change do not meet the criteria for similarity and/or convergence, then receiving a second set of data concerning what the person eats and calculating a second estimate of caloric intake using this second set of data.

In an example, collecting the first set of data does not require voluntary actions by the person associated with particular eating events other than the actions of eating, but collecting the second set of data does require voluntary actions by the person associated with particular eating events other than the actions of eating. In an example, collecting the second set of data does not require voluntary actions by the person associated with particular eating events other than the actions of eating, but collecting the first set of data does require voluntary actions by the person associated with particular eating events other than the actions of eating.

As shown in FIGS. 13 through 20, a first set of data can be received concerning what the person eats, wherein this first set includes involuntary data that is collected in a manner that does not require voluntary actions by the person associated with particular eating events other than the actions of eating, and wherein this first set also includes voluntary data that is collected in a manner that requires voluntary actions by the person associated with particular eating events other than the actions of eating.

As shown in FIGS. 13 through 20, this invention can be embodied in a method for measuring a person's caloric intake comprising: (a) receiving a first set of data concerning what the person eats, wherein this first set includes involuntary data that is collected in a manner that does not require voluntary actions by the person associated with particular eating events other than the actions of eating, and wherein this first set also includes voluntary data that is collected in a manner that requires voluntary actions by the person associated with particular eating events other than the actions of eating and; (b) calculating a first estimate of the person's caloric intake based on this first set of data, using this first estimate of the person's caloric intake to estimate predicted weight change for the person during a period of time, and comparing predicted weight change to actual weight change to determine whether predicted weight change and actual weight change meet criteria for similarity and/or convergence; and (c) if predicted weight change and actual weight change do not meet the criteria for similarity and/or convergence, then receiving a second set of data concerning what the person eats and calculating a second estimate of caloric intake using this second set of data.

In an example, the first set of data comprises image data whose collection requires voluntary actions by the person associated with particular eating events other than the actions of eating and the second set of data comprises image data whose collection is more continuous than that of the first set of data. In an example, the first set of data comprises image data whose collection is intermittent, periodic, or random, not requiring voluntary actions by the person associated with particular eating events other than the actions of eating, and the second set of data comprises image data whose collection is more continuous than that of the first set of data. In an example, the first set of data comprises image data whose collection is triggered by sounds, motions, or sounds and motions indicating an eating event, not requiring voluntary actions by the person associated with particular eating events other than the actions of eating, and the second set of data comprises image data whose collection is more continuous than that of the first set of data. In an example, the first set of data comprises sound data, motion data, or both sound and motion data, and wherein the second set of data comprises image data.

As shown in FIGS. 13 through 20, this invention can be embodied in a method for measuring a person's caloric intake comprising: (a) receiving a first set of data concerning what the person eats, wherein collecting this first set of data requires a first level of intrusion into the person's privacy or time; (b) calculating a first estimate of the person's caloric intake based on the first set of data, using this first estimate of the person's caloric intake to estimate predicted weight change for the person during a period of time, and comparing predicted weight change to actual weight change to determine whether predicted weight change and actual weight change meet criteria for similarity and/or convergence; and (c) if predicted weight change and actual weight change do not meet the criteria for similarity and/or convergence, then receiving a second set of data concerning what the person eats, wherein collection of this second set of data requires a second level of intrusion into the person's privacy or time that is greater than the first level, and calculating a second estimate of caloric intake based, in whole or in part, on this second set of data.

In an example, this invention can be embodied in a method for measuring the types and quantities of food consumed by a person comprising: (a) receiving a first set of data concerning what the person eats; (b) calculating a first estimate of the types and quantities of food consumed based on the first set of data, using this first estimate of the types and quantities of food consumed to estimate predicted weight change for the person during a period of time, and comparing predicted to actual weight change to determine whether predicted and actual weight change meet criteria for similarity and/or convergence; and then (c) if predicted weight change and actual weight change do not meet the criteria for similarity and/or convergence, then receiving a second set of data concerning what the person eats and calculating a second estimate of the types and quantities of food consumed using this second set of data.

In an example, collection of the first set of data does not require voluntary actions by the person associated with particular eating events other than the actions of eating, but collection of the second set of data does require voluntary actions by the person associated with particular eating events other than the actions of eating. In an example, collection of the second set of data does not require voluntary actions by the person associated with particular eating events other than the actions of eating, but collection of the first set of data does require voluntary actions by the person associated with particular eating events other than the actions of eating.

In an example, the first set of data comprises image data whose collection requires voluntary actions by the person associated with particular eating events other than the actions of eating, and the second set of data comprises image data whose collection is more continuous than that of the first set of data. In an example, the first set of data comprises image data whose collection is intermittent, periodic, or random, not requiring voluntary actions by the person associated with particular eating events other than the actions of eating, and the second set of data comprises image data whose collection is more continuous than that of the first set of data. In an example, the first set of data comprises image data whose collection is triggered by sounds, motions, or sounds and motions indicating an eating event, not requiring voluntary actions by the person associated with particular eating events other than the actions of eating, and the second set of data comprises image data whose collection is more continuous than that of the first set of data. In an example, the first set of data comprises sound data, motion data, or both sound and motion data, the second set of data comprises image data, and neither the collection the first set of data nor the collection of the second set of data requires voluntary actions by the person associated with particular eating events other than the actions of eating.

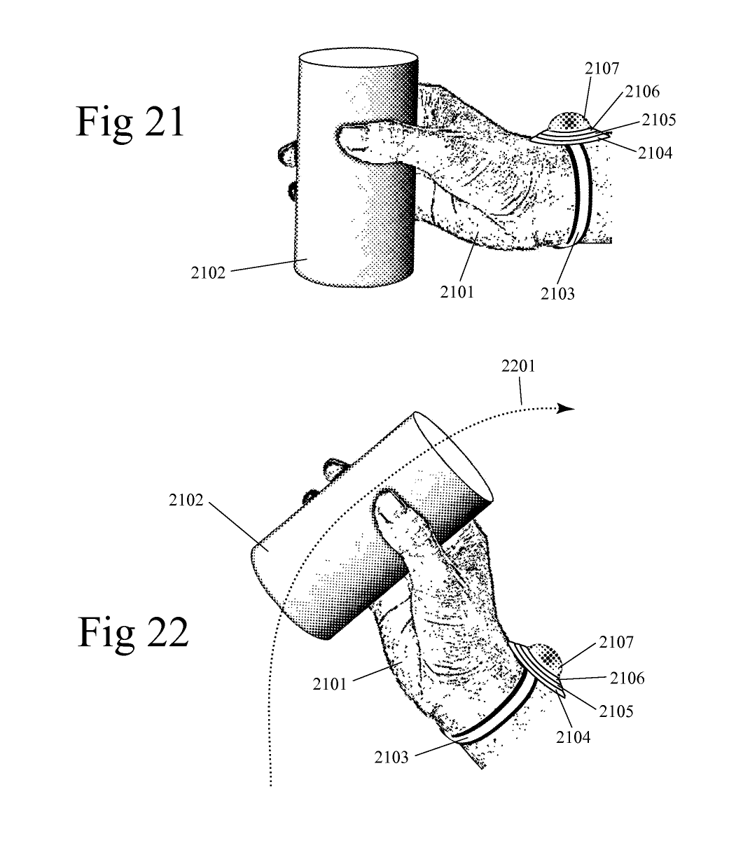

FIGS. 21 through 27 show a sequence of images that illustrate the structure and operational stages of an example of how this invention may be embodied in a wearable device that measures a person's caloric intake. In this example, the device is worn on a person's wrist in a manner similar to a wrist watch. This device includes: (a) a motion sensor that automatically analyzes movement of the person's wrist to detect when the person is probably eating; (b) a microphone and speaker unit, with voice recognition capability, which enables two-way vocal communication between the device and the person; (c) a wireless data processing and transmission unit that communicates with a remote scale; and (d) a miniature video camera that automatically takes pictures of food as it is transported to the person's mouth by the person's hand. We now discuss these figures in detail.

FIG. 21 shows a person's hand 2101 holding a food-transporting member 2102 that transports food up to the person's mouth. In this example, food is broadly defined to include liquid beverages, as well as solid and semi-solid food. In this example, the food-transporting member is a glass that contains a drinkable beverage. In various examples, the food-transporting member may be a cup, mug, or other beverage container. In an example, the food-transporting member may be a fork, spoon, chop stick, or other utensil that transports solid or semi-solid food up to the person's mouth. In an example, the person may transport food directly to their mouth by grasping it with their fingers, without the need for a food-transporting member as an intermediary. For example, the person may grasp a piece of food (such as a potato chip or a peanut or an apple) directly with their fingers and bring it up to their mouth to consume it.

FIG. 21 shows a wristband 2103 that is worn around the person's wrist in a manner like a wrist-watch strap or a bracelet. Attached to wristband 2103 is a compound member that includes one or more sensors that collect information concerning food consumption and a data processing and transmission unit. In this example, this compound member includes: data processing and transmission unit 2104; motion sensor 2105; microphone and speaker unit 2106; and miniature video camera 2107. In an example, the person may wear one such device on each wrist.

In various examples, there may be one or more sensors in this compound member. In an example, these sensors can be selected from the group consisting of: accelerometer, inclinometer, other motion sensor, chewing sensor, swallow sensor, voice or other sound sensor, smell or olfactory sensor, blood pressure sensor, heart rate sensor, EEG sensor, ECG sensor, EMG sensor, electrical sensor, chemical sensor, gastric activity sensor, GPS sensor, camera or other image-creating sensor or device, optical sensor, piezoelectric sensor, respiration sensor, strain gauge, electrogoniometer, temperature sensor, and pressure sensor.

In various examples, a compound member such as the one shown in FIG. 21 can be worn directly on the person's body. Alternatively, it can be attached to the person's clothing. In various examples, this compound member can be worn on the person's wrist, neck, ear, head, arm, finger, mouth, or torso. In various examples, this compound member can be worn in a manner similar to a wrist watch, bracelet, necklace, pendant, button, belt, hearing aid, ear plug, headband, eyeglasses, bluetooth device, ear ring, or finger ring.

In an example, a compound member such as the one shown on wristband 2103 in FIG. 21 can be used to collect involuntary data concerning the person's food consumption, without requiring any voluntary actions by the person other than the actual actions of eating. In an example, a compound member such as this one can be used to collect voluntary data concerning the person's food consumption through voluntary actions by the person other than the actual actions of eating. In an example, the same compound member can be used to collect both involuntary data and voluntary data concerning the person's food consumption. In an example, collection of involuntary data vs. voluntary data concerning food consumption can be independent of each other. In an example, collection of involuntary and voluntary data can be causally linked. In an example, when involuntary data from a sensor indicates that the person is probably eating, then the device can prompt the person to provide voluntary data concerning what they are eating.

In an example, such a compound member can estimate the person's caloric intake based on both involuntary data and voluntary data concerning food consumption. In an example, a device can escalate data collection to a more-accurate, but also more-intrusive, level of involuntary data collection if the estimate of caloric intake from a less-intrusive level is not sufficiently accurate. In an example, the accuracy of estimates of caloric intake can be tested by comparing predicted weight gain or loss to actual weight gain or loss. In an example, if predicted and actual weight gain or loss do not meet the criteria for similarity and/or convergence, then the device can activate a level of automatic monitoring (and involuntary data collection) which is more-accurate, but also more-intrusive into the person's privacy and/or time.

In an example, this device gives the person an incentive to provide timely and accurate voluntary data concerning food consumption in order to avoid potentially more-intrusive sensor monitoring and involuntary data collection. Such a device and method can engage the person in their own energy balance and weight management to a greater degree than an entirely-involuntary device for automatic monitoring. Such a device and method can also ensure greater compliance and accuracy than an entirely-voluntary device for diet logging.

In the device embodiment that is shown in FIGS. 21 through 27, data processing and transmission unit 2104 analyzes data from one or more sensors. In this example, data processing and transmission unit 2104 receives data from motion sensor 2105, microphone and speaker unit 2106, and video camera 2107. This data processing and transmission unit is also able to communicate data to and from a remote computer.

In this example, motion sensor 2105 detects movement patterns of the person's hand that indicate that the person is probably eating. In an example, these movements may include reaching for food, grasping food (or a glass or utensil for transporting food), raising food up to the mouth, tilting the hand to move food into the mouth, pausing to chew or swallow food, and then lowering the hand. In an example, these movements may also include the back-and-forth hand movements that are involved when a person cuts food on a plate. In this example, a motion sensor is categorized as a relatively less-intrusive sensor, even though it operates continually to monitor possible eating events. In another example, a sound sensor may be used for this continuous, but less-intrusive, monitoring function. A sound sensor may continually monitor for eating events by monitoring for biting, chewing, and swallowing sounds.

In this example, microphone and speaker unit 2106 functions as a two-way voice-based user interface. In this example, microphone and speaker unit 2106 emits voice-based messages that are heard by the person wearing the device and this unit also receives voice-based messages from this person. In an example, data processing and transmission unit 2104 includes voice generation and voice recognition software. In an example, unit 2106 is used to prompt the person wearing the device to enter voluntary data concerning food consumption. In an example, unit 2106 is used to receive voluntary data (in voice form) concerning food consumption from this person. In other examples, this device may send messages to the person in voice form, but receive data from the person in another form such as through a keypad or touch screen. In other examples, this device can send messages to the person in non-voice form, such as a display screen, but receive messages from the person in voice form.

In the example of the device that is shown in FIGS. 21 through 27, miniature video camera 2107 takes pictures of the person's hand and fingers, and also the space surrounding the person's hand and fingers, in order to detect and identify food. In this example, video camera 2107 need not operate continuously. In this example, video camera 2107 only operates when voluntary data and less-intrusive involuntary data do not combine to create sufficiently-accurate estimates of caloric intake. In this example, the accuracy of caloric intake estimation is tested by comparing predicted weight gain or loss (based on the caloric intake estimate) vs. actual weight gain or loss.

In an example, video camera 2107 can be activated to take pictures when other components of the device indicate that the person is probably eating. In an example, the operation of video camera 2107 can be triggered when motion sensor 2105 indicates that the person is probably eating. In another example, the operation of video camera 2107 can be triggered when a sound sensor indicates that the person is probably eating. In an example, the operation of video camera 2107 can be triggered when voluntary data received from the person, such as through microphone and speaker unit 2106, indicates that the person is eating.

In an example, video camera 2107 can have a fixed focal direction and focal length. In an example, the focal direction of the video camera may always point toward the person's fingers and the space surrounding the person's fingers. In another example, the video camera can have a focal direction or focal length that is automatically adjusted while the camera is in operation. In an example, when it is in operation, the video camera can scan back and forth through the space near the person's hand and fingers to search for food. In an example, the video camera can use pattern recognition to track the relative location of the person's fingers. In an example, the camera can automatically adjust its focal direction and/or focal length to monitor and identify eating-related objects (such as a fork or glass) that come into contact with the person's fingers.

In an example, video camera 2107 can scan in a spiral, radial, or back-and-forth pattern in order to monitor activity near both the person's fingers and the person's mouth. This is more complex than just tracking the person's fingers. This requires that the device keep track of where the person's fingers and mouth are, in three-dimensional space, relative to the camera as the person moves their arm, hand, and head. In an example, face recognition software can help the device to track the person's mouth and gesture recognition software can help the device to track the person's fingers.

In the example shown in FIG. 21, there is only one miniature video camera in this device and it is located on the outer portion of the person's wrist where the main body of a wrist watch would generally be located. In another example, such a device may have one video camera located on the opposite side of the person's wrist. In other examples, there may be two or more video cameras mounted on different locations around the person's wrist. In an example with two or more video cameras, different cameras may track different objects. For example, one camera may track the person's fingers and the other camera may track the person's mouth. In various examples, different cameras may operate at different times and/or with different focal lengths.

FIGS. 21 through 27 show this device in sequential stages of operation as it progressively monitors the person's food consumption and estimates the person's caloric intake. FIG. 22 shows the device as it is tilted when the person the tilts their hand 2101 upwards to bring glass 2102 up to their mouth to drink. This tilting movement, especially when followed by a pause and then a reverse tilting movement, is detected and recognized by motion sensor 2105 as indicating a probable eating event.

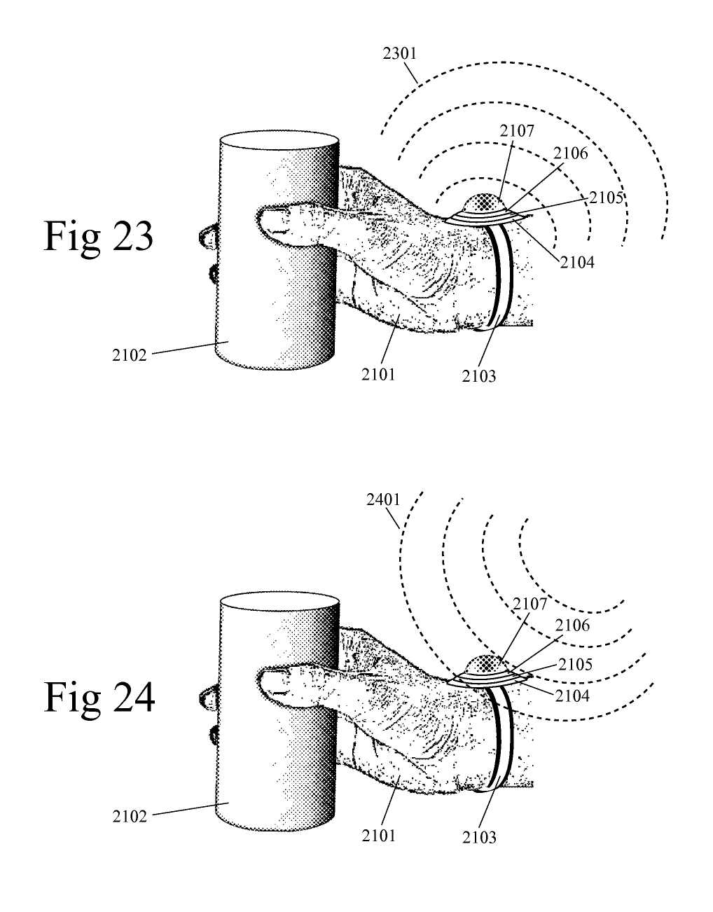

In FIG. 23, the motion sensor has detected this possible eating event (i.e. the glass being tilted up to the mouth and then back down) and this event has triggered a voice-based inquiry from the device to the person via microphone and speaker unit 2106. In an example, the device, upon detection of a probable eating event, can ask the person a question such as—“If you are eating something, please identify it.” The sound waves of this voice-based inquiry from the device are represented in FIG. 23 by concentric dotted lines 2301 expanding outward from the device. In this example, the device solicits voluntary data concerning food consumption from the person through a voice-based message. In other examples, a device may solicit voluntary data via other means such as a display screen, buzzing or ring tone, vibration, or text message.

In an example, solicitation or prompting of voluntary data collection concerning food consumption can occur in real time when the motion sensor first detects a possible eating event. In another example, solicitation of voluntary data may be delayed until after an eating event is finished. In another example, the device may keep a record of multiple eating events throughout the day and inquire about each during a cumulative data collection session at the end of the day. The latter is less intrusive with respect to eating events, but risks imprecision due to imperfect recall and “caloric amnesia.”

FIG. 24 shows the person responding to the voice-based prompt with voice-based data concerning what the person is eating. In an example, the person might respond to the device inquiry with the statement—“I am drinking a large glass of apple juice.” The person's voice-based response is received by microphone and speaker unit 2106. The sound waves of this voice-based response from the person are represented in FIG. 24 by concentric dotted lines 2401 expanding toward the device. In this example, the voice-based response that is received by microphone and speaker unit 2106 is analyzed and understood by data processing and transmission unit 2104. In another example, the voice-based response may be transmitted to, and analyzed by, a remote computer. In an example, voice recognition or speech recognition software can be used to analyze the voice-based response.

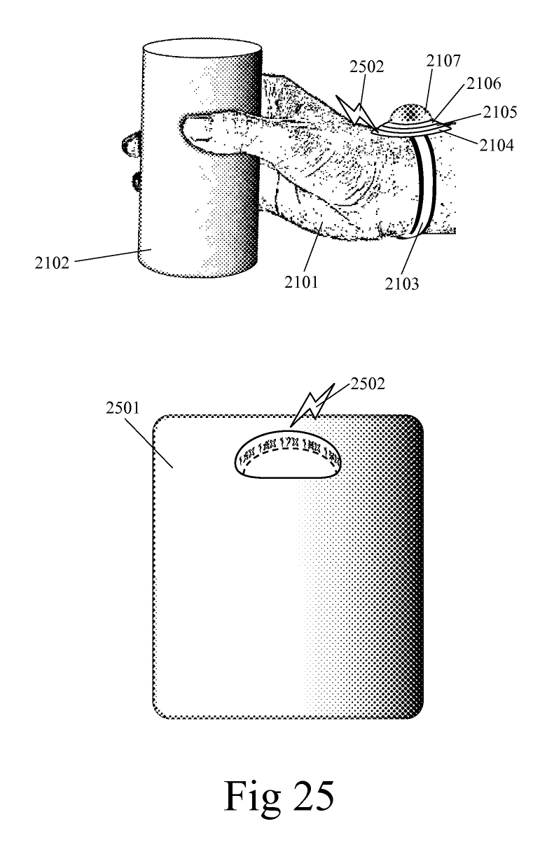

In the upper portion of FIG. 25, data processing and transmission unit 2104 has estimated the person's caloric intake. This estimate of caloric intake is based on involuntary data concerning food consumption collected by the motion sensor, voluntary data concerning food consumption received via the person's voice, or both involuntary data and voluntary data. In an example, an estimate of the person's caloric expenditure is subtracted from the estimate of the person's caloric intake in order to calculate the person's net energy balance and to predict the person's weight gain or loss. In an example, the estimate of caloric expenditure can come from a different device and be transmitted wirelessly to data processing and transmission unit 2104. In another example, the estimate of caloric expenditure can come from analysis of the person's activities as monitored by motion sensor 2105.

In an example, all of these data processing tasks can occur within the wearable device, such as within data processing and transmission unit 2104. In another example, some of these data processing tasks can occur within the wearable device and other tasks can occur in a remote computer. In an example, data can be transmitted back and forth from the wearable device to a remote computer via data processing and transmission unit 2104.

In an example, caloric intake may be estimated by combining involuntary data and voluntary data using weights from a multivariate linear estimation model; using a Bayesian statistical model; using linear or non-linear mathematical programming; or using other multivariate statistical methods. In an example, weights can be standardized based on empirical evidence from a large population. In an example, weights can be customized to a specific individual based on the individual's own eating habits, sensor output patterns, and diet logging behavior.

The bottom portion of picture in FIG. 25 shows scale 2501. The person's actual weight is measured when the person stands on scale 2501 and this weight value is then transmitted wirelessly to data processing and transmission unit 2104 of the wearable device. This wireless transmission is figuratively represented by lightning bolt symbol 2502. Actual weight gain or loss is determined by changes in weight measurements between different times. The predicted weight gain or loss (based on estimated caloric intake and caloric expenditure) for the person is compared to actual weight gain or loss for the person. If the predicted and actual weight gain or loss meet the criteria for similarity and/or convergence, then the device does not need to gather more information about food consumption.

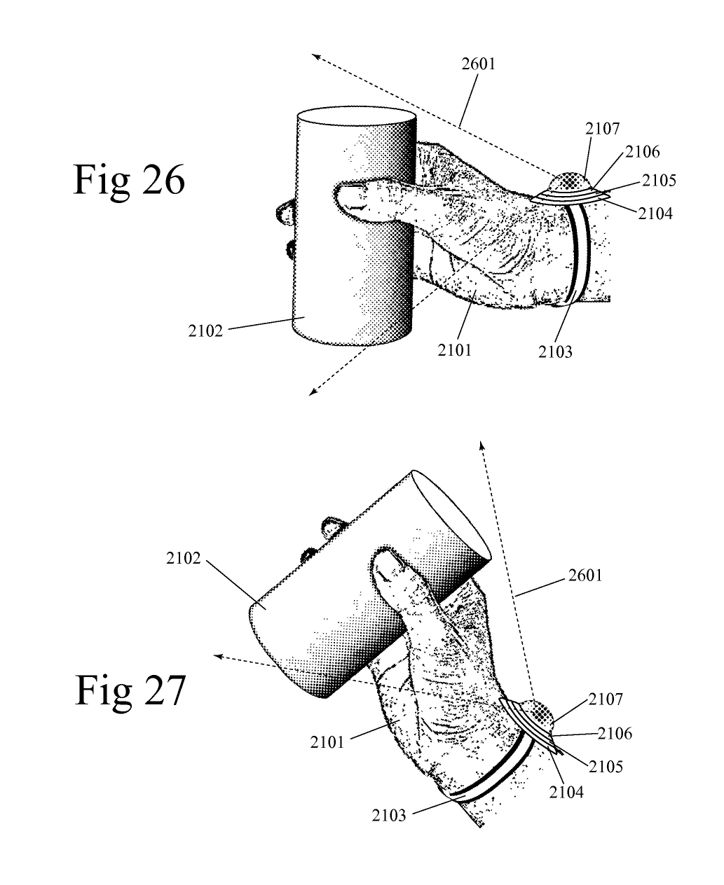

However, if the predicted and actual weight gain or loss do not meet the criteria for similarity and/or convergence, then the device escalates collection of involuntary data concerning food consumption to a more-accurate (but also more-intrusive) level, as shown in FIGS. 26 and 27. In FIGS. 26 and 27, miniature video camera 2107 is activated to take pictures to detect and identify food consumption. In an example, video camera 2107 is only activated when predicted and actual weight gain or loss fail to meet the criteria for similarity and/or convergence. In an example, the person can avoid being monitored by the video camera if the person provides accurate and timely voluntary data concerning food consumption in the voice-based exchange that is shown in FIGS. 23 and 24. This provides an incentive for the person to be actively and accurately engaged in monitoring their own caloric intake and managing their own energy balance.

FIGS. 26 and 27 show how miniature video camera 2107 can track a food-transporting member (such as glass 2102) as it is lifted upwards towards the person's mouth, paused during consumption of the food, and then lowered back down. Food is broadly defined herein to include beverages as well as solid and semi-solid food. In an example, the resulting images of food or food containers can be automatically analyzed to estimate the types and quantities of food consumed. In addition to the color, texture, and volume of food itself, features of food containers and packages may also be analyzed to identify food. For example, if the hand in FIGS. 26 and 27 were holding a beverage can instead of a glass, then the image analysis might recognize a logo on the can in order to identify the beverage.

If a person really wanted to “fool” this device, they could do so in the short run. For example, they could pour a less-healthy beverage into the empty can of a more-healthy beverage, before consuming the less-healthy beverage in view of the camera. The camera might be “fooled” by the logo on the can into thinking that the person drank the more-healthy beverage. However, over the long run, such deception would show up in discrepancies between predicted and actual weight gain or loss. These discrepancies could result in further escalation of involuntary data collection with diverse sensors with more-continuous operation. Overall, the device and method disclosed herein provides incentives for the person to be engaged in honest, accurate, and timely voluntary reporting of food consumed in order to avoid escalation of involuntary data collection.

In various examples, analysis and identification of food or food packaging can include one or more methods selected from the group consisting of: food recognition or identification; visual pattern recognition or identification; chemical recognition or identification; smell recognition or identification; word recognition or identification; logo recognition or identification; bar code recognition or identification; and 3D modeling. The results of this image data and analysis can then be used to improve the accuracy of caloric intake estimation.

We now digress to discuss in more depth the rationale for escalating involuntary data collection in response to inaccurate voluntary data. Such escalation can be viewed as intrusive, but it can also be viewed in the context of who initiates it and what purpose it serves. Few human beings are constant in their willpower and resolve. Most people have times of strength and moments of weakness. This includes moments of strength and weakness when it comes to achieving health goals such as losing weight. People have strong moments wherein their willpower and resolution to achieve a health goal (such as losing weight or quitting smoking) are high. People also have weak moments wherein their willpower and resolution to achieve this goal are low. How can a person extend their strength of resolve from a peak moment in order to shore up their low willpower at moments of weakness?

This device and method provide a way for the person to strengthen their willpower and resolve at low moments. In an example, a person can decide to start wearing this device at a time of relatively high willpower and resolution to lose weight. Once the person starts wearing the device, its interactive nature and incentives help to strengthen the person's willpower at their moments of weakness. If potentially-escalating monitoring in response to inaccurate voluntary reporting of food consumption is initiated by the person and helps them to reach an important health goal, then it can be a good thing in the long run. This device and method can help the person to shore up their willpower in moments of personal weakness by a decision that they make at a time of personal strength.

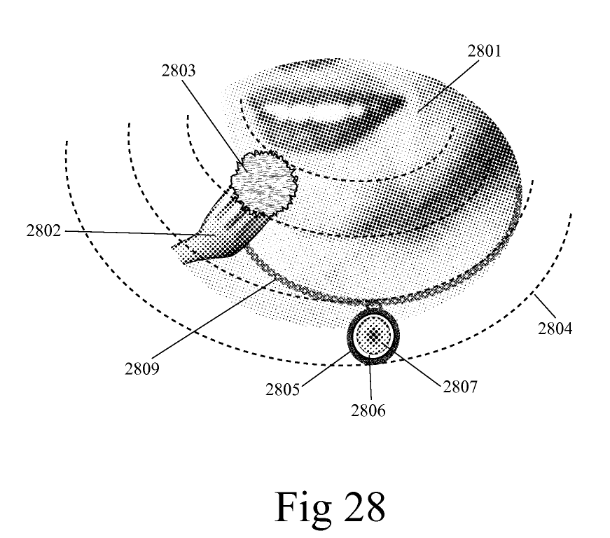

FIGS. 28 through 31 show another example of how this invention may be embodied in a wearable device that measures a person's caloric intake. FIGS. 28 through 31 show the structure and operation of this wearable device in a sequence of operations during food consumption.

FIG. 28 shows a person's mouth 2801, a food-transporting member 2802, and a piece of food 2803 being transported to the person's mouth 2801 via the food-transporting member 2802. In this example, food-transporting member 2802 is a fork. In other examples, food-transporting member can be a spoon or a beverage container. In another example, this device can also work if the person uses their fingers directly to bring food up to their mouth.

FIG. 28 also shows an ornamental chain 2809 that is worn around the person's neck like a necklace. FIG. 28 also shows an oval compound member that is worn on the necklace like a pendant. In this example, this oval compound member includes three parts: (a) a wireless data processing and transmission unit 2805 that communicates with a remote scale; (b) a microphone and speaker unit 2806 with voice recognition capability; and (c) a miniature video camera 2807 that automatically takes pictures of food as it is transported by the person's hand up to their mouth.

In another example, a compound member such as the one shown on a necklace in FIG. 28 can be worn on a person's clothing as a button or a brooch instead of being worn like a pendant on a necklace. In another example, such a compound member may be worn on a person's ear like an ear ring. In another example, such a compound member may be incorporated into a person's eyeglasses.

In this example, microphone and speaker unit 2806 continually monitors sounds for biting, chewing, or swallowing sounds that indicate that the person is probably eating something. As the person inserts food 2803 into their mouth and begins to bite, chew, and swallow, these sounds are detected by microphone and speaker unit 2806. The sound waves comprising with these biting, chewing, and swallowing sounds are represented by concentric dotted lines 2804. In another example, chewing, biting, and swallowing sounds may be conducted through the person's body to microphone and speaker unit 2806, instead of (or in addition to) being conducted through the air. These sounds can be analyzed directly in microphone and speaker unit 2806 or they can be transmitted for analysis in data processing and transmission unit 2805. In an example, analysis of these sounds can indicate probable eating.

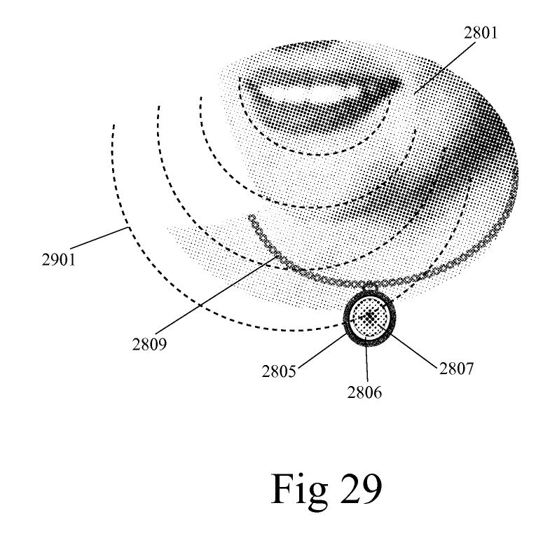

FIG. 29 shows another step in the operation of this device. In this step, the person provides voluntary data concerning what they will eat, are eating, or have eaten. In this example, this voluntary data is form of a voice message from the person and is received by microphone and speaker unit 2806. The sound waves of the person's voice are represented by concentric dotted lines 2901. In an example, the person's voice message can be analyzed using voice recognition software.

In an example, voluntary data provided by the person in this step can include information about the types and quantities of food consumed. In various examples, this data can be provided before, during, or after eating. In an example, voluntary data collection may be prompted or solicited in real time, when the microphone and speaker unit first detects probable eating. In another example, voluntary data collection may be prompted or solicited at the end of the day and may be associated with multiple eating events detected by the microphone and speaker throughout the day. In an example, voluntary data collection may be entirely independent; it may not be prompted or solicited at all.

In an example, data processing and transmission unit 2805 can estimate the person's caloric intake based on what the person says about what they are eating (voluntary data), based on biting, chewing, and swallowing sounds (involuntary data) or the combination of both of these data sources. In an example, data processing and transmission unit 2805 may transmit these data to a remote computer wherein the person's caloric intake is estimated.

In this example, an estimate of the person's caloric expenditure is subtracted from the above estimate of the person's caloric intake in order to calculate the person's net energy balance and to predict the person's weight gain or loss for a given period of time. There are many methods for measuring caloric expenditure in the prior art and the precise method is not central to this example, so it is not specified herein. In an example, these calculations and predictions can occur in data processing and transmission unit 2805. In another example, these calculations and predictions can occur in a remote computer that is in wireless communication with data processing and transmission unit 2805.

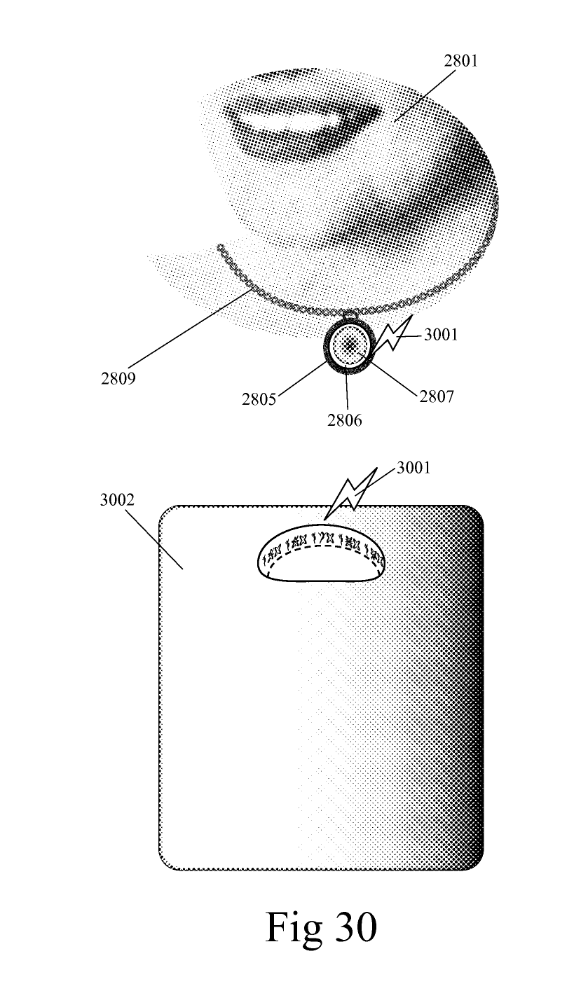

FIG. 30 shows the next step in the operation of this device. In an example, this next step may occur on a periodic basis, such as at the end of each day, each week, or each month. In this step, the person stands on scale 3002 and this scale wirelessly transmits the person's weight to data processing and transmission unit 2805. This wireless data transmission is represented by lightning bolt symbol 3001. The predicted weight gain or loss for the person is then compared to the actual weight gain or loss for the person for a period of time.

In this example, if the predicted weight gain or loss and the actual weight gain or loss for the person meet the criteria for similarity and/or convergence, then miniature video camera 2807 is never activated. In this example, video camera 2807 only operates when predicted and actual weight gain or loss do not meet the criteria for similarity and/or convergence. In this manner, this device provides the person with an incentive to provide timely and accurate voluntary data concerning food consumption in order to avoid more-intrusive (image-based) monitoring. This device thus engages the person in their own energy balance and weight management more so than an entirely-involuntary data collection device. It also provides greater compliance and accuracy than an entirely-voluntary data collection device.

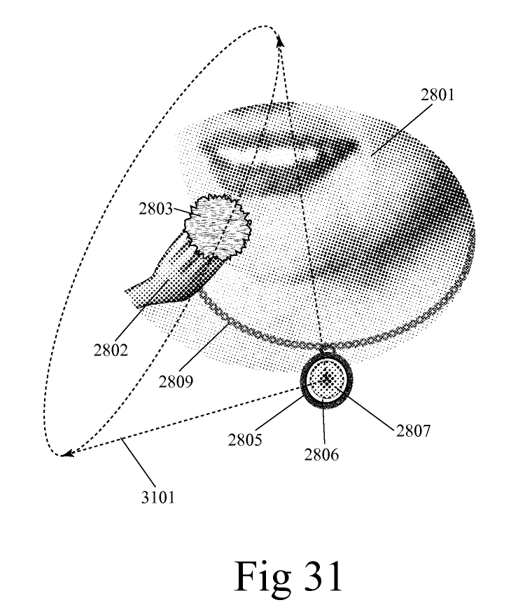

FIG. 31 shows how miniature video camera 2807 operates if the predicted weight gain or loss (based on the prior steps of voluntary and involuntary data collection) does not meet the criteria for similarity and/or convergence with actual weight gain or loss. In the absence of such similarity and/or convergence, the device activates video camera 2807 to monitor for food consumption. The results of this video monitoring are then used to improve the measurement of caloric intake. In an example, the person could have avoided monitoring by the video camera if the person had provided accurate and timely voluntary data concerning food consumption in the voice-based information shown in FIG. 29.

FIG. 31 shows how a miniature video camera 2807 that attached like a pendant to a necklace can track a food-transporting member 2802 (such as a fork) as it transports food 2803 towards the person's mouth 2801. In FIG. 31, the field of vision that is seen by miniature video camera 2807 is represented by dotted lines 3101. These dotted lines comprise a radially-extending circle that encompasses the space surrounding the person's fingers, including food 2803.

In an example, the resulting images of food 2803 can be automatically analyzed to estimate the types and quantities of food consumed. In various examples, analysis and identification of food and/or food packaging can include one or more methods selected from the group consisting of: food recognition or identification; visual pattern recognition or identification; chemical recognition or identification; smell recognition or identification; word recognition or identification; logo recognition or identification; bar code recognition or identification; and 3D modeling. The results of this new video data and analysis are then used to improve the accuracy of caloric intake estimation.

As shown in FIGS. 21 through 31, this invention can be embodied in a device for measuring a person's food consumption and/or caloric intake comprising: (a) a first sensor and/or user interface that collects a first set of data concerning what the person eats; (b) a data processor that calculates a first estimate of the person's caloric intake based on the first set of data, uses this first estimate of the person's caloric intake to estimate predicted weight change for the person during a period of time, and compares predicted to actual weight change to determine whether predicted and actual weight change meet criteria for similarity and/or convergence; and (c) a second sensor and/or user interface that collects a second set of data concerning what the person eats if the criteria for similarity and/or convergence of predicted and actual weight change are not met. In an example, at least one of the sensors and/or user interfaces are worn by the person.

In an example, collecting the first set of data does not require voluntary actions by the person associated with particular eating events other than the actions of eating, but collecting the second set of data does require voluntary actions by the person associated with particular eating events other than the actions of eating. In an example, collecting the second set of data does not require voluntary actions by the person associated with particular eating events other than the actions of eating, but collecting the first set of data does require voluntary actions by the person associated with particular eating events other than the actions of eating.

In an example, the first set of data comprises image data whose collection requires voluntary actions by the person associated with particular eating events other than the actions of eating and the second set of data comprises image data whose collection is more continuous than that of the first set of data. In an example, the first set of data comprises image data whose collection is intermittent, periodic, or random, not requiring voluntary actions by the person associated with particular eating events other than the actions of eating, and the second set of data comprises image data whose collection is more continuous than that of the first set of data. In an example, the first set of data comprises image data whose collection is triggered by sounds, motions, or sounds and motions indicating an eating event, not requiring voluntary actions by the person associated with particular eating events other than the actions of eating, and the second set of data comprises image data whose collection is more continuous than that of the first set of data. In an example, the first set of data comprises sound data, motion data, or both sound and motion data and the second set of data comprises image data.

In an example, the first set of data can be received concerning what the person eats, wherein this first set includes involuntary data that is collected in a manner that does not require voluntary actions by the person associated with particular eating events other than the actions of eating, and wherein this first set also includes voluntary data that is collected in a manner that requires voluntary actions by the person associated with particular eating events other than the actions of eating.

As shown in FIGS. 21 through 31, this invention can be embodied in a device for measuring a person's food consumption and/or caloric intake comprising: (a) a first set of sensors and/or user interfaces that collect a first set of data concerning what the person eats, wherein this first set includes involuntary data that is collected in a manner that does not require voluntary actions by the person associated with particular eating events other than the actions of eating, and wherein this first set also includes voluntary data that is collected in a manner that requires voluntary actions by the person associated with particular eating events other than the actions of eating; (b) a data processor that calculates a first estimate of the person's caloric intake based on the first set of data, uses this first estimate of the person's caloric intake to estimate predicted weight change for the person during a period of time, and compares predicted to actual weight change to determine whether predicted and actual weight change meet criteria for similarity and/or convergence; and (c) a second set of sensors and/or user interfaces that collect a second set of data concerning what the person eats if the criteria for similarity and/or convergence of predicted and actual weight change are not met.

As shown in FIGS. 21 through 31, this invention can be embodied in a device for measuring a person's food consumption and/or caloric intake comprising: (a) a first set of sensors and/or user interfaces that receive a first set of data concerning what the person eats, wherein this first set includes involuntary data that is received in a manner that does not require voluntary actions by the person associated with particular eating events other than the actions of eating, and wherein this first set also includes voluntary data that is received in a manner that requires voluntary actions by the person associated with particular eating events other than the actions of eating; (b) a data processor that calculates a first estimate of the person's caloric intake based on the first set of data, uses this first estimate of the person's caloric intake to estimate predicted weight change for the person during a period of time, and compares predicted to actual weight change to determine whether predicted and actual weight change meet criteria for similarity and/or convergence; and (c) a second set of sensors and/or user interfaces that receive a second set of data concerning what the person eats if the criteria for similarity and/or convergence of predicted and actual weight change are not met.

As shown in FIGS. 5 through 31, a method for measuring a person's caloric intake can comprise: receiving a first set of data concerning what the person eats from a first source and receiving a second set of data concerning what the person eats from a second source; calculating a first estimate of the person's caloric intake based on the first set of data, calculating a second estimate of the person's caloric intake based on the second set of data, and comparing these first and second estimates of caloric intake to determine whether these estimates meet criteria for similarity and/or convergence; and if the first and second estimates of caloric intake do not meet the criteria for similarity and/or convergence, then receiving a third set of data concerning what the person eats and calculating one or more new estimates of caloric intake using this third set of data. In an example, collection of the first set of data does not require voluntary actions by the person associated with particular eating events other than the actions of eating, but collection of the second set of data does require voluntary actions by the person associated with particular eating events other than the actions of eating, or vice versa.

In an example, data sets can be selected from the group consisting of: (a) at least one of the first set of data and the second set of data comprises image data whose collection requires voluntary actions by the person associated with particular eating events other than the actions of eating and the third set of data comprises image data whose collection is more continuous than the collection of at least one of the first and second sets of data; (b) at least one of the first set of data and the second set of data comprises image data whose collection is intermittent, periodic, or random, not requiring voluntary actions by the person associated with particular eating events other than the actions of eating, and the third set of data comprises image data whose collection is more continuous than the collection of at least one of the first and second sets of data; and (c) at least one of the first set of data and the second set of data comprises image data whose collection is triggered by sounds, motions, or sounds and motions indicating an eating event, this collection does not require voluntary actions by the person associated with particular eating events other than the actions of eating, and the third set of data comprises image data whose collection is more continuous than the collection of at least one of the first and second sets of data. In an example, at least one of the first set of data and the second set of data can comprise sound data, motion data, or both sound and motion data and the third set of data comprises image data.

In an example, criteria for similarity and/or convergence can be selected from the group consisting of: raw difference between two values is less than a target value; percentage difference between two values is less than a target value; mathematical analysis of paired variables predicts convergence between them; and statistical analysis of two variables does not show a statistically-significant difference between them.

In an example, a method for measuring a person's caloric intake can comprise: receiving a first set of data concerning what the person eats; calculating a first estimate of the person's caloric intake based on the first set of data, using this first estimate of the person's caloric intake to estimate predicted weight change for the person during a period of time, and comparing predicted weight change to actual weight change to determine whether predicted weight change and actual weight change meet criteria for similarity and/or convergence; and if predicted weight change and actual weight change do not meet the criteria for similarity and/or convergence, then receiving a second set of data concerning what the person eats and calculating a second estimate of caloric intake using this second set of data.

In an example, collecting the first set of data does not require voluntary actions by the person associated with particular eating events other than the actions of eating, but collecting the second set of data does require voluntary actions by the person associated with particular eating events other than the actions of eating. In an example, collecting the second set of data does not require voluntary actions by the person associated with particular eating events other than the actions of eating, but collecting the first set of data does require voluntary actions by the person associated with particular eating events other than the actions of eating. In an example, the first set of data comprises image data whose collection requires voluntary actions by the person associated with particular eating events other than the actions of eating and wherein the second set of data comprises image data whose collection is more continuous than that of the first set of data.

In an example, the first set of data comprises image data whose collection is intermittent, periodic, or random, not requiring voluntary actions by the person associated with particular eating events other than the actions of eating, and wherein the second set of data comprises image data whose collection is more continuous than that of the first set of data. In an example, the first set of data comprises image data whose collection is triggered by sounds, motions, or sounds and motions indicating an eating event, not requiring voluntary actions by the person associated with particular eating events other than the actions of eating, and wherein the second set of data comprises image data whose collection is more continuous than that of the first set of data. In an example, the first set of data comprises sound data, motion data, or both sound and motion data, and wherein the second set of data comprises image data.

In an example, a device for measuring a person's caloric intake can comprise: a first sensor and/or user interface that collects a first set of data concerning what the person eats; a data processor that calculates a first estimate of the person's caloric intake based on the first set of data, uses this first estimate of the person's caloric intake to estimate predicted weight change for the person during a period of time, and compares predicted to actual weight change to determine whether predicted and actual weight change meet criteria for similarity and/or convergence; and a second sensor and/or user interface that collects a second set of data concerning what the person eats if the criteria for similarity and/or convergence of predicted and actual weight change are not met. In an example, at least one of the sensors and/or user interfaces are worn by the person.

In an example, collecting the first set of data does not require voluntary actions by the person associated with particular eating events other than the actions of eating, but collecting the second set of data does require voluntary actions by the person associated with particular eating events other than the actions of eating. In an example, collecting the second set of data does not require voluntary actions by the person associated with particular eating events other than the actions of eating, but collecting the first set of data does require voluntary actions by the person associated with particular eating events other than the actions of eating.

In an example, the first set of data comprises image data whose collection requires voluntary actions by the person associated with particular eating events other than the actions of eating and wherein the second set of data comprises image data whose collection is more continuous than that of the first set of data. In an example, the first set of data comprises image data whose collection is intermittent, periodic, or random, not requiring voluntary actions by the person associated with particular eating events other than the actions of eating, and wherein the second set of data comprises image data whose collection is more continuous than that of the first set of data. In an example, the first set of data comprises image data whose collection is triggered by sounds, motions, or sounds and motions indicating an eating event, not requiring voluntary actions by the person associated with particular eating events other than the actions of eating, and wherein the second set of data comprises image data whose collection is more continuous than that of the first set of data. In an example, the first set of data comprises sound data, motion data, or both sound and motion data and wherein the second set of data comprises image data.

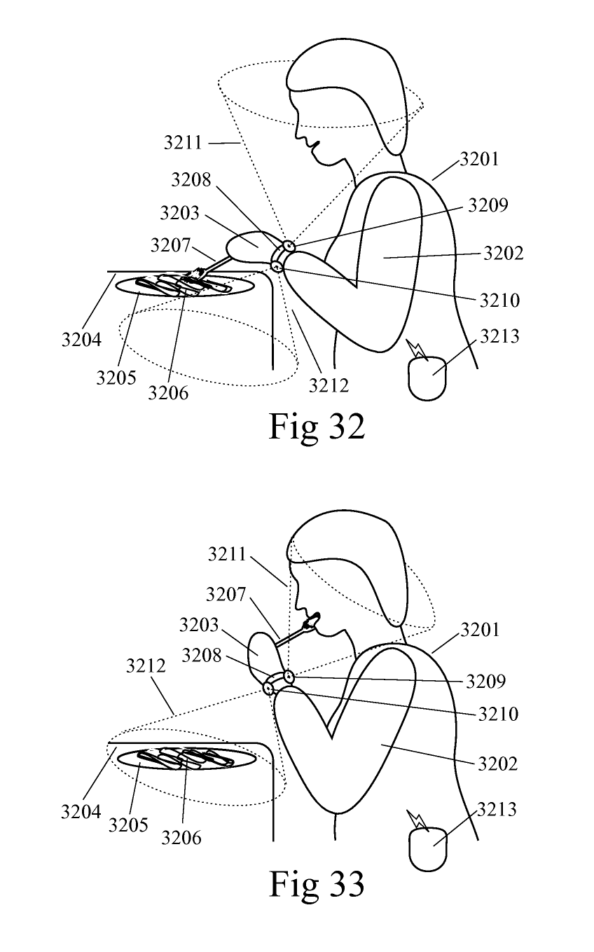

FIGS. 32 through 53 show examples of devices and methods that use gesture recognition to monitor food consumption. This invention can be embodied in a device that automatically monitors caloric intake comprising: an automatic-imaging member that is worn on a person; and an image-analyzing member which automatically analyzes pictures taken by the automatic-imaging member in order to monitor caloric intake, wherein the image-analyzing member uses one or more methods selected from the group consisting of: human motion recognition or identification; and gesture recognition or identification.

This invention can also be embodied in a device that automatically monitors caloric intake comprising: an automatic-imaging member that is worn on a person; and an image-analyzing member which automatically analyzes pictures taken by the automatic-imaging member in order to monitor caloric intake, wherein indications that a person is eating are selected from the group consisting of: inclination, twisting, or rolling of the person's hand, wrist, or arm; inclination of the person's lower arm or upper arm; and bending of the person's shoulder, elbow, wrist, or finger joints.

This invention can also be embodied as a method. Specifically, this invention can be embodied in a method to automatically monitor caloric intake comprising: having a person wear an automatic-imaging member; and automatically analyzing pictures taken by the automatic-imaging member in order to monitor caloric intake using one or more methods selected from the group consisting of: human motion recognition or identification; and gesture recognition or identification.

In an example, gesture recognition methods can be used by this device and method to track the location of one or both of a person's hands. In an example, the automatic-imaging member can use gesture recognition methods to shift its focus so as to always maintain a line of sight to a person's hand and/or to scan for potential reachable food sources. In an example, the automatic-imaging member can scan space in order to identify the person's hand and then scan space surrounding the person's hand in order to identify food sources. In an example, gesture recognition methods can be used to detect and measure hand-to-mouth proximity and interaction.

In an example, indications that a person is eating can be selected from the group consisting of: inclination, twisting, or rolling of the person's hand, wrist, or arm; inclination of the person's lower arm or upper arm; and bending of the person's shoulder, elbow, wrist, or finger joints. In an example, an image-analyzing member can analyze one or more factors selected from the group consisting of: the number of times that the person brings food to their mouth; and the sizes of portions of food that the person brings up to their mouth.

A wearable image-analyzing member can also analyze one or more factors selected from the group consisting of: number of reachable food sources; types of reachable food sources; and changes in the volume of food at a reachable food source. A wearable image-analyzing member can also use one or more methods selected from the group consisting of: pattern recognition or identification; face recognition or identification; food recognition or identification; word recognition or identification; logo recognition or identification; bar code recognition or identification; and 3D modeling.

In an example, a wearable automatic-imaging member can take pictures continually (or at least continually while the person is wearing the automatic-imaging member). Alternatively, the automatic-imaging member can be automatically activated to take pictures only when a person eats, based on information from a sensor selected from the group consisting of: accelerometer, inclinometer, motion sensor, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor.

In an example, an automatic-imaging member can be worn on a person's wrist, hand, or arm in a manner similar to a wrist watch, bracelet, arm band, or finger ring. In an example, an automatic-imaging member can be worn on a person's head in a manner similar to eyeglasses. In an example, an automatic-imaging member can be worn on a person's neck in a manner similar to a necklace, pendant, dog tags, or brooch.

The term “food” is broadly defined to include liquid nourishment, such as beverages, in addition to solid food. The term “reachable food source” is defined as a source of food that a person can access and from which they can bring a piece (or portion) of food to their mouth by moving their arm and hand. Arm and hand movement can include movement of the person's shoulder, elbow, wrist, and finger joints. In various examples, a reachable food source can be selected from the group consisting of: food on a plate, food in a bowl, food in a glass, food in a cup, food in a bottle, food in a can, food in a package, food in a container, food in a wrapper, food in a bag, food in a box, food on a table, food on a counter, food on a shelf, and food in a refrigerator.

The term “food consumption pathway” is defined as a path in space that is traveled by (a piece of) food from a reachable food source to a person's mouth as the person eats. The distal endpoint of a food consumption pathway is the reachable food source and the proximal endpoint of a food consumption pathway is the person's mouth. In various examples, food may be moved along the food consumption pathway by contact with a member selected from the group consisting of: a utensil; a beverage container; the person's fingers; and the person's hand.

These two cameras take pictures of a reachable food source and the person's mouth. These pictures are used to estimate, in an automatic and tamper-resistant manner, the types and quantities of food consumed by the person. Information on food consumed, in turn, is used to estimate the person's caloric intake. As the person eats, these two cameras of the automatic-imaging member take pictures of a reachable food source and the person's mouth. These pictures are analyzed, using pattern recognition or other image-analyzing methods, to estimate the types and quantities of food that the person consumes. In this example, these pictures are motion pictures (e.g. videos). In another example, these pictures may be still-frame pictures.

FIGS. 32 and 33 show one example of a device and method for automatically monitoring and estimating human caloric intake. In this example, the device and method comprise an automatic-imaging member that is worn on a person's wrist. This imaging member has two cameras attached to a wrist band on opposite (narrow) sides of the person's wrist.

FIG. 32 shows person 3201 seated at table 3204 wherein this person is using their arm 3202 and hand 3203 to access food 3206 on plate 3205 located on table 3204. In this example in FIGS. 32 and 33, food 3206 on plate 3205 comprises a reachable food source. In this example, person 3201 is shown picking up a piece of food 3206 from the reachable food source using utensil 3207. In various examples, a food source may be selected from the group consisting of: food on a plate, food in a bowl, food in a glass, food in a cup, food in a bottle, food in a can, food in a package, food in a container, food in a wrapper, food in a bag, food in a box, food on a table, food on a counter, food on a shelf, and food in a refrigerator.

In this example, the person is wearing an automatic-imaging member comprised of a wrist band 3208 to which are attached two cameras, 3209 and 3210, on the opposite (narrow) sides of the person's wrist. Camera 3209 takes pictures within field of vision 3211. Camera 3210 takes pictures within field of vision 3212. Each field of vision, 3211 and 3212, is represented in these figures by a dotted-line conical shape. The narrow tip of the dotted-line cone is at the camera's aperture and the circular base of the cone represents the camera's field of vision at a finite focal distance from the camera's aperture.

In this example, camera 3209 is positioned on the person's wrist at a location from which it takes pictures along an imaging vector that is directed generally upward from the automatic-imaging member toward the person's mouth as the person eats. In this example, camera 3210 is positioned on the person's wrist at a location from which it takes pictures along an imaging vector that is directed generally downward from the automatic-imaging member toward a reachable food source as the person eats. These imaging vectors are represented in FIG. 32 by the fields of vision, 3211 and 3212, indicated by cone-shaped dotted-line configurations. The narrow end of the cone represents the aperture of the camera and the circular end of the cone represents a focal distance of the field of vision as seen by the camera. Although theoretically the field of vision could extend outward in an infinite manner from the aperture, we show a finite length cone to represent a finite focal length for a camera's field of vision.

Field of vision 3211 from camera 3209 is represented in FIG. 32 by a generally upward-facing cone-shaped configuration of dotted lines that generally encompasses the person's mouth and face as the person eats. Field of vision 3212 from camera 3210 is represented in FIG. 32 by a generally downward-facing cone-shaped configuration of dotted lines that generally encompasses the reachable food source as the person eats.

This device and method of taking pictures of both a reachable food source and the person's mouth, while a person eats, can do a much better job of estimating the types and quantities of food actually consumed than one of the devices or methods in the prior art that only takes pictures of either a reachable food source or the person's mouth. There is prior art that uses imaging to identify food that requires a person to manually aim a camera toward a food source and then manually take a picture of the food source. Such prior art does not take also pictures of the person's mouth. There are multiple disadvantages with this prior art. We will discuss later the disadvantages of requiring manual intervention to aim a camera and push a button to take a picture. For now, we discuss the disadvantages of prior art that only takes pictures of a reachable food source or only takes pictures of the person's mouth, but not both.

First, let us consider a “source-only” imaging device, such as those in the prior art, that only takes pictures of a food source within a reachable distance of the person and does not also take pictures of the person's mouth. Using a “source-only” device, it is very difficult to know whether the person actually consumes the food that is seen in the pictures. A “source-only” imaging device can be helpful in indentifying what types of foods the person has reachable access to, and might possibly eat, but such a device is limited as means for measuring how much of these foods the person actually consumes. For example, consider a person walking through a grocery store. As the person walks through the store, a wide variety of food sources in various packages and containers come into a wearable camera's field of vision. However, the vast majority of these food sources are ones that the person never consumes. The person only actually consumes those foods that the person buys and consumes later. An automatic wearable imaging system that only takes pictures of reachable food sources would be very limited for determining how many of these reachable food sources are actually consumed by the person.

One could try to address this problem by making the picture-taking process a manual process rather than an automatic process. One could have an imaging system that requires human intervention to actively aim a camera (e.g. a mobile imaging device) at a food source and also require human intervention (to click a button) to indicate that the person is actually going to consume that food. However, relying on such a manual process for caloric intake monitoring makes this process totally dependent on the person's compliance. Even if a person wants to comply, it can be tough for a person to manually aim a camera and take pictures each time that the person snacks on something. If the person does not want to comply, the situation is even worse. It is easy for a person to thwart a monitoring process that relies on manual intervention. All that a person needs to do to thwart the process is to not take pictures of something that they eat.

A manual imaging system is only marginally better than old-fashioned “calorie counting” by writing down what a person eats on a piece of paper or entering it into a computer. If a person buys a half-gallon of ice cream and consumes it without manually taking a picture of the ice-cream, either intentionally or by mistaken omission, then the device that relies on a manual process is clueless with respect to those calories consumed. A “source-only” imaging device makes it difficult, if not impossible, to track food actually consumed without manual intervention. Further, requiring manual intervention to record consumption makes it difficult, if not impossible, to fully automate calorie monitoring and estimation.

As another example of the limitations of a “source-only” imaging device, consider the situation of a person sitting at a table with many other diners wherein the table is set with food in family-style communal serving dishes. These family-style dishes are passed around to serve food to everyone around the table. It would be challenging for a “source-only” imaging device to automatically differentiate between these communal serving dishes and a person's individual plate. What happens when the person's plate is removed or replaced? What happens when the person does not eat all of the food on their plate? These examples highlight the limitations of a device and method that only takes pictures of a reachable food source, without also taking pictures of the person's mouth.

This present invention overcomes these limitations by automatically taking pictures of both a reachable food source and the person's mouth. With images of both a reachable food source and the person's mouth, as the person eats, this present device and method can determine not only what food the person has access to, but how much of that food the person actually eats.

We have considered the limitations of devices and methods in the prior art that only take pictures of a reachable food source. We now also consider the limitations of “mouth-only” imaging devices and methods, wherein these devices only take pictures of the person's mouth while they eat. It is very difficult for a “mouth-only” imaging device to use pattern recognition, or some other image-based food identification method, on a piece of food approaching the person's mouth to identify the food, without also having pictures of the total food source.

For example, pattern recognition software can identify the type of food at a reachable food source by: analyzing the food's shape, color, texture, and volume; or by analyzing the food's packaging. However, it is much more difficult for a device to identify a piece (or portion) of food that is obscured within in the scoop of a spoon, hidden within a cup, cut and then pierced by the tines of a fork, or clutched in partially-closed hand as it is brought up to the person's mouth.

For example, pattern recognition software could identify a bowl of peanuts on a table, but would have a tough time identifying a couple peanuts held in the palm of a person's partially-closed hand as they move from the bowl to the person's mouth. It is difficult to get a line of sight from a wearable imaging member to something inside the person's hand as it travels along the food consumption pathway. For these reasons, a “mouth-only” imaging device may be useful for estimating the quantity of food consumed (possibly based on the number of food consumption pathway motions, chewing motions, swallowing motions, or a combination thereof) but is limited for identifying the types of foods consumed, without having food source images as well.

We have discussed the limitations of “source-only” and “mouth-only” prior art that images only a reachable food source or only a person's mouth. This present invention is an improvement over this prior art because it comprises a device and method that automatically estimates the types and quantities of food actually consumed based on pictures of both a reachable food source and the person's mouth. Having both such images provides better information than either separately. Pictures of a reachable food source may be particularly useful for identifying the types of food available to the person for potential consumption. Pictures of the person's mouth (including food traveling the food consumption pathway and food-mouth interaction such as chewing and swallowing) may be particularly useful for identifying the quantity of food consumed by the person. Combining both images in an integrated analysis provides more accurate estimation of the types and quantities of food actually consumed by the person. This information, in turn, provides better estimation of caloric intake by the person.

The fact that this present invention is wearable further enhances its superiority over prior art that is non-wearable. It is possible to have a non-wearable imaging device that can be manually positioned (on a table or other surface) to be aimed toward an eating person, such that its field of vision includes both a food source and the person's mouth. In theory, every time the person eats a meal or takes a snack, the person could: take out an imaging device (such as a smart phone); place the device on a nearby surface (such as a table, bar, or chair); manually point the device toward them so that both the food source and their mouth are in the field of vision; and manually push a button to initiate picture taking before they start eating. However, this manual process with a non-wearable device is highly dependent on the person's compliance with this labor-intensive and possibly-embarrassing process.

Even if a person has good intentions with respect to compliance, it is expecting a lot for a person to carry around a device and to set it up at just the right direction each time that the person reaches for a meal or snack. How many people, particularly people struggling with their weight and self-image, would want to conspicuously bring out a mobile device, place it on a table, and manually aim it toward themselves when they eat, especially when they are out to eat with friends or on a date? Even if this person has good intentions with respect to compliance with a non-wearable food-imaging device, it is very unlikely that compliance would be high. The situation would get even worse if the person is tempted to obstruct the operation of the device to cheat on their “diet.” With a non-wearable device, tampering with the operation of the device is easy as pie (literally). All the person has to do is to fail to properly place and activate the imaging device when they snack.

It is difficult to design a non-wearable imaging device that takes pictures, in an automatic and tamper-resistant manner, of both a food source and the person's mouth whenever the person eats. Is it easier to design a wearable imaging device that takes pictures, in an automatic and tamper-resistant manner, of a food source and the person's mouth whenever the person eats. Since the device and method disclosed herein is wearable, it is an improvement over non-wearable prior art, even if that prior art could be used to manually take pictures of a food source and a person's mouth.

The fact that the device and method disclosed herein is wearable makes it less dependent on human intervention, easier to automate, and easier to make tamper-resistant. With the present invention, there is no requirement that a person must carry around a mobile device, place it on an external surface, and aim it toward a food source and their mouth every time that they eat in order to track total caloric intake. This present device, being wearable and automatic, goes with the person where ever they go and automatically takes pictures whenever they eat, without the need for human intervention.

In an example, this device may have an unobtrusive, or even attractive, design like a piece of jewelry. In various examples, this device may look similar to an attractive wrist watch, bracelet, finger ring, necklace, or ear ring. As we will discuss further, the wearable and automatic imaging nature of this invention allows the incorporation of tamper-resistant features into this present device to increase the accuracy and compliance of caloric intake monitoring and estimation.

For measuring total caloric intake, ideally it is desirable to have a wearable device and method that automatically monitors and estimates caloric intake in a comprehensive and involuntary manner. The automatic and involuntary nature of a device and method will enhance accuracy and compliance. This present invention makes significant progress toward this goal, especially as compared to the limitations of relevant prior art. There are devices and methods in the prior art that assist in manual calorie counting, but they are heavily reliant on the person's compliance. The prior art does not appear to disclose a wearable, automatic, tamper-resistant, image-based device or method that takes pictures of a food source and a person's mouth in order to estimate the person's caloric intake.

The fact that this device and method incorporates pictures of both a food source and the person's mouth, while a person eats, makes it much more accurate than prior art that takes pictures of only a food source or only the person's mouth. The wearable nature of this invention makes it less reliant on manual activation, and much more automatic in its imaging operation, than non-wearable devices. This present device does not depend on properly placing, aiming, and activating an imaging member every time a person eats. This device and method operates in an automatic manner and is tamper resistant. All of these features combine to make this invention a more accurate and dependable device and method of monitoring and measuring human caloric intake than devices and methods in the prior art. This present invention can serve well as the caloric-intake measuring component of an overall system of human energy balance and weight management.

In the example of this invention that is shown in FIG. 32, the pictures of the person's mouth and the pictures of the reachable food source that are taken by cameras 3209 and 3210 (part of a wrist-worn automatic-imaging member) are transmitted wirelessly to image-analyzing member 3213 that is worn elsewhere on the person. In this example, image-analyzing member 3213 automatically analyzes these images to estimate the types and quantities of food consumed by the person.

In an example, this invention includes an image-analyzing member that uses one or more methods selected from the group consisting of: pattern recognition or identification; human motion recognition or identification; face recognition or identification; gesture recognition or identification; food recognition or identification; word recognition or identification; logo recognition or identification; bar code recognition or identification; and 3D modeling.

In an example, this invention includes an image-analyzing member that analyzes one or more factors selected from the group consisting of: number of reachable food sources; types of reachable food sources; changes in the volume of food at a reachable food source; number of times that the person brings food to their mouth; sizes of portions of food that the person brings to their mouth; number of chewing movements; frequency or speed of chewing movements; and number of swallowing movements.

In an example, this invention includes an image-analyzing member that provides an initial estimate of the types and quantities of food consumed by the person and this initial estimate is then refined by human interaction and/or evaluation.

In an example, this invention includes wireless communication from a first wearable member (that takes pictures of a reachable food source and a person's mouth) to a second wearable member (that analyzes these pictures to estimate the types and quantities of food consumed by the person). In another example, this invention may include wireless communication from a wearable member (that takes pictures of a reachable food source and a person's mouth) to a non-wearable member (that analyzes these pictures to estimate the types and quantities of food consumed by the person). In another example, this invention may include a single wearable member that takes and analyzes pictures, of a reachable food source and a person's mouth, to estimate the types and quantities of food consumed by the person.

In the example of this invention that is shown in FIG. 32, an automatic-imaging member is worn around the person's wrist. Accordingly, the automatic-imaging member moves as food travels along the food consumption pathway. This means that the imaging vectors and the fields of vision, 3211 and 3212, from the two cameras, 3209 and 3210, that are located on this automatic-imaging member, shift as the person eats.

In this example, the fields of vision from these two cameras on the automatic-imaging member automatically and collectively encompass the person's mouth and a reachable food source, from at least some locations, as the automatic-imaging member moves when food travels along the food consumption pathway. In this example, this movement allows the automatic-imaging member to take pictures of both the person's mouth and the reachable food source, as the person eats, without the need for human intervention to manually aim cameras toward either the person's mouth or a reachable food source, when the person eats.

The reachable food source and the person's mouth do not need to be within the fields of vision, 3211 and 3212, at all times in order for the device and method to accurately estimate food consumed. As long as the reachable food source and the person's mouth are encompassed by the field of vision from at least one of the two cameras at least once during each movement cycle along the food consumption pathway, the device and method should be able to reasonably interpolate missing intervals and to estimate the types and quantities of food consumed.

FIG. 33 shows the same example of the device and method for automatically monitoring and estimating caloric intake that was shown in FIG. 32, but at a later point as food moves along the food consumption pathway. In FIG. 33, a piece of food has traveled from the reachable food source to the person's mouth via utensil 3207. In FIG. 33, person 3201 has bent their arm 3202 and rotated their hand 3203 to bring this piece of food, on utensil 3207, up to their mouth. In FIG. 33, field of vision 3212 from camera 3210, located on the distal side of the person's wrist, now more fully encompasses the reachable food source. Also, field of vision 3211 from camera 3209, located on the proximal side of the person's wrist, now captures the interaction between the piece of food and the person's mouth.

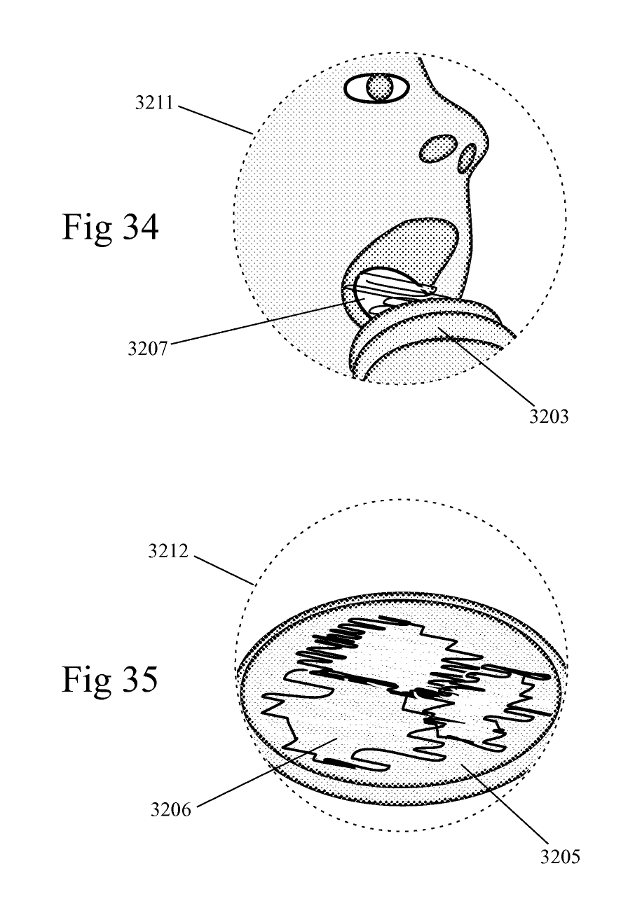

FIGS. 34 and 35 provide additional insight into how this device and method for monitoring and estimating caloric intake works. FIGS. 34 and 35 show still-frame views of the person's mouth and the reachable food source as captured by the fields of vision, 3211 and 3212, from the two cameras, 3209 and 3210, worn on the person's wrist, as the person eats. In FIGS. 34 and 35, the boundaries of fields of vision 3211 and 3212 are represented by dotted-line circles. These dotted-line circles correspond to the circular ends of the dotted-line conical fields of vision that are shown in FIG. 33.

For example, FIG. 33 shows a side view of camera 3209 with conical field of vision 3211 extending outwards from the camera aperture and upwards toward the person's mouth. FIG. 34 shows this same field of vision 3211 from the perspective of the camera aperture. In FIG. 34, the person's mouth is encompassed by the circular end of the conical field of vision 3211 that was shown in FIG. 33. In this manner, FIG. 34 shows a close-up view of utensil 3207, held by hand 3203, as it inserts a piece of food into the person's mouth.

As another example, FIG. 33 shows a side view of camera 3210 with conical field of vision 3212 extending outwards from the camera aperture and downwards toward the reachable food source. In this example, the reachable food source is food 3206 on plate 3205. FIG. 35 shows this same field of vision 3212 from the perspective of the camera aperture. In FIG. 35, the reachable food source is encompassed by the circular end of the conical field of vision 3212 that was shown in FIG. 33. In this manner, FIG. 35 shows a close-up view of food 3206 on plate 3205.

The example of this invention for monitoring and estimating human caloric intake that is shown in FIGS. 32-35 comprises a wearable imaging device. In various examples, this invention can be a device and method for measuring caloric intake that comprises one or more automatic-imaging members that are worn on a person at one or more locations from which these members automatically take (still or motion) pictures of the person's mouth as the person eats and automatically take (still or motion) pictures of a reachable food source as the person eats. In this example, these images are automatically analyzed to estimate the types and quantities of food actually consumed by the person.

In an example, there may be one automatic-imaging member that takes pictures of both the person's mouth and a reachable food source. In an example, there may be two or more automatic-imaging members, worn on one or more locations on a person, that collectively and automatically take pictures of the person's mouth when the person eats and pictures of a reachable food source when the person eats. In an example, this picture taking can occur in an automatic and tamper-resistant manner as the person eats.

In various examples, one or more imaging devices worn on a person's body take pictures of food at multiple points as it moves along the food consumption pathway. In various examples, this invention comprises a wearable, mobile, calorie-input-measuring device that automatically records and analyzes food images in order to detect and measure human caloric input. In various examples, this invention comprises a wearable, mobile, energy-input-measuring device that automatically analyzes food images to measure human energy input.

In an example, this device and method comprise one or more imaging members that take pictures of: food at a food source; a person's mouth; and interaction between food and the person's mouth. The interaction between the person's mouth and food can include biting, chewing, and swallowing. In an example, utensils or beverage-holding members may be used as intermediaries between the person's hand and food. In an example, this invention comprises an imaging device that automatically takes pictures of the interaction between food and the person's mouth as the person eats. In an example, this invention comprises a wearable device that takes pictures of a reachable food source that is located in front of the person.

In an example, this invention comprises a method of estimating a person's caloric intake that includes the step of having the person wear one or more imaging devices, wherein these imaging devices collectively and automatically take pictures of a reachable food source and the person's mouth. In an example, this invention comprises a method of measuring a person's caloric intake that includes having the person wear one or more automatic-imaging members, at one or more locations on the person, from which locations these members are able to collectively and automatically take pictures of the person's mouth as the person eats and take pictures of a reachable food source as the person eats.

In the example of this invention that is shown in FIGS. 32 and 33, two cameras, 3209 and 3210, are worn on the narrow sides of the person's wrist, between the posterior and anterior surfaces of the wrist, such that the moving field of vision from the first of these cameras automatically encompasses the person's mouth (as the person moves their arm when they eat) and the moving field of vision from the second of these cameras automatically encompasses the reachable food source (as the person moves their arm when they eat). This embodiment of the invention is comparable to a wrist-watch that has been rotated 90 degrees around the person's wrist, with a first camera located where the watch face would be and a second camera located on the opposite side of the wrist.

In another example, this device and method can comprise an automatic-imaging member with a single wide-angle camera that is worn on the narrow side of a person's wrist or upper arm, in a manner similar to wearing a watch or bracelet that is rotated approximately 90 degrees. This automatic-imaging member can automatically take pictures of the person's mouth, a reachable food source, or both as the person moves their arm and hand as the person eats. In another example, this device and method can comprise an automatic-imaging member with a single wide-angle camera that is worn on the anterior surface of a person's wrist or upper arm, in a manner similar to wearing a watch or bracelet that is rotated approximately 180 degrees. This automatic-imaging member automatically takes pictures of the person's mouth, a reachable food source, or both as the person moves their arm and hand as the person eats. In another example, this device and method can comprise an automatic-imaging member that is worn on a person's finger in a manner similar to wearing a finger ring, such that the automatic-imaging member automatically takes pictures of the person's mouth, a reachable food source, or both as the person moves their arm and hand as the person eats.

In various examples, this invention comprises a caloric-input measuring member that automatically estimates a person's caloric intake based on analysis of pictures taken by one or more cameras worn on the person's wrist, hand, finger, or arm. In various examples, this invention includes one or more automatic-imaging members worn on a body member selected from the group consisting of: wrist, hand, finger, upper arm, and lower arm. In various examples, this invention includes one or more automatic-imaging members that are worn in a manner similar to a wearable member selected from the group consisting of: wrist watch; bracelet; arm band; and finger ring.

In various examples of this device and method, the fields of vision from one or more automatic-imaging members worn on the person's wrist, hand, finger, or arm are shifted by movement of the person's arm bringing food to their mouth along the food consumption pathway. In an example, this movement causes the fields of vision from these one or more automatic-imaging members to collectively and automatically encompass the person's mouth and a reachable food source.

In various examples, this invention includes one or more automatic-imaging members that are worn on a body member selected from the group consisting of: neck; head; and torso. In various examples, this invention includes one or more automatic-imaging members that are worn in a manner similar to a wearable member selected from the group consisting of: necklace; pendant, dog tags; brooch; cuff link; ear ring; eyeglasses; wearable mouth microphone; and hearing aid.

In an example, this device and method comprise at least two cameras or other imaging members. A first camera may be worn on a location on the human body from which it takes pictures along an imaging vector which points toward the person's mouth while the person eats. A second camera may be worn on a location on the human body from which it takes pictures along an imaging vector which points toward a reachable food source. In an example, this invention may include: (a) an automatic-imaging member that is worn on the person's wrist, hand, arm, or finger such that the field of vision from this member automatically encompasses the person's mouth as the person eats; and (b) an automatic-imaging member that is worn on the person's neck, head, or torso such that the field of vision from this member automatically encompasses a reachable food source as the person eats.

In other words, this device and method can comprise at least two automatic-imaging members that are worn on a person's body. One of these automatic-imaging members may be worn on a body member selected from the group consisting of the person's wrist, hand, lower arm, and finger, wherein the field of vision from this automatic-imaging member automatically encompasses the person's mouth as the person eats. A second of these automatic-imaging members may be worn on a body member selected from the group consisting of the person's neck, head, torso, and upper arm, wherein the field of vision from the second automatic-imaging member automatically encompasses a reachable food source as the person eats.

In various examples, one or more automatic-imaging members may be integrated into one or more wearable members that appear similar to a wrist watch, wrist band, bracelet, arm band, necklace, pendant, brooch, collar, eyeglasses, ear ring, headband, or ear-mounted bluetooth device. In an example, this device may comprise two imaging members, or two cameras mounted on a single member, which are generally perpendicular to the longitudinal bones of the upper arm. In an example, one of these imaging members may have an imaging vector that points toward a food source at different times while food travels along the food consumption pathway. In an example, another one of these imaging members may have an imaging vector that points toward the person's mouth at different times while food travels along the food consumption pathway. In an example, these different imaging vectors may occur simultaneously as food travels along the food consumption pathway. In another example, these different imaging vectors may occur sequentially as food travels along the food consumption pathway. This device and method may provide images from multiple imaging vectors, such that these images from multiple perspectives are automatically and collectively analyzed to identify the types and quantities of food consumed by the person.

In an example of this invention, multiple imaging members may be worn on the same body member. In another example, multiple imaging members may be worn on different body members. In an example, an imaging member may be worn on each of a person's wrists or each of a person's hands. In an example, one or more imaging members may be worn on a body member and a supplemental imaging member may be located in a non-wearable device that is in proximity to the person. In an example, wearable and non-wearable imaging members may be in wireless communication with each other. In an example, wearable and non-wearable imaging members may be in wireless communication with an image-analyzing member.

In an example, a wearable imaging member may be worn on the person's body, a non-wearable imaging member may be positioned in proximity to the person's body, and a tamper-resisting mechanism may ensure that both the wearable and non-wearable imaging members are properly positioned to take pictures as the person eats. In various examples, this device and method may include one or more imaging members that are worn on the person's neck, head, or torso and one or more imaging devices that are positioned on a table, counter, or other surface in front of the person in order to simultaneously, or sequentially, take pictures of a reachable food source and the person's mouth as the person eats.

In an example, this invention comprises an imaging device with multiple imaging components that take images along different imaging vectors so that the device takes pictures of a reachable food source and a person's mouth simultaneously. In an example, this invention comprises an imaging device with a wide-angle lens that takes pictures within a wide field of vision so that the device takes pictures of a reachable food source and a person's mouth simultaneously.

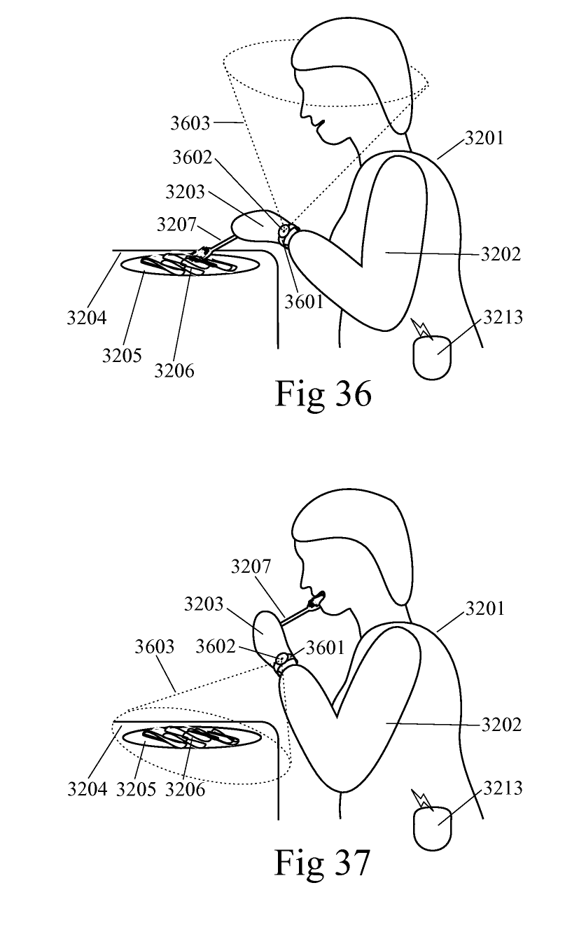

FIGS. 36 through 39 show additional examples of how this device and method for monitoring and estimating human caloric intake can be embodied. These examples are similar to the examples shown previously in that they comprise one or more automatic-imaging members that are worn on a person's wrist. These examples similar to the example shown in FIGS. 32 and 33, except that now in FIGS. 36 through 39 there is only one camera 3602 located a wrist band 3601.

This automatic-imaging member has features that enable the one camera, 3602, to take pictures of both the person's mouth and a reachable food source with only a single field of vision 3603. In an example, this single wrist-mounted camera has a wide-angle lens that allows it to take pictures of the person's mouth when a piece of food is at a first location along the food consumption pathway (as shown in FIG. 36) and allows it to take pictures of a reachable food source when a piece food is at a second location along the food consumption pathway (as shown in FIG. 37).

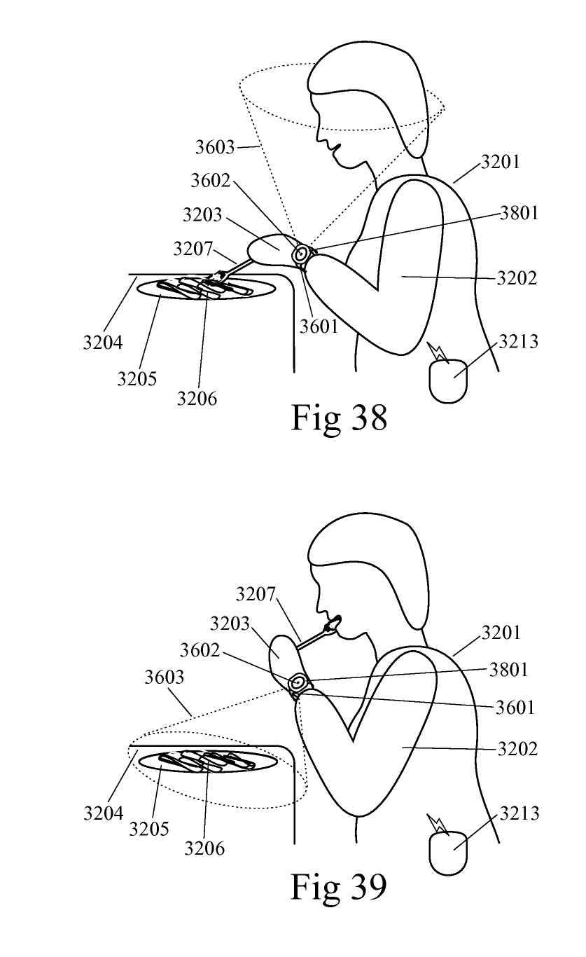

In an example, such as that shown in FIGS. 38 and 39, a single wrist-mounted camera is linked to a mechanism that shifts the camera's imaging vector (and field of vision) automatically as food moves along the food consumption pathway. This shifting imaging vector allows a single camera to encompass a reachable food source and the person's mouth, sequentially, from different locations along the food consumption pathway.

In the example of this invention that is shown in FIGS. 38 and 39, an accelerometer 3801 is worn on the person's wrist and linked to the imaging vector of camera 3602. Accelerometer 3801 detects arm and hand motion as food moves along the food consumption pathway. Information concerning this arm and hand movement is used to automatically shift the imaging vector of camera 3602 such that the field of vision, 3603, of camera 3602 sequentially captures images of the reachable food source and the person's mouth from different positions along the food consumption pathway. In an example, when accelerometer 3801 indicates that the person's arm is in the downward phase of the food consumption pathway (in proximity to the reachable food source) then the imaging vector of camera 3602 is directed upwards to get a good picture of the person's mouth interacting with food. Then, when accelerometer 3801 indicates that the person's arm is in the upward phase of the food consumption pathway (in proximity to the person's mouth), the imaging vector of camera 3602 is directed downwards to get a good picture of the reachable food source.

A key advantage of this present invention for monitoring and measuring a person's caloric intake is that it works in an automatic and (virtually) involuntary manner. It does not require human intervention each time that a person eats to aim a camera and push a button in order to take the pictures necessary to estimate the types and quantities of food consumed. This is a tremendous advantage over prior art that requires human intervention to aim a camera (at a food source, for example) and push a button to manually take pictures. The less human intervention that is required to make the device work, the more accurate the device and method will be in measuring total caloric intake. Also, the less human intervention that is required, the easier it is to make the device and method tamper-resistant.

Ideally, one would like an automatic, involuntary, and tamper-resistant device and method for monitoring and measuring caloric intake—a device and method which not only operates independently from human intervention at the time of eating, but which can also detect and respond to possible tampering or obstruction of the imaging function. At a minimum, one would like a device and method that does not rely on the person to manually aim a camera and manually initiate pictures each time the person eats. A manual device puts too much of a burden on the person to stay in compliance. At best, one would like a device and method that detects and responds if the person tampers with the imaging function of the device and method. This is critical for obtaining an accurate overall estimate of a person's caloric intake. The device and method disclosed herein is a significant step toward an automatic, involuntary, and tamper-resistant device, system, and method of caloric intake monitoring and measuring.

In an example, this device and method comprise one or more automatic-imaging members that automatically and collectively take pictures of a person's mouth and pictures of a reachable food source as the person eats, without the need for human intervention to initiate picture taking when the person starts to eat. In an example, this invention comprises one or more automatic-imaging members that collectively and automatically take pictures of the person's mouth and pictures of a reachable food source, when the person eats, without the need for human intervention, when the person eats, to activate picture taking by pushing a button on a camera.

In an example, one way to design a device and method to take pictures when a person eats without the need for human intervention is to simply have the device take pictures continuously. If the device is never turned off and takes pictures all the time, then it necessarily takes pictures when a person eats. In an example, such a device and method can: continually track the location of, and take pictures of, the person's mouth; continually track the location of, and take pictures of, the person's hands; and continually scan for, and take pictures of, any reachable food sources nearby.

However, having a wearable device that takes pictures all the time can raise privacy concerns. Having a device that continually takes pictures of a person's mouth and continually scans space surrounding the person for potential food sources may be undesirable in terms of privacy, excessive energy use, or both. People may be so motivated to monitor caloric intake and to lose weight that the benefits of a device that takes pictures all the time may outweigh privacy concerns. Accordingly, this invention may be embodied in a device and method that takes pictures all the time. However, for those for whom such privacy concerns are significant, we now consider some alternative approaches for automating picture taking when a person eats.

In an example, an alternative approach to having imaging members take pictures automatically when a person eats, without the need for human intervention, is to have the imaging members start taking pictures only when sensors indicate that the person is probably eating. This can reduce privacy concerns as compared to a device and method that takes pictures all the time. In an example, an imaging device and method can automatically begin taking images when wearable sensors indicate that the person is probably consuming food.

In an example of this alternative approach, this device and method may take pictures of the person's mouth and scan for a reachable food source only when a wearable sensor, such as the accelerometer 3801 in FIGS. 38 and 39, indicates that the person is (probably) eating. In various examples, one or more sensors that detect when the person is (probably) eating can be selected from the group consisting of: accelerometer, inclinometer, motion sensor, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor.

In various examples, indications that a person is probably eating may be selected from the group consisting of: acceleration, inclination, twisting, or rolling of the person's hand, wrist, or arm; acceleration or inclination of the person's lower arm or upper arm; bending of the person's shoulder, elbow, wrist, or finger joints; movement of the person's jaw, such as bending of the jaw joint; smells suggesting food that are detected by an artificial olfactory sensor; detection of chewing, swallowing, or other eating sounds by one or more microphones; electromagnetic waves from the person's stomach, heart, brain, or other organs; GPS or other location-based indications that a person is in an eating establishment (such as a restaurant) or food source location (such as a kitchen).

In previous paragraphs, we discussed how this present invention is superior to prior art because this present invention does not require manual activation of picture taking each time that a person eats. This present invention takes pictures automatically when a person eats. We now discuss how this present invention is also superior to prior art because this present invention does not require manual aiming of a camera (or other imaging device) toward the person's mouth or a reachable food source each time that a person eats. This present invention automatically captures the person's mouth and a reachable food source within imaging fields of vision when a person eats.

In an example, this device and method comprise one or more automatic-imaging members that automatically and collectively take pictures of a person's mouth and pictures of a reachable food source as the person eats, without the need for human intervention to actively aim or focus a camera toward a person's mouth or a reachable food source. In an example, this device and method takes pictures of a person's mouth and a food source automatically by eliminating the need for human intervention to aim an imaging member, such as a camera, towards the person's mouth and the food source. This device and method includes imaging members whose locations, and/or the movement of those locations while the person eats, enables the fields of vision of the imaging members to automatically encompass the person's mouth and a food source.

In an example, the fields of vision from one or more automatic-imaging members in this invention collectively and automatically encompass the person's mouth and a reachable food source, when the person eats, without the need for human intervention (when the person eats) to manually aim an imaging member toward the person's mouth or toward the reachable food source. In an example, the automatic-imaging members have wide-angle lenses that encompass a reachable food source and the person's mouth without any need for aiming or moving the imaging members. Alternatively, an automatic-imaging member may sequentially and iteratively focus on the food source, then on the person's mouth, then back on the food source, and so forth.

In an example, this device can automatically adjust the imaging vectors or focal lengths of one or more imaging components so that these imaging components stay focused on a food source and/or the person's mouth. Even if the line of sight from an automatic-imaging member to a food source, or to the person's mouth, becomes temporarily obscured, the device can track the last-known location of the food source, or the person's mouth, and search near that location in space to re-identify the food source, or mouth, to re-establish imaging contact. In an example, the device may track movement of the food source, or the person's mouth, relative to the imaging device. In an example, the device may extrapolate expected movement of the food source, or the person's mouth, and search in the expected projected of the food source, or the person's mouth, in order to re-establish imaging contact. In various examples, this device and method may use face recognition and/or gesture recognition methods to track the location of the person's face and/or hand relative to a wearable imaging device.

In an example, this device and method comprise at least one camera (or other imaging member) that takes pictures along an imaging vector which points toward the person's mouth and/or face, during certain body configurations, while the person eats. In an example, this device and member uses face recognition methods to adjust the direction and/or focal length of its field of vision in order to stay focused on the person's mouth and/or face. Face recognition methods and/or gesture recognition methods may also be used to detect and measure hand-to-mouth proximity and interaction. In an example, one or more imaging devices automatically stay focused on the person's mouth, even if the device moves, by the use of face recognition methods. In an example, the fields of vision from one or more automatic-imaging members collectively encompass the person's mouth and a reachable food source, when the person eats, without the need for human intervention, when the person eats, because the imaging members remain automatically directed toward the person's mouth, toward the reachable food source, or both.

In various examples, movement of one or more automatic-imaging members allows their fields of vision to automatically and collectively capture images of the person's mouth and a reachable food source without the need for human intervention when the person eats. In an example, this device and method includes an automatic-imaging member that is worn on the person's wrist, hand, finger, or arm, such that this automatic-imaging member automatically takes pictures of the person's mouth, a reachable food source, or both as the person moves their arm and hand when they eat. This movement causes the fields of vision from one or more automatic-imaging members to collectively and automatically encompass the person's mouth and a reachable food source as the person eats. Accordingly, there is no need for human intervention, when the person starts eating, to manually aim a camera (or other imaging member) toward the person's mouth or toward a reachable food source. Picture taking of the person's mouth and the food source is automatic and virtually involuntary. This makes it relatively easy to incorporate tamper-resisting features into this invention.

In an example, one or more imaging members are worn on a body member that moves as food travels along the food consumption pathway. In this manner, these one or more imaging members have lines of sight to the person's mouth and to the food source during at least some points along the food consumption pathway. In various examples, this movement is caused by bending of the person's shoulder, elbow, and wrist joints. In an example, an imaging member is worn on the wrist, arm, or hand of a dominant arm, wherein the person uses this arm to move food along the food consumption pathway. In another example, an imaging member may be worn on the wrist, arm, or hand of a non-dominant arm, wherein this other arm is generally stationery and not used to move food along the food consumption pathway. In another example, automatic-imaging members may be worn on both arms.

In an example, this invention comprises two or more automatic-imaging members wherein a first imaging member is pointed toward the person's mouth most of the time, as the person moves their arm to move food along the food consumption pathway, and wherein a second imaging member is pointed toward a reachable food source most of the time, as the person moves their arm to move food along the food consumption pathway. In an example, this invention comprises one or more imaging members wherein: a first imaging member points toward the person's mouth at least once as the person brings a piece (or portion) of food to their mouth from a reachable food source; and a second imaging member points toward the reachable food source at least once as the person brings a piece (or portion) of food to their mouth from the reachable food source.

In an example, this device and method comprise an imaging device with a single imaging member that takes pictures along shifting imaging vectors, as food travels along the food consumption pathway, so that it take pictures of a food source and the person's mouth sequentially. In an example, this device and method takes pictures of a food source and a person's mouth from different positions as food moves along the food consumption pathway. In an example, this device and method comprise an imaging device that scans for, locates, and takes pictures of the distal and proximal endpoints of the food consumption pathway.

In an example of this invention, the fields of vision from one or more automatic-imaging members are shifted by movement of the person's arm and hand while the person eats. This shifting causes the fields of vision from the one or more automatic-imaging members to collectively and automatically encompass the person's mouth and a reachable food source while the person is eating. This encompassing imaging occurs without the need for human intervention when the person eats. This eliminates the need for a person to manually aim a camera (or other imaging member) toward their mouth or toward a reachable food source.

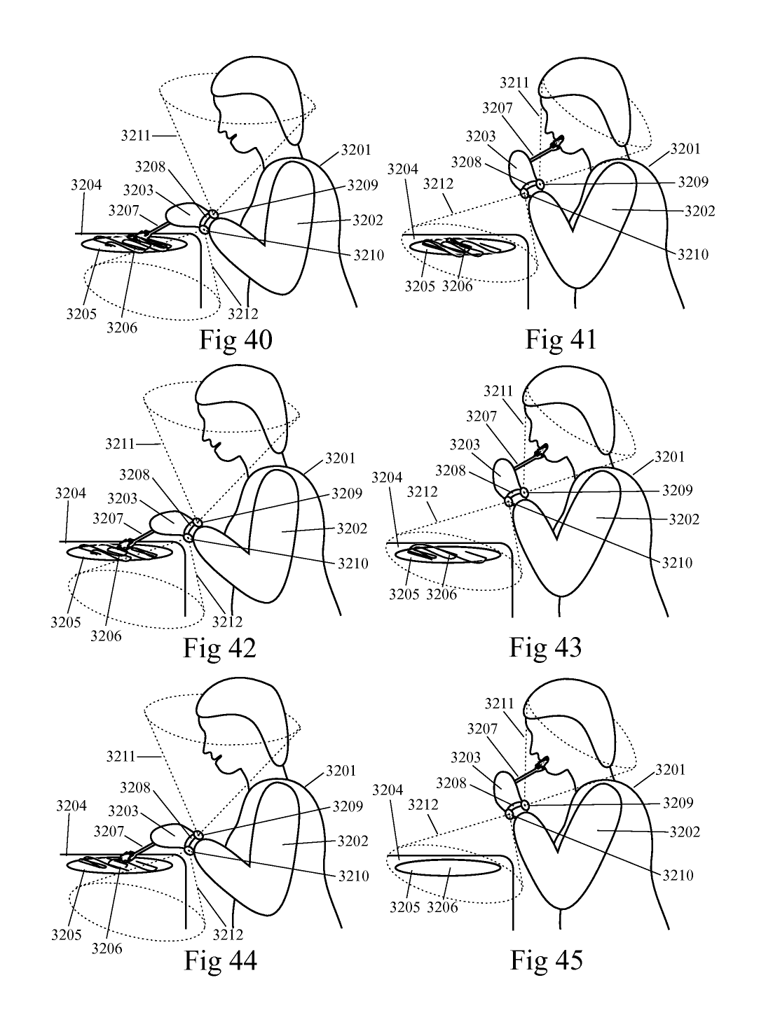

FIGS. 40-45 again show the example of this invention that was introduced in FIGS. 32-33. However, this example is now shown as functioning in a six-picture sequence of food consumption, involving multiple cycles of pieces (or portions) of food moving along the food consumption pathway until the food source is entirely consumed. In FIGS. 40-45, this device and method are shown taking pictures of a reachable food source and the person's mouth, from multiple perspectives, as the person eats until all of the food on a plate is consumed.

FIG. 40 starts this sequence by showing a person 3201 engaging food 3206 on plate 3205 with utensil 3207. The person moves utensil 3207 by moving their arm 3202 and hand 3203. Wrist-mounted camera 3209, on wrist band 3208, has a field of vision 3211 that encompasses the person's mouth. Wrist-mounted camera 3210, also on wrist band 3208, has a field of vision 3212 that partially encompasses a reachable food source which, in this example, is food 3206 on plate 3205 on table 3204.

FIG. 41 continues this sequence by showing the person having bent their arm 3202 and wrist 3203 in order to move a piece of food up to their mouth via utensil 3207. In FIG. 41, camera 3209 has a field of vision 3211 that encompasses the person's mouth (including the interaction of the person's mouth and the piece of food) and camera 3210 has a field of vision 3212 that now fully encompasses the food source.

FIGS. 42-45 continue this sequence with additional cycles of the food consumption pathway, wherein the person brings pieces of food from the plate 3205 to the person's mouth. In this example, by the end of this sequence shown in FIG. 45 the person has eaten all of the food 3206 from plate 3205.

In the sequence of food consumption pathway cycles that is shown in FIGS. 40-45, pictures of the reachable food source (food 3206 on plate 3205) taken by camera 3210 are particularly useful in identifying the types of food to which the person has reachable access. In this simple example, featuring a single person with a single plate, changes in the volume of food on the plate could also be used to estimate the quantities of food which this person consumes. However, with more complex situations featuring multiple people and multiple food sources, images of the food source only would be limited for estimating the quantity of food that is actually consumed by a given person.

In this example, the pictures of the person's mouth taken by camera 3209 are particularly useful for estimating the quantities of food actually consumed by the person. Static or moving pictures of the person inserting pieces of food into their mouth, refined by counting the number or speed of chewing motions and the number of cycles of the food consumption pathway, can be used to estimate the quantity of food consumed. However, images of the mouth only would be limited for identifying the types of food consumed.

Integrated analysis of pictures of both the food source and the person's mouth can provide a relatively accurate estimate of the types and quantities of food actually consumed by this person, even in situations with multiple food sources and multiple diners. Integrated analysis can compare estimates of food quantity consumed based on changes in observed food volume at the food source to estimates of food quantity consumed based on mouth-food interaction and food consumption pathway cycles.

Although it is preferable that the field of vision 3211 for camera 3209 encompasses the person's mouth all the time and that the field of vision 3211 for camera 3210 encompasses the reachable food source all the time, integrated analysis can occur even if this is not possible. As long as the field of vision 3212 for camera 3210 encompasses the food source at least once during a food consumption pathway cycle and the field of vision 3211 from camera 3209 encompasses the person's mouth at least once during a food consumption pathway cycle, this device and method can extrapolate mouth-food interaction and also changes in food volume at the reachable food source.

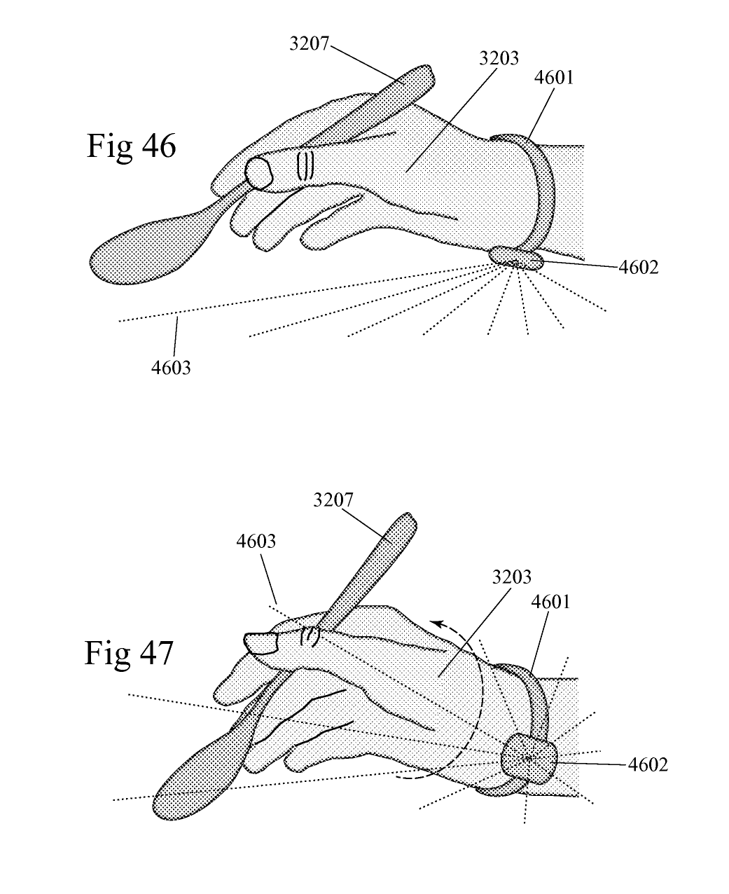

FIGS. 46 and 47 show, in greater detail, how the field of vision from a wrist-worn imaging member can advantageously shift as a person moves and rolls their wrist to bring food up to their mouth along the food consumption pathway. These figures show a person's hand 3203 holding utensil 3207 from the perspective of a person looking at their hand, as their hand brings the utensil up to their mouth. This rolling and shifting motion can enable a single imaging member, such as a single camera 4602 mounted on wrist band 4601, to take pictures of a reachable food source and the person's mouth, from different points along the food consumption pathway.

FIGS. 46 and 47 show movement of a single camera 4602 mounted on the anterior (inside) surface of wrist band 4601 as the person moves and rolls their wrist to bring utensil 3207 up from a food source to their mouth. The manner in which this camera is worn is like a wrist watch, with a camera instead of a watch face, which has been rotated 180 degrees around the person's wrist. In FIG. 46, field of vision 4603 from camera 4602 points generally downward in a manner that would be likely to encompass a reachable food source which the person would engage with utensil 3207. In FIG. 47, this field of vision 4603 has been rotated upwards towards the person's mouth by the rotation of the person's wrist as the person brings utensil 3207 up to their mouth. These two figures illustrate an example wherein a single wrist-worn imaging member can take pictures of both a reachable food source and the person's mouth, due to the rolling motion of a person's wrist as food is moved along the food consumption pathway.

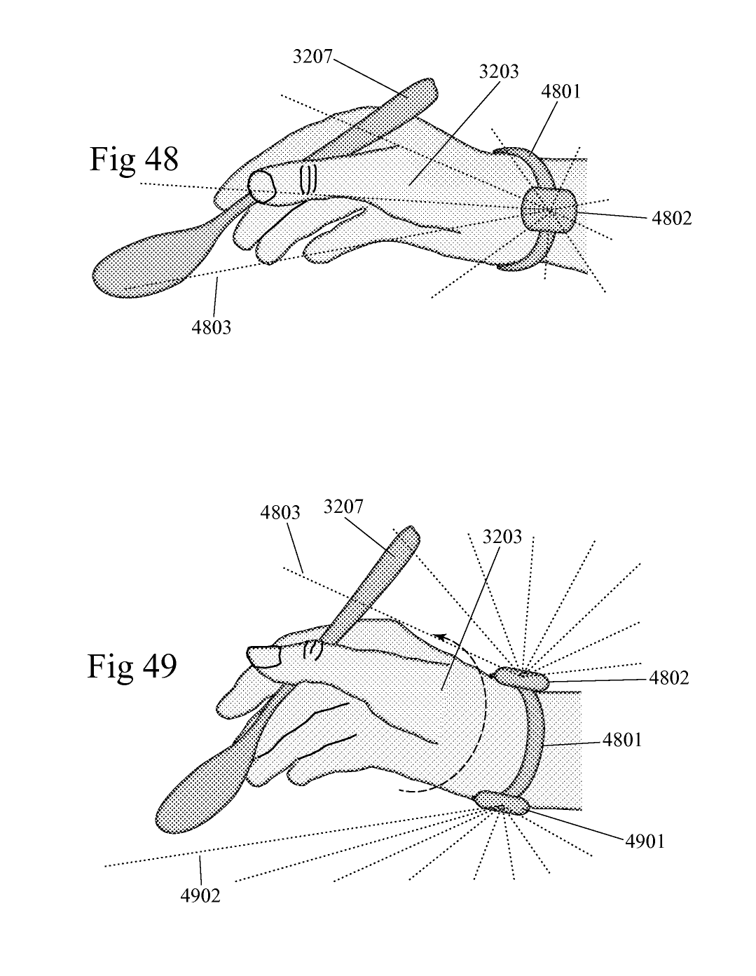

FIGS. 48 and 49 are similar to FIGS. 46 and 47, except that FIGS. 48 and 49 show a wrist-worn automatic-imaging member with two cameras, 4802 and 4901, instead of just one. This is similar to the example introduced in FIGS. 32 and 33. These figures show the person's hand 3203 holding utensil 3207 from the perspective of a person looking at their hand, as their hand brings the utensil up to their mouth. FIGS. 48 and 49 show how the rolling motion of the wrist, as food is moved along the food consumption pathway, enables a wrist-worn imaging member with two cameras, 4802 and 4901, to collectively and automatically take pictures of a reachable food source and a person's mouth.

The two cameras in FIGS. 48 and 49 are attached to the narrow sides of the person's wrist via wrist band 4801. Camera 4901 is not shown in FIG. 48 because it is on the far-side of the person's wrist which is not visible in FIG. 48. After the person's rolls their wrist to bring the utensil up toward their mouth, as shown in FIG. 49, camera 4901 comes into view. This rolling and shifting motion of the person's wrist, occurring between FIGS. 48 and 49, enables the two cameras, 4802 and 4901, to automatically and collectively take pictures of a reachable food source and the person's mouth, from different points along the food consumption pathway. In FIG. 48, field of vision 4803 from camera 4802 is directed toward the person's mouth. In FIG. 49, after the person has moved their arm and rotated their wrist, field of vision 4902 from camera 4901 is directed toward (the likely location of) a reachable food source. In an example, camera 4901 may scan the vicinity in order to detect and identify a reachable food source.

Having two cameras mounted on opposite sides of a person's wrist increases the probability of encompassing both the person's mouth and a reachable food source as the person rolls their wrist and bends their arm to move food along the food consumption pathway. In other examples, more than two cameras may be attached on a band around the person's wrist to further increase the probability of encompassing both the person's mouth and the reachable food source.

In an example, the location of one or more cameras may be moved automatically, independently of movement of the body member to which the cameras are attached, in order to increase the probability of encompassing both the person's mouth and a reachable food source. In an example, the lenses of one or more cameras may be automatically and independently moved in order to increase the probability of encompassing both the person's mouth and a reachable food source. In various examples, a lens may be automatically shifted or rotated to change the direction or focal length of the camera's field of vision. In an example, the lenses of one or more cameras may be automatically moved to track the person's mouth and hand. In an example, the lenses of one or more cameras may be automatically moved to scan for reachable food sources.

In an example, this device and method comprise a device that is worn on a person so as to take images of food, or pieces of food, at multiple locations as food travels along a food consumption pathway. In an example, this device and method comprise a device that takes a series of pictures of a portion of food as it moves along a food consumption pathway between a reachable food source and the person's mouth. In an example, this device and method comprise a wearable imaging member that takes pictures upwards toward a person's face as the person's arm bends when the person eats. In an example, this invention comprises an imaging member that captures images of the person's mouth when the person's elbow is bent at an angle between 40-140 degrees as the person brings food to their mouth. In various examples, this device and method automatically takes pictures of food at a plurality of positions as food moves along the food consumption pathway. In an example, this device and method estimates the type and quantity of food consumed based, at least partially, on pattern analysis of images of the proximal and distal endpoints of the food consumption pathway.

In an example, this invention comprises a human-energy input measuring device and method that includes a wearable imaging member that identifies the types and quantities of food consumed based on images of food from a plurality of points along a food consumption pathway. In an example, this device and method takes pictures of a person's mouth and a reachable food source from multiple angles, from an imaging member worn on a body member that moves as food travels along the food consumption pathway.

In an example, this invention comprises one or more of imaging devices which are worn on a location on the human body that provides at least one line of sight from the device to the person's mouth and at least one line of sight to a reachable food source, as food travels along the food consumption pathway. In various examples, these one or more imaging devices simultaneously or sequentially record images along at least two different vectors, one which points toward the mouth during at least some portion of the food consumption pathway and one which points toward the food source during at least some portion of the food consumption pathway. In various examples, this device and method comprise multiple imaging members that are worn on a person's wrist, hand, arm, or finger—with some imaging elements pointed toward the person's mouth from certain locations along the food consumption pathway and some imaging elements pointed toward a reachable food source from certain locations along the food consumption pathway.

Thus far in our description of the figures, we have discussed a variety of ways in which the automatic image-taking members and methods of this invention may be embodied. We now turn our attention to discuss, in greater detail, the automatic imaging-analyzing members and methods which are also an important part of this invention. This invention comprises a device and method that includes at least one image-analyzing member. This image-analyzing member automatically analyzes pictures of a person's mouth and pictures of a reachable food source in order to estimate the types and quantities of food consumed by this person. This is superior to prior art that only analyzes pictures of a reachable food source because the person might not actually consume all of the food at this food source.

In various examples, one or more methods to analyze pictures, in order to estimate the types and quantities of food consumed, can be selected from the group consisting of: pattern recognition; food recognition; word recognition; logo recognition; bar code recognition; face recognition; gesture recognition; and human motion recognition. In various examples, a picture of the person's mouth and/or a reachable food source may be analyzed with one or more methods selected from the group consisting of: pattern recognition or identification; human motion recognition or identification; face recognition or identification; gesture recognition or identification; food recognition or identification; word recognition or identification; logo recognition or identification; bar code recognition or identification; and 3D modeling. In an example, images of a person's mouth and a reachable food source may be taken from at least two different perspectives in order to enable the creation of three-dimensional models of food.

In various examples, this invention comprises one or more image-analyzing members that analyze one or more factors selected from the group consisting of: number and type of reachable food sources; changes in the volume of food observed at a reachable food source; number and size of chewing movements; number and size of swallowing movements; number of times that pieces (or portions) of food travel along the food consumption pathway; and size of pieces (or portions) of food traveling along the food consumption pathway. In various examples, one or more of these factors may be used to analyze images to estimate the types and quantities of food consumed by a person.

In an example, this invention is entirely automatic for both food imaging and food identification. In an example, this invention comprises a device and method that automatically and comprehensively analyzes images of food sources and a person's mouth in order to provide final estimates of the types and quantities of food consumed. In an example, the food identification and quantification process performed by this device and method does not require any manual entry of information, any manual initiation of picture taking, or any manual aiming of an imaging device when a person eats. In an example, this device and method automatically analyzes images to estimate the types and quantities of food consumed without the need for real-time or subsequent human evaluation.

In an example, this device identifies the types and quantities of food consumed based on: pattern recognition of food at a reachable food source; changes in food at that source; analysis of images of food traveling along a food consumption pathway from a food source to the person's mouth; and/or the number of cycles of food moving along the food consumption pathway. In various examples, food may be identified by pattern recognition of food itself, by recognition of words on food packaging or containers, by recognition of food brand images and logos, or by recognition of product identification codes (such as “bar codes”). In an example, analysis of images by this device and method occurs in real time, as the person is consuming food. In an example, analysis of images by this device and method occurs after the person has consumed food.

In another example, this invention is partially automatic and partially refined by human evaluation or interaction. In an example, this device and method comprise a device and method that automatically analyzes images of food sources and a person's mouth in order to provide initial estimates of the types and quantities of food consumed. These initial estimates are then refined by human evaluation and/or interaction. In an example, estimation of the types and quantities of food consumed is refined or enhanced by human interaction and/or evaluation.

For example, the device may prompt the person with clarifying questions concerning the types and quantities of food that person has consumed. These questions may be asked in real time, as a person eats, at a subsequent time, or periodically. In an example, this device and method may prompt the person with queries to refine initial automatically-generated estimates of the types and quantities of food consumed. Automatic estimates may be refined by interaction between the device and the person. However, such refinement should have limits and safeguards to guard against possible tampering. For example, the device and method should not allow a person to modify automatically-generated initial estimates of food consumed to a degree that would cause the device and method to under-estimate caloric intake.

In an example, analysis of food images and estimation of food consumed by this device and method may be entirely automatic or may be a mixture of automated estimates plus human refinement. Even a partially-automated device and method for calorie monitoring and estimation is superior to prior art that relies completely on manual calorie counting or manual entry of food items consumed. In an example, the estimates of the types and quantities of food consumed that are produced by this invention are used to estimate human caloric intake. In an example, images of a person's mouth, a reachable food source, and the interaction between the person's mouth and food are automatically, or semi-automatically, analyzed to estimate the types of quantities of food that the person eats. These estimates are, in turn, used to estimate the person's caloric intake.

In an example, the caloric intake estimation provided by this device and method becomes the energy-input measuring component of an overall system for energy balance and weight management. In an example, the device and method can estimate the energy-input component of energy balance. In an example, this invention comprises an automatic and tamper-resistant device and method for estimating human caloric intake.

In an example, the device and method for estimating human caloric intake that is disclosed herein may be used in conjunction with a device and method for estimating human caloric output and/or human energy expenditure. In an example, this present invention can be used in combination with a wearable and mobile energy-output-measuring component that automatically records and analyses images in order to detect activity and energy expenditure. In an example, this present invention may be used in combination with a wearable and mobile device that estimates human energy output based on patterns of acceleration and movement of body members. In an example, this invention may be used in combination with an energy-output-measuring component that estimates energy output by measuring changes in the position and configuration of a person's body.

In an example, this invention may be incorporated into an overall device, system, and method for human energy balance and weight management. In an example, the estimates of the types and quantities of food consumed that are provided by this present invention are used to estimate human caloric intake. These estimates of human caloric intake are then, in turn, used in combination with estimates of human caloric expenditure as part of an overall system for human energy balance and weight management. In an example, estimates of the types and quantities of food consumed are used to estimate human caloric intake and wherein these estimates of human caloric intake are used in combination with estimates of human caloric expenditure as part of an overall system for human energy balance and human weight management.

This invention can include an optional analytic component that analyzes and compares human caloric input vs. human caloric output for a particular person as part of an overall device, system, and method for overall energy balance and weight management. This overall device, system, and method may be used to help a person to lose weight or to maintain a desirable weight. In an example, this device and method can be used as part of a system with a human-energy input measuring component and a human-energy output measuring component. In an example, this invention is part of an overall system for energy balance and weight management.

Thus far in our description of the figures, we have repeatedly described this invention as being tamper resistant, but have not shown details of how tamper-resistant features could be embodied. We now show and discuss, in some detail, some of the specific ways in which this device and method for monitoring and measuring caloric intake can be made tamper resistant. This invention advantageously can be made tamper-resistant because the imaging members are wearable and can operate in an automatic manner.

In an example, this invention includes one or more automatic-imaging members that collectively and automatically take pictures of the person's mouth and pictures of a reachable food source, when the person eats, without the need for human intervention, when the person eats, to activate picture taking. In an example, these one or more automatic-imaging members take pictures continually. In an example, these one or more automatic-imaging members are automatically activated to take pictures when a person eats based on a sensor selected from the group consisting of: accelerometer, inclinometer, motion sensor, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor.

In an example, the fields of vision from these one or more automatic-imaging members collectively and automatically encompass the person's mouth and a reachable food source, when the person eats, without the need for human intervention, when the person eats, to manually aim an imaging member toward the person's mouth or toward the reachable food source. In an example, the fields of vision from one or more automatic-imaging members are moved as the person moves their arm when the person eats; and wherein this movement causes the fields of vision from one or more automatic-imaging members to collectively and automatically encompass the person's mouth and a reachable food source, when the person eats, without the need for human intervention, when the person eats, to manually aim an imaging member toward the person's mouth or toward the reachable food source.

In an example, these one or more automatic-imaging members are worn on one or more body members selected from the group consisting of the person's wrist, hand, arm, and finger; wherein the fields of vision from one or more automatic-imaging members are moved as the person moves their arm when the person eats; and wherein this movement causes the fields of vision from one or more automatic-imaging members to collectively and automatically encompass the person's mouth and a reachable food source, when the person eats, without the need for human intervention, when the person eats, to manually aim an imaging member toward the person's mouth or toward the reachable food source.

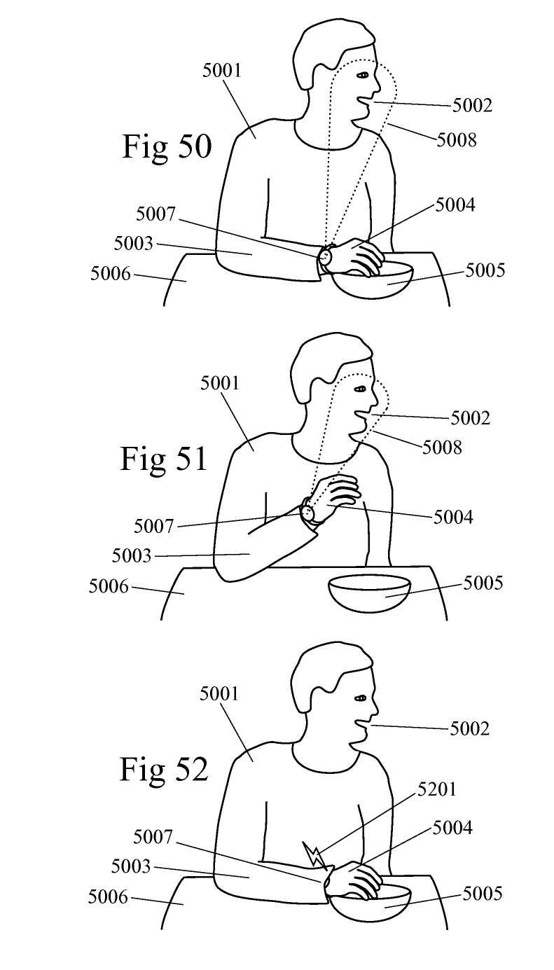

FIGS. 50-52 show one example of how this invention can be made tamper resistant. FIGS. 50-52 show a person, 5001, who can access a reachable food source 5005 (food in a bowl, in this example), on table 5006, by moving their arm 5003 and hand 5004. In this example, the person 5001 is wearing a wrist-based automatic-imaging member 5007 with field of vision 5008. In FIG. 50, this wrist-based automatic-imaging member 5007 is functioning properly because the field of vision 5008 from of this automatic-imaging member 5007 has an unobstructed line of sight to the person's mouth 5002. This imaging member can monitor the person's mouth 5002 to detect if the person is eating and then analyze pictures to estimate the quantity of food consumed.

In FIG. 50, automatic-imaging member 5007 recognizes that the line of sight to the person's mouth is unobstructed because it recognizes the person's mouth using face recognition methods. In other examples, automatic-imaging member 5007 may recognize that the line of sight to the person's mouth is unobstructed by using other pattern recognition or imaging-analyzing means. As long as a line of sight from the automatic-imaging member to the person's mouth is maintained (unobstructed), the device and method can detect if the person starts eating and, in conjunction with images of the reachable food source, it can estimate caloric intake based on quantities and types of food consumed.

In FIG. 51, person 5001 has bent their arm 5003 and moved their hand 5004 in order to bring a piece of food from the reachable food source 5005 up to their mouth 5002. In this example, the piece of food is clutched (hidden) in the person's hand as it travels along the food consumption pathway. In this example, the automatic-imaging member 5007 used face recognition methods to track the relative location of the person's mouth 5002 and has shifted its field of vision 5008 in order to maintain the line of sight to the person's mouth. As long as this line of sight is maintained, this mouth-imaging component of this device and method for estimating caloric intake can function properly.

In FIG. 52, however, the functioning of this imaging member 5007 has been impaired. This impairment may be intentional tampering by the person or it may be accidental. In either event, the device and method detects and responds to the impairment in order to correct the impairment. In FIG. 52, the sleeve of the person's shirt has slipped down over the automatic-imaging device, obstructing the line of sight from the imaging device 5007 to the person's mouth 5002. Thus covered, the obstructed automatic-imaging member cannot function properly. In this example, the automatic-imaging member recognizes that its line of sight to the person's mouth has been lost. In an example, it may recognize this by using face recognition methods. When the person's face is no longer found at an expected location (or nearby), then the device and method recognizes that its functioning is impaired.

Without a line of sight to the person's mouth in FIG. 52, the wrist-worn automatic-imaging device 5007 no longer works properly to monitor and estimate caloric intake. In response, automatic-imaging device 5007 gives a response 5201 that is represented in FIG. 52 by a lightning bolt symbol. In an example, this response 5201 may be an electronic buzzing sound or a ring tone. In another example, response 5201 may include vibration of the person's wrist. In another example, response 5201 may be transmission or a message to a remote location or monitor. In various examples, this invention detects and responds to loss of imaging functionality in a manner that helps to restore proper imaging functionality. In this example, response 5201 prompts the person to move their shirt sleeve upwards to uncover the wrist-worn imaging member 5004 so that this imaging member can work properly once again.

In an example, the line of sight from an automatic-imaging member to the person's mouth may be obstructed by an accidental event, such as the accidental downward sliding of the person's shirt sleeve. In another example, the line of sight from the automatic-imaging member to the person's mouth may be intentionally obstructed by the person. Technically, only the second type of causation should be called “tampering” with the operation of the device and method. However, one can design tamper-resisting features for operation of the device and method that detect and correct operational impairment whether this impairment is accidental or intentional. The device can be designed to detect if the automatic-imaging function is obstructed, or otherwise impaired, and to respond accordingly to restore functionality.

One example of a tamper-resistant design is for the device to constantly monitor the location of the person's mouth and to respond if a line of sight to the person's mouth is ever obstructed. Another example of a tamper-resistant design is for the device to constantly scan and monitor space around the person, especially space in the vicinity of the person's hand, to detect possible reachable food sources. In a variation on these examples, a device may only monitor the location of the person's mouth, or scan for possible reachable food sources, when one or more sensors indicate that the person is probably eating. These one or more sensors may be selected from the group consisting of: accelerometer, inclinometer, motion sensor, pedometer, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor.

In an example, this invention can be embodied in a tamper-resistant device that automatically monitors caloric intake comprising: one or more automatic-imaging members that are worn on one or more locations on a person from which these members: collectively and automatically take pictures of the person's mouth when the person eats and pictures of a reachable food source when the person eats; wherein a reachable food source is a food source that the person can reach by moving their arm; and wherein food can include liquid nourishment as well as solid food; a tamper-resisting mechanism which detects and responds if the operation of the one or more automatic-imaging members is impaired; and an image-analyzing member which automatically analyzes pictures of the person's mouth and pictures of the reachable food source in order to estimate the types and quantities of food that are consumed by the person.

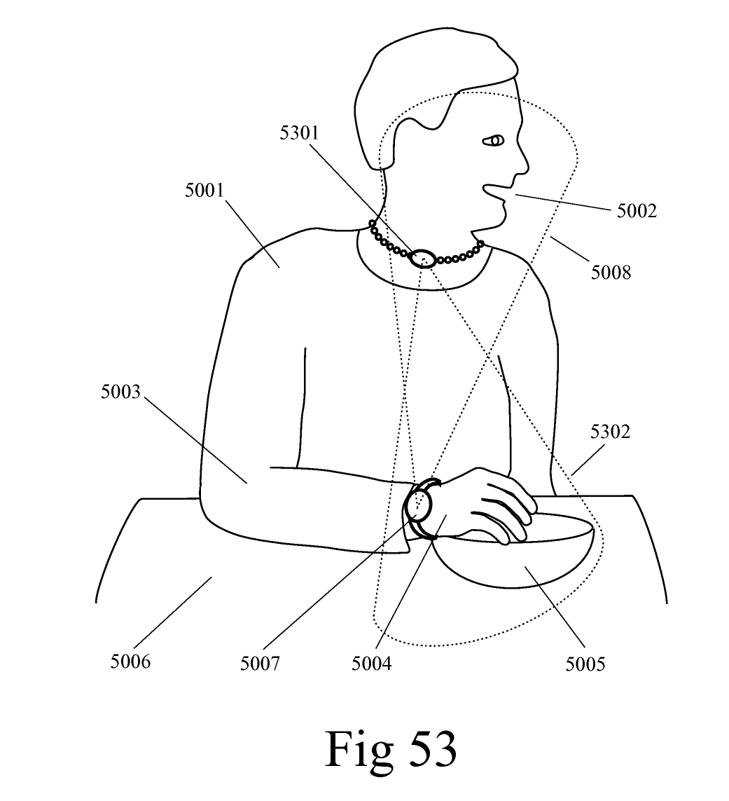

FIG. 53 shows another example of how this invention may be embodied a tamper-resisting device and method to automatically monitor and measure caloric intake. In FIG. 53, this device and method comprise two wearable automatic-imaging members. The first automatic-imaging member, 5007, is worn on a person's wrist like a wrist watch. This first member takes pictures of the person's mouth and detects if the line of sight from this first imaging member to the person's mouth is obstructed or otherwise impaired. The second automatic-imaging member, 5301, is worn on a person's neck like a necklace. This second member takes pictures of the person's hand and a reachable food source and detects if the line of sight from the second imaging member to the person's hand and a reachable food source is obstructed or otherwise impaired. In this example, this device and method is tamper-resistant because it detects and responds if either of these lines of sight are obstructed or otherwise impaired.

Discussing FIG. 53 in further detail, this figure shows person 5001 accessing reachable food source (e.g. a bowl of food) 5005 on table 5006 by moving their arm 5003 and hand 5004. Person 5001 wears a first automatic-imaging member 5007 around their wrist. From its wrist-worn location, this first imaging member 5007 has a field of vision 5008 that encompasses the person's mouth 5002. In an example, this automatic-imaging member 5007 uses face recognition to shift its field of vision 5007, as the person moves their wrist or head, so as to maintain a line of sight from the wrist to the person's mouth. In an example, the field of vision 5007 may be shifted by automatic rotation or shifting of the lens on automatic-imaging member 5007.

In an example, first automatic-imaging member 5007 constantly maintains a line of sight to the person's mouth by constantly shifting the direction and/or focal length of its field of vision 5008. In another example, this first automatic-imaging member 5007 scans and acquires a line of sight to the person's mouth only when a sensor indicates that the person is eating. In an example, this scanning function may comprise changing the direction and/or focal length of the member's field of vision 5008. If the line of sight from this member to the person's mouth is obstructed, or otherwise impaired, then this device and method detects and responds to this impairment as part of its tamper-resisting function. In an example, its response to tampering helps to restore proper imaging function for automatic monitoring and estimation of caloric intake.

In this example, this person 5001 also wears a second automatic-imaging member 5301 around their neck. In this example, automatic-imaging member 5301 is worn like a central pendant on the front of a necklace. From this location, this second imaging member has a forward-and-downward facing field of vision, 5302, that encompasses the person's hand 5004 and a reachable food source 5005. In an example, this second automatic-imaging member 5301 uses gesture recognition, or other pattern recognition methods, to shift its focus so as to always maintain a line of sight to the person's hand and/or to scan for potential reachable food sources.

FIG. 53 shows an example of how this invention can be embodied in a device that automatically monitors caloric intake comprising: an automatic-imaging member that is worn on a person; and an image-analyzing member which automatically analyzes pictures taken by the automatic-imaging member in order to monitor caloric intake, wherein the image-analyzing member uses one or more methods selected from the group consisting of: human motion recognition or identification; and gesture recognition or identification.

FIG. 53 also shows an example of how this invention can be embodied in a method to automatically monitor caloric intake comprising: having a person wear an automatic-imaging member; and automatically analyzing pictures taken by the automatic-imaging member in order to monitor caloric intake using one or more methods selected from the group consisting of: human motion recognition or identification; and gesture recognition or identification.

In an example, this second automatic-imaging member 5301 constantly maintains a line of sight to one or both of the person's hands. In another example, this second automatic-imaging member 5301 scans for (and identifies and maintains a line of sight to) the person's hand only when a sensor indicates that the person is eating. In another example, this second automatic-imaging member 5301 scans for, acquires, and maintains a line of sight to a reachable food source only when a sensor indicates that the person is probably eating. In various examples, the sensors used to activate one or more of these automatic-imaging members may be selected from the group consisting of: accelerometer, inclinometer, motion sensor, pedometer, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor.

In an example, this device and method comprise one or more imaging members that scan nearby space in order to identify a person's mouth, hand, and/or reachable food source in response to sensors indicating that the person is probably eating. In an example, one of these imaging members: (a) scans space surrounding the imaging member in order to identify the person's hand and acquire a line of sight to the person's hand when a sensor indicates that the person is eating; and then (b) scans space surrounding the person's hand in order to identify and acquire a line of sight to any reachable food source near the person's hand. In an example, the device and method may concentrate scanning efforts on the person's hand at the distal endpoint of a food consumption pathway to detect and identify a reachable food source. If the line of sight from this imaging member to the person's hand and/or a reachable food source is subsequently obstructed or otherwise impaired, then this device and method detects and responds as part of its tamper-resisting features. In an example, this response is designed to restore imaging functionality to enable proper automatic monitoring and estimation of caloric intake.

More generally, in various examples, this invention includes one or more tamper-resisting mechanisms which detect and respond if the operation of one or more automatic-imaging members are obstructed or otherwise impaired. In an example, this invention includes a tamper-resisting mechanism which detects and responds if a person hinders the operation of one or more automatic-imaging members. For example, the device and method disclosed herein can have a tamper-resistant feature that is triggered if the device is removed from the body member as indicated by a sensor selected from the group consisting of: accelerometer, inclinometer, motion sensor, pedometer, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor.

In an example, this invention comprises a device and method with features that resist tampering with the automatic and involuntary estimation of the types and quantities of food consumed by a person. In an example, this device and method includes an alarm that is triggered if a wearable imaging device is covered up. In various examples, this invention comprises one or more imaging devices which detect and respond if their direct line of sight with the person's mouth or a reachable food source is impaired. In an example, this invention includes a tamper-resisting member that monitors a person's mouth using face recognition methods and responds if the line of sight from an automatic-imaging member to the person's mouth is impaired when a person eats. In another example, this invention includes a tamper-resisting member that detects and responds if the person's actual weight gain or loss is inconsistent with predicted weight gain or loss. Weight gain or loss may be predicted by the net balance of estimated caloric intake and estimated caloric expenditure.

The tamper-resisting features of this invention help to make the operation of this invention relatively automatic, tamper-resistant, and virtually involuntary. This ensures comprehensive and accurate monitoring and measuring of caloric intake.

In an example, this invention can include at least two automatic-imaging members worn on a person's body, wherein the field of vision from a first automatic-imaging member automatically encompasses the person's mouth as the person eats, and wherein the field of vision from a second automatic-imaging member automatically encompasses a reachable food source as the person eats.

In an example, this invention can include at least two automatic-imaging members worn on a person's body: wherein a first automatic-imaging member is worn on a body member selected from the group consisting of the person's wrist, hand, lower arm, and finger; wherein the field of vision from the first automatic-imaging member automatically encompasses the person's mouth as the person eats; wherein a second automatic-imaging member is worn on a body member selected from the group consisting of the person's neck, head, torso, and upper arm; and wherein the field of vision from the second automatic-imaging member automatically encompasses a reachable food source as the person eats.

In an example, this invention can include a tamper-resisting member that comprises a sensor that detects and responds if an automatic-imaging member is removed from the person's body, wherein this sensor is selected from the group consisting of: accelerometer, inclinometer, motion sensor, pedometer, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor.

In an example, this invention can include a tamper-resisting member that comprises a sensor that detects and responds if the line of sight from one or more automatic-imaging members to the person's mouth or to a food source is impaired when a person is probably eating based on a sensor, wherein this sensor is selected from the group consisting of: accelerometer, inclinometer, motion sensor, pedometer, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor.

In an example, this invention can include a tamper-resisting member that monitors a person's mouth using face recognition methods and responds if the line of sight from an automatic-imaging member to the person's mouth is impaired when a person is probably eating based on a sensor, wherein this sensor is selected from the group consisting of: accelerometer, inclinometer, motion sensor, pedometer, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor.

In an example, this invention can include a tamper-resisting member that detects and responds if the person's actual weight gain or loss is inconsistent with the predicted weight gain or loss predicted by the combination of the estimated caloric intake and the estimated caloric expenditure.

In an example, this invention can be embodied in a tamper-resistant device that automatically monitors caloric intake comprising: one or more automatic-imaging members that are worn on one or more locations on a person from which these members: collectively and automatically take pictures of the person's mouth when the person eats and take pictures of a reachable food source when the person eats; wherein a reachable food source is a food source that the person can reach by moving their arm; wherein food can include liquid nourishment as well as solid food; wherein one or more automatic-imaging members collectively and automatically take pictures of the person's mouth and pictures of a reachable food source, when the person eats, without the need for human intervention, when the person eats, to activate picture taking; and wherein the fields of vision from one or more automatic-imaging members collectively and automatically encompass the person's mouth and a reachable food source, when the person eats, without the need for human intervention, when the person eats, to manually aim an imaging member toward the person's mouth or toward the reachable food source; a tamper-resisting mechanism which detects and responds if the operation of the one or more automatic-imaging members is impaired; wherein a tamper-resisting member comprises a sensor that detects and responds if the line of sight from one or more automatic-imaging members to the person's mouth or to a food source is impaired when a person is probably eating based on a sensor, wherein this sensor is selected from the group consisting of: accelerometer, inclinometer, motion sensor, pedometer, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor; and an image-analyzing member which automatically analyzes pictures of the person's mouth and pictures of the reachable food source in order to estimate not just what food is at the reachable food source, but the types and quantities of food that are actually consumed by the person; and wherein the image-analyzing member uses one or more methods selected from the group consisting of: pattern recognition or identification; human motion recognition or identification; face recognition or identification; gesture recognition or identification; food recognition or identification; word recognition or identification; logo recognition or identification; bar code recognition or identification; and 3D modeling.

In an example, this invention can be embodied in a tamper-resistant method for automatically monitoring caloric intake comprising: having a person wear one or more automatic-imaging members at one or more locations on the person from which these members collectively and automatically take pictures of the person's mouth when the person eats and pictures of a reachable food source when the person eats; wherein a reachable food source is a food source that the person can reach by moving their arm; and wherein food can include liquid nourishment as well as solid food; detecting and responding if the operation of the one or more automatic-imaging members is impaired; and automatically analyzing pictures of the person's mouth and pictures of the reachable food source in order to estimate the types and quantities of food that are consumed by the person.

FIGS. 32 through 53 show examples of how this invention can be embodied in a device that automatically monitors caloric intake comprising: an automatic-imaging member that is worn on a person; and an image-analyzing member which automatically analyzes pictures taken by the automatic-imaging member in order to monitor caloric intake, wherein the image-analyzing member uses one or more methods selected from the group consisting of: human motion recognition or identification; and gesture recognition or identification.

In an example, gesture recognition methods can be used to track the location of the person's hand. In an example, the automatic-imaging member can use gesture recognition methods to shift its focus so as to always maintain a line of sight to the person's hand and/or to scan for potential reachable food sources. In an example, the automatic-imaging member can scan space in order to identify the person's hand and then scans space surrounding the person's hand in order to identify food sources. In an example, gesture recognition methods can be used to detect and measure hand-to-mouth proximity and interaction.

In an example, indications that a person is eating can be selected from the group consisting of: inclination, twisting, or rolling of the person's hand, wrist, or arm; inclination of the person's lower arm or upper arm; and bending of the person's shoulder, elbow, wrist, or finger joints. In an example, the image-analyzing member can analyze one or more factors selected from the group consisting of: number of times that the person brings food to their mouth; and sizes of portions of food that the person brings to their mouth. In an example, the image-analyzing member can analyze one or more factors selected from the group consisting of: number of reachable food sources; types of reachable food sources; and changes in the volume of food at a reachable food source.

In an example, the image-analyzing member can use one or more methods selected from the group consisting of: pattern recognition or identification; face recognition or identification; food recognition or identification; word recognition or identification; logo recognition or identification; bar code recognition or identification; and 3D modeling. In an example, this device can identify the types and quantities of food consumed based on: pattern recognition of food itself; recognition of words on food packaging or containers; recognition of food brand images and logos; recognition of product identification codes; and/or the number of cycles of food moving along the food consumption pathway. In an example, the automatic-imaging member can take pictures continually.

In an example, the automatic-imaging member can be automatically activated to take pictures when a person eats based on a sensor selected from the group consisting of: accelerometer, inclinometer, motion sensor, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor. In an example, the automatic-imaging member can be worn in a manner similar to a wrist watch, bracelet, arm band, or finger ring. In an example, the automatic-imaging member can be worn in a manner similar to eyeglasses. In an example, the automatic-imaging member can be worn in a manner similar to a necklace, pendant, dog tags, or brooch.

FIGS. 32 through 53 also show examples of how this invention can be embodied in a device that automatically monitors caloric intake comprising: an automatic-imaging member that is worn on a person; and an image-analyzing member which automatically analyzes pictures taken by the automatic-imaging member in order to monitor caloric intake, wherein indications that a person is eating are selected from the group consisting of: inclination, twisting, or rolling of the person's hand, wrist, or arm; inclination of the person's lower arm or upper arm; and bending of the person's shoulder, elbow, wrist, or finger joints. In an example, gesture recognition methods can be used to track the location of the person's hand. In an example, an automatic-imaging member can use gesture recognition methods to shift its focus so as to always maintain a line of sight to the person's hand and/or to scan for potential reachable food sources. In an example, an automatic-imaging member can scan space in order to identify the person's hand and then scans space surrounding the person's hand in order to identify food sources.

FIGS. 32 through 53 also show examples of how this invention can be embodied in a method to automatically monitor caloric intake comprising: having a person wear an automatic-imaging member; and automatically analyzing pictures taken by the automatic-imaging member in order to monitor caloric intake using one or more methods selected from the group consisting of: human motion recognition or identification; and gesture recognition or identification.

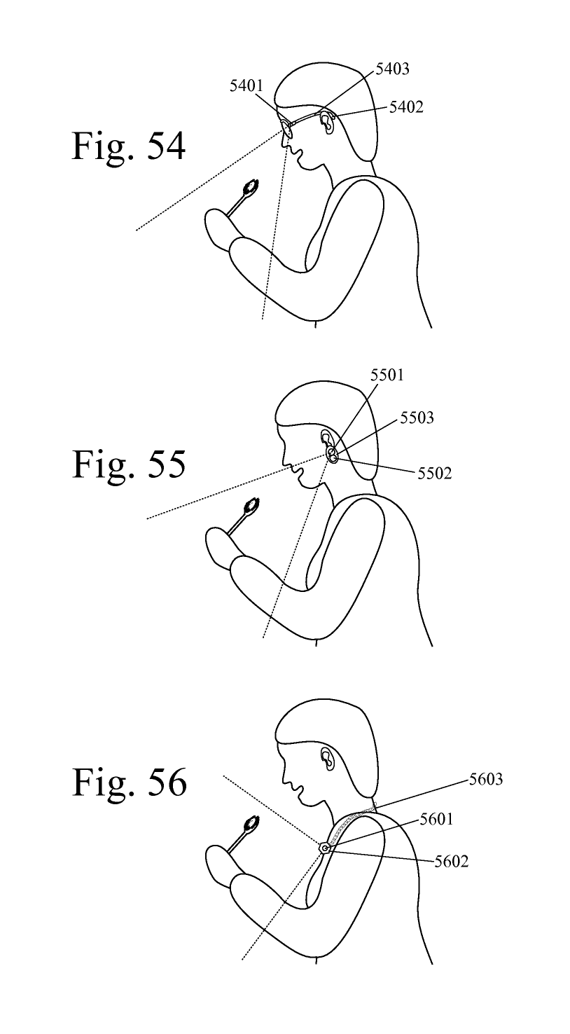

FIGS. 54 through 94 show examples of how this invention can be embodied in a wearable device for identifying food consumption using gesture recognition. We now provide an introductory section for FIGS. 54 through 94. The embodiment variations which are discussed in this introductory section can be applied where relevant to the specific examples and embodiments which are individually shown and discussed with respect to each of FIGS. 54 through 94. Discussing these variations once in this introductory section avoids having to repeat them in the context of each of the individual discussions which accompanies each of FIGS. 54 through 94. Nonetheless, it is to be understood that the variations discussed in this introductory section can apply as variations of each the individual examples which follow in FIGS. 54 through 94.

FIGS. 54 through 94 show examples of how this invention can be embodied in a wearable device for identifying food consumption comprising: (1) a wearable camera that is configured to be worn on a person's head or around their neck; and (2) a data processor which uses gesture recognition to analyze the pictures taken by this camera in order to identify when the person is eating, wherein selected eating-related gestures are recognized by tracking the configuration and movement of: the person's thumb; the person's index finger; and (a portion of) food or a food-transporting object. In an example, the configurations and movements of a person's middle finger, ring finger, and little finger (pinky) can also be tracked.

FIGS. 54 through 94 show examples of how this invention can be embodied in a wearable device for identifying food consumption comprising: (1) a wearable camera that is configured to be worn on a person's head or around their neck; and (2) a data processor which uses gesture recognition to analyze the pictures taken by this camera in order to identify when the person is eating—wherein selected eating-related gestures are recognized by tracking the configuration and movement of one or more objects selected from the group consisting of: the person's thumb comprising a distal segment and a proximal segment; the person's index finger comprising a distal segment, a middle segment, and a proximal segment; a portion of food; and a food-transporting object selected from the group consisting of a fork, spoon, chop stick, drinking glass, beverage can, cup, mug, and bowl. In an example, the configurations and movements of a person's middle finger, ring finger, and little finger (pinky) can also be tracked.

FIGS. 54 through 94 also show examples of how this invention can be embodied in a method for identifying food consumption comprising: (1) receiving pictures from a wearable camera that is configured to be worn on a person's head or around their neck; and (2) analyzing these pictures in a data processor using gesture recognition in order to identify when the person is eating, wherein gestures associated with eating are recognized by tracking the configuration and movement of one or more objects selected from the group consisting of: the person's thumb comprising a distal segment and a proximal segment; the person's index finger comprising a distal segment, a middle segment, and a proximal segment; a portion of food; and a food-transporting object selected from the group consisting of a fork, spoon, chop stick, drinking glass, beverage can, cup, mug, and bowl. In an example, the configurations and movements of a person's middle finger, ring finger, and little finger (pinky) can also be tracked.

In an example, this invention can comprise creating a virtual model of a person's hand and its interaction with a portion of food and/or a food-transporting object such as a fork, spoon, knife, chop stick, glass, can, mug, or bowl. In an example, this virtual model can comprise virtual objects which correspond in size, shape, configuration, and movement to actual objects involved in eating. In an example, analysis of objects in this virtual model can be used to recognize gestures. In an example, virtual objects which correspond to segments of a person's hand can include segments of a virtual thumb and segments of a virtual index finger. In an example, these virtual objects can also include segments of a virtual middle finger, a virtual ring finger, and a virtual little finger (ie. “pinky”).

In an example, the configurations and movements of a virtual thumb, a virtual index finger, a virtual portion of food, and a virtual food-transporting object (as seen from a virtual camera) in a virtual model can represent, respectively, the configurations and movements of a person's actual thumb, a person's actual index finger, an actual portion of food, and an actual food-transporting object (as seen from the wearable camera). In an example, such a virtual model which is analyzed for gesture recognition can incorporate known features and dynamics of hand anatomy, physiology, and kinematics. In an example, known features and dynamics of hand anatomy such as phalange length and range of motion can be used to approximate the configuration of hand and finger segments, including those which are (partially) obscured from the view of a wearable camera.

In an example, eating-related gestures can be recognized by analyzing joint angles (and changes in those angles) between pairs of hand segments in a virtual model. In an example, eating-related gestures can be recognized by analyzing the joint angles between thumb segments, between index finger segments, and between thumb and index finger segments in a virtual model. In an example, an eating-related gesture can be recognized by identification of a specific array of joint angles between contiguous segment pairs in a virtual hand in a virtual model. In an example, an eating-related gesture can be recognized by identification of a specific matrix of joint angles in a virtual model.

In an example, identification and/or recognition of a specific joint angle matrix associated with a specific eating-related gesture can be done using one or more methods selected from the group consisting of: multivariate linear regression or least squares estimation; factor analysis; Fourier Transformation; mean; median; multivariate logit; principal components analysis; spline function; auto-regression; centroid analysis; correlation; covariance; decision tree analysis; kinematic modeling; Kalman filter; linear discriminant analysis; linear transform; logarithmic function; logit analysis; Markov model; multivariate parametric classifiers; non-linear programming; orthogonal transformation; pattern recognition; random forest analysis; spectroscopic analysis; variance; artificial neural network; Bayesian filter or other Bayesian statistical method; chi-squared; eigenvalue decomposition; logit model; machine learning; power spectral density; power spectrum analysis; and probit model.

In an example, this invention can be embodied in a wearable device for identifying food consumption which comprises: (1) a wearable camera that is configured to be worn on a person's head or around their neck; and (2) a data processor which uses gesture recognition to analyze the pictures taken by this camera in order to identify when the person is eating—(a) wherein eating-related gestures are recognized by creating a virtual model, as seen from the perspective of a virtual camera, comprising one or more objects selected from the group consisting of: a virtual thumb comprising a distal segment and a proximal segment; a virtual index finger comprising a distal segment, a middle segment, and a proximal segment; a virtual portion of food; and a virtual food-transporting object selected from the group consisting of a virtual fork, spoon, chop stick, drinking glass, beverage can, cup, mug, and bowl; and (b) wherein the configurations and movements of the one or more objects selected from the group consisting of the virtual thumb, the virtual index finger, the virtual portion of food, and the virtual food-transporting object (as seen from the virtual camera) represent, respectively, the configurations and movements of one or more actual objects selected from the group consisting of: the person's actual thumb, the person's actual index finger, an actual portion of food, and an actual food-transporting object (as seen from the perspective of the actual wearable camera).

In an example, an eating-related gesture can be recognized based on the configuration and movement of a person's thumb and index finger, as well as interaction among the thumb, index finger, and a portion of food. In an example, an eating-related gesture can be recognized based on the configuration and movement of a person's thumb and index finger, as well as interaction between the thumb, finger, and a food-transporting object (such as a fork, spoon, chop stick, drinking glass, beverage can, cup, mug, or bowl). In an example, an eating-related gesture can be recognized based on the configuration and movement of a person's thumb and index finger, as well as interaction among the thumb, finger, a portion of food, and a food-transporting object (such as a fork, spoon, chop stick, drinking glass, beverage can, cup, mug, or bowl). In an example, an eating-related gesture can be recognized based on the configuration and movement of a person's thumb and index finger, as well as interaction between the thumb and finger and a food-transporting object, and also interaction between the food-transporting object and a portion of food.

In an example, interaction between a person's hand and a portion of food can be selected from the group consisting of: reaching for food with thumb and index finger extended; grasping and/or holding a portion of food with the thumb and index finger; reaching for food with thumb and multiple fingers extended; grasping and/or holding a portion of food with the thumb and multiple other fingers (as in a first hold); moving food toward the mouth; hand and food rotation during movement toward the mouth; hand and food tilting during movement toward the mouth; and movement of the hand away from the mouth with less food than the hand held when it moved toward the mouth. In an example, an eating-related gesture can comprise: observing a person's hand move toward the person's mouth with a mass of food with a first size: and subsequently observing the hand move away from the person's mouth with a mass of food of a second size, wherein the second size is less than the first size. In an example, an eating-related gesture can comprise: observing a person's hand move toward the person's mouth with food: and subsequently observing the hand move away from the person's mouth without food.

In an example, interaction between a person's hand and a food-transporting object (such as a fork, spoon, knife, chop stick, glass, can, cup, mug, or bowl) can be selected from the group consisting of: reaching for the food-transporting object with thumb and finger extended; grasping and/or holding the food-transporting object with the thumb and index finger such that a handle of the object rests between (is visible between) the thumb and index finger; reaching for the food-transporting object with thumb and multiple fingers extended; grasping and/or holding the food-transporting object with the thumb and multiple fingers (as in a first hold) such that a handle of the object is obscured from view; reciprocal movement of a food-transporting object in contact with a main mass of food and separating a portion of food from the main mass; inserting and/or scooping a food-transporting object into a main mass of food and detaching a portion of food for transportation to the mouth; moving a food-transporting object toward the mouth; hand and object rotation during movement toward the mouth; hand and object tilting during movement toward the mouth; and movement of an object away from the mouth with less food than the object held when it moved toward the mouth.

In an example, interaction between a food-transporting object (such as a fork, spoon, knife, chop stick, glass, can, cup, mug, or bowl) and food can be selected from the group consisting of: pouring a beverage into a glass, can, cup, mug, or bowl; reciprocal movement of a knife or fork in contact with a main mass of food and separating a portion of food from the main mass; inserting a fork into a main mass of food and detaching a portion of food for transportation to the mouth; scooping a spoon into a main mass of food and detaching a portion of food for transportation to the mouth; moving a food-transporting object toward the mouth; hand and object rotation during movement toward the mouth; hand and object tilting during movement toward the mouth; and movement of an object away from the mouth with less food than the object held when it moved toward the mouth. In an example, an eating-related gesture can comprise: observing a a food-transporting object move toward the person's mouth with a mass of food with a first size: and subsequently observing the object move away from the person's mouth with a mass of food of a second size, wherein the second size is less than the first size. In an example, an eating-related gesture can comprise: observing a food-transporting object move toward the person's mouth with food: and subsequently observing the object move away from the person's mouth without food.

In an example, interactions between a person's hand and food, between a person's hand and a food-transporting object, or between a food-transporting object and food can be identified visually based on overlapping object from a camera's perspective. In an example, interactions between a person's hand and food, between a person's hand and a food-transporting object, or between a food-transporting object and food can be identified when a first object at least partially obscures the view of a second object from a camera's perspective. In an example, interactions between a person's hand and food, between a person's hand and a food-transporting object, or between a food-transporting object and food can be identified based on changes in object shading or lighting. In an example, interactions between a person's hand and food, between a person's hand and a food-transporting object, or between a food-transporting object and food can be identified based on changes in object size or compression.

For example, interaction between a thumb and an index finger can be visually recognized when they overlap. For example, interaction between a thumb and an index finger can be visually recognized when the thumb at least partially obscures the view of the index finger, or vice versa. For example, interaction between a hand and a portion of food can be visually recognized when they overlap. For example, interaction between a hand and a portion of food can be visually recognized when the hand at least partially obscures the view of the food, or vice versa. For example, interaction between a hand and a food-transporting object can be visually recognized when they overlap. For example, interaction between a hand and a food-transporting object be visually recognized when the hand at least partially obscures the (handle of) the food-transporting object, or vice versa. For example, interaction between a food-transporting object and food can be visually recognized when they overlap. For example, interaction between a food-transporting object and food be visually recognized when the object at least partially obscures the food, or vice versa.

In an example, the portion or percentage of a food-transporting object which is obscured by food from the perspective of a wearable camera can be calculated. In an example, the portion or percentage of the tines of a fork which are obscured by food from the perspective of a wearable camera can be calculated. In an example, the portion or percentage of the concave end of a spoon which is obscured by food from the perspective of a wearable camera can be calculated. In an example, one can calculate the difference between (a) the portion or percentage of a food-transporting object which is obscured by food during movement toward the mouth and (b) the portion or percentage of the food-transporting object which is obscured by food during subsequent movement away from the mouth. In an example, the percentage of (the end portion of) a food-transporting object which is obscured by food can be in the range of 0% to 50%. In an example, this percentage can be in the range of 0% to 90%.

In an example, movement of a hand, food, and/or food-transporting object toward a person's mouth can be recognized by an apparent increase in size from the perspective of a wearable camera which is near the person's mouth. This is more consistently true with a wearable camera which is worn at mouth level or above (such as a camera which is incorporated into eyewear, earware, or a head band). For a camera which is worn at a level below the mouth (such as a necklace camera) an object may first increase in size and then decrease in size as it moves toward the mouth.

In an example, movement of a hand, food, and/or food-transporting object away from a person's mouth can be recognized by an apparent decrease in size from the perspective of a wearable camera which is near the person's mouth. This is more consistently true with a wearable camera which is worn at mouth level or above (such as a camera which is incorporated into eyewear, earware, or a head band). For a camera which is worn at a level below the mouth (such as a necklace camera) an object may first increase in size and then decrease in size as it moves away from the mouth.

In an example, rotation or tilting of a hand, portion of food, and/or food-transporting object can be recognized by differences in size changes among segments or portions of the hand, food, and/or food-transporting object. For example, rotation can occur when a person extends their thumb and/or index finger away from their body to grasp food or a utensil and then draws the thumb and/or index finger toward their body to put food into their mouth. In an example, rotation can be recognized when the distal segment of a person's thumb or index finger increases more in apparent size than the proximal segment of the person's thumb and/or index finger, respectively, during movement toward the mouth. For example, tilting can occur when a person tips a glass, can, cup, mug, or bowl in order to bring contained liquid closer to the proximal portion of the glass, can, cup, mug, or bowl. In an example, tilting can be recognized when the upper portion of a glass, can, mug, or bowl increases more in apparent size than the lower portion of the glass, can, cup, mug, or bowl. Alternatively, tilting can be recognized by a change in the vertical axis of the apparent geometric shape of the top portion of a glass, can, cup, mug, or bowl—such a change in the vertical axis of an apparent ellipse or oval which comprises the top of the glass, can, cup, mug, or bowl.

In an example, an eating-related gesture can be recognized when a person grasps (a portion of) food with their hand and then brings this (portion of) food up to their mouth (toward a wearable camera). In an example, grasping food can be recognized visually when the person's thumb, index finger, or both at least partially obscure the view of the (portion of) food. In an example, a selected type of eating-related gesture can be recognized when: (a) the distal segment of the thumb and the distal segment of the index finger move toward each other; (b) at least one of these two distal segments at least partially obscures the view of a portion of food from the camera; and (c) then at least one of these two distal segments moves toward the camera. In an example, a selected type of eating-related gesture can be recognized when: (a) the distal segment of the thumb and the distal segment of the index finger move toward each other; (b) at least one of these two distal segments at least partially obscures the view of a portion of food from the camera; and (c) then at least one of these two distal segments increases in apparent size from the perspective of the camera. In an alternative example, this eating-related gesture can be recognized based on the same configurations and movements of virtual objects, wherein the virtual objects correspond to these actual objects.

In an example, an eating-related gesture can be recognized when (a portion of) food at least partially obscures the view of a person's thumb, index finger, or both. In an example, a selected type of eating-related gesture can be recognized when: (a) the distal segment of the thumb and the distal segment of the index finger move toward each other; (b) a portion of food at least partially obscures the view of at least one of these two distal segments from the camera; and (c) then the portion of food moves toward the camera. In an example, a selected type of eating-related gesture can be recognized when: (a) the distal segment of the thumb and the distal segment of the index finger move toward each other; (b) a portion of food at least partially obscures the view of at least one of these two distal segments from the camera; and (c) then the portion of food increases in apparent size from the perspective of the camera. In an alternative example, this eating-related gesture can be recognized based on the same configurations and movements of virtual objects, wherein the virtual objects correspond to these actual objects.

In an example, at least one of the eating-related gestures which is recognized by the device can occur when a person grasps (a portion of) food with their hand and then brings (the portion of) food up to their mouth, wherein the person's hand is rotated as it approaches the mouth. Hand rotation can be recognized by a greater increase in the apparent size of the distal segment of a thumb or finger relative to the increase in the apparent size of the proximal segment of a thumb or finger. In an example, a selected type of eating-related gesture can be recognized when: (a) the distal segment of the thumb and the distal segment of the index finger move toward each other; (b) a portion of food at least partially obscures the view of at least one of these two distal segments from the camera; and (c) then the portion of food moves toward the camera, during which movement at least one of these two distal segments increases in apparent size, from the perspective of the camera, more than the increase in apparent size of the proximal segment of the same object. In an alternative example, this eating-related gesture can be recognized based on the same configurations and movements of virtual objects, wherein the virtual objects correspond to these actual objects.

In an example, a selected type of eating-related gesture with hand rotation can be recognized when: (a) the distal segment of the thumb and the distal segment of the index finger move toward each other; (b) a portion of food at least partially obscures the view of at least one of these two distal segments from the camera; and (c) then the portion of food moves toward the camera, during which movement at least one of these two distal segments moves closer to the camera than the proximal segment of the same object. In an example, a selected type of eating-related gesture can be recognized when: (a) the distal segment of the thumb and the distal segment of the index finger move toward each other; (b) a portion of food at least partially obscures the view of at least one of these two distal segments from the camera; and (c) then the portion of food moves toward the camera, during which movement at least one of these two distal segments moves a greater distance than the proximal segment of the same object. In an alternative example, this eating-related gesture can be recognized based on the same configurations and movements of virtual objects, wherein the virtual objects correspond to these actual objects.

In an example, an eating-related gesture can involve interaction between a person's hand and a food-transporting object such as a fork, spoon, chop stick, drinking glass, beverage can, cup, mug, or bowl. In an example, this interaction can involve grasping the object. In an example, this interaction can involve moving the object into contact with (a portion of) food. In an example, this interaction can involve moving the object toward the mouth. In an example, this interaction can involve rotating or tipping the object as it is moved toward the mouth. In an example, a selected type of eating-related gesture can be recognized when: (a) the distal segment of the thumb and the distal segment of the index finger move toward each other; (b) the distal segment of the thumb at least partially obscures the view of the handle of a fork, spoon, or chop stick from the camera; and (c) then the fork, spoon, or chop stick moves toward the camera. In an example, a selected type of eating-related gesture can be recognized when: (a) the distal segment of the thumb and the distal segment of the index finger move toward each other; (b) the distal segment of the thumb at least partially obscures the view of the handle of a fork, spoon, or chop stick from the camera; and (c) then the fork, spoon, or chop stick increases in apparent size from the perspective of the camera. In an alternative example, this eating-related gesture can be recognized based on the same configurations and movements of virtual objects, wherein the virtual objects correspond to these actual objects.

In an example, a selected type of eating-related gesture can be recognized when: (a) the distal segment of the thumb and the distal segment of the index finger move toward each other; (b) the distal segment of the thumb at least partially obscures the view of the handle of a fork, spoon, or chop stick from the camera; and (c) then the fork, spoon, or chop stick moves toward the camera, during which movement the distal segment of the thumb moves closer to the camera than the proximal segment of the thumb. In an example, a selected type of eating-related gesture can be recognized when: (a) the distal segment of the thumb and the distal segment of the index finger move toward each other; (b) the distal segment of the thumb at least partially obscures the view of the handle of a fork, spoon, or chop stick from the camera; and (c) then the fork, spoon, or chop stick moves toward the camera, during which movement the distal segment of the thumb moves a greater distance than the proximal segment of the thumb. In an alternative example, this eating-related gesture can be recognized based on the same configurations and movements of virtual objects, wherein the virtual objects correspond to these actual objects.

In an example, a selected type of eating-related gesture can be recognized when: (a) the distal segment of the thumb at least partially obscures the view of the handle of a fork, spoon, or chop stick from the camera; (b) the fork, spoon, or chop stick moves from right to left, or vice versa, across a portion of the field of view of the camera; and (c) then the fork, spoon, or chop stick moves toward the camera. In an example, a selected type of eating-related gesture can be recognized when: (a) the distal segment of the thumb at least partially obscures the view of the handle of a fork, spoon, or chop stick from the camera; (b) the fork, spoon, or chop stick moves from right to left, or vice versa, across a portion of the field of view of the camera; and (c) then the fork, spoon, or chop stick moves toward the camera, during which movement the distal segment of the thumb moves closer to the camera than the proximal segment of the thumb. In an example, a selected type of eating-related gesture can be recognized when: (a) the distal segment of the thumb at least partially obscures the view of the handle of a fork, spoon, or chop stick from the camera; (b) the fork, spoon, or chop stick moves from right to left, or vice versa, across a portion of the field of view of the camera; and (c) then the fork, spoon, or chop stick moves toward the camera, during which movement the distal segment of the thumb moves a greater distance than the proximal segment of the thumb. In an alternative example, this eating-related gesture can be recognized based on the same configurations and movements of virtual objects, wherein the virtual objects correspond to these actual objects.

In an example, a selected type of eating-related gesture can be recognized when: (a) the distal segment of the thumb and the distal segment of the index finger move toward each other; (b) the distal segment of the thumb at least partially obscures the view of a drinking glass, beverage can, cup, or bowl from the camera; and (c) then the drinking glass, beverage can, cup, or bowl moves toward the camera. In an example, a selected type of eating-related gesture can be recognized when: (a) the distal segment of the thumb and the distal segment of the index finger move toward each other; (b) the distal segment of the thumb at least partially obscures the view of a drinking glass, beverage can, cup, or bowl from the camera; and (c) then the drinking glass, beverage can, cup, or bowl moves toward the camera, during which movement the distal segment of the index finger moves a greater distance than the distal segment of the thumb. In an example, a selected type of eating-related gesture can be recognized when: (a) the distal segment of the thumb and the distal segment of the index finger move toward each other; (b) the distal segment of the thumb at least partially obscures the view of a drinking glass, beverage can, cup, or bowl from the camera; and (c) then the drinking glass, beverage can, cup, or bowl moves toward the camera, during which movement the top of the drinking glass, beverage can, cup, or bowl tilts toward the camera. In an alternative example, this eating-related gesture can be recognized based on the same configurations and movements of virtual objects, wherein the virtual objects correspond to these actual objects.

In an example, this device can estimate the amount of food that a person consumes (during a selected period of time) based on the number, frequency, and/or timing of repeated eating-related gestures. In an example, this device can estimate the amount of food that a person consumes (during a selected period of time) based on Fourier Transformation analysis of the timing of repeated eating-related gestures. In an example, Fourier Transformation analysis of the timing of repeated gestures can be used to confirm that these gestures are repeated eating-related gestures rather than some other type of repeated gestures (such as brushing teeth, smoking, coughing, sneezing, playing a musical instrument, adjusting eyeglasses, or hand motions accompanying animated conversation).

In an example, gesture recognition can employ one or more statistical methods selected from the group consisting of: multivariate linear regression or least squares estimation; factor analysis; Fourier Transformation; mean; median; multivariate logit; principal components analysis; spline function; auto-regression; centroid analysis; correlation; covariance; decision tree analysis; kinematic modeling; Kalman filter; linear discriminant analysis; linear transform; logarithmic function; logit analysis; Markov model; multivariate parametric classifiers; non-linear programming; orthogonal transformation; pattern recognition; random forest analysis; spectroscopic analysis; variance; artificial neural network; Bayesian filter or other Bayesian statistical method; chi-squared; eigenvalue decomposition; logit model; machine learning; power spectral density; power spectrum analysis; and probit model.

In an example, this device can recognize (a portion of) food using pattern recognition. In an example, this device can recognize (a portion of) food using a combination of visual cues or features. In an example, this device can recognize (a portion of) food based on one or more visual cues or features selected from the group consisting of: shape, size, color, shading, lighting, reflectivity, light spectrum distribution, texture, movement, compression, co-located objects or food, geographic location, type of food-transporting object used, shape of packaging or container, size of packaging or container, color packaging or container, design of packaging or container, logo of packaging or container, and identification code on packaging or container. In an example, this device can recognize food (in general) when the device is used for identifying food consumption in general. In an example, this device can recognize specific types of food if the device is also used to identify and measure consumption of specific types of food.

In an example, food recognition can employ one or more statistical methods selected from the group consisting of: multivariate linear regression or least squares estimation; factor analysis; Fourier Transformation; mean; median; multivariate logit; principal components analysis; spline function; auto-regression; centroid analysis; correlation; covariance; decision tree analysis; kinematic modeling; Kalman filter; linear discriminant analysis; linear transform; logarithmic function; logit analysis; Markov model; multivariate parametric classifiers; non-linear programming; orthogonal transformation; pattern recognition; random forest analysis; spectroscopic analysis; variance; artificial neural network; Bayesian filter or other Bayesian statistical method; chi-squared; eigenvalue decomposition; logit model; machine learning; power spectral density; power spectrum analysis; and probit model.

In an example, there can be changes in food mass between sequential gestures. In an example, food can be observed during a first portion of a gesture when a hand is moving toward a person's mouth and food can be gone (presumably eaten) during a second portion of a gesture when a hand is moving away from a person's mouth. In an example, there can be reduction in apparent food mass in sequential gestures when a mass of food held in a hand requires several bites to consume completely.

In an example, changes in the attributes of a portion of food between sequential gestures can be used to confirm that the gestures comprise eating behavior and/or to better estimate the amount of food consumed. In an example, changes in the shape, size, color, shading, lighting, reflectivity, light spectrum distribution, and/or texture of a portion of food between sequential gestures can be used to confirm eating behavior and/or better estimate the amount of food consumed. In an example, decreases in the size of a portion of food between gestures can be used to confirm eating behavior and/or better estimate the amount of food consumed.

In an example, changes in the attributes of a portion of food between hand movement toward a person's mouth and hand movement away from the person's mouth can be used to confirm that a gesture is eating behavior and/or to better estimate the amount of food consumed. In an example, changes in the shape, size, color, shading, lighting, reflectivity, light spectrum distribution, and/or texture of a portion of food between movement toward a person's mouth and movement away from a person's mouth can be used to confirm that a gesture is eating behavior and/or to better estimate the amount of food consumed. In an example, decreases in the size of a portion of food between movement toward a person's mouth and movement away from a person's mouth can be used to confirm that a gesture is eating behavior and/or to better estimate the amount of food consumed.

In an example, a wearable camera can be a part of (or attached to) eyeglasses. In an example, a wearable camera can be a part of (or attached to) a visor. In an example, a wearable camera can be a part of Augmented Reality (AR) or Virtual Reality (VR) eyewear. In an example, a wearable camera can be worn around or behind a person's ear like a hearing aid. In an example, a wearable camera can be inserted into a person's ear in a manner like an ear bud or ear plug. In an example, a wearable camera can be worn on a person's ear like an ear ring. In an example, a wearable camera can be part of a set of headphones. In an example, a wearable camera can be part of a nose ring. In an example, a wearable camera can be worn on a necklace, chain, or collar around a person's neck. In an example, a wearable camera can be worn on a necklace like a pendant. In an example, a wearable camera can be part of a hair comb, hair band, or mobile EEG monitor. In an example, a wearable camera can be part of a hat or cap. In various examples, a wearable camera can be: part of eyewear; worn on, in, or around an ear; part of a necklace or pendant; or worn on a collar.

In an example, a wearable camera can record video pictures. In an example, a wearable camera can record (one or a series of) still pictures. In an example, a wearable camera can have a focal direction mechanism which adjusts the camera's focal direction so as to keep a person's hand in its field of view (if possible). In an example, a wearable camera can have a focal distance mechanism which adjusts the camera's focal distance so as to keep a person's hand in focus (if possible). In an example, this device can be part of a system which further comprises a wrist band and/or object attached to a person's hand which helps a wearable camera to track the location of the person's hand for gesture recognition purposes.

In an example, a device can analyze the space surrounding a person's hand to identify any proximal food objects (or food-transporting objects) and any potential interaction between the person's hand and those food objects (or food-transporting objects). In an example, a wearable camera can record pictures continually. In an example, a wearable camera can be triggered to start taking pictures when data from another type of wearable sensor and/or an environmental cue indicates that a person is likely to be eating (or will start eating soon). In an example, another type of wearable sensor can be triggered to start collecting data when analysis of pictures from a wearable camera indicates that a person is eating (or will start eating soon).

In an example, this device can be part of a multi-sensor system for identifying food consumption and tracking caloric intake. In an example, this device can be part of a system for identifying food consumption which further comprises one or more other wearable sensors selected from the group consisting of: EMG sensor; bending-based motion sensor; accelerometer; gyroscope; inclinometer; vibration sensor; gesture-recognition interface; goniometer; strain gauge; stretch sensor; pressure sensor; flow sensor; air pressure sensor; altimeter; blood flow monitor; blood pressure monitor; global positioning system (GPS) module; compass; skin conductance sensor; impedance sensor; Hall-effect sensor; electrochemical sensor; electrocardiography (ECG) sensor; electroencephalography (EEG) sensor; electrogastrography (EGG) sensor; electromyography (EMG) sensor; electrooculography (EOG); cardiac function monitor; heart rate monitor; pulmonary function and/or respiratory function monitor; light energy sensor; ambient light sensor; infrared sensor; optical sensor; ultraviolet light sensor; photoplethysmography (PPG) sensor; camera; video recorder; spectroscopic sensor; light-spectrum-analyzing sensor; near-infrared, infrared, ultraviolet, or white light spectroscopy sensor; mass spectrometry sensor; Raman spectroscopy sensor; sound sensor; microphone; speech and/or voice recognition interface; chewing and/or swallowing monitor; ultrasound sensor; thermal energy sensor; skin temperature sensor; blood glucose monitor; blood oximeter; body fat sensor; caloric expenditure monitor; caloric intake monitor; glucose monitor; humidity sensor; and pH level sensor.

In an example, in addition to a wearable camera and data processor, this device can further comprise one or more components selected from the group consisting of: a battery or other power source; a kinetic or thermal energy transducer; a wireless data transmitter; a wireless data receiver; a microphone; a speaker; a separate spectroscopic sensor or other optical sensor; a keypad, button, and/or turn knob; and a tactile-sensation-creating member. In an example, a data processor can be located in the same housing as a wearable camera. In an example, a data processor can be in a separate (and remote) location. In an example, a data processor can be in wireless communication with a wearable camera.

FIGS. 54 through 56 show three examples of how this invention can be embodied in a wearable device for identifying food consumption comprising: (1) a wearable camera that is configured to be worn on a person's head or around their neck; and (2) a data processor which uses gesture recognition to analyze the pictures taken by this camera in order to identify when the person is eating—wherein selected eating-related gestures are recognized by tracking the configuration and movement of one or more objects selected from the group consisting of: the person's thumb comprising a distal segment and a proximal segment; the person's index finger comprising a distal segment, a middle segment, and a proximal segment; a portion of food; and a food-transporting object selected from the group consisting of a fork, spoon, chop stick, drinking glass, beverage can, cup, mug, and bowl. In FIG. 54, the wearable camera is part of eyewear. In FIG. 55, the wearable camera is part of earwear. In FIG. 56, the wearable camera is worn around the neck. Relevant variations from the introductory section can apply to these three examples.

Specifically, the example shown in FIG. 54 comprises: wearable camera 5401; data processor 5402; and eyewear 5403. In this example, wearable camera 5401 is a video camera which records pictures of objects in the space immediately in front of the person, thereby capturing pictures of eating-related gestures by the person's hand. In this example, data processor 5402 analyzes these pictures in order to recognize eating-related gestures. In this example, eyewear 5403 is a pair of eyeglasses.

Specifically, the example shown in FIG. 55 comprises: wearable camera 5501; data processor 5502; and earware 5503. In this example, wearable camera 5501 is a video camera which records pictures of objects in the space immediately in front of the person, thereby capturing pictures of eating-related gestures by the person's hand. In this example, data processor 5502 analyzes these pictures in order to recognize eating-related gestures. In this example, earware 5503 is an ear ring.

Specifically, the example shown in FIG. 56 comprises: wearable camera 5601; data processor 5602; and necklace 5603. In this example, wearable camera 5601 is a video camera which records pictures of objects in the space immediately in front of the person, thereby capturing pictures of eating-related gestures by the person's hand. In this example, data processor 5602 analyzes these pictures in order to recognize eating-related gestures. In this example, wearable camera 5501 and data processor 5502 are attached, like a pendant, to necklace 5603.

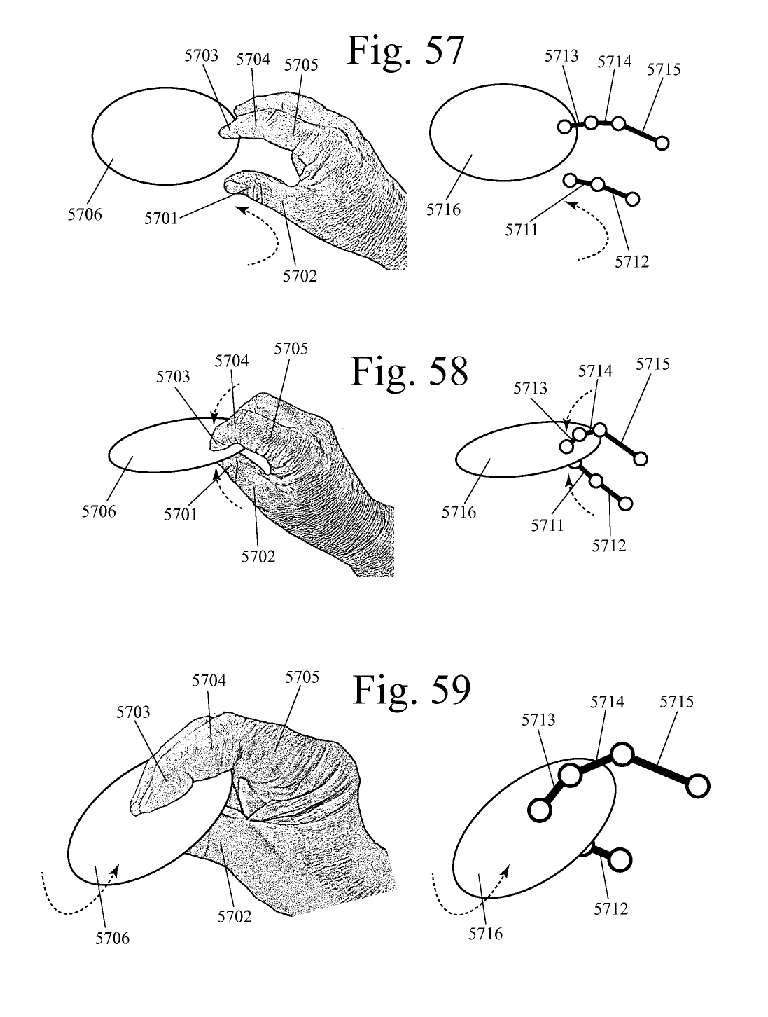

FIGS. 57 through 59 show three sequential views of an example of how an eating-related gesture can be modeled and recognized. The left sides of these three sequential figures show the configurations and movements of a person's hand as the person grasps food and brings the food up toward their mouth. The right sides of these three sequential figures show corresponding views of a virtual model of the person's hand and the portion of food. The right-side virtual components of the virtual model reflect the configurations and movements of the corresponding left-side actual objects. FIG. 57 shows this example at a first point in time when the person is reaching for a portion of food 5706. FIG. 58 shows this example at a second point in time when the person is grasping the portion of food 5706. FIG. 59 shows this example at a third point in time when the person is bringing the portion of food 5706 up toward their mouth.

In this example, the left-side actual objects which are tracked include: the distal segment of the person's thumb 5701; the proximal segment of the person's thumb 5702; the distal segment of the person's index finger 5703; the middle segment of the person's index finger 5704; the proximal segment of the person's index finger 5705; and a portion of food 5706. In this example, the right-side virtual objects which are modeled and tracked include: the distal segment of a virtual thumb 5711; the proximal segment of the a virtual thumb 5712; the distal segment of a virtual index finger 5713; the middle segment of a virtual index finger 5714; the proximal segment of a virtual index finger 5715; and a virtual portion of food 5716. The configurations and movements of the virtual thumb, virtual index finger, and virtual portion of food represent, respectively, the configurations and movements of a person's actual thumb, the person's actual index finger, and the actual portion of food. A virtual model can incorporate known features of hand anatomy, hand physiology, and body kinematics. Interaction between a virtual hand and a virtual food can be modeled and analyzed.

In this example, a portion of food is disk shaped (like a cookie or a chip). In other examples, a portion of food can have other shapes. In this specific gesture, a person grasps food with the distal segments of their thumb and index finger. In other gestures, a person can grasp a portion of food with all of their fingers (as in a first hold). In this specific gesture, a person rotates their hand as they bring a portion of food up to their mouth. In other gestures, a person might not rotate their hand. In this specific gesture, a person grasps food with their thumb on the far (or lower) surface of a portion of food and their index finger on the near (or upper) surface of the portion of food. In other gestures, this can be reversed. In this specific gesture, the orientation of a portion of food is maintained as it is brought up to the person's mouth. In other gestures, the orientation of a portion of food can be flipped as it is brought up to the person's mouth.

In an example, an eating-related gesture can be recognized when a person grasps (a portion of) food with their hand and then brings this (portion of) food up to their mouth (toward a wearable camera). In an example, grasping food can be recognized visually when a person's thumb, index finger, or both at least partially obscure the view of a (portion of) food. In an example, interaction between objects in the field of vision of a wearable camera can be visually recognized when a first object overlaps a second object. In an example, interaction between a thumb and an index finger can be visually recognized when the thumb and index finger overlap each other. In an example, interaction between a thumb and portion of food can be visually recognized when the thumb overlaps the portion of food, or vice versa.

In an example, overlap between objects in the field of vision of a wearable camera can be visually recognized when a first object partially obscures the view of a second object. In an example, overlap between objects in the field of vision of a wearable camera can be visually recognized when a first object shades (or otherwise modifies light patterns on) a second object. In an example, overlap between objects in the field of vision of a wearable camera can be visually recognized when proximity between a first object and a second object causes a change in shape of one or both of the objects.

In an example, movement of an object toward a person's mouth can be recognized by an apparent increase in object size (from the perspective of a wearable camera which is near the person's mouth). In an example, an apparent increase in the size of a person's thumb and/or index finger can indicate that the person's hand is moving toward their mouth. In an example, an apparent increase in the size of a portion of food can indicate that the portion of food is moving toward a person's mouth. This is more consistently true for a camera which is worn at, or above, mouth level—such as a wearable camera which is part of eyewear, earwear, or a hair band. With a camera worn around the neck, the apparent size of a hand or food can first increase and then slightly decrease during movement of a hand or food toward a mouth.

In an example, movement of an object away from a person's mouth can be recognized by an apparent decrease in object size (from the perspective of a wearable camera which is near the person's mouth). In an example, an apparent decrease in the size of a person's thumb and/or index finger can indicate that the person's hand is moving away from their mouth. In an example, an apparent decrease in the size of a portion of food can indicate that a portion of food is moving away from a person's mouth. This is more consistently true for a camera which is worn at, or above, mouth level—such as a wearable camera which is part of eyewear, earwear, or a hair band. With a camera worn around the neck, the apparent size of a hand or food can first slightly increase and then decrease during movement of a hand or food away from a mouth.

In an example, differences in apparent size changes of different objects (or object segments) during movement can indicate hand rotation during movement. For example, hand rotation can occur when a person extends their thumb and index finger away from their body to grasp food and then draws their thumb and index finger toward their body to bring the food into their mouth. When the distal segment of a person's thumb increases in apparent size more so than the proximal segment of the person's thumb, then this can indicate hand rotation as the hand moves toward the person's mouth. When a distal segment of a person's index finger increases in apparent size more than the proximal segment of the index finger, then this can indicate hand rotation as the hand moves toward the person's mouth.

Specifically, FIGS. 57 through 59 show an example of how a selected eating-related gesture can be recognized when: (a) the distal segment of a thumb 5701 and the distal segment of an index finger 5703 move toward each other; (b) at least one of these two distal segments 5703 at least partially obscures the view of a portion of food 5706 from a camera; and (c) then at least one of these two distal segments 5703 moves toward the camera. Similarly, FIGS. 57 through 59 show an example of how a selected type of eating-related gesture can be recognized when: (a) the distal segment of the thumb 5701 and the distal segment of the index finger 5703 move toward each other; (b) at least one of these two distal segments 5703 at least partially obscures the view of a portion of food 5706 from a camera; and (c) then at least one of these two distal segments 5703 increases in apparent size from the perspective of the camera. Alternatively, this gesture can be recognized when a portion of food 5706 obscures the thumb or finger.

In an alternative example, this eating-related gesture can be recognized based on equivalent configurations and movements of virtual objects, wherein the virtual objects correspond to actual objects. Specifically, the right sides of FIGS. 57 through 59 show an example of how a selected eating-related gesture can be recognized when: (a) the distal segment of a virtual thumb 5711 and the distal segment of a virtual index finger 5713 move toward each other; (b) at least one of these two distal segments 5713 at least partially obscures the view of a virtual portion of food 5716 from a virtual camera; and (c) then at least one of these two distal segments 5713 moves toward the virtual camera. Similarly, FIGS. 57 through 59 show an example of how a selected type of eating-related gesture can be recognized when: (a) the distal segment of a virtual thumb 5711 and the distal segment of a virtual index finger 5713 move toward each other; (b) at least one of these two distal segments 5713 at least partially obscures the view of a virtual portion of food 5716 from a virtual camera; and (c) then at least one of these two distal segments 5713 increases in apparent size from the perspective of the virtual camera. Alternatively, this gesture can be recognized when a virtual portion of food 5716 obscures a virtual thumb or virtual finger.

The example shown in FIGS. 57 through 59 also shows how recognition of an eating-related gesture can include recognition of hand rotation. In this example, a selected type of eating-related gesture with hand rotation can be recognized when: (a) the distal segment of the thumb 5701 and the distal segment of the index finger 5703 move toward each other; (b) a portion of food 5706 at least partially obscures the view of at least one of these two distal segments 5701 from a camera; and (c) then the portion of food 5706 moves toward the camera, during which movement at least one of these two distal segments 5703 moves closer to the camera than the proximal segment of the same object 5705. In an example, a selected type of eating-related gesture can be recognized when: (a) the distal segment of the thumb and the distal segment of the index finger move toward each other; (b) a portion of food at least partially obscures the view of at least one of these two distal segments from the camera; and (c) then the portion of food moves toward the camera, during which movement at least one of these two distal segments moves a greater distance than the proximal segment of the same object.

In an alternative example, this eating-related gesture can be recognized based on equivalent configurations and movements of virtual objects, wherein the virtual objects correspond to these actual objects. In an example, a selected type of eating-related gesture with hand rotation can be recognized when: (a) the distal segment of a virtual thumb 5711 and the distal segment of a virtual index finger 5713 move toward each other; (b) a virtual portion of food 5716 at least partially obscures the view of at least one of these two distal segments 5711 from a virtual camera; and (c) then the virtual portion of food 5716 moves toward the camera, during which movement at least one of these two distal segments 5713 moves closer to the virtual camera than the proximal segment of the same object 5715.

In an example, this device can estimate the amount of food that a person consumes (during a selected period of time) based on the number, frequency, and/or timing of repeated eating-related gestures. In an example, this device can estimate the amount of food that a person consumes (during a selected period of time) based on Fourier Transformation analysis of the timing of repeated eating-related gestures. In an example, Fourier Transformation analysis of the timing of repeated gestures can be used to confirm that these gestures are repeated eating-related gestures rather than some other type of repeated gestures (such as brushing teeth, smoking, coughing, sneezing, playing a musical instrument, adjusting eyeglasses, or hand motions accompanying animated conversation).

In an example, gesture recognition can employ one or more statistical methods selected from the group consisting of: multivariate linear regression or least squares estimation; factor analysis; Fourier Transformation; mean; median; multivariate logit; principal components analysis; spline function; auto-regression; centroid analysis; correlation; covariance; decision tree analysis; kinematic modeling; Kalman filter; linear discriminant analysis; linear transform; logarithmic function; logit analysis; Markov model; multivariate parametric classifiers; non-linear programming; orthogonal transformation; pattern recognition; random forest analysis; spectroscopic analysis; variance; artificial neural network; Bayesian filter or other Bayesian statistical method; chi-squared; eigenvalue decomposition; logit model; machine learning; power spectral density; power spectrum analysis; and probit model.

In an example, this device can recognize (a portion of) food using pattern recognition. In an example, this device can recognize (a portion of) food using a combination of visual cues or features. In an example, this device can recognize (a portion of) food based on one or more visual cues or features selected from the group consisting of: shape, size, color, shading, lighting, reflectivity, light spectrum distribution, texture, movement, co-located objects or food, geographic location, type of food-transporting object used, shape of packaging or container, size of packaging or container, color packaging or container, design of packaging or container, logo of packaging or container, and identification code on packaging or container. In an example, this device can recognize food (in general) when the device is used for identifying food consumption in general. In an example, this device can recognize specific types of food if the device is also used to identify and measure consumption of specific types of food.

In an example, food recognition can employ one or more statistical methods selected from the group consisting of: multivariate linear regression or least squares estimation; factor analysis; Fourier Transformation; mean; median; multivariate logit; principal components analysis; spline function; auto-regression; centroid analysis; correlation; covariance; decision tree analysis; kinematic modeling; Kalman filter; linear discriminant analysis; linear transform; logarithmic function; logit analysis; Markov model; multivariate parametric classifiers; non-linear programming; orthogonal transformation; pattern recognition; random forest analysis; spectroscopic analysis; variance; artificial neural network; Bayesian filter or other Bayesian statistical method; chi-squared; eigenvalue decomposition; logit model; machine learning; power spectral density; power spectrum analysis; and probit model.

In an example, there can be changes in food mass between sequential gestures. In an example, food can be observed during a first portion of a gesture when a hand is moving toward a person's mouth and food can be gone (presumably eaten) during a second portion of a gesture when a hand is moving away from a person's mouth. In an example, there can be reduction in apparent food mass in sequential gestures when the mass of food held in a hand requires several bites to consume.

In an example, changes in the attributes of a portion of food between sequential gestures can be used to confirm that the gestures comprise eating behavior and/or to better estimate the amount of food consumed. In an example, changes in the shape, size, color, shading, lighting, reflectivity, light spectrum distribution, and/or texture of a portion of food between sequential gestures can be used to confirm eating behavior and/or better estimate the amount of food consumed. In an example, decreases in the size of a portion of food between gestures can be used to confirm eating behavior and/or better estimate the amount of food consumed.

In an example, changes in the attributes of a portion of food between hand movement toward a person's mouth and hand movement away from the person's mouth can be used to confirm that a gesture is eating behavior and/or to better estimate the amount of food consumed. In an example, changes in the shape, size, color, shading, lighting, reflectivity, light spectrum distribution, and/or texture of a portion of food between movement toward a person's mouth and movement away from a person's mouth can be used to confirm that a gesture is eating behavior and/or to better estimate the amount of food consumed. In an example, decreases in the size of a portion of food between movement toward a person's mouth and movement away from a person's mouth can be used to confirm that a gesture is eating behavior and/or to better estimate the amount of food consumed.

In an example, a wearable camera can be a part of (or attached to) eyeglasses. In an example, a wearable camera can be a part of (or attached to) a visor. In an example, a wearable camera can be a part of Augmented Reality (AR) or Virtual Reality (VR) eyewear. In an example, a wearable camera can be worn around or behind a person's ear like a hearing aid. In an example, a wearable camera can be inserted into a person's ear in a manner like an ear bud or ear plug. In an example, a wearable camera can be worn on a person's ear like an ear ring. In an example, a wearable camera can be part of a set of headphones. In an example, a wearable camera can be part of a nose ring. In an example, a wearable camera can be worn on a necklace, chain, or collar around a person's neck. In an example, a wearable camera can be worn on a necklace like a pendant. In an example, a wearable camera can be part of a hair comb, hair band, or mobile EEG monitor. In an example, a wearable camera can be part of a hat or cap. In various examples, a wearable camera can be: part of eyewear; worn on, in, or around an ear; part of a necklace or pendant; or worn on a collar.

In an example, a wearable camera can record video pictures. In an example, a wearable camera can record (one or a series of) still pictures. In an example, a wearable camera can have a focal direction mechanism which adjusts the camera's focal direction so as to keep a person's hand in its field of view (if possible). In an example, a wearable camera can have a focal distance mechanism which adjusts the camera's focal distance so as to keep a person's hand in focus (if possible). In an example, this device can be part of a system which further comprises a wrist band and/or object attached to a person's hand which helps a wearable camera to track the location of the person's hand for gesture recognition purposes.

In an example, a device can analyze space surrounding a person's hand to identify any proximal food objects (or food-transporting objects) and any potential interaction between the person's hand and those food objects (or food-transporting objects). In an example, a wearable camera can record pictures continually. In an example, a wearable camera can be triggered to start taking pictures when data from another type of wearable sensor and/or an environmental cue indicates that a person is likely to be eating (or will start eating soon). In an example, another type of wearable sensor can be triggered to start collecting data when analysis of pictures from a wearable camera indicates that a person is eating (or will start eating soon).

In an example, this device can be part of a multi-sensor system for identifying food consumption (and tracking caloric intake). In an example, this device can be part of a system for identifying food consumption which further comprises one or more other wearable sensors selected from the group consisting of: EMG sensor; bending-based motion sensor; accelerometer; gyroscope; inclinometer; vibration sensor; gesture-recognition interface; goniometer; strain gauge; stretch sensor; pressure sensor; flow sensor; air pressure sensor; altimeter; blood flow monitor; blood pressure monitor; global positioning system (GPS) module; compass; skin conductance sensor; impedance sensor; Hall-effect sensor; electrochemical sensor; electrocardiography (ECG) sensor; electroencephalography (EEG) sensor; electrogastrography (EGG) sensor; electromyography (EMG) sensor; electrooculography (EOG); cardiac function monitor; heart rate monitor; pulmonary function and/or respiratory function monitor; light energy sensor; ambient light sensor; infrared sensor; optical sensor; ultraviolet light sensor; photoplethysmography (PPG) sensor; camera; video recorder; spectroscopic sensor; light-spectrum-analyzing sensor; near-infrared, infrared, ultraviolet, or white light spectroscopy sensor; mass spectrometry sensor; Raman spectroscopy sensor; sound sensor; microphone; speech and/or voice recognition interface; chewing and/or swallowing monitor; ultrasound sensor; thermal energy sensor; skin temperature sensor; blood glucose monitor; blood oximeter; body fat sensor; caloric expenditure monitor; caloric intake monitor; glucose monitor; humidity sensor; and pH level sensor.

In an example, in addition to a wearable camera and data processor, this device can further comprise one or more components selected from the group consisting of: a battery or other power source; a kinetic or thermal energy transducer; a wireless data transmitter; a wireless data receiver; a microphone; a speaker; a separate spectroscopic sensor or other optical sensor; a keypad, button, and/or turn knob; and a tactile-sensation-creating member. In an example, a data processor can be located in the same housing as a wearable camera. In an example, a data processor can be in a separate (and remote) location. In an example, a data processor can be in wireless communication with a wearable camera.

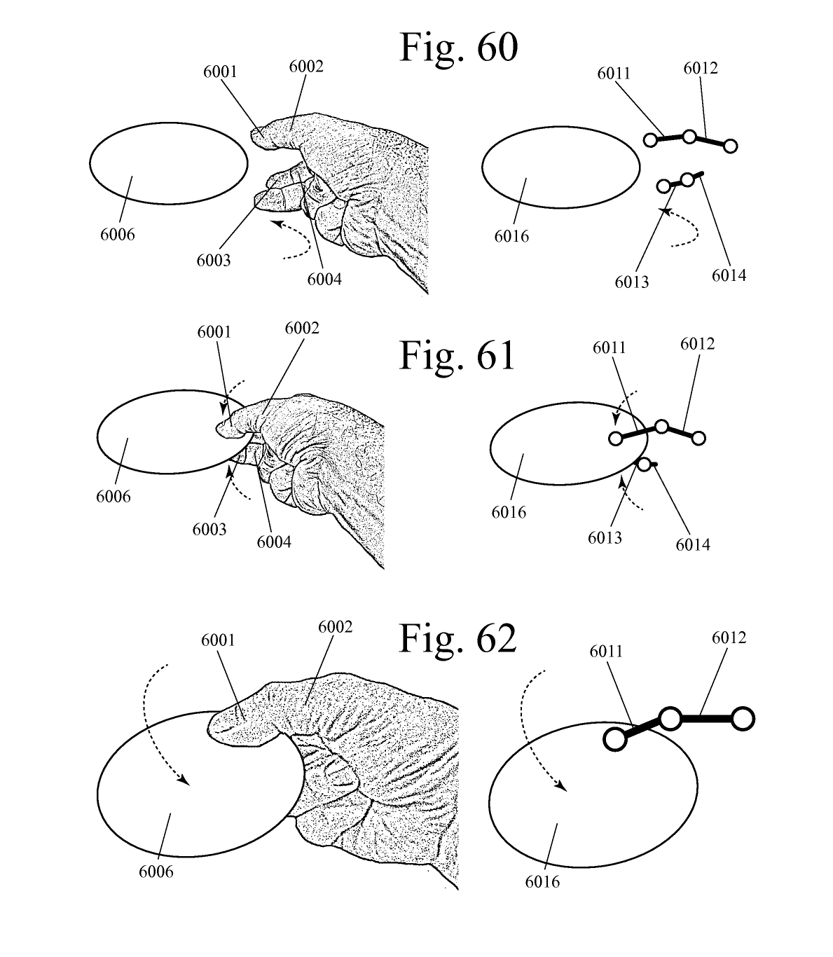

FIGS. 60 through 62 show another example of how an eating-related gesture can be modeled and recognized. This example is like the one shown in FIGS. 57 through 59 except that now the thumb is on the near (or upper) surface of a portion of food and the index finger is on the far (or lower) surface of the portion of food. FIGS. 60 through 62 show three sequential views. The left sides show a person's hand as the person grasps food and brings the food up toward their mouth. The right sides show corresponding views of a virtual model of the person's hand and the portion of food. FIG. 60 shows this example when the person is reaching for a portion of food 6006. FIG. 61 shows this example when the person is grasping the portion of food 6006. FIG. 62 shows this example when the person is bringing the portion of food 6006 up toward their mouth. Relevant embodiment variations from the introductory section and discussions of other figures can be applied to this example.

In this example, left-side actual objects which are visible and tracked include: the distal segment of the person's thumb 6001; the proximal segment of the person's thumb 6002; the distal segment of the person's index finger 6003; the middle segment of the person's index finger 6004; and a portion of food 6006. In this example, right-side virtual objects which are tracked include: the distal segment of a virtual thumb 6011; the proximal segment of the a virtual thumb 6012; the distal segment of a virtual index finger 6013; the middle segment of a virtual index finger 6014; and a virtual portion of food 6016.

In this example, a portion of food is disk shaped (like a cookie or a chip). In other examples, a portion of food can have other shapes. In this specific gesture, a person grasps food with the distal segments of their thumb and index finger. In other gestures, a person can grasp a portion of food with all of their fingers (as in a first hold). In this specific gesture, a person rotates their hand as they bring the portion of food up to their mouth. In other gestures, a person does not rotate their hand. In this specific gesture, a person grasps food with their thumb on the near (or upper) surface of a portion of food and their index finger on the far (or lower) surface of the portion of food. In other gestures, this can be reversed. In this specific gesture, the orientation of a portion of food is maintained as it is brought up to the person's mouth. In other gestures, the orientation of a portion of food can be flipped as it is brought up to the person's mouth.

Specifically, FIGS. 60 through 62 show an example of how a selected eating-related gesture can be recognized when: (a) the distal segment of a thumb 6001 and the distal segment of an index finger 6003 move toward each other; (b) at least one of these two distal segments 6001 at least partially obscures the view of a portion of food 6006 from a camera; and (c) then at least one of these two distal segments 6001 moves toward the camera. Similarly, FIGS. 60 through 62 show an example of how a selected type of eating-related gesture can be recognized when: (a) the distal segment of the thumb 6001 and the distal segment of the index finger 6003 move toward each other; (b) at least one of these two distal segments 6001 at least partially obscures the view of a portion of food 6006 from a camera; and (c) then at least one of these two distal segments 6001 increases in apparent size from the perspective of the camera. Alternatively, this gesture can be recognized when the portion of food 6006 obscures the thumb or finger.

In an alternative example, this eating-related gesture can be recognized based on equivalent configurations and movements of virtual objects in a virtual model, wherein the virtual objects correspond to actual objects. Specifically, the right sides of FIGS. 60 through 62 show an example of how a selected eating-related gesture can be recognized when: (a) the distal segment of a virtual thumb 6011 and the distal segment of a virtual index finger 6013 move toward each other; (b) at least one of these two distal segments 6011 at least partially obscures the view of a virtual portion of food 6016 from a virtual camera; and (c) then at least one of these two distal segments 6011 moves toward the virtual camera. Similarly, FIGS. 60 through 62 show an example of how a selected type of eating-related gesture can be recognized when: (a) the distal segment of a virtual thumb 6011 and the distal segment of a virtual index finger 6013 move toward each other; (b) at least one of these two distal segments 6011 at least partially obscures the view of a virtual portion of food 6016 from a virtual camera; and (c) then at least one of these two distal segments 6011 increases in apparent size from the perspective of the virtual camera. Alternatively, this gesture can be recognized when a virtual portion of food 6016 obscures a virtual thumb or virtual finger.

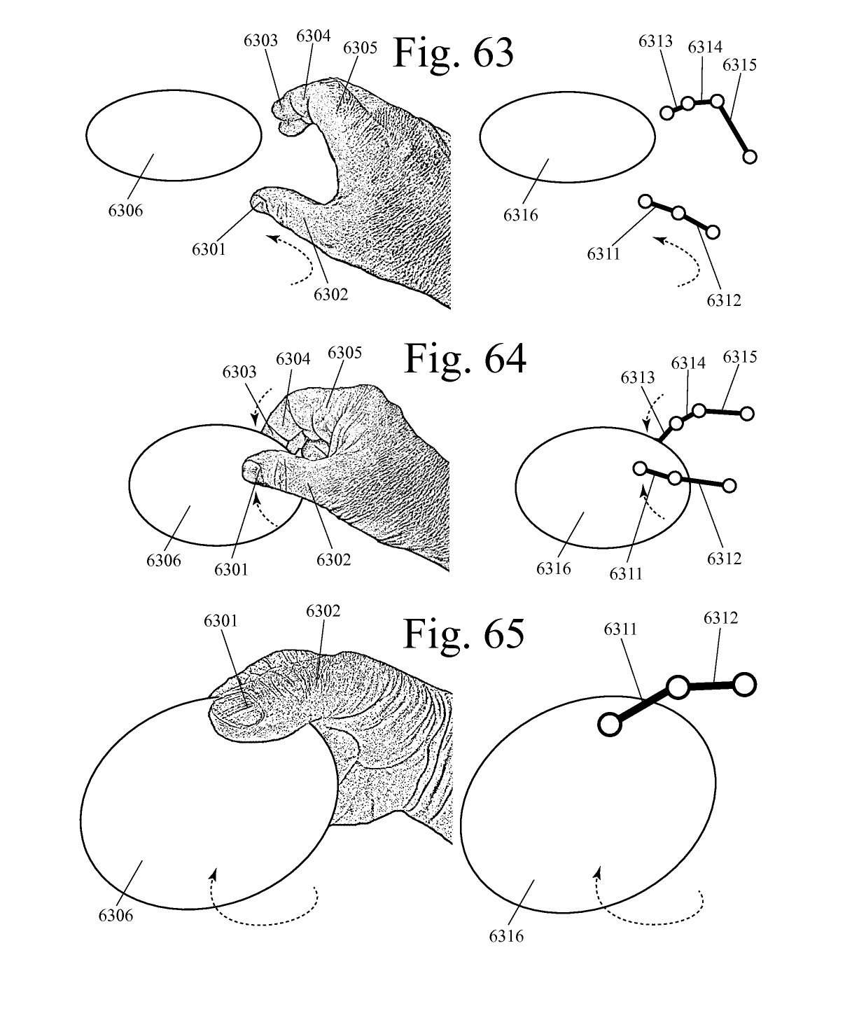

FIGS. 63 through 65 show another example of how an eating-related gesture can be recognized. This example is like the one shown in FIGS. 57 through 59, except that now the food is flipped (as with a “scooping” motion”) as is it moved toward the person's mouth. Such flipping can occur when a person uses a piece of food (such as a chip) to scoop up an edible liquid or gel (such as dip or sauce). FIGS. 63 through 65 show three sequential views. The left sides show a person's actual hand and food. The right sides show corresponding views of a virtual model of the person's hand and food. FIG. 63 shows the person reaching for food. FIG. 64 shows the person grasping food. FIG. 65 shows the person bringing the food up toward their mouth. Relevant embodiment variations from the introductory section and discussions of other figures can be applied to this example.

Left-side actual objects which are tracked in this example include: the distal segment of the person's thumb 6301; the proximal segment of the person's thumb 6302; the distal segment of the person's index finger 6303; the middle segment of the person's index finger 6304; the proximal segment of the person's index finger 6305; and a portion of food 6306. Right-side virtual objects which are tracked include: the distal segment of a virtual thumb 6311; the proximal segment of the a virtual thumb 6312; the distal segment of a virtual index finger 6313; the middle segment of a virtual index finger 6314; the proximal segment of a virtual index finger 6315; and a virtual portion of food 6316.

FIGS. 63 through 65 show an example of how a selected eating-related gesture can be recognized when: (a) the distal segment of a thumb 6301 and the distal segment of an index finger 6303 move toward each other; (b) at least one of these two distal segments at least partially obscures the view of a portion of food from a camera; and (c) then at least one of these two distal segments 6301 moves toward the camera. Similarly, FIGS. 63 through 65 show an example of how a selected type of eating-related gesture can be recognized when: (a) the distal segment of the thumb and the distal segment of the index finger move toward each other; (b) at least one of these two distal segments at least partially obscures the view of a portion of food from a camera; and (c) then at least one of these two distal segments increases in apparent size from the perspective of the camera. Alternatively, this gesture can be recognized when the portion of food obscures the thumb or finger.

In an alternative example, this eating-related gesture can be recognized based on equivalent configurations and movements of virtual objects in a virtual model, wherein the virtual objects correspond to actual objects. Specifically, the right sides of FIGS. 63 through 65 show an example of how a selected eating-related gesture can be recognized when: (a) the distal segment of a virtual thumb 6311 and the distal segment of a virtual index finger 6313 move toward each other; (b) at least one of these two distal segments at least partially obscures the view of a virtual portion of food 6316 from a virtual camera; and (c) then at least one of these two distal segments 6311 moves toward the virtual camera. Similarly, FIGS. 63 through 65 show an example of how a selected type of eating-related gesture can be recognized when: (a) the distal segment of a virtual thumb and the distal segment of a virtual index finger move toward each other; (b) at least one of these two distal segments at least partially obscures the view of a virtual portion of food from a virtual camera; and (c) then at least one of these two distal segments increases in apparent size from the perspective of the virtual camera. Alternatively, this gesture can be recognized when a virtual portion of food obscures a virtual thumb or virtual finger.

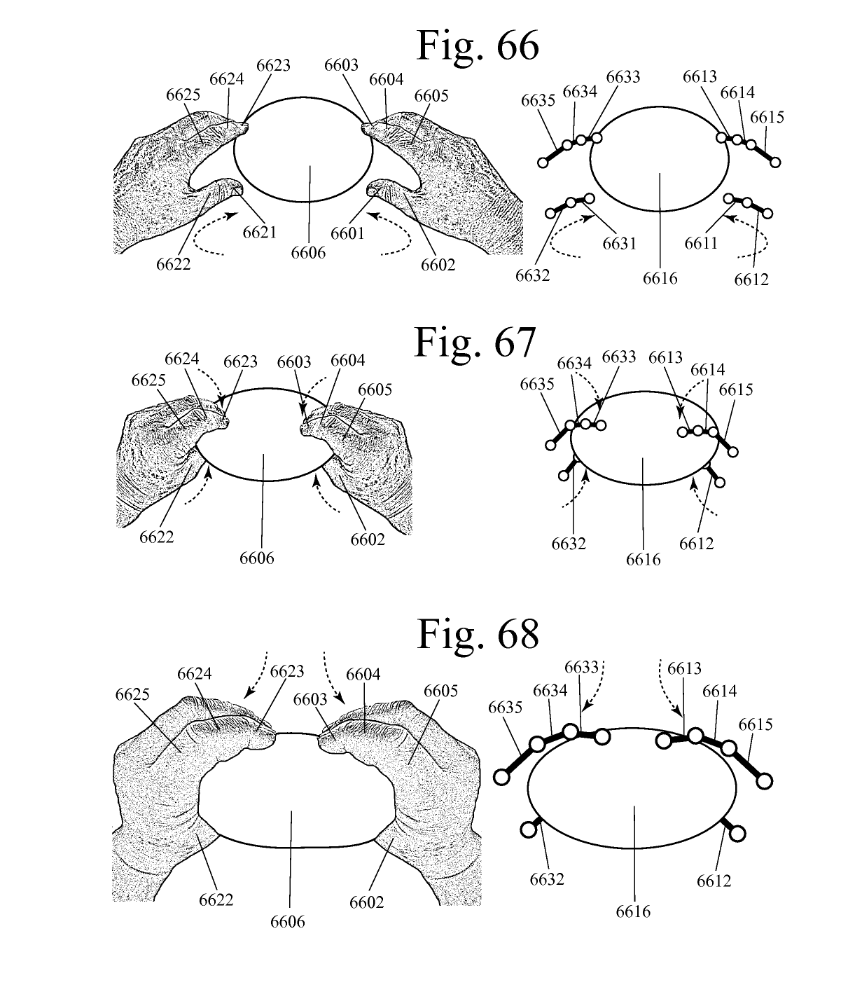

FIGS. 66 through 68 show another example of how an eating-related gesture can be recognized. This example is like the one shown in FIGS. 57 through 59, except that now the food is held with both hands instead of one hand. For example, this can occur when a person holds a hamburger or a sandwich with both hands. The left sides of these figures show a person's hand and food. The right sides show corresponding views of a virtual model of the person's hand and food. FIG. 66 shows the person reaching for food. FIG. 67 shows the person holding the food. FIG. 68 shows the person bringing the food up to their mouth. Relevant embodiment variations from the introductory section and discussions of other figures can also be applied to this example.

Actual objects which are tracked herein include: the distal 6601 and the proximal 6602 segments of the person's right thumb; the distal 6621 and the proximal 6622 segments of the person's left thumb; the distal 6603, middle 6604, and proximal 6605 segments of the person's right index finger; the distal 6623, middle 6624, and proximal 6625 segments of the person's left index finger; and a portion of food 6606. Virtual objects which are tracked in the virtual model herein include: the distal 6611 and the proximal 6612 segments of a virtual right thumb; the distal 6631 and the proximal 6632 segments of a virtual left thumb; the distal 6613, middle 6614, and proximal 6615 segments of a virtual right index finger; the distal 6633, middle 6634, and proximal 6635 segments of a virtual left index finger; and a virtual portion of food 6616.

FIGS. 66 through 68 show an example of how a selected eating-related gesture can be recognized when: (a) the distal segment of a (right, left, or both) thumb 6601 and the distal segment of a (right, left, or both) index finger 6603 move toward each other; (b) at least one of these distal segments at least partially obscures the view of a portion of food from a camera; and (c) then at least one of these distal segments 6601 moves toward the camera. Similarly, FIGS. 66 through 68 show an example of how a selected type of eating-related gesture can be recognized when: (a) the distal segment of a (right, left or both) thumb and the distal segment of a (right, left, or both) index finger move toward each other; (b) at least one of these distal segments at least partially obscures the view of a portion of food from the camera; and (c) then at least one of these distal segments increases in apparent size from the perspective of that camera. Alternatively, this gesture can be recognized when the portion of food obscures the thumb or finger.

Alternatively, this eating-related gesture can be recognized based on equivalent configurations and movements of virtual objects in a virtual model, wherein the virtual objects correspond to actual objects. Specifically, the right sides of FIGS. 66 through 68 show an example of how a selected eating-related gesture can be recognized when: (a) the distal segment of a (right, left or both) virtual thumb and the distal segment of a (right, left, or both) virtual index finger move toward each other; (b) at least one of these segments at least partially obscures the view of a virtual portion of food from a virtual camera; and (c) then at least one of these distal segments moves toward the virtual camera. Similarly, FIGS. 66 through 68 show an example of how a selected type of eating-related gesture can be recognized when: (a) the distal segment of a (right, left, or both) virtual thumb and the distal segment of a (right, left, or both) virtual index finger move toward each other; (b) at least one of these distal segments at least partially obscures the view of a virtual portion of food from a virtual camera; and (c) then at least one of these distal segments increases in apparent size from the perspective of the virtual camera. Alternatively, this gesture can be recognized when a virtual portion of food obscures a virtual thumb or virtual finger.

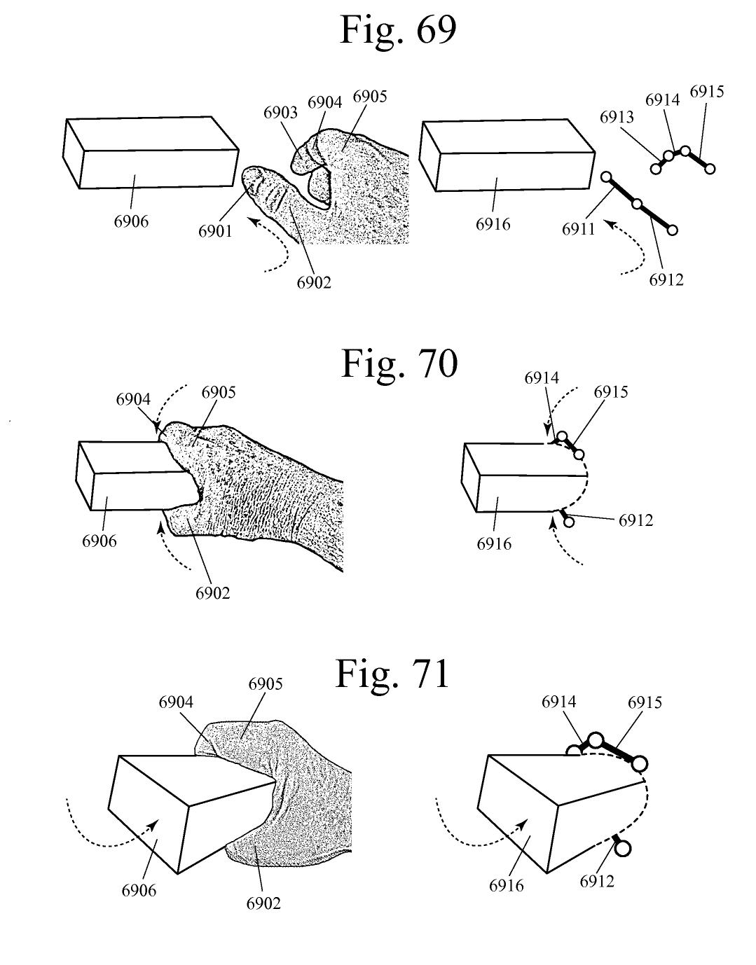

FIGS. 69 through 71 show another example of how an eating-related gesture can be recognized. This example is like the one shown in FIGS. 57 through 59, except that now food is held in a first grip instead of a thumb and index (and/or middle) finger grip. For example, this can occur when a person holds a candy bar or chicken leg in their fist. The left sides of these figures show the person's actual hand and food, while the right sides show corresponding views of a virtual model of the person's hand and food. FIG. 69 shows the person reaching for food. FIG. 70 shows the person holding the food. FIG. 71 shows the person bringing the food up to their mouth. Actual objects tracked herein include: distal 6901 and proximal 6902 segments of the person's thumb; distal 6903, middle 6904, and proximal 6905 segments of the person's index finger; and a portion of food 6906. Corresponding virtual objects tracked in the virtual model herein include: distal 6911 and proximal 6912 segments of a virtual thumb; distal 6913, middle 6914, and proximal 6915 segments of a virtual index finger; and a virtual portion of food 6916. Relevant embodiment variations from the introductory section and other discussions herein can also be applied to this example.

FIGS. 69 through 71 show an example of how a selected eating-related gesture can be recognized when: (a) the distal segment of a thumb and the distal segment of an index finger move toward each other; (b) at least one of these distal segments at least partially obscures the view of a portion of food from a camera; and (c) then at least one of these distal segments moves toward the camera. Similarly, FIGS. 69 through 71 show an example of how a selected type of eating-related gesture can be recognized when: (a) the distal segment of a thumb and the distal segment of an index finger move toward each other; (b) at least one of these distal segments at least partially obscures the view of a portion of food from a camera; and (c) then at least one of these distal segments increases in apparent size from the perspective of that camera. Alternatively, this gesture can be recognized when the portion of food obscures the thumb or finger.

Alternatively, this eating-related gesture can be recognized based on equivalent configurations and movements of virtual objects in a virtual model, wherein the virtual objects correspond to actual objects. Specifically, the right sides of FIGS. 69 through 71 show an example of how a selected eating-related gesture can be recognized when: (a) the distal segment of a virtual thumb and the distal segment of a virtual index finger move toward each other; (b) at least one of these distal segments at least partially obscures the view of a virtual portion of food from a virtual camera; and (c) then at least one of these distal segments moves toward the virtual camera. Similarly, FIGS. 69 through 71 show an example of how a selected type of eating-related gesture can be recognized when: (a) the distal segment of a virtual thumb and the distal segment of a virtual index finger move toward each other; (b) at least one of these distal segments at least partially obscures the view of a virtual portion of food from a virtual camera; and (c) then at least one of these distal segments increases in apparent size from the perspective of the virtual camera. Alternatively, this gesture can be recognized when a virtual portion of food obscures a virtual thumb or virtual finger.

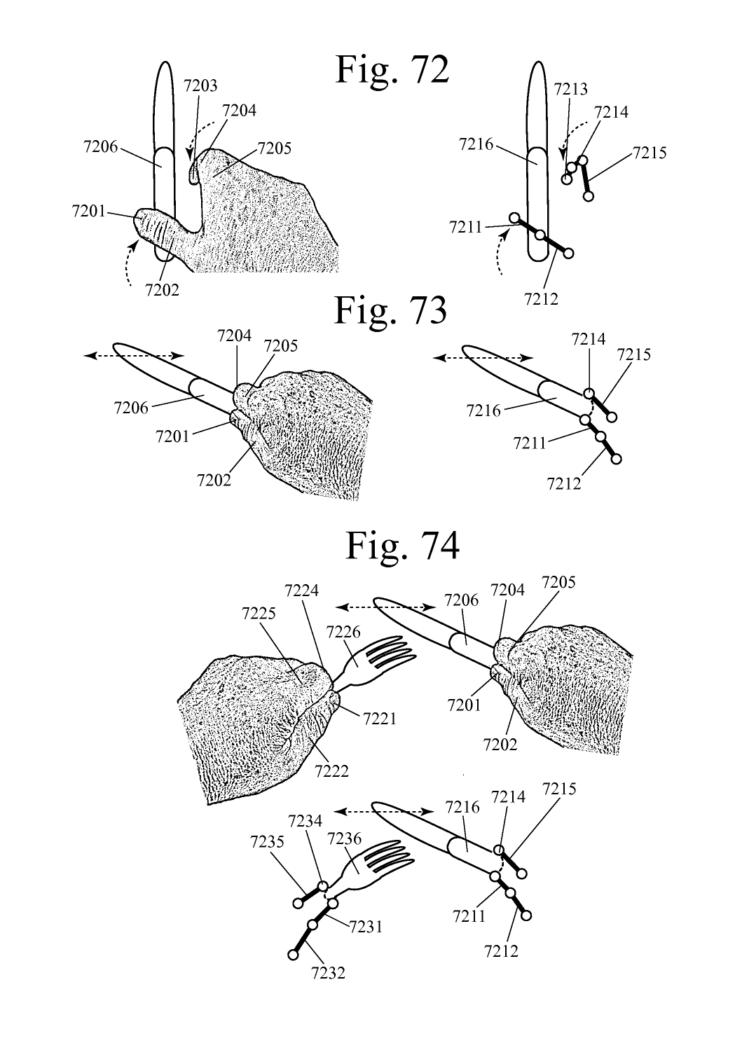

FIGS. 72 through 74 show another example of how an eating-related gesture can be recognized. This example shows a person using a knife (and fork) for cutting food. The left sides of FIGS. 72 and 73 and the top part of FIG. 74 show the person's actual hands and actual utensils. The right sides of FIGS. 72 and 73 and the bottom part of FIG. 74 show views of a virtual model with corresponding virtual hands and virtual utensils. FIG. 72 shows the person reaching for a knife. FIG. 73 shows the person holding the knife. FIG. 74 shows the person holding the knife and a fork, while they move the knife in a reciprocating lateral manner (right-to-left or vice versa) or diagonal manner (lower-right to upper-left, or vice versa). In an example, a left-handed person may move a knife in a diagonal lower-left to upper-right manner, or vice versa.

Actual objects tracked in this example include: distal 7201 and proximal 7202 segments of a person's right thumb; distal 7221 and proximal 7222 segments of the person's left thumb; distal 7203, middle 7204, and proximal 7205 segments of the person's right index finger; distal 7223, middle 7224, and proximal 7225 segments of the person's left index finger; a knife 7206, and a fork 7226. Corresponding virtual objects tracked in the virtual model herein include: distal 7211 and proximal 7212 segments of a virtual right thumb; distal 7231 and proximal 7232 segments of a virtual left thumb; distal 7213, middle 7214, and proximal 7215 segments of a virtual right index finger; distal 7233, middle 7234, and proximal 7235 segments of a virtual left index finger; a virtual knife 7216, and a virtual fork 7236. Relevant embodiment variations from the introductory section and other discussions herein can also be applied to this example.

FIGS. 72 through 74 show an example of how a selected eating-related gesture can be recognized when: (a) the distal segment of a thumb and the distal segment of an index finger move toward each other; (b) at least one of these distal segments at least partially obscures the view of a knife from the perspective of a wearable camera; and (c) then at least one of these distal segments moves in a reciprocating lateral manner (e.g. right to left, or vice versa) or reciprocating diagonal manner (e.g. lower-right to upper-left, or vice versa) across the field of vision of the wearable camera. In an example, a left-handed person can hold the knife in their left hand and move one of these distal segments in a lower-left to upper-right reciprocating diagonal manner. Alternatively, corresponding configurations and movements of corresponding virtual objects in a virtual model of a virtual hand and virtual knife can be used to recognize this gesture.

In an example, this gesture can be accompanied by a fork held by the other person's other hand. FIGS. 72 through 74 show an example of how a selected eating-related gesture can be recognized when: (a) the distal segment of a thumb and the distal segment of an index finger on a first hand move toward each other; (b) at least one of these distal segments at least partially obscures the view of a knife from the perspective of a wearable camera; (c) the distal segment of a thumb or the distal segment of an index finger on a second hand at least partially obscures the view of a fork from the perspective of a wearable camera; and (d) then at least one of the distal segments on the first hand moves in a reciprocating lateral manner (e.g. right to left, or vice versa) or reciprocating diagonal manner (e.g. lower-right to upper-left, or vice versa) across the field of vision of the wearable camera. In an example, a left-handed person can hold the knife in their left hand and move one of these distal segments in a lower-left to upper-right reciprocating diagonal manner. Alternatively, corresponding configurations and movements of corresponding virtual objects in a virtual model of virtual hands, a virtual knife, and a virtual fork can be used to recognize this gesture.

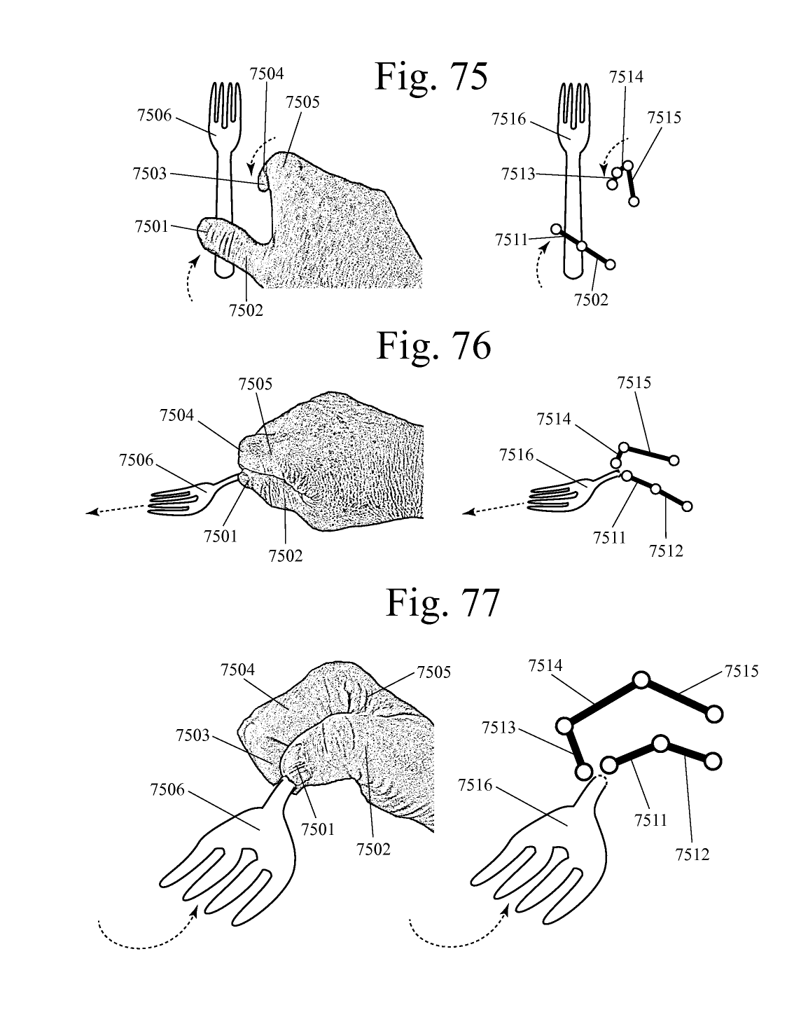

FIGS. 75 through 77 show another example of how an eating-related gesture can be recognized. This example shows a person holding a fork with a first grip, moving the fork laterally, and then bringing the fork up to their mouth. The left sides of these figures show the person's actual hand and an actual fork. The right sides of these figures show views of a virtual model with a corresponding virtual hand and virtual fork. FIG. 75 shows the person reaching for a fork. FIG. 76 shows the person holding and moving the fork laterally. FIG. 77 shows the person bringing the fork up to their mouth. Actual objects tracked in this example include: distal 7501 and proximal 7502 segments of a person's thumb; distal 7503, middle 7504, and proximal 7505 segments of the person's index finger; and a fork 7506. Corresponding virtual objects tracked in the virtual model herein include: distal 7511 and proximal 7512 segments of a virtual thumb; distal 7513, middle 7514, and proximal 7515 segments of a virtual index finger; and a virtual fork 7516. Relevant embodiment variations from the introductory section and other discussions herein can also be applied to this example.

FIGS. 75 through 77 show an example of how an eating-related gesture can involve interaction between a person's hand and a fork. In this example, a person is shown grasping a fork with their fist, moving the fork in a reciprocal lateral (right to left, or vice versa) manner, and then bringing the fork up to their mouth. In this example, the person rotates the fork as it is brought up to their mouth. In this example, the fork is held in a first grip and the handle of the fork is completely obscured by the person's hand when the fork is held. Food is not explicitly included in this series of figures in the interest of model parsimony. It is assumed that a person is eating when the person grasps a fork, moves the fork laterally, and then brings the fork up to their mouth. The assumption is that recognition of this pattern of interaction between a person's hand and a fork is sufficient to recognize an eating-related gesture.

However, if one desires to have more restrictive recognition criteria, then one can include recognition of food in proximity to the fork, such as when the fork is moved in a lateral manner (right to left, or vice versa) manner. For example, one could include a portion of food on the fork in the recognition model. Further, if so desired, one could also include recognition of a portion of food on the fork as the fork is brought up to the person's mouth. In an example, a model could require recognition of food on the tines of a fork as the fork is moved toward a person's mouth and require that this food be gone when the fork is moved away from the person's mouth. In an example, an eating-related gesture can be recognized by observing a first percentage of fork tines being visible (from the perspective of a wearable camera) as a fork is moved toward the camera, followed by a second percentage of fork tines being visible as the fork is moved away from the camera, wherein the second percentage is greater than the first percentage.

FIGS. 75 through 77 show how an example of how an eating-related gesture can be recognized when: (a) the distal segment of a thumb and the distal segment of an index finger move toward each other; (b) the distal segment of the thumb at least partially obscures the view of the handle of a fork from a camera; and (c) then the fork moves toward the camera. FIGS. 75 through 77 show how an example of how an eating-related gesture can be recognized when: (a) the distal segment of a thumb and the distal segment of an index finger move toward each other; (b) the distal segment of the thumb at least partially obscures the view of the handle of a fork; and (c) then the fork increases in apparent size from the perspective of the camera. In an alternative example, this eating-related gesture can be recognized based on the same configurations and movements of virtual objects, wherein the virtual objects correspond to these actual objects.

FIGS. 75 through 77 also show an example of how an eating-related gesture can be recognized when: (a) the distal segment of a thumb and the distal segment of an index finger move toward each other; (b) the distal segment of the thumb at least partially obscures the view of the handle of a fork from a camera; and (c) then the fork moves toward the camera, during which movement the distal segment of the thumb moves closer to the camera than the proximal segment of the thumb. FIGS. 75 through 77 also show an example of how an eating-related gesture can be recognized when: (a) the distal segment of a thumb and the distal segment of an index finger move toward each other; (b) the distal segment of the thumb at least partially obscures the view of the handle of a fork from a camera; and (c) then the fork moves toward the camera, during which movement the tines of the fork move closer to the camera than the handle of the fork. In an alternative example, this eating-related gesture can be recognized based on the same configurations and movements of virtual objects, wherein the virtual objects correspond to these actual objects.

FIGS. 75 through 77 also show an example of how an eating-related gesture can be recognized when: (a) the distal segment of a thumb at least partially obscures the view of the handle of a fork from a camera; (b) the fork moves from right to left, or vice versa, across a portion of the field of view of the camera; and (c) then the fork moves toward the camera. FIGS. 75 through 77 also show an example of how an eating-related gesture can be recognized when: (a) the distal segment of a thumb at least partially obscures the view of the handle of a fork from a camera; (b) the fork moves from right to left, or vice versa, across a portion of the field of view of the camera; and (c) then the fork increases in apparent size from the perspective of the camera. In an alternative example, this eating-related gesture can be recognized based on the same configurations and movements of virtual objects, wherein the virtual objects correspond to these actual objects.

FIGS. 75 through 77 also show an example of how an eating-related gesture can be recognized when: (a) the distal segment of a thumb at least partially obscures the view of the handle of a fork from the camera; (b) the fork moves in a lateral manner (from right to left, or vice versa); and (c) then the fork moves toward the camera, during which movement the distal segment of the thumb moves closer to the camera than the proximal segment of the thumb. FIGS. 75 through 77 also show an example of how an eating-related gesture can be recognized when: (a) the distal segment of a thumb at least partially obscures the view of the handle of a fork from the camera; (b) the fork moves in a lateral manner (from right to left, or vice versa); and (c) then the fork moves toward the camera, during which movement the tines of the fork move closer to the camera than the handle of the fork. In an alternative example, this eating-related gesture can be recognized based on the same configurations and movements of virtual objects, wherein the virtual objects correspond to these actual objects.

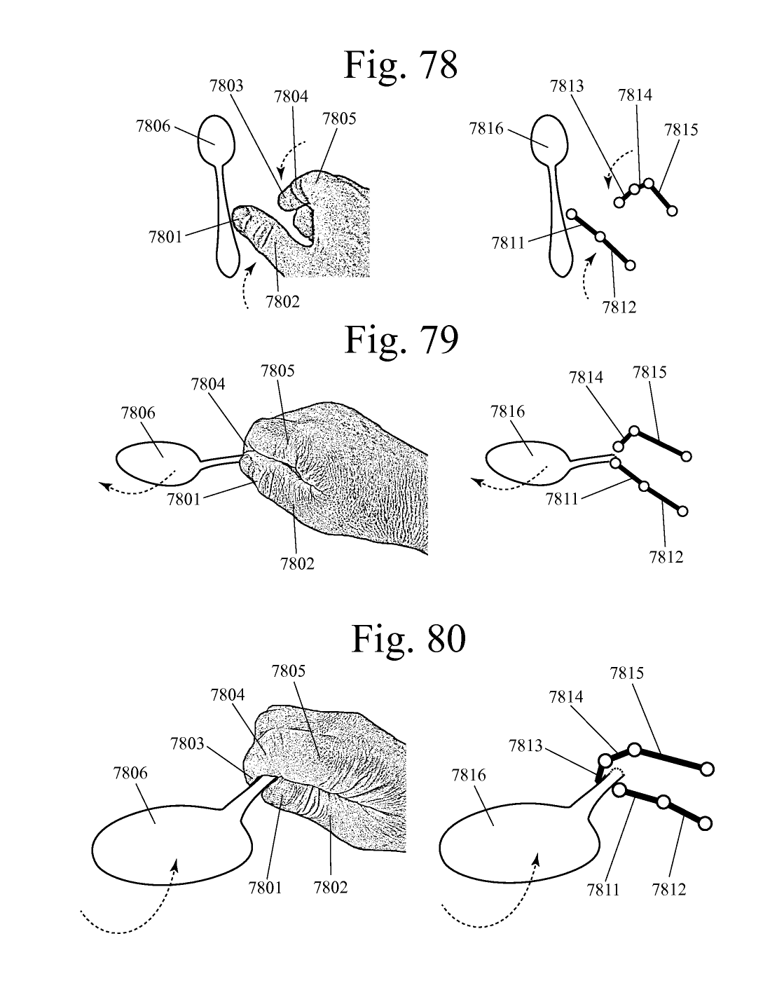

FIGS. 78 through 80 show another example of how an eating-related gesture can be recognized. This example shows a person holding a spoon with a first grip, moving the spoon in a scooping motion, and then bringing the spoon up to their mouth. The left sides of these figures show the person's actual hand and an actual spoon. The right sides of these figures show views of a virtual model with a corresponding virtual hand and virtual spoon. FIG. 78 shows the person reaching for a spoon. FIG. 79 shows the person holding and moving the spoon. FIG. 80 shows the person bringing the spoon up to their mouth. Actual objects tracked in this example include: distal 7801 and proximal 7802 segments of a person's thumb; distal 7803, middle 7804, and proximal 7805 segments of the person's index finger; and a spoon 7806. Corresponding virtual objects tracked in the virtual model herein include: distal 7811 and proximal 7812 segments of a virtual thumb; distal 7813, middle 7814, and proximal 7815 segments of a virtual index finger; and a virtual spoon 7816. Relevant embodiment variations from the introductory section and other discussions herein can also be applied to this example.

FIGS. 78 through 80 show an example of how an eating-related gesture can involve interaction between a person's hand and a spoon. In this example, a person is shown grasping a spoon with their fist, moving the spoon in a scooping (downward-forward-upward) manner, and then bringing the spoon up to their mouth. In this example, the person slightly rotates the convex end of the spoon as it is brought up to their mouth. In this example, the spoon is held in a first grip and the handle of the spoon is completely obscured by the person's hand when the spoon is held. Food is not explicitly included in this series of figures in the interest of model parsimony. It is assumed that a person is eating when the person grasps a spoon, scoops with the spoon, and then brings the spoon up to their mouth. The assumption is that recognition of this pattern of interaction between a person's hand and a spoon is sufficient to recognize an eating-related gesture.

However, if one desires to have more restrictive recognition criteria, then one can include recognition of food in proximity to the spoon, such as when the spoon is moved in a scooping manner. For example, one could include a portion of food on the spoon in the recognition model. Further, if so desired, one could also include recognition of a portion of food in the convex end of the spoon as the spoon is brought up to the person's mouth. In an example, a model could require recognition of food in the convex end of a spoon as the spoon is moved toward a person's mouth and require that this food be gone when the spoon is moved away from the person's mouth. In an example, an eating-related gesture can be recognized by observing a first percentage of the convex end of the spoon being visible (from the perspective of a wearable camera) as a spoon is moved toward the camera, followed by a second percentage of this convex end being visible as the spoon is moved away from the camera, wherein the second percentage is greater than the first percentage.

FIGS. 78 through 80 show how an example of how an eating-related gesture can be recognized when: (a) the distal segment of a thumb and the distal segment of an index finger move toward each other; (b) the distal segment of the thumb at least partially obscures the view of the handle of a spoon from a camera; and (c) then the spoon moves toward the camera. FIGS. 78 through 80 show how an example of how an eating-related gesture can be recognized when: (a) the distal segment of a thumb and the distal segment of an index finger move toward each other; (b) the distal segment of the thumb at least partially obscures the view of the handle of a spoon; and (c) then the spoon increases in apparent size from the perspective of the camera. In an alternative example, this eating-related gesture can be recognized based on the same configurations and movements of virtual objects, wherein the virtual objects correspond to these actual objects.

FIGS. 78 through 80 also show an example of how an eating-related gesture can be recognized when: (a) the distal segment of a thumb and the distal segment of an index finger move toward each other; (b) the distal segment of the thumb at least partially obscures the view of the handle of a spoon from a camera; and (c) then the spoon moves toward the camera, during which movement the distal segment of the thumb moves closer to the camera than the proximal segment of the thumb. FIGS. 78 through 80 also show an example of how an eating-related gesture can be recognized when: (a) the distal segment of a thumb and the distal segment of an index finger move toward each other; (b) the distal segment of the thumb at least partially obscures the view of the handle of a spoon from a camera; and (c) then the spoon moves toward the camera, during which movement the convex end of the spoon moves closer to the camera than the handle of the spoon. In an alternative example, this eating-related gesture can be recognized based on the same configurations and movements of virtual objects, wherein the virtual objects correspond to these actual objects.

FIGS. 78 through 80 also show an example of how an eating-related gesture can be recognized when: (a) the distal segment of a thumb at least partially obscures the view of the handle of a spoon from a camera; (b) the spoon moves in a scooping (downward-forward-upward) manner; and (c) then the spoon moves toward the camera. FIGS. 78 through 80 also show an example of how an eating-related gesture can be recognized when: (a) the distal segment of a thumb at least partially obscures the view of the handle of a spoon from a camera; (b) the spoon moves in a scooping (downward-forward-upward) manner; and (c) then the spoon increases in apparent size from the perspective of the camera. In an alternative example, this eating-related gesture can be recognized based on the same configurations and movements of virtual objects, wherein the virtual objects correspond to these actual objects.

FIGS. 78 through 80 also show an example of how an eating-related gesture can be recognized when: (a) the distal segment of a thumb at least partially obscures the view of the handle of a spoon from the camera; (b) the spoon moves in a scooping (downward-forward-upward) manner; and (c) then the spoon moves toward the camera, during which movement the distal segment of the thumb moves closer to the camera than the proximal segment of the thumb. FIGS. 78 through 80 also show an example of how an eating-related gesture can be recognized when: (a) the distal segment of a thumb at least partially obscures the view of the handle of a spoon from the camera; (b) the spoon moves in a scooping (downward-forward-upward) manner; and (c) then the spoon moves toward the camera, during which movement the convex end of the spoon moves closer to the camera than the handle of the spoon. In an alternative example, this eating-related gesture can be recognized based on the same configurations and movements of virtual objects, wherein the virtual objects correspond to these actual objects.

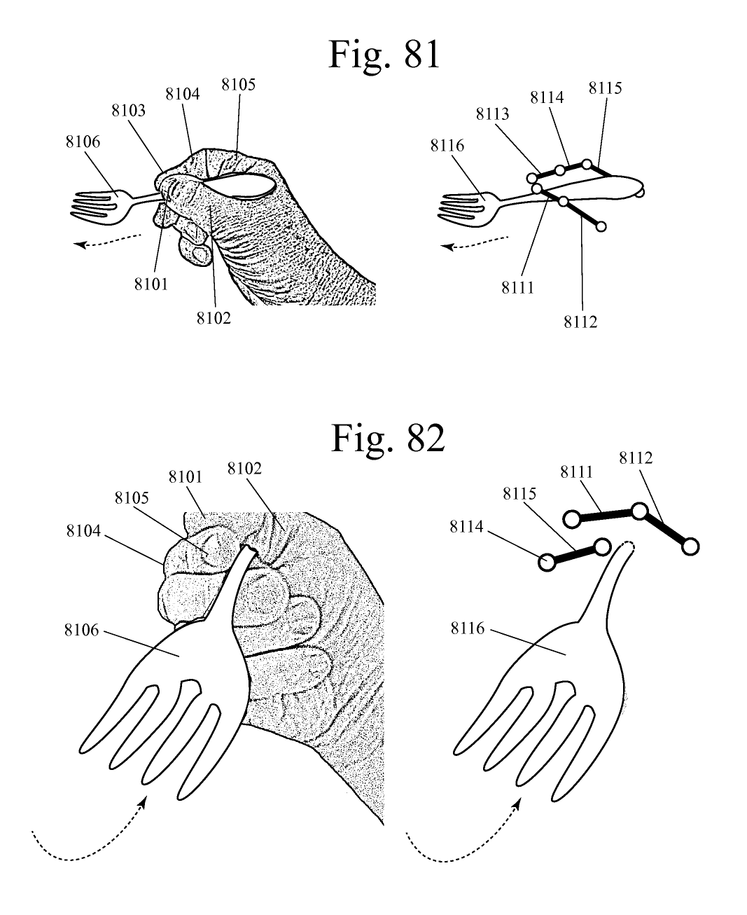

FIGS. 81 and 82 show another example of how an eating-related gesture can be recognized. This example is like the one shown in FIGS. 75 through 77 except that the person holds a fork with the handle resting on top of the hand (visible) between the thumb and the index finger. Also, this two-picture sequence does not show the person reaching for the fork, as shown in FIG. 75, which would look very similar to FIG. 75. The left sides of these figures show the person's actual hand and an actual fork. The right sides of these figures show views of a virtual model with a corresponding virtual hand and virtual fork.

FIG. 81 shows a person's hand holding and moving a fork laterally. FIG. 82 shows the person bringing the fork up to their mouth. Actual objects tracked in this example include: distal 8101 and proximal 8102 segments of a person's thumb; distal 8103, middle 8104, and proximal 8105 segments of the person's index finger; and a fork 8106. Corresponding virtual objects tracked in the virtual model herein include: distal 8111 and proximal 8112 segments of a virtual thumb; distal 8113, middle 8114, and proximal 8115 segments of a virtual index finger; and a virtual fork 8116. Relevant embodiment variations from the introductory section and other discussions herein can also be applied to this example.

FIGS. 81 and 82 show an example of how an eating-related gesture can involve interaction between a person's hand and a fork. In this example, a person is shown holding and moving the fork in a reciprocal lateral (right to left, or vice versa) manner, and then bringing the fork up to their mouth. In this example, the person rotates the fork as it is brought up to their mouth. In this example, the fork is held between the person's thumb, index finger, and middle finger. The end of the fork handle is visible between the person's thumb and index finger. Food is not explicitly included in this series of figures in the interest of model parsimony. It is assumed that a person is eating when the person holds a fork, moves the fork laterally, and then brings the fork up to their mouth. The assumption is that recognition of this pattern of interaction between a person's hand and a fork is sufficient to recognize an eating-related gesture.

However, if one desires to have more restrictive recognition criteria, then one can include recognition of food in proximity to the fork, such as when the fork is moved in a lateral manner (right to left, or vice versa) manner. For example, one could include a portion of food on the fork in the recognition model. Further, if so desired, one could also include recognition of a portion of food on the fork as the fork is brought up to the person's mouth. In an example, a model could require recognition of food on the tines of a fork as the fork is moved toward a person's mouth and require that this food be gone when the fork is moved away from the person's mouth. In an example, an eating-related gesture can be recognized by observing a first percentage of fork tines being visible (from the perspective of a wearable camera) as a fork is moved toward the camera, followed by a second percentage of fork tines being visible as the fork is moved away from the camera, wherein the second percentage is greater than the first percentage.

FIGS. 81 and 82 show an example of how an eating-related gesture can be recognized when: (a) the distal segment of a thumb at least partially obscures the view of the handle of a fork from a camera; (b) the fork moves from right to left, or vice versa, across a portion of the field of view of the camera; and (c) then the fork moves toward the camera. FIGS. 81 and 82 also show an example of how an eating-related gesture can be recognized when: (a) the distal segment of a thumb at least partially obscures the view of the handle of a fork from a camera; (b) the fork moves from right to left, or vice versa, across a portion of the field of view of the camera; and (c) then the fork increases in apparent size from the perspective of the camera. In an alternative example, this eating-related gesture can be recognized based on the same configurations and movements of virtual objects, wherein the virtual objects correspond to these actual objects.

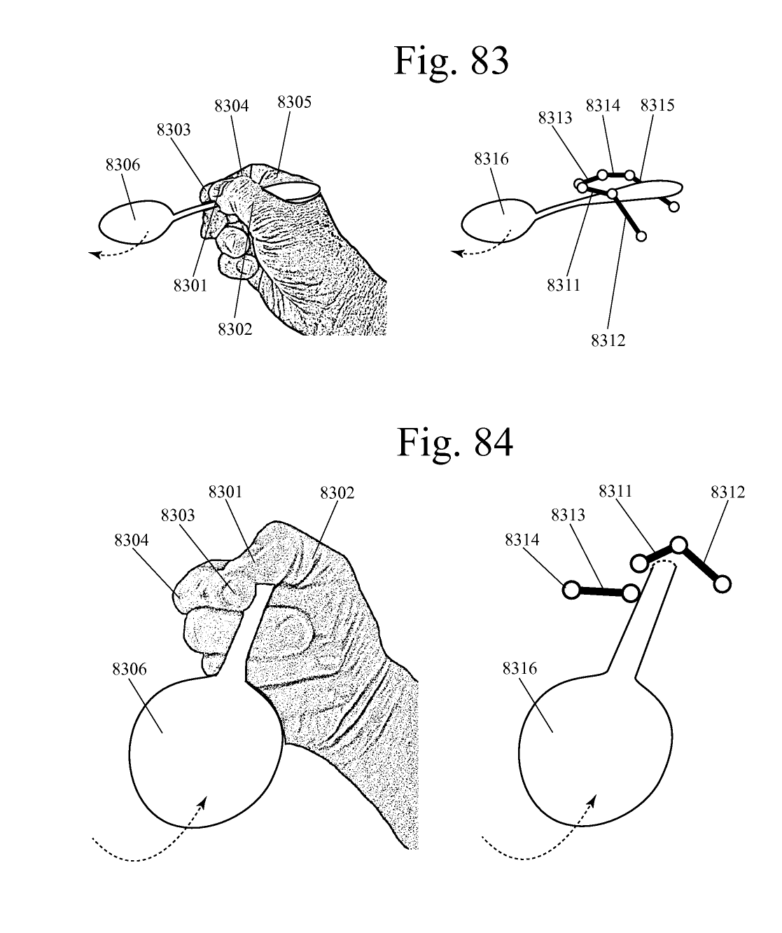

FIGS. 83 and 84 show another example of how an eating-related gesture can be recognized. This example is like the one shown in FIGS. 78 through 80 except that the person holds a spoon with the handle resting on top of the hand (visible) between the thumb and the index finger. Also, this two-picture sequence does not show the person reaching for the spoon, as shown in FIG. 78, which would look very similar to FIG. 78. The left sides of these figures show the person's actual hand and an actual spoon. The right sides of these figures show views of a virtual model with a corresponding virtual hand and virtual spoon.

FIG. 83 shows a person's hand holding and moving a spoon in a scooping (downward-forward-upward) manner. FIG. 84 shows the person bringing the spoon up to their mouth. Actual objects tracked in this example include: distal 8301 and proximal 8302 segments of a person's thumb; distal 8303, middle 8304, and proximal 8305 segments of the person's index finger; and a spoon 8306. Corresponding virtual objects tracked in the virtual model herein include: distal 8311 and proximal 8312 segments of a virtual thumb; distal 8313, middle 8314, and proximal 8315 segments of a virtual index finger; and a virtual spoon 8316. Relevant embodiment variations from the introductory section and other discussions herein can also be applied to this example.

FIGS. 83 and 84 show an example of how an eating-related gesture can involve interaction between a person's hand and a spoon. In this example, a person is shown holding and moving the spoon in a scooping (downward-forward-upward) manner, and then bringing the spoon up to their mouth. In this example, the person rotates the spoon as it is brought up to their mouth. In this example, the spoon is held between the person's thumb, index finger, and middle finger. The end of the spoon handle is visible between the person's thumb and index finger. Food is not explicitly included in this series of figures in the interest of model parsimony. It is assumed that a person is eating when the person holds a spoon, moves the spoon in a scooping (downward-forward-upward) manner, and then brings the spoon up to their mouth. The assumption is that recognition of this pattern of interaction between a person's hand and a spoon is sufficient to recognize an eating-related gesture.

However, if one desires to have more restrictive recognition criteria, then one can include recognition of food in proximity to the spoon, such as when the spoon is moved in a scooping (downward-forward-upward) manner. For example, one could include a portion of food on the spoon in the recognition model. Further, if so desired, one could also include recognition of a portion of food on the spoon as the spoon is brought up to the person's mouth. In an example, a model could require recognition of food on the convex end of a spoon as the spoon is moved toward a person's mouth and require that this food be gone when the spoon is moved away from the person's mouth. In an example, an eating-related gesture could be recognized by observing a first percentage of the convex end of the spoon being visible (from the perspective of a wearable camera) as a spoon is moved toward the camera, followed by a second percentage of the convex end of the spoon being visible as the spoon is moved away from the camera, wherein the second percentage is greater than the first percentage.

FIGS. 83 and 84 show an example of how an eating-related gesture can be recognized when: (a) the distal segment of a thumb at least partially obscures the view of the handle of a spoon from a camera; (b) the spoon moves in a scooping (downward-forward-upward) manner; and (c) then the spoon moves toward the camera. FIGS. 83 and 84 also show an example of how an eating-related gesture can be recognized when: (a) the distal segment of a thumb at least partially obscures the view of the handle of a spoon from a camera; (b) the spoon moves in a scooping (downward-forward-upward) manner; and (c) then the spoon increases in apparent size from the perspective of the camera. In an alternative example, this eating-related gesture can be recognized based on the same configurations and movements of virtual objects, wherein the virtual objects correspond to these actual objects.

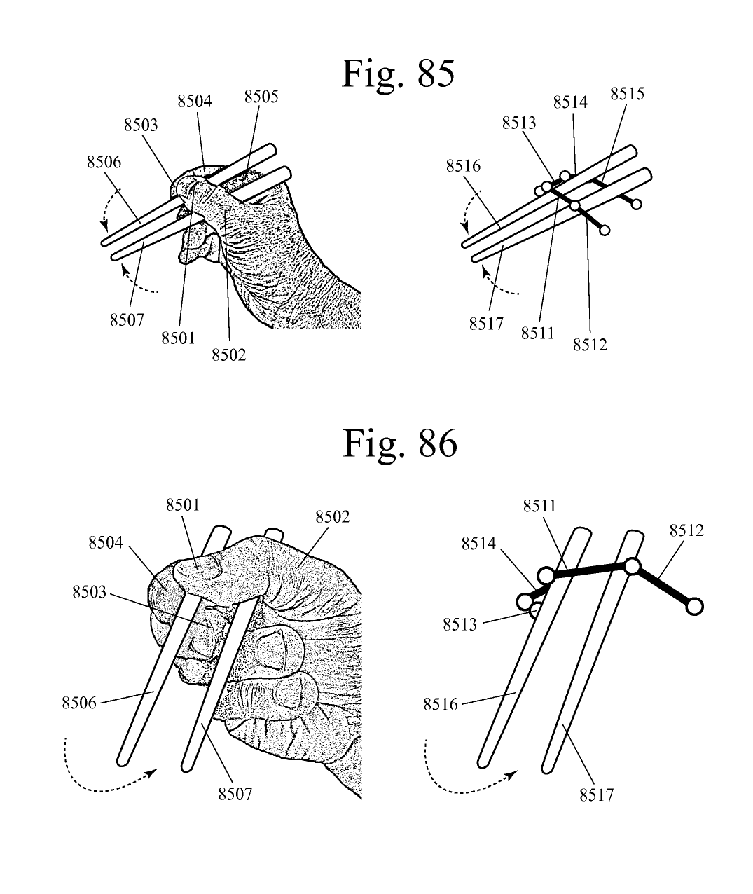

FIGS. 85 and 86 show another example of how an eating-related gesture can be recognized. In this example, a person holds a set of two chop sticks for transporting food to the mouth. The proximal ends of the chop sticks rest on the person's hand, between the thumb and the index finger. The distal ends of the chop sticks extend outward from the hand to engage portions of food and bring them up to the mouth. The left sides of these figures show the person's actual hand and an actual set of chop sticks. The right sides of these figures show views of a virtual model with a corresponding virtual hand and virtual set of chop sticks. FIG. 85 shows a person's hand moving the distal ends of two chop sticks toward each other. FIG. 86 shows the person bringing the chop sticks up to their mouth.

Actual objects tracked in this example include: distal 8501 and proximal 8502 segments of a person's thumb; distal 8503, middle 8504, and proximal 8505 segments of the person's index finger; and chop sticks 8506 and 8507. Corresponding virtual objects tracked in the virtual model herein include: distal 8511 and proximal 8512 segments of a virtual thumb; distal 8513, middle 8514, and proximal 8515 segments of a virtual index finger; and virtual chop sticks 8516 and 8517. Relevant embodiment variations from the introductory section and other discussions herein can also be applied to this example.

FIGS. 85 and 86 show an example of how an eating-related gesture can involve interaction between a person's hand and a set of chop sticks. In this example, a person is shown moving the distal ends of the chop sticks toward each other (to engage food) and then bringing the chop sticks up to their mouth. In this example, the person rotates the chop sticks during movement toward the mouth. In this example, the chop sticks are held between the person's thumb, index finger, and middle finger. The proximal ends of the chop sticks are visible, resting on the person's hand between the thumb and index finger. In an example, the proximal ends of the chop sticks are wider than the distal ends of the chop sticks. In an example, a portion of food is held between the distal ends of the chop sticks.

Food is not explicitly shown in these of figures for the sake of model parsimony. It is assumed that a person is eating when that person holds chop sticks, moves the distal ends of the chop sticks toward each other, and then brings the chop sticks up toward the mouth. The assumption is that recognition of this pattern of interaction between a person's hand and chop sticks is sufficient to recognize an eating-related gesture. However, if one desires to have more restrictive recognition criteria, then one can include recognition of food in proximity to the chop sticks. In an example, a more complex and restrictive model could also require recognition of food between the distal ends of chop sticks as they are moved toward a person's mouth and that this food be gone when the chop sticks are moved away from the person's mouth. In an example, an eating-related gesture could be recognized by observing a first percentage of the distal ends of chop sticks being visible as they move toward a camera, followed by a second percentage of the distal ends of chop sticks being visible as they move away from the camera, wherein the second percentage is greater than the first percentage.

FIGS. 85 and 86 show an example of how an eating-related gesture can be recognized when: (a) the distal segment of a thumb at least partially obscures the view of one or more chop sticks from a camera; (b) the distal ends of two chop sticks move toward each other; and (c) then the chop sticks move toward the camera. FIGS. 85 and 86 also show an example of how an eating-related gesture can be recognized when: (a) the distal segment of a thumb at least partially obscures the view one or more chop sticks from a camera; (b) the distal ends of two chop sticks move toward each other; and (c) then the chop sticks increase in apparent size from the perspective of the camera. In an alternative example, this eating-related gesture can be recognized based on the same configurations and movements of virtual objects, wherein the virtual objects correspond to these actual objects.

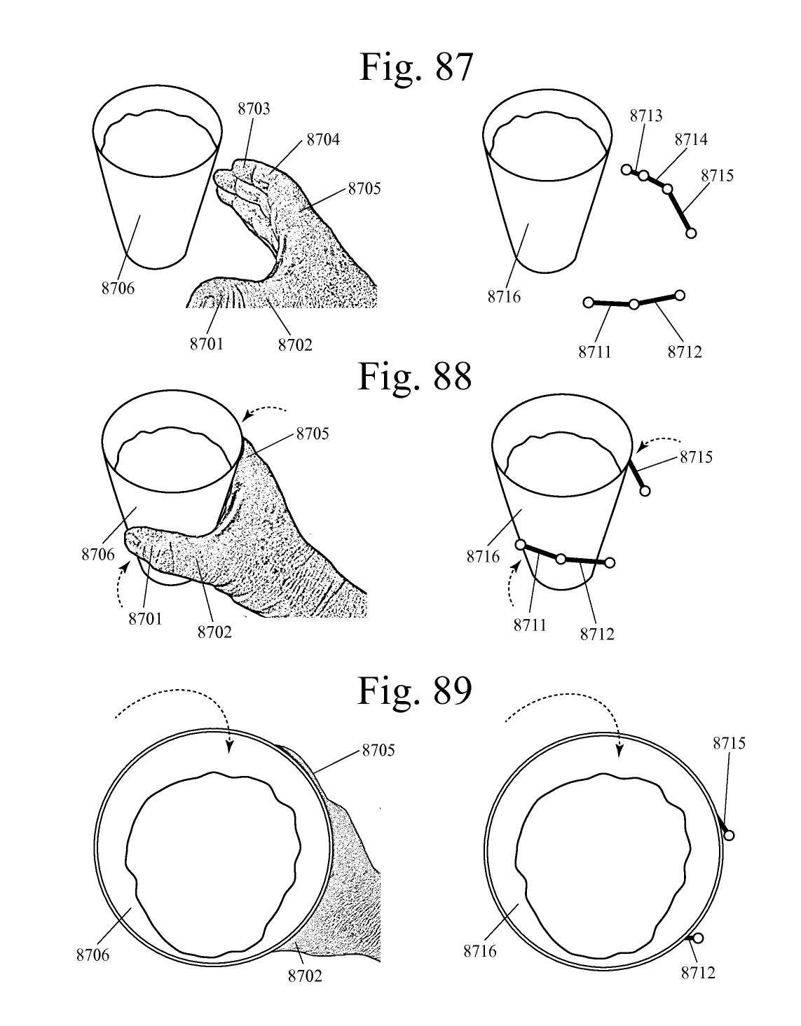

FIGS. 87 through 89 show another example of how an eating-related gesture can be recognized. In this example, a person grasps a beverage glass and then brings it up toward their mouth, tilting the top of the beverage glass toward their mouth during this movement. In this disclosure, food can be in the form of a liquid or gel. In this disclosure, food need not be solid. A consumable liquid or beverage can also be considered food. In this example, a beverage glass does not have a handle. Examples of beverage containers with handles, such as a cup or mug, are shown in some of the following figures. In this example, the top of the beverage container is tilted toward the person's mouth as the person brings it up to their mouth in order to move the liquid inside closer to the proximal portion of the top of the container for easier drinking. The left sides of these figures show the person's actual hand and actual glass. The right sides of these figures show views of a virtual model with a corresponding virtual hand and virtual glass.

FIG. 87 shows a person's hand reaching for a glass containing a liquid beverage. FIG. 88 shows the person grasping this glass with their thumb and multiple fingers (e.g. with a first hold). FIG. 89 shows the person bringing the glass up toward their mouth, tilting the top of the glass toward their mouth during this movement. Actual objects tracked in this example include: distal 8701 and proximal 8702 segments of a person's thumb; distal 8703, middle 8704, and proximal 8705 segments of the person's index finger; and beverage glass 8706. Corresponding virtual objects tracked in the virtual model herein include: distal 8711 and proximal 8712 segments of a virtual thumb; distal 8713, middle 8714, and proximal 8715 segments of a virtual index finger; and virtual glass 8716. Relevant embodiment variations from the introductory section and other discussions herein can also be applied to this example.

FIGS. 87 through 89 show an example of how an eating-related gesture can involve interaction between a person's hand and a beverage container. In this example, a person reaches for a beverage container (e.g. a glass), grasps the beverage container with their thumb and fingers, moves the beverage container toward their mouth, and tilts the top of the beverage container toward their mouth during this movement. In an example, tilting of the beverage container can be recognized by a change in the apparent geometric shape of the top of the container. In this example, the top of the container (in this example, the top of a glass) is actually circular, but appears elliptical from the perspective of a wearable camera. As the glass is tilted, the apparent shape of the top changes; it becomes less elliptical and more circular. In an example, tilting of a beverage container can be recognized by a change in the size of the vertical axis of the apparent geometric shape of the top of the container. Depending on the location of the wearable camera, the apparent geometric shape of the top of the glass can change from being less circular to more circular, or from being more circular to less circular, during selected portions of the movement path to the mouth.

In the case of an open-top beverage container (such as a glass, cup, mug, or bowl), tilting of this beverage container can also be recognized by a change in the (apparent) shape and/or relative configuration of the upper surface of a liquid within that container. For example, the upper surface of a liquid in a glass, cup, mug, or bowl can have a generally circular shape which appears elliptical from the perspective of a wearable camera. In an example, the (apparent) geometric shape of this upper surface can become more circular (and less elliptical) as the beverage container is tilted. The tilting of an open-top beverage container can also be recognized by a change in the relative configurations of the upper surface of the liquid contained and the top (or sides) of the beverage container. For example, when the top of a beverage container is tilted toward a person's mouth, then the upper surface of the liquid can move closer to the proximal portion of the top of the container and further from the distal portion of the top of the container. In an example, when the top of a beverage container is tilted toward a person's mouth, then the closest distance between the upper surface of the liquid and the top of the container can decrease.

FIGS. 87 through 89 show an example of how an eating-related gesture can be recognized when: (a) a person extends their thumb and fingers toward a food-transporting object (such as a beverage glass) containing a liquid; (b) the person grasps the food-transporting object such that their thumb at least partially obscures the view of the food-transporting object; and (c) the person moves the food-transporting object toward the camera, tilting the top of the object toward the camera during this movement. FIGS. 87 through 89 show an example of how an eating-related gesture can be recognized when: (a) a person extends their thumb and fingers toward a glass containing a liquid; (b) the person grasps the glass such that their thumb at least partially obscures the view of the glass; and (c) the person moves the glass toward the camera, tilting the top of the glass toward the camera during this movement. FIGS. 87 through 89 show an example of how an eating-related gesture can be recognized when: (a) a person extends their thumb and fingers toward a glass containing a liquid; (b) the person grasps the glass such that their thumb at least partially obscures the view of the glass; and (c) the person moves the glass toward the camera, during which movement the vertical axis of the apparent geometric shape of the top of the glass changes. In an alternative example, this eating-related gesture can be recognized based on the same configurations and movements of virtual objects, wherein the virtual objects correspond to these actual objects.

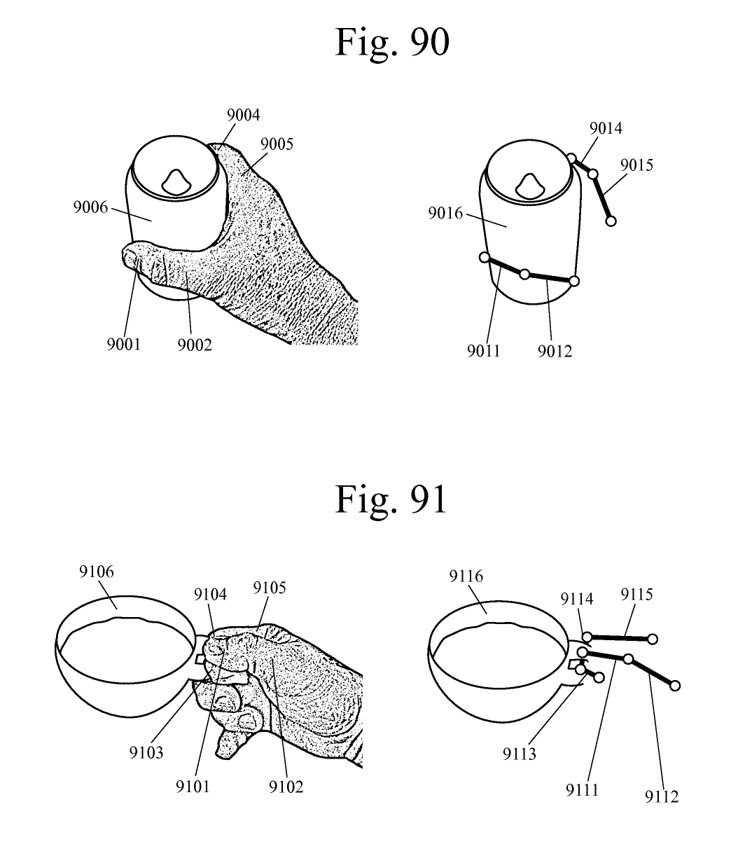

FIG. 90 shows an eating-related gesture in which a person grasps a beverage can with their hand (in a first hold). The left side of this figure shows the hand and can, while the right side of this figure shows a virtual model of the hand and can. Actual objects tracked include: distal 9001 and proximal 9002 segments of a person's thumb; middle 9004 and proximal 9005 segments of the person's index finger; and beverage can 9006. Corresponding virtual objects tracked include: distal 9011 and proximal 9012 segments of a virtual thumb; middle 9014 and proximal 9015 segments of a virtual index finger; and virtual beverage can 9016. An eating-related gesture can be recognized when a person grasps a beverage can such that their thumb at least partially obscures the can. In an example, the gesture is recognized because the thumb obscures the geometric outline of the can. In an example, the gesture is recognized because the thumb obscures wording and/or a logo on the can. In an example, gesture recognition can further comprise recognizing the person bringing (and tilting the top of) the can toward their mouth.

In an example, a beverage can be recognized by having a generally cylindrical shape with a generally solid top, wherein the top further comprises an arcuate opening comprising between 10% and 30% of the area of the top. In an example, this opening can have a longitudinal axis along a radius of the top which extends from the center of the top to a proximal edge of the top. In an example, a distal (or center-facing) portion of this opening can be narrower than a proximal (or outer-facing) portion of this opening. In an example, an opening can have a shape selected from the group consisting of: circular, oval, asymmetric oval, rounded trapezoid, and tear drop. In an example, a beverage can may be recognized by a logo and/or wording on the can. In an example, a beverage can may be recognized by recognizing the gesture of a person pulling a tab or ring on the top of the can in order to expose the opening.

FIG. 91 shows an eating-related gesture in which a person grasps the handle of a (tea) cup with their thumb and index finger. The left side of this figure shows the person's hand and (tea) cup, while the right side shows a virtual model of the hand and (tea) cup. Actual objects tracked include: distal 9101 and proximal 9102 segments of a person's thumb; distal 9103, middle 9104, and proximal 9105 segments of the person's index finger; and (tea) cup 9106. Corresponding virtual objects tracked include: distal 9111 and proximal 9112 segments of a virtual thumb; distal 9113, middle 9114, and proximal 9115 segments of a virtual index finger; and virtual (tea) cup 9116. An eating-related gesture can be recognized when a person grasps a (tea) cup such that their thumb at least partially obscures the handle of the cup. In an example, the gesture is recognized because the thumb obscures the geometric outline of the cup. In an example, gesture recognition can further comprise recognizing the person bringing (and tilting the top of) the cup toward their mouth. In an example, the pinky can be extended when watching Downton Abbey.

FIG. 92 shows an example of an eating-related gesture in which a person grasps the handle of a cup (or mug) with their thumb, index finger, and middle finger. The left side of this figure shows the person's hand and cup (or mug), while the right side shows a virtual model of the hand and cup (or mug). Actual objects tracked include: distal 9201 and proximal 9202 segments of a person's thumb; distal 9203, middle 9204, and proximal 9205 segments of the person's index finger; and cup (or mug) 9206. Corresponding virtual objects tracked include: distal 9211 and proximal 9212 segments of a virtual thumb; distal 9213, middle 9214, and proximal 9215 segments of a virtual index finger; and virtual cup (or mug) 9216.

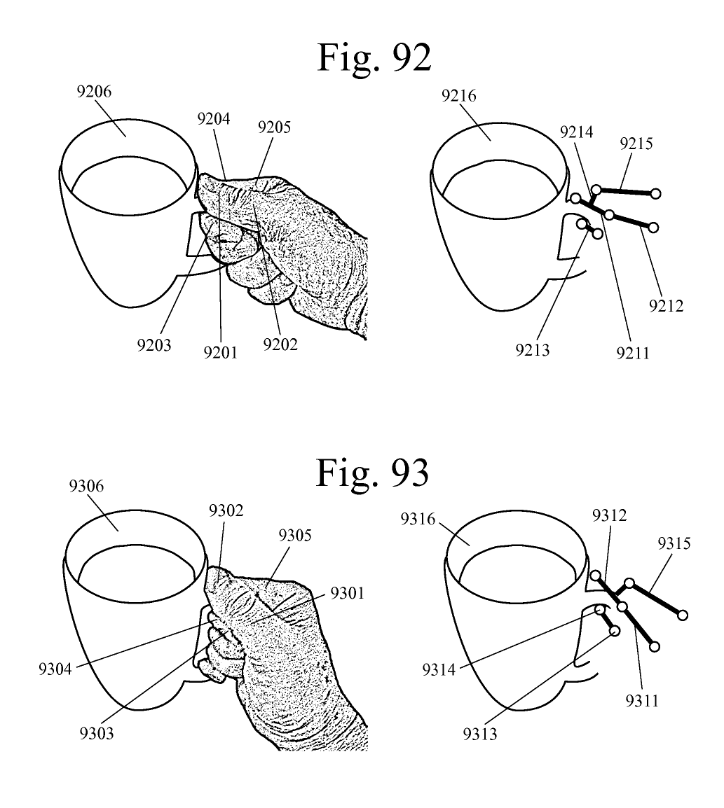

FIG. 93 shows an example of an eating-related gesture in which a person grasps the handle of a cup (or mug) with their thumb, index finger, middle finger, ring finger, and pinky finger. The left side of this figure shows the person's hand and cup (or mug), while the right side shows a virtual model of the hand and cup (or mug). Actual objects tracked include: distal 9301 and proximal 9302 segments of a person's thumb; distal 9303, middle 9304, and proximal 9305 segments of the person's index finger; and cup (or mug) 9306. Corresponding virtual objects tracked include: distal 9311 and proximal 9312 segments of a virtual thumb; distal 9313, middle 9314, and proximal 9315 segments of a virtual index finger; and virtual cup (or mug) 9316.

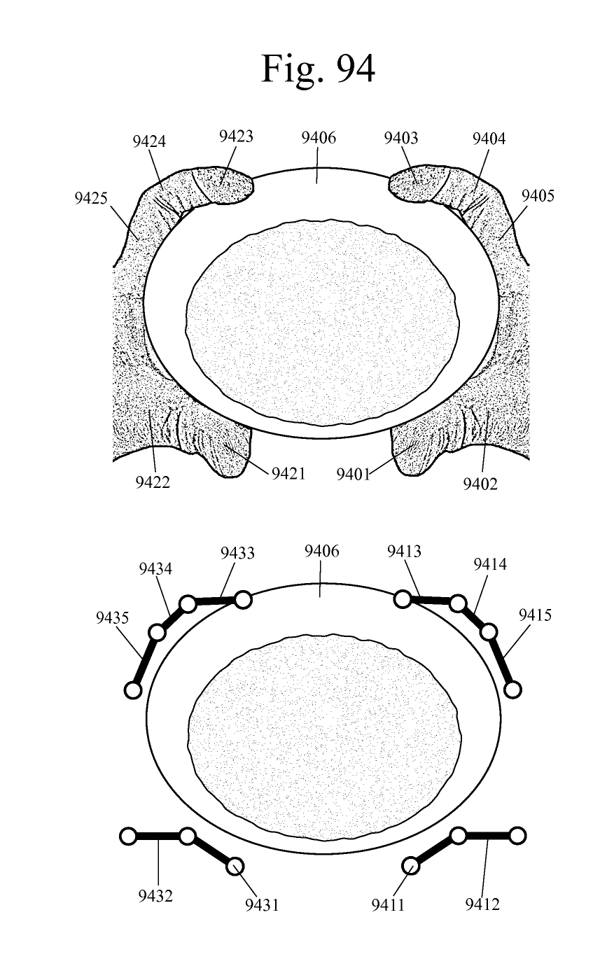

FIG. 94 shows an example of an eating-related gesture in which a person grasps a bowl with both hands. The top portion of this figure shows the person's hand and bowl, while the bottom portion shows a virtual model of the hand and bowl. Actual objects tracked include: distal 9401 and proximal 9402 segments of a person's right thumb; distal 9421 and proximal 9422 segments of a person's left thumb; distal 9403, middle 9404, and proximal 9405 segments of the person's right index finger; distal 9423, middle 9424, and proximal 9425 segments of the person's left index finger; and bowl 9406. Corresponding virtual objects tracked include: distal 9411 and proximal 9412 segments of a virtual right thumb; distal 9431 and proximal 9432 segments of a virtual left thumb; distal 9413, middle 9414, and proximal 9415 segments of a virtual right index finger; distal 9433, middle 9434, and proximal 9435 segments of a virtual left index finger; and virtual bowl 9416.

In an example, this invention can be embodied in a wearable device for identifying food consumption comprising: a wearable camera that is configured to be: part of eyewear; worn on, in, or around an ear; part of a necklace or pendant; or worn on a collar; and a data processor which uses gesture recognition to analyze the pictures taken by the camera in order to identify when the person is eating—wherein selected eating gestures are recognized by tracking the configuration and movement of one or more objects selected from the group consisting of: the person's thumb comprising a distal segment and a proximal segment; the person's index finger comprising a distal segment, a middle segment, and a proximal segment; a portion of food; and a food-transporting object selected from the group consisting of a fork, spoon, chop stick, drinking glass, beverage can, cup, mug, and bowl.

In an example, this invention can be embodied in a wearable device for identifying food consumption comprising: a wearable camera that is configured to be: part of eyewear; worn on, in, or around an ear; part of a necklace or pendant; or worn on a collar; and a data processor which uses gesture recognition to analyze pictures taken by the camera in order to identify when the person is eating—(a) wherein eating gestures are recognized by creating a virtual model, as seen from the perspective of a virtual camera, comprising one or more objects selected from the group consisting of: a virtual thumb comprising a distal segment and a proximal segment; a virtual index finger comprising a distal segment, a middle segment, and a proximal segment; a virtual portion of food; and a virtual food-transporting object selected from the group consisting of a virtual fork, spoon, chop stick, drinking glass, beverage can, cup, mug, and bowl; and (b) wherein the configurations and movements of one or more objects selected from the group consisting of: the virtual thumb, the virtual index finger, the virtual portion of food, and the virtual food-transporting object as seen from the virtual camera represent, respectively, the configurations and movements of one or more objects selected from the group consisting of: the person's actual thumb, the person's actual index finger, an actual portion of food, and an actual food-transporting object as seen from the perspective of the actual wearable camera.

In an example, this invention can be embodied in a method for identifying food consumption comprising: receiving pictures from a wearable camera that is configured to be: part of eyewear; worn on, in, or around an ear; part of a necklace or pendant; or worn on a collar; and analyzing these pictures in a data processor using gesture recognition in order to identify when the person is eating, wherein eating gestures associated with eating are recognized by tracking the configuration and movement of one or more objects selected from the group consisting of: the person's thumb comprising a distal segment and a proximal segment; the person's index finger comprising a distal segment, a middle segment, and a proximal segment; a portion of food; and a food-transporting object selected from the group consisting of a fork, spoon, chop stick, drinking glass, beverage can, cup, mug, and bowl.

In an example, an eating gesture can be recognized when: (a) the distal segment of the thumb and the distal segment of the index finger move toward each other; (b) at least one of these two distal segments at least partially obscures the view of the portion of food from the camera; and (c) then at least one of these two distal segments moves toward the camera. In an example, an eating gesture can be recognized when: (a) the distal segment of the thumb and the distal segment of the index finger move toward each other; (b) at least one of these two distal segments at least partially obscures the view of the portion of food from the camera; and (c) then at least one of these two distal segments increases in apparent size from the perspective of the camera.

In an example, an eating gesture can be recognized when: (a) the distal segment of the thumb and the distal segment of the index finger move toward each other; (b) the portion of food at least partially obscures the view of at least one of these two distal segments from the camera; and (c) then the portion of food moves toward the camera. In an example, an eating gesture can be recognized when: (a) the distal segment of the thumb and the distal segment of the index finger move toward each other; (b) the portion of food at least partially obscures the view of at least one of these two distal segments from the camera; and (c) then the portion of food increases in apparent size from the perspective of the camera.

In an example, an eating gesture can be recognized when: (a) the distal segment of the thumb and the distal segment of the index finger move toward each other; (b) the portion of food at least partially obscures the view of at least one of these two distal segments from the camera; and (c) then the portion of food moves toward the camera, during which movement at least one of these two distal segments moves closer to the camera than the proximal segment of the same object. In an example, an eating gesture can be recognized when: (a) the distal segment of the thumb and the distal segment of the index finger move toward each other; (b) the portion of food at least partially obscures the view of at least one of these two distal segments from the camera; and (c) then the portion of food moves toward the camera, during which movement at least one of these two distal segments moves a greater distance than the proximal segment of the same object.

In an example, an eating gesture can be recognized when: (a) the distal segment of the thumb and the distal segment of the index finger move toward each other; (b) the portion of food at least partially obscures the view of at least one of these two distal segments from the camera; and (c) then the portion of food moves toward the camera, during which movement at least one of these two distal segments increases in apparent size, from the perspective of the camera, more than the increase in apparent size of the proximal segment of the same object. In an example, an eating gesture can be recognized when: (a) the distal segment of the thumb and the distal segment of the index finger move toward each other; (b) the distal segment of the thumb at least partially obscures the view of the handle of the fork, spoon, or chop stick from the camera; and (c) then the fork, spoon, or chop stick moves toward the camera.

In an example, an eating gesture can be recognized when: (a) the distal segment of the thumb and the distal segment of the index finger move toward each other; (b) the distal segment of the thumb at least partially obscures the view of the handle of the fork, spoon, or chop stick from the camera; and (c) then the fork, spoon, or chop stick increases in apparent size from the perspective of the camera. In an example, an eating gesture can be recognized when: (a) the distal segment of the thumb and the distal segment of the index finger move toward each other; (b) the distal segment of the thumb at least partially obscures the view of the handle of the fork, spoon, or chop stick from the camera; and (c) then the fork, spoon, or chop stick moves toward the camera, during which movement the distal segment of the thumb moves closer to the camera than the proximal segment of the thumb.

In an example, an eating gesture can be recognized when: (a) the distal segment of the thumb and the distal segment of the index finger move toward each other; (b) the distal segment of the thumb at least partially obscures the view of the handle of the fork, spoon, or chop stick from the camera; and (c) then the fork, spoon, or chop stick moves toward the camera, during which movement the distal segment of the thumb moves a greater distance than the proximal segment of the thumb. In an example, an eating gesture can be recognized when: (a) the distal segment of the thumb at least partially obscures the view of the handle of the fork, spoon, or chop stick from the camera; (b) the fork, spoon, or chop stick moves from right to left, or vice versa, across a portion of the field of view of the camera; and (c) then the fork, spoon, or chop stick moves toward the camera.

In an example, an eating gesture can be recognized when: (a) the distal segment of the thumb at least partially obscures the view of the handle of the fork, spoon, or chop stick from the camera; (b) the fork, spoon, or chop stick moves from right to left, or vice versa, across a portion of the field of view of the camera; and (c) then the fork, spoon, or chop stick moves toward the camera, during which movement the distal segment of the thumb moves closer to the camera than the proximal segment of the thumb. In an example, an eating gesture can be recognized when: (a) the distal segment of the thumb at least partially obscures the view of the handle of the fork, spoon, or chop stick from the camera; (b) the fork, spoon, or chop stick moves from right to left, or vice versa, across a portion of the field of view of the camera; and (c) then the fork, spoon, or chop stick moves toward the camera, during which movement the distal segment of the thumb moves a greater distance than the proximal segment of the thumb.

In an example, an eating gesture can be recognized when: (a) the distal segment of the thumb and the distal segment of the index finger move toward each other; (b) the distal segment of the thumb at least partially obscures the view of the drinking glass, beverage can, cup, or bowl from the camera; and (c) then the drinking glass, beverage can, cup, or bowl moves toward the camera. In an example, an eating gesture can be recognized when: (a) the distal segment of the thumb and the distal segment of the index finger move toward each other; (b) the distal segment of the thumb at least partially obscures the view of the drinking glass, beverage can, cup, or bowl from the camera; and (c) then the drinking glass, beverage can, cup, or bowl moves toward the camera, during which movement the distal segment of the index finger moves a greater distance than the distal segment of the thumb. In an example, an eating gesture can be recognized when: (a) the distal segment of the thumb and the distal segment of the index finger move toward each other; (b) the distal segment of the thumb at least partially obscures the view of the drinking glass, beverage can, cup, or bowl from the camera; and (c) then the drinking glass, beverage can, cup, or bowl moves toward the camera, during which movement the top of the drinking glass, beverage can, cup, or bowl tilts toward the camera.

In an example, a portion of food can be recognized based on one or more factors selected from the group consisting of: shape, size, color, shading, lighting, texture, co-located food, geographic location, type of food-transporting object used, shape of packaging or container, size of packaging or container, color packaging or container, design of packaging or container, logo of packaging or container, and identification code on packaging or container. In an example, a data processor can estimate the amount of food that the person consumes based on the number, frequency, and/or timing of repeated eating gestures. In an example, a data processor can estimate the amount of food that the person consumes based on Fourier Transformation analysis of the timing of repeated eating gestures.

I claim:

1. A wearable device for identifying food consumption comprising:
a wearable camera that is configured to be: part of eyewear; worn on, in, or around an ear; part of a necklace or pendant; or worn on a collar; and
a data processor which uses gesture recognition to analyze the pictures taken by the camera in order to identify when the person is eating—wherein selected eating gestures are recognized by tracking the configuration and movement of one or more objects selected from the group consisting of: the person's thumb comprising a distal segment and a proximal segment; the person's index finger comprising a distal segment, a middle segment, and a proximal segment; a portion of food; and a food-transporting object selected from the group consisting of a fork, spoon, chop stick, drinking glass, beverage can, cup, mug, and bowl.

2. The device in claim 1 wherein a selected type of eating gesture is recognized when: (a) the distal segment of the thumb and the distal segment of the index finger move toward each other; (b) at least one of these two distal segments at least partially obscures the view of the portion of food from the camera; and (c) then at least one of these two distal segments moves toward the camera.

3. The device in claim 1 wherein a selected type of eating gesture is recognized when: (a) the distal segment of the thumb and the distal segment of the index finger move toward each other; (b) at least one of these two distal segments at least partially obscures the view of the portion of food from the camera; and (c) then at least one of these two distal segments increases in apparent size from the perspective of the camera.

4. The device in claim 1 wherein a selected type of eating gesture is recognized when: (a) the distal segment of the thumb and the distal segment of the index finger move toward each other; (b) the portion of food at least partially obscures the view of at least one of these two distal segments from the camera; and (c) then the portion of food moves toward the camera.

5. The device in claim 1 wherein a selected type of eating gesture is recognized when: (a) the distal segment of the thumb and the distal segment of the index finger move toward each other; (b) the portion of food at least partially obscures the view of at least one of these two distal segments from the camera; and (c) then the portion of food increases in apparent size from the perspective of the camera.

6. The device in claim 1 wherein a selected type of eating gesture is recognized when: (a) the distal segment of the thumb and the distal segment of the index finger move toward each other; (b) the portion of food at least partially obscures the view of at least one of these two distal segments from the camera; and (c) then the portion of food moves toward the camera, during which movement at least one of these two distal segments moves closer to the camera than the proximal segment of the same object.

7. The device in claim 1 wherein a selected type of eating gesture is recognized when: (a) the distal segment of the thumb and the distal segment of the index finger move toward each other; (b) the portion of food at least partially obscures the view of at least one of these two distal segments from the camera; and (c) then the portion of food moves toward the camera, during which movement at least one of these two distal segments moves a greater distance than the proximal segment of the same object.

8. The device in claim 1 wherein a selected type of eating gesture is recognized when: (a) the distal segment of the thumb and the distal segment of the index finger move toward each other; (b) the portion of food at least partially obscures the view of at least one of these two distal segments from the camera; and (c) then the portion of food moves toward the camera, during which movement at least one of these two distal segments increases in apparent size, from the perspective of the camera, more than the increase in apparent size of the proximal segment of the same object.

9. The device in claim 1 wherein a selected type of eating gesture is recognized when: (a) the distal segment of the thumb and the distal segment of the index finger move toward each other; (b) the distal segment of the thumb at least partially obscures the view of the handle of the fork, spoon, or chop stick from the camera; and (c) then the fork, spoon, or chop stick moves toward the camera.

10. The device in claim 1 wherein a selected type of eating gesture is recognized when: (a) the distal segment of the thumb and the distal segment of the index finger move toward each other; (b) the distal segment of the thumb at least partially obscures the view of the handle of the fork, spoon, or chop stick from the camera; and (c) then the fork, spoon, or chop stick increases in apparent size from the perspective of the camera.

11. The device in claim 1 wherein a selected type of eating gesture is recognized when: (a) the distal segment of the thumb and the distal segment of the index finger move toward each other; (b) the distal segment of the thumb at least partially obscures the view of the handle of the fork, spoon, or chop stick from the camera; and (c) then the fork, spoon, or chop stick moves toward the camera, during which movement the distal segment of the thumb moves closer to the camera than the proximal segment of the thumb.

12. The device in claim 1 wherein a selected type of eating gesture is recognized when: (a) the distal segment of the thumb and the distal segment of the index finger move toward each other; (b) the distal segment of the thumb at least partially obscures the view of the handle of the fork, spoon, or chop stick from the camera; and (c) then the fork, spoon, or chop stick moves toward the camera, during which movement the distal segment of the thumb moves a greater distance than the proximal segment of the thumb.

13. The device in claim 1 wherein a selected type of eating gesture is recognized when: (a) the distal segment of the thumb at least partially obscures the view of the handle of the fork, spoon, or chop stick from the camera; (b) the fork, spoon, or chop stick moves from right to left, or vice versa, across a portion of the field of view of the camera; and (c) then the fork, spoon, or chop stick moves toward the camera.

14. The device in claim 1 wherein a selected type of eating gesture is recognized when: (a) the distal segment of the thumb at least partially obscures the view of the handle of the fork, spoon, or chop stick from the camera; (b) the fork, spoon, or chop stick moves from right to left, or vice versa, across a portion of the field of view of the camera; and (c) then the fork, spoon, or chop stick moves toward the camera, during which movement the distal segment of the thumb moves closer to the camera than the proximal segment of the thumb.

15. The device in claim 1 wherein a selected type of eating gesture is recognized when: (a) the distal segment of the thumb at least partially obscures the view of the handle of the fork, spoon, or chop stick from the camera; (b) the fork, spoon, or chop stick moves from right to left, or vice versa, across a portion of the field of view of the camera; and (c) then the fork, spoon, or chop stick moves toward the camera, during which movement the distal segment of the thumb moves a greater distance than the proximal segment of the thumb.

16. The device in claim 1 wherein a selected type of eating gesture is recognized when: (a) the distal segment of the thumb and the distal segment of the index finger move toward each other; (b) the distal segment of the thumb at least partially obscures the view of the drinking glass, beverage can, cup, or bowl from the camera; and (c) then the drinking glass, beverage can, cup, or bowl moves toward the camera.

17. The device in claim 1 wherein a selected type of eating gesture is recognized when: (a) the distal segment of the thumb and the distal segment of the index finger move toward each other; (b) the distal segment of the thumb at least partially obscures the view of the drinking glass, beverage can, cup, or bowl from the camera; and (c) then the drinking glass, beverage can, cup, or bowl moves toward the camera, during which movement the distal segment of the index finger moves a greater distance than the distal segment of the thumb.

18. The device in claim 1 wherein a selected type of eating gesture is recognized when: (a) the distal segment of the thumb and the distal segment of the index finger move toward each other; (b) the distal segment of the thumb at least partially obscures the view of the drinking glass, beverage can, cup, or bowl from the camera; and (c) then the drinking glass, beverage can, cup, or bowl moves toward the camera, during which movement the top of the drinking glass, beverage can, cup, or bowl tilts toward the camera.

19. The device in claim 1 wherein a portion of food is recognized based on one or more factors selected from the group consisting of: shape, size, color, shading, lighting, texture, co-located food, geographic location, type of food-transporting object used, shape of packaging or container, size of packaging or container, color packaging or container, design of packaging or container, logo of packaging or container, and identification code on packaging or container.

20. A wearable device for identifying food consumption comprising:
a wearable camera that is configured to be: part of eyewear; worn on, in, or around an ear; part of a necklace or pendant; or worn on a collar; and
a data processor which uses gesture recognition to analyze pictures taken by the camera in order to identify when the person is eating—(a) wherein eating gestures are recognized by creating a virtual model, as seen from the perspective of a virtual camera, comprising one or more objects selected from the group consisting of: a virtual thumb comprising a distal segment and a proximal segment; a virtual index finger comprising a distal segment, a middle segment, and a proximal segment; a virtual portion of food; and a virtual food-transporting object selected from the group consisting of a virtual fork, spoon, chop stick, drinking glass, beverage can, cup, mug, and bowl; and (b) wherein the configurations and movements of one or more objects selected from the group consisting of: the virtual thumb, the virtual index finger, the virtual portion of food, and the virtual food-transporting object as seen from the virtual camera represent, respectively, the configurations and movements of one or more objects selected from the group consisting of: the person's actual thumb, the person's actual index finger, an actual portion of food, and an actual food-transporting object as seen from the perspective of the actual wearable camera.
